(19) United States
(12) Patent Application Publication
(10) Pub. No.: US 2009/0135345 A1
(43) Pub. Date: May 28, 2009

(54) Polarizing Plate Protective Film, Film Producing Method, Polarizing Plate, and Liquid Crystal Display

(76) Inventors: Takatoshi Yajima, Hyogo (JP); Takashi Murakami, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/086,112

(22) PCT Filed: Dec. 1, 2006
(86) PCT No.: PCT/JP2006/324051

§ 371 Date: Jun. 5, 2008

(30) Foreign Application Priority Data
Dec. 12, 2005 (JP) 2005-357809

(51) Int. Cl. G02F 1/1335; G02B 1/08; B29C 67/00

(52) U.S. Cl. 349/96; 359/485; 264/175

(57) ABSTRACT

Disclosed is a method for production of a film, which comprises the steps of: extruding a molted material containing a cellulose resin on a cooling roll from a die in a film-like form at a draw ratio ranging from 10 to 30 inclusive; pressing the extruded molted film on the cooling roll with a touch roll; and transferring the molted film while solidifying the film on the cooling roll, wherein the touch roll has a metal-made outer cylinder, an inner cylinder, and a space for accommodating a cooling medium between the metal-made outer cylinder and the inner cylinder and also has a touch roll linear pressure ranging from 1 to 15 kg/cm inclusive during pressing with the touch roll.

### TECHNICAL FIELD

The present invention relates to a polarizing plate protective film, film producing method, polarizing plate, and liquid crystal display, in particular, to the polarizing plate protective film which employs cellulose ester resin, is produced by a melt casting film forming method and does not exhibit light and dark streaks caused by die lines and spot-like unevenness when an image is displayed on it with a liquid crystal display, the film producing method, the polarizing plate, and the liquid crystal display.

### BACKGROUND ART

In comparison with conventional CRT displays, a liquid crystal display has been widely used as a monitor from viewpoints of space saving and energy saving. Furthermore, it becomes popular to be used for TV. For such a liquid crystal display, various kinds of optical films such as polarizing plate protective film, retardation film, antireflection film, luminance improving film are used.

In a polarizing plate, a cellulose ester film is laminated at one side or both sides of a polarizer composed of a stretched polyvinyl alcohol film. Namely, a polarizer itself has not sufficient durability over humidity or ultraviolet rays. Then, the polarizer is provided with the sufficient durability by being laminated with a cellulose ester film of about 40 to 100 μm thickness as a protection film.

These optical films including the cellulose ester film are required to have no optical defect and uniform retardation. In particular, as a monitor and TV are being enlarged more and resolved finely more, such required qualities become more severe.

The producing methods of optical films are roughly classified into a solution casting film forming method and a melt casting film forming method.

The solution casting film forming method forms a film by melting polymer in a solvent, casting the solution on a support, evaporating the solvent and drying the film, and further stretching the film if required. This method is applicable if polymer is soluble to a solvent and is excellent in uniformity of film thickness. Therefore, this method has been widely adopted for a norbornene base polymer film and a cellulose triacetate film and so on. However, this method has problems that the equipment becomes larger for drying solvents.

The melt casting film forming method forms a film by heating and melting polymer to obtain melt, extruding the melt from a die in the shape of a film, cooling and solidifying this film, and further stretching the film if required. Since it is not necessary to evaporating solvent, there is an advantage that the equipment can be made comparatively compact.

However, in comparison with a polymer solution, the viscosity of a molten polymer is usually higher about 10 to 100 times and it may be difficult to level the molten polymer on a support. Therefore, it may be easy to cause strong streak-like defects called die lines. If these die lines are too strong, there has been a problem that light and dark streaks caused by die lines are observed when an obtained optical film is built into a liquid crystal display.

Especially, the melt of cellulosic resin has high viscosity and the characteristics which cannot be extended easily. Therefore, it has been difficult to form a film by the melt casting method. On the condition where a draw ratio mentioned later is high, there are problems that the thickness unevenness in the film conveying direction (hereafter, the film conveying direction may be referred sometimes to a film longitudinal direction) becomes large and fracture takes place easily in a tenter stretching process. Therefore, the reduction of the die lines has been a task in the melt casting film forming method with cellulosic resin.

As a method of reducing such a streak-like defect, a method of bringing a film in close contact with a cooling roller by a rigid metal touch roller has been considered. However, with this method, unevenness of touch pressure could never be removed. As a result, there is a problem that optical unevenness such as retardation becomes large.

In order to solve the problem at the time of using such a metal touch roller, a method of using an elastic touch roller has been proposed.

Patent document 1 discloses that when amorphous thermoplastic resin is extruded to form a film, if the film of a specific film temperature is brought in pressure contact with a cooling roller by a temperature-controlled elastic roller, an optical film having no optical unevenness may be obtained. As the elastic roller, it is supposed that a rubber roller covered with a metal sleeve is desirable. More concretely, a silicone rubber (thickness of 5 mm) roller covered with a metal sleeve with a thickness of 200 μm is used.

Patent document 2 discloses that when amorphous thermoplastic resin is extruded to form a film, if the film is brought in close contact with a cooling roller by a touch roller having a elastic deformable surface on the condition where a contact width between the touch roller and the cooling roller becomes a specified contact width at the time of being not rotated, an optical film excellent in thickness accuracy may be obtained. As a concrete example of touch roller, a silicon rubber (thickness of 5 mm) roller whose surface is covered with a metal tube of 200 μm is used.

In these examples, the effects are verified by the use of norbornene base resin as polymer.

However, in the case where the melt casting film formation of cellulose ester resin was conducted in such ways that the film formation was performed by the use of the elastic touch roller disclosed by the above-mentioned Patent documents 1 and Patent documents 2 and a polarizing plate was produced by the use of the obtained cellulose ester film, the inventor learned that when the produced polarizing plate was installed in a liquid crystal display and the display was used on a black indication mode, there was a problem that light and dark spot-like unevenness was observed overall.

Then, as a result of investigating the cause of the occurrence of spot-like unevenness, the inventor found the following problems. Since a rubber having a high adiathermic is used for this elastic touch roller, even if the touch roller is cooled with a coolant from the inside of the touch roller, the touch roller surface is not fully cooled. Since minute gaps occur inevitably between a thin metal sleeve and a rubber, the temperature unevenness on the surface of the touch roller is not avoided.

Furthermore, in the investigation of the melt casting film formation of cellulose ester resin by the inventor, when a 100 μm film was formed by the use of a die having the same lip clearance of 800 μm as the example described in Patent documents 2, that is, when the film was formed with a draw rate of 8, remarkable problems were not observed on the surface of the film right after the casting when the film forming speed was slow. However, the inventor found that as the film forming speed was increased more, concavo-convex-like unevenness and spot-like unevenness occurred on the film surface right after the casting.

Although there is no description about the film forming speed in the above-mentioned patent documents, even when the film forming speed is for example 15m/minutes, the actual situation is that spot-like unevenness is remarkable, productivity is poor and the obtained film cannot be used for actual usage.

Moreover, in Patent document 3, the temperature of an amorphous-thermoplastic-resin film just before being brought in contact with a cooling roller is made Tg+30° C. or more, and when the film thickness is 70 μm to 100 μm, the draw ratio is set to 10 or less, when the film thickness is 50 μm to 70 μm, the draw ratio is set to 15 or less, and further when the film thickness is 50 μm or less, the draw ratio is set to 20 or less, an optical film having no optical unevenness can be obtained. In this document, the technique that a film is brought in close contact with a cooling roller by pressing or sucking is described and various means are listed. Concretely, an air chamber is used in the case of shaping norbornene base resin and polysulfone resin.

However, with this method, the die line is strong. Therefore, when an image is displayed on a liquid crystal display, there is a problem that light and dark streaks caused by the die lines are observed.

As explained above, the present situation is that a polarizing plate protective film produced by the melt casting film forming method with cellulose ester resin does not reached a practical use level.

The film made of cellulose ester resin as a main constitutional raw material has features such as optical evenness, less optical defects and so on, and has another features such as excellent adhesive ability with a polarizer and proper moisture permeability at the time of being pasted onto a polarizing plate stretched by a wet type. Therefore, there is a demand for a producing method of a polarizing plate protective film made of a cellulose ester resin as a main constitutional raw material by the melt casting film forming method in which the above various problems are improved.

Patent document 1: Japanese Patent Unexamined Publication No. 2005-172940

Patent document 2: Japanese Patent Unexamined Publication No. 2005-280217

Patent document 3: Japanese Patent Unexamined Publication No. 2005-131006

### DISCLOSURE OF THE INVENTION

### Problem to be Solved by the Invention

Therefore, an object of the present invention is to provide a polarizing plate protective film which employs cellulose ester resin, is produced by a melt casting film forming method and does not exhibit light and dark streaks caused by die lines and spot-like unevenness when an image is displayed on a liquid crystal display, the film producing method, a polarizing plate, and a liquid crystal display.

### Means for Solving the Problem

As a result of investigation, the inventor found that the above-mentioned various tasks can be solved by setting a relationship (draw ratio) between the lip clearance of a die and the average film thickness of a cast, cooled and solidified film to a range larger the conventional range well know for cellulose ester film, and pressing the film with a specified touch roller on a specified condition, and the inventor finally reached the present invention.

Namely, in comparison with other thermoplastic resins, a melt containing cellulosic resin has a high melt viscosity and is difficultly stretched. Therefore, there are problems that when the draw ratio is large, thickness fluctuations tends to take place in a conveying direction and fracture tends to take place when the film is stretched in a tenter process. Accordingly, the film formation has been conducted with a draw ratio of about 7 to 8.

In contrast, in the present invention, a melt containing cellulosic resin is extruded from a die into the shape of a film such that the draw ratio becomes 10 or more and 30 or less, and the extruded film is conveyed while being pressed onto a cooling roller by a touch roller, whereby the above-mentioned themes can be solved.

More concretely, the above-mentioned theme of the present invention can be attained by the following constitutions.

The invention described in claim 1 is a film producing method of extruding a melt containing cellulosic resin from a die onto a cooling roller in the shape of a film such that the draw ratio becomes 10 or more and 30 or less; pressing the extruded melted film onto the cooling roller by a touch roll; and conveying the melted film while further solidifying the melted film on the cooling roller, and the film producing method is characterized in that the touch roller comprises a metallic outer cylinder, an inner cylinder and a space to accommodate a coolant between the metallic outer cylinder and the inner cylinder; and when the touch roller presses the film onto the cooling roller, a touch roller line pressure is 1 kg/cm² or more and 15 kg/cm² or less, (here, the draw ratio is a value obtained by dividing the lip clearance B of the die by the average thickness A of the solidified film on the cooling roller).

The invention described in claim 2 is the film producing method described in claim 1 and characterized in that when the thickness of the film solidified on the above-mentioned cooling roller is 70 μm or more and 100 μm or less, the draw ratio is 10 or more and less than 20.

The invention described in claim 3 is the film producing method described in claim 1 and characterized in that when the thickness of the film solidified on the above-mentioned cooling roller is 50 μm or more and less than 70 μm or less, the draw ratio is 20 or more and less than 25.

The invention described in claim 4 is the film producing method described in claim 1 and characterized in that when the thickness of the film solidified on the above-mentioned cooling roller is less than 50 μm, the draw ratio is 25 or more and 30 or less.

The invention described in claim 5 is the film producing method described in claim 1 and characterized in that the above-mentioned touch roller line pressure is 2 kg/cm or more and less than 10 kg/cm.

The invention described in claim 6 is the film producing method described in any one of claims 1 to 5 and characterized in that the touch roller side film surface temperature T (° C.) of the melted film is Tg<T<Tg+110, (here, Tg is a glass transition temperature of the film obtained by DSC measurement).

The invention described in claim 7 is a polarizing plate protective film characterized by being produced by the film producing method described in any one of claims 1 to 5.

The invention described in claim 8 is a polarizing plate characterized in that the polarizing plate protective film described in claim 7 is pasted on at least one surface of a polarizer.

The invention described in claim 9 is a liquid crystal display apparatus characterized in that the polarizing plate described in claim 8 is pasted on at least one surface of a liquid crystal cell.

### EFFECT OF THE INVENTION

According to the present invention, it is possible to provide a polarizing plate protective film which employs cellulose ester resin, is produced by a melt casting film forming method and does not exhibit light and dark streaks caused by die lines and spot-like unevenness when an image is displayed on a liquid crystal display, a film producing method, a polarizing plate, and a liquid crystal display.

### BRIEF DESCRIPTION OF THE DRAWING

FIG. 1 is an explanatory diagram for an apparatus for producing a polarizing plate protective film of the present invention.

FIG. 2 is an explanatory diagram for a lip clearance B of a die and a cast film F.

FIG. 3 is a sectional view of a touch roller of the present invention.

### EXPLANATION OF REFERENCE SIGN

1 extruder
2 filter
3 static mixer
4 casting die (including a thickness adjusting section)
5 touch Roller
6 first Cooling Roller
7 second Cooling Roller
8 separating roller
9 stretching device
10 thickness measuring section
11 wind-up device
12 wound-up roll
B lip clearance of a die

### BEST MODE FOR CARRYING OUT THE INVENTION

Although the best mode for carrying out the present invention is explained below in detail, the present invention is not limited to these.

The melt casting in the present invention is defined as a method of heat melting a composition containing cellulosic resin and additives such as a plasticizer to a temperature at which the composition shows fluidity, thereafter casting a melt containing fluid cellulosic resin.

More particularly, a forming method by the heat melting can be classified into a melt extruding method, a press-forming method, an inflation method, an injection molding process, a blow molding method, and a stretching forming method. Among these methods, in order to obtain a polarizing plate protective film excellent in terms of mechanical strength, surface precision, etc., the melt extruding method is excellent.

Here, as a melt casting film forming method, the melted film producing method according to the present invention includes a method of heating a film constituting material so as to exhibit fluidity, and thereafter, extruding the material onto a drum or an endless belt so as to form a film.

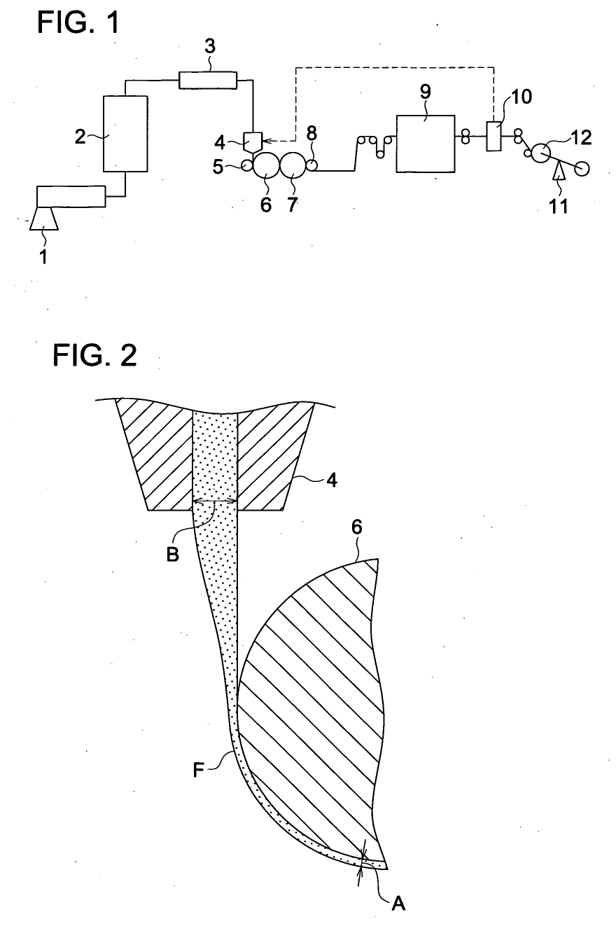

FIG. 1 is an explanatory diagram for an apparatus for producing an optical film based on the melt casting film forming method. In FIG. 1, after film materials containing cellulosic resin and additives are mixed, the mixed film material is melted and extruded by the use of an extruder 1. The extruded film material is filtered with a filter 2, whereby a foreign matter is removed. Furthermore, by a static mixer 3, an additive can be added into the film material and mixed uniformly.

The melted film material prepared at these processes is cast on a first cooling roller 6 from a casting die 4, and forms a melted film on the first cooling roller 6. The melted film is pressed onto the surface of the first cooling roller 5 with a predetermined pressure by a touch roller 5. Furthermore, the melted film is brought in contact with an outer surface of a second cooling roller 7, whereby melted film is cooled and solidified, and then the solidified film is separated from the second cooling roller 7 with a separating roller 8. The separated web-like film 10 is stretched widthwise direction while being grasped both ends of the film by a stretching device 9, and thereafter, the web-like film 10 is wound up as a roll 12 by a wind-up device 11.

FIG. 2 is a schematic diagram showing the status that a melted film F is cast onto the first cooling roller 6 from a casting section of a die 4, and a lip clearance B of a die is a gap (slit gap) of an extruding section. The draw ratio is a value obtained by dividing the lip clearance B of the casting section of the die 4 by an average thickness A of the film F solidified on the cooling roller. The film thickness after stretching is measured in the thickness measuring section 10 in FIG. 1, however, the film thickness after solidification on the cooling roller is measured before stretching, and then a thickness adjusting section of the die is controlled in accordance with the measurement result so as to obtain a specified thickness A of the film F.

By making the draw ratio into a range of 10 or more and 30 or less, it becomes possible to obtain a polarizing plate protective film which is excellent in productivity and does not exhibits light and dark streaks and spot-like unevenness when an image is displayed on it with a liquid crystal display. The draw ratio can be adjusted by the lip clearance of a die and a take-up velocity of the cooling roller. The die lip clearance is desirably 900 μm or more, and more desirably 1 mm or more and 2 mm or less. If this lip clearance is too small or too large, the spot-like unevenness may not be improved.

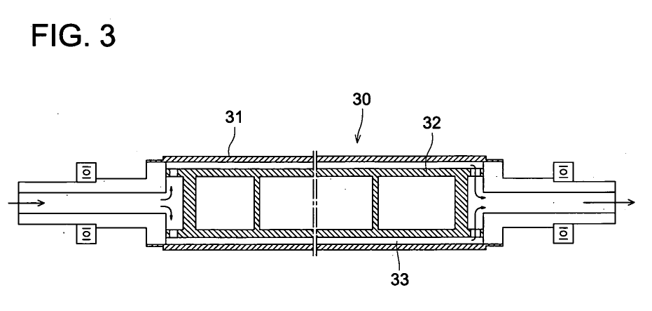

As shown in FIG. 3, the touch roller 30 used in the present invention has a double structure of a metallic outer cylinder 31 and an inner cylinder 32 and has a space 33 between these cylinders to allow cooling fluid to flow through. Furthermore, since the metallic outer cylinder has elasticity, the temperature on the surface of a touch roller can be controlled with sufficient precision. In addition, by utilizing the characteristic to elastically deform moderately, a distance to press the film in a longitudinal direction can be obtained. With these effects, when an image is displayed on a film with a liquid crystal display, it is possible to obtain the effects of the present invention of no light and dark steaks and no spot-like unevenness.

If the range of the thickness of a metallic outer cylinder is 0.003≦(the thickness of the metallic outer cylinder)/(the radius of the metallic outer cylinder)≦0.03, it is desirable that it's elasticity becomes proper. If the radius of the metallic outer cylinder is large, even if the thickness of metallic outer cylinder is thick, it sags or bends moderately. The diameter of the metallic outer cylinder is desirably 100 mm to 600 mm. When the thickness of the metallic outer cylinder is too thin, the strength becomes insufficient. As a result, there is concern of breakage. On the other hand, when it is too thick, the weight of the roller becomes heavy, and there is concern of rotational unevenness. Therefore, the thickness of the metallic outer cylinder is desirably 0.1 to 5 mm.

The surface roughness of the surface of the metallic outer cylinder is desirably 0.1 μm or less by Ra, and more desirably 0.05 μm or less. The smoother the surface of the roller is, the smoother the surface of the obtained film can also be made.

The material of the metallic outer cylinder is required to be smooth, moderately elastic and durable. Carbon steel, stainless steel, titanium, the nickel manufactured by electroforming, etc. can be used preferably. Furthermore, in order to raise the hardness of its surface or to improve a separating ability with resin, it is desirable to be applied with a surface treatment such as a hard chrome plating, a nickel plate, an amorphous chrome plating, and a ceramic spraying. It is desirable to further polish the surface having being applied with the surface treatment so as to make it to be the above-mentioned surface roughness.

The inner cylinder is desirably a metallic inner cylinder which is rigid and made of carbon steel, stainless steel, aluminium, and titanium to be light in weight. By giving rigidity to the inner cylinder, rotational fluctuation of the roller can be suppressed. By making the thickness of the inner cylinder into two to 10 times of that of the outer cylinder, it is possible to obtain sufficient rigidity. The inner cylinder may be covered with an elastic material made of resin such as silicone and fluororubber.

The structure of a space to allow a cooling fluid to flow through may be one which can control the temperature of the surface of the roller uniformly. For example, with structures to flow a fluid forward and backward alternately over the widthwise direction or to flow a fluid in a spiral shape, the temperature distribution of the surface of the roller can be controlled with a small deviation. The cooling fluid is not restricted in particular, and water or oil may be used as it in accordance with a temperature range to be used.

The temperature of the surface of a touch roller (metallic outer cylinder) is desirably lower than the glass transition temperature (Tg) of a film. If it is higher than Tg, the separating ability between the film and the roller may be inferior. If it is too low, a volatile component may deposit out of the film onto the roller. Therefore, it is more desirable that it is 10° C. to Tg−10° C.

Here, Tg is Tg of a film and is obtained by DSC measurement (temperature rising rate: 10° C./minute) such that the measured temperature states deviating from a baseline at the temperature of Tg.

The touch roller used in the present invention is desirably shaped in a so-called crown roller in which the diameter at a central portion along the width direction is larger than that at end portions. Usually, both ends of the touch roller are pushed toward a film by a pressing means. At this time, since the touch roller may bend, there is a phenomenon that the film is pressed with a force at the both end portions stronger than that at the central portion. By shaping the touch roller in a crown form, the film is pressed with a highly uniform force along the widthwise direction.

The width of the touch roller used in the present invention is preferably made larger than that of a film, because the touch roller can bring the whole film in close contact with a cooling roller. Further, if the draw ratio becomes larger, the both ends of a film may become “ear high” (the thickness of end portions becomes thick than a central portion) due to a neck-in phenomenon. In this case, in order to avoid “ear high”, the width of a metallic outer cylinder may be made narrower than that of a film. Alternatively, in order to avoid “ear high”, the outside diameter of a metallic outer cylinder may be made smaller.

As concrete examples of the metallic elastic touch roller, rollers for shaping disclosed in U.S. Pat. No. 3,194,904, U.S. Pat. No. 3,422,798, Japanese Patent Unexamined Publication No. 2002-36332, and Japanese Patent Unexamined Publication No. 2002-36333 are listed up.

In order to prevent bending or sagging of a touch roller, a support roll may be arranged to a cooling roller at the opposite side of a touch roller.

An equipment to clean the soil of a touch roller may be arranged. For the cleaning equipment, for example, a method of pressing against the touch roller a member such as a nonwoven fabric into which solvent is made to penetrate as required, a method of bring the touch roller in contact with a liquid, or a method of volatilizing the soil on the surface of a touch roller by plasma discharging, such as a corona discharging and a glow discharging may be preferably employed.

In order to make the temperature of the surface of a touch roller more uniform, a temperature control roller may be brought in contact with the touch roller, temperature-controlled air may be sprayed onto the touch roller, or a heat transfer media such as a liquid may be brought in contact with the touch roller.

In the present invention, a touch roller line pressure at the time of pressing a touch roller is needed to be 1 kg/cm or more and 15 kg/cm or less, and is desirably made to be 1 kg/cm or more and 10 kg/cm or less.

By making the touch roller line pressure within the above range, it is possible to obtain a polarizing plate protective film which exhibits no light and dark streak and no spot-like unevenness when an image is displayed on it with a liquid crystal display.

The line pressure is a value obtained by the calculation of dividing a power of a touch roller to press a film by the width of the film at the time of being pressed. The method of making the line pressure within the above-mentioned range is not limited in particular, for example, a method of pressing both ends of the roller by air cylinder or a hydraulic cylinder may be employed. By pressing the touch roller with a support roll, a film may be pressed indirectly.

Further, a touch roller side film surface temperature T at the time of pressing a touch roller is preferably made within a range of Tg<T<Tg+110° C. (Tg: glass transition temperature of a film), because die lines on the surface of a film can be smoothed. The higher the temperature of a film at the time of pressing the film with a touch roller is, the more light and dark streaks caused by die lines can be improved. However, if it is too high, spot-like unevenness may deteriorate. This is expected because a volatile component volatilizes out of a film, and then the film is not pressed uniformly at the time of being pressed by a touch roller. On the other hand, if it is too low, the light and dark streaks resulting from die lines may not be improved.

The method of making the film temperature within the above-mentioned range at the time of pressing the film is not limited specifically. However, for example, For example, a method of bringing a distance between a die and a cooling roller closer so as to suppress cooling between the die and the cooling roller, and a method of enclosing between a die and a cooling roller with a heat insulating material so as to keep temperature or warming by hot blast, an infrared heater, a microwave heating, etc. may be employed. Of course, the extrusion temperature may be set high.

The film surface temperature and the roller surface temperature can be measured with a non-contact-type infrared thermometer. Concretely, ten places of a film along the widthwise direction are measured with a distance of 0.5 m from the film by the use of a non-contact type handy thermometer (IT2-80, manufactured by KEYENCE Company Ltd.).

The touch roller side film surface temperature T represents a film surface temperature measured for the film currently being conveyed from the touch roller side with a non-contact type infrared thermometer on the condition where a touch roller is detached.

The cooling roller is a high rigidity metallic roller and a roller equipped at an inside thereof with a structure to allow a temperature-controllable heating medium or cooling medium to flow. Its size is not limited specifically, however, it may have a size enough for cooling a melted and extruded film, and usually the diameter of a cooling roller is about from 100 mm to 1 m. Examples of the materials of the surface of a cooling roller, include a carbon steel, a stainless steel, aluminium, and titanium. Furthermore, in order to increase surface hardness or to improve a separating ability with resin, it is desirable to apply a surface treatment such as a hard chrome plating, a nickel plate, an amorphous chrome plating, and a ceramic spraying. The surface roughness on the surface of a cooling roller is desirably made to be 0.1 μm or less by Ra, and more desirably 0.05 μm or less. The smoother the surface of a roller is, the smoother the surface of an obtained film can also be made. Of course, it is desirable to polish further the surface having being subjected to the surface treatment in order to make it to be the surface roughness mentioned above.

Hereafter, a film forming method of a film is explained.

Plural raw materials used for melt extrusion are kneaded beforehand and are usually pelletized. A well-known method is employed for the pelletizing. For example, dry cellulose ester and other additives are supplied to an extruder with a feeder, kneaded by the use of a uniaxial or biaxial extruder, extruded in the shape of a strand from a die, cooled with water-cooling or air cooling, and then cut into pellets. It is important to dry the raw materials before carrying out extrusion in order to prevent decomposition of the raw materials. Especially, since cellulose ester tends to absorb moisture easily, it is desirable to dry it at 70 to 140° C. for 3 hours or more with a dehumidification hot air dryer or a vacuum dryer such that the moisture content is made 200 ppm or less, more preferably 100 ppm or less. Additives may be mixed before being supplied to an extruder, or may be supplied respectively by respective feeders. A small amount of additives such as an antioxidant may be preferably mixed in advance in order to mix it uniformly. In the mixing of the antioxidant, the antioxidant may be mixed as solids to each other. Alternately, the antioxidant is dissolved in a solvent as required, and is mixed by being penetrated in cellulose ester as a solution, or by being sprayed. A vacuum mixer may be preferable, because it can make drying and mixing simultaneously. Moreover, when the pellets may touch with air at the outlet of a feeder section and a die, it is desirable to make the outlet under atmosphere such as dehumidified air and dehumidified N2 gas. Moreover, it is desirable to keep a feed hopper to an extruder warm, because it can prevent moisture absorption. A matting agent, UV absorbent, etc. may be sprinkled on the obtained pellets, or may be added in an extruder at the time of forming a film.

It is desirable to suppress the shearing power of an extruder and to process at a temperature capable of pelletizing as low as possible in order to avoid the deterioration of resin (the decrease of a molecular weight, coloring, gel formation, etc.). For example, in the case of a biaxial extruder, it is desirable to rotate them in the same direction by the use of a deep groove type screw. In the viewpoint of the homogeneity in kneading, an engagement type is desirable. Although a kneader disk can improve a kneading ability, cautions are needed for heat generation caused by shearing. The kneading ability may be sufficient even if the kneader disk is not used. Suctioning may be conducted from a vent hole if needed. As long as it is low temperature, since it hardly generates a volatile component, no vent hole may be provided.

With regard to the color of a pellet, b* value being an index of yellow is desirably in the range of −5 to 10, more desirably −1 to 8, and still more desirably −1 to 5. The b* value can be measured by the use of a spectrocolorimetry meter CM-3700d (manufactured by Konica Minolta Sensing Company Ltd.) with a light source of D65 (color temperature: 6504K) at a view angle of 10°.

The film formation is performed by use of the pellets obtained above. Of course, it is also possible not to pelletize, but to supply the powder of a raw material as it is to an extruder with a feeder, and to carry out a film formation by using it.

Polymer having been dried by a dehumidified hot wind or under vacuum or reduced pressure is melt at an extrusion temperature of 200-300° C. by use of a uniaxial or biaxial type extruder, and after foreign matters having been eliminated by filtering through such as a leaf disc type filter, the melt polymer is cast in a film form through a T die to be solidified on a cooling drum. Introduction into extruder from a supply hopper is preferably performed under vacuum, or under a reduced pressure or inert gas atmosphere to prevent such as oxidative decomposition of polymer.

It is preferable to stably control the extrusion flow rate by utilizing such as a gear pump. Further, as a filter utilized for elimination of foreign matters, a stainless fiber sintered filter is preferably utilized. A stainless fiber sintered filter is comprised of a stainless fiber assembly having been made into a complex coiled state and compressed to sinter the contacting points resulting in one body, and the filtering precision is adjustable by varying a density depending on the fiber thickness and the compression amount. One in which coarse and dense filtering precisions are repeated plural times to make a multi-layered body is preferable. Further, it is preferable to make a filter having a composition of gradually increasing filtering precision or of repeating coarse and dense filtering precisions since a filter life is prolonged as well as capturing efficiency of foreign matters and gel is improved.

There is a case to generate a defect of a streak form when a flaw or a foreign matter is adhered on a die. Such a defect is also called as a die line, and it is preferable to make a structure having as small stagnant portion of resin as possible to minimize surface defects such as a die line. It is preferable to use a die having as minimum flaws as possible in the interior and on a lip of a die. It is preferable to suction the atmosphere containing volatile components since volatile components may precipitate at the die surrounding to cause a die line. Further, since precipitation may be caused also on an apparatus of such as an electrostatic applicator, it is preferable to prevent precipitation by applying alternate current or employing another heating means.

The inside surface of an extruder or a die which contacts with melt resin is preferably subjected to a surface treatment to be made barely adhere melt resin by decreasing the surface roughness or by utilizing a material having a low surface energy. Specifically, listed are those having been subjected to hard chromium plating or ceramic melt spattering are ground to make a surface roughness of not more than 0.2 S.

An additive such as a plasticizer may be mixed with resin in advance or may be kneading mixed in the way of an extruder. It is preferable to utilize a mixing device such as a static mixer for homogeneous addition.

Since roll contamination due to precipitation of volatile components in melt resin on the roll may become problematic when adhesion of melt film with a cooling drum is insufficient, it is preferable to employ such as a method to keep adhesion by electrostatic application, a method to keep adhesion by wind pressure, a method to keep adhesion by nipping the whole width or the edges, and a method to keep adhesion by reduced pressure.

At the time of peeling off film from a cooling roll, it is preferable to control tension to prevent film from deformation.

In this invention, the film prepared in the above manner is preferably further stretched in at least one direction by 1.01 to 3.00 times. The sharpness of streaks is loosened by a step of stretching to prepare film in a highly corrected state. It is preferable to stretch by 1.10 to 2.00 times in each of the both longitudinal (film transport direction) and lateral (width direction) directions.

As a method of stretching, a roll stretching machine and a tenter, which are well known in the art, can be suitably utilized. In the case of optical film being phase difference film, it is specifically preferable that accumulation with polarizer film can be performed in a roll form by making the stretching direction to be the width direction. The slow axis of optical film comprising polymer film becomes the width direction by being stretched in the width direction. On the other hand, also the transparent axis of polarizer film is generally the width direction. Excellent viewing angle can be obtained by assembling a polarizer plate, in which polarizer film and optical film are accumulated so that the transparent axis of the polarizer film and the slow axis of the optical film are parallel, in a liquid crystal display.

Further, in the case of utilizing optical film of this invention as phase difference film, temperature and magnification of stretching can be selected so as to achieve desired retardation characteristics. Generally, the stretching magnification is 1.1-3.0 times and preferably 1.2-1.5 times, and the stretching temperature is set generally in a range of Tg of resin constituting film to (Tg+50) ° C., and preferably in a range of Tg to (Tg+40) ° C. A desired retardation may not be obtained when the stretching magnification is too small, while film may be broken when it is too large. Film may be broken when the stretching temperature is too low, while a desired retardation may not be obtained when it is too high.

Stretching is preferably performed under a controlled and uniform temperature distribution. The temperature distribution is preferably within ±2° C., more preferably within ±1° C. and most preferably within ±0.5° C.

For the purpose of adjusting retardation or decreasing a dimension variation ratio of polymer film prepared in the above-described method, stretching or shrinking in the longitudinal direction or in the width direction may be performed. To shrink in the longitudinal direction, for example, there is a method to relax film in the longitudinal direction by temporarily clip out of the width stretching, or to shrink film by gradually decreasing the interval between clips adjacent to each other in a lateral stretching machine. The latter method can be practiced, utilizing an ordinary simultaneous biaxial stretching machine, by driving clip portions according to a pantograph method or a linear drive method to smoothly and gradually decrease the interval between clips adjacent to each other in the longitudinal direction. Shrinkage can be performed appropriately in combination with stretching in an arbitrary direction (the diagonal direction). The dimension variation ratio of optical film can be decreased by being shrunk by 0.5 to 10% either in the longitudinal direction or in the width direction.

Before winding up film, the edge portions are cut down by slitting to make the width of a product and a knurling process (an embossing process) may be applied on the both edges of film to prevent adhesion and abrasion marks at the center of a roll. To provide knurling, a metal ring, on the side surface of which is provided with a roughness pattern, is heated and pressed on film. Herein, since the clipped portion at the both edge portions of film is not usable as a product because of deformation of the film, it is cut out to be reused as a starting material.

In this invention, it is preferable that a variation ratio of retardation by humidity and a dimension variation ratio can be minimized by decrease of the free volume radius of the film. The free volume radius is usually about 0.32 nm, however, the free volume radius is preferably 0.25 to 0.31 nm, and the free volume radius can be measured by positron annihilation lifetime spectroscopy.

To decrease a free volume, it is effective to heat treat film at a neighborhood of Tg of the film. The time of the heat treatment is preferably 1 second to 1,000 hours at from (Tg−20) ° C. to Tg, because the effect is recognized from not shorter than 1 second and the effect increases the longer is the time, however, the effect saturates at approximately 1,000 hours. It is furthermore preferably 1 minute to 1 hour at from (Tg−15) ° C. to Tg. Further, it is preferable to heat treat film over a range of not lower than Tg to (Tg−20) ° C. while being gradually cooled because an effect can be achieved in shorter time than to heat treat film at a constant temperature. The cooling rate is preferably from −0.1° C./sec to −20° C./sec and furthermore preferably from −1° C./sec to −10° C./sec. A method of the heat treatment is not specifically limited, and it can be performed by such as a tempered oven or a roll group, a hot wind, an infrared heater and a microwave heating device. Film may be heat treated while being transported or as either a sheet form or a rolled form. In the case of a treatment while being transported, film can be transported while being heat treated by use of a roll group or a tenter. In the case of treatment in a roll form, film is wound at a neighboring temperature of Tg and may be gradually cooled by being cooled as it is.

In the case that polarizing plate protective film of this invention is also used as a retardation film, retardation in the film plane (Ro) is 20 to 200 nm and retardation in the thickness direction (Rt) is 90 to 400 nm; it is preferable that retardation in the film plane (Ro) is 20 to 100 nm and retardation in the thickness direction (Rt) is 90 to 200 nm. Further, the ratio of Rt to Ro (Rt/Ro) is preferably 0.5 to 4 and specifically preferably 1 to 3.

Herein, Ro=(Nx−Ny)×d

Rt={(Nx+Ny)/2−Nz}×d,

wherein a refractive index in the slow axis direction of film is Nx, a refractive index in the fast axis direction is Ny, a refractive index in the thickness direction is Nz and a layer thickness of film is d (nm), (measuring wavelength: 590 nm).

The smaller is distribution of retardation, the better, and it is generally within ±10 nm, preferably within ±5 nm and more preferably within ±2 nm.

Uniformity of direction of the slow axis is also important and the distribution the angle against the film width direction is preferably in a range of −5 to +5°, more preferably in a range of −1 to +1°, specifically preferably in a range of −0.5 to +0.5°, and more specifically preferably in a range of −0.1 to +0.1°. This distribution can be achieved by optimization of the stretching conditions.

In the film of the present invention, it is preferable that the height from the top of neighboring mountains to the bottom of valleys is 300 nm or more, and there is no streak having an inclination of 300 nm/mm or more and continuing in a longitudinal direction.

A form of streaks is measured by the use of a surface roughness meter, and concretely, the measurement is performed by use of SV-3100S4 produced by Mitsutoyo Corp. at a scanning speed in the film width direction of 1.0 mm/sec while applying a weight of 0.75 mN, based on a measurement force, on a prove needle (a diamond needle) having a top form of 600 cone and a top curvature radius of 2 μm to determine cross-sectional curve at a Z axis (thickness direction) resolution of 0.001 μm. From the cross-sectional curve, a height of streaks is obtained by reading a vertical distance (H) from the top of a mountain to the bottom of a valley. The inclination of streak is obtained by a step of reading a horizontal distance (L) from the top of a mountain to the bottom of a valley and dividing a vertical distance (H) by the horizontal distance (L).

(Cellulose Ester)

The cellulose ester resin of this invention is a single or mixed acid ester of cellulose which has a cellulose ester structure and includes at least one of a fatty acid acyl group and a substituted or unsubstituted aromatic acyl group.

The following are examples of the useful cellulose ester which meet the objective of this invention, but the cellulose ester is not limited to these examples.

Examples of the benzene ring substituent group when the aromatic ring in the aromatic acyl group is a benzene ring include, a halogen atom, cyano, an alkyl group, an alkoxy group, and aryl group, an aryloxy group, an acyl group, a carbonamide group, a sulfonamide group, a ureido group, an aralkyl group, nitro, an alkoxy carbonyl group, an aryloxy carbonyl group, aralkyoxy carbonyl group, carbamoyl group, a sulfamoyl group, an acyloxy group, an alkenyl group, alkinyl group, an alkyl sulfonyl group, an aryl sulfonyl group, an alkyloxy sulfonyl group, an aryloxy sulfonyl group, alkyl sulfonyloxy group, and an aryloxy sulfonyl group, —S—R, —NH—CO—OR, —PH—R, —P(—R)₂, —PH—O—R, —P(—R) (—O—R), —P(—O—R)₂, —PH(═O)—R—P(═O) (—R)₂, —PH(═O)—O—R, —P(═O) (—R) (—O—R), —P(═O)(—O—R)₂, —O—PH(═O)—R, —O—P(═O) (—R)₂—O—PH(═O)—O—R, —O—P(═O)(—R) (—O—R), —O—P(═O) (—O—R)₂, —NH—PH(═O)—R, —NH—P(═O) (—R) (—O—R) —NH—P(═O) (—O—R)₂, —SiH₂—R, —SiH(R)₂, —Si(—R)₃, —O—SiH₂—R, —O—SiH(—R)₂ and —O—Si(—R)₃. R above is an aliphatic group, an aromatic group, or a heterocyclic group. The number of substituent groups is preferably between 1 and 5, more preferably between 1 and 4 and still more preferably between 1 and 3, and most preferably either 1 or 2. Examples of the substituent group preferably include a halogen atom, cyano, an alkyl group, an alkoxy group, an aryl group, an aryloxy group, an acyl group, a carbonamide group, a sulfonamide group, and a ureido group, and more preferably, a halogen atom, cyano, an alkyl group, an alkoxy group, an aryloxy group, an acyl group, and a carbonamide group, and still more preferably, a halogen atom, cyano, an alkyl group, an alkoxy group, and an aryloxy group, and most preferably; a halogen atom, an alkyl group, and an alkoxy group.

Examples of the halogen atom include a fluorine atom, a chlorine atom, a bromine atom, and an iodine atom. The alkyl group may have ring structure or a branched structure. The number of carbon atoms in the alkyl group is preferably 1 to 20, more preferably 1 to 12, still more preferably 1 to 6, and most preferably 1 to 4. Examples of the alkyl group include methyl, ethyl, propyl, isopropyl, butyl, t-butyl, hexyl, cyclohexyl, octyl and 2-ethyl hexyl. The alkoxy group may have ring structure or a branched structure. The number of carbon atoms in the alkoxy group is preferably 1-20, more preferably 1-12, still more preferably 1-6, and most preferably 1-4. The alkoxy group may be further substituted by another alkoxy group. Examples of the alkoxy group include a methoxy, ethoxy, 2-methoxy ethoxy, 2-methoxy-2-ethoxy ethoxy, butyloxy, hexyl oxy and octyloxy.

The number of carbon atoms in the aryl group is preferably 6 to 20, and more preferably 6 to 12. Examples of the aryl group include phenyl and naphtyl. The number of carbon atoms in the aryloxy group is preferably 6 to 20, and more preferably 6 to 12. Examples of the aryloxy group include phenoxy and naphthoxy. The number of carbon atoms in the acyl group is preferably 1 to 20, and more preferably 1 to 12. Examples of the acyl group include hormyl, acetyl, and benzoyl. The number of carbon atoms in the carbonamide group is preferably 1 to 20, and more preferably 1 to 12. Examples of the carbonamide include acetoamide and benzamide. The number of carbon atoms in the sulfonamide group is preferably 1 to 20, and more preferably 1 to 12. Examples of the sulfonamide group include methane sulfonamide, benzene sulfonamide, and p-toluene sulfonamide. The number of carbon atoms in the ureido group is preferably 1 to 20, and more preferably 1 to 12. Examples of the ureido group include (unsubstituted) ureido.

The number of carbon atoms in the aralkyl group is preferably 7 to 20, and more preferably 7 to 12. Examples of the aralkyl group include benzyl, phenethyl, and naphtyl methyl. The number of carbon atoms in the alkoxycarbonyl group is preferably 1 to 20, and more preferably 2 to 12. Examples of the alkoxycarbonyl group include methoxy carbonyl. The number of carbon atoms in the aryloxy carbonyl group is preferably 7 to 20, and more preferably 7 to 12. Examples of the aryloxy carbonyl group include phenoxy carbonyl. The number of carbon atoms in the aralkyloxycarbonyl is preferably 8 to 20, and more preferably 8 to 12. Examples of the aralkyoxycarbonyl group include benzyloxycarbonyl. The number of carbon atoms in the carbamoyl group is preferably 1 to 20, and more preferably 1 to 12. Examples of the carbamoyl group include (unsubstituted) carbamoyl and N-methyl carbamoyl. The number of carbon atoms in the sulfamoyl group is preferably no greater than 20, and more preferably no greater than 12. Examples of the sulfamoyl group include (unsubstituted) sulfamoyl and N-methyl sulfamoyl. The number of carbon atoms in the acyloxy group is preferably 1 to 20, and more preferably 2 to 12. Examples of the acyloxy group include acetoxy and benzoyloxy.

The number of carbon atoms in the alkenyl group is preferably 2 to 2.0, and more preferably 2 to 12. Examples of the alkenyl group include vinyl, aryl and isopropenyl. The number of carbon atoms in the alkinyl group is preferably 2 to 20, and more preferably 2 to 12. Examples of the alkinyl group include dienyl. The number of carbon atoms in the alkyl sulfonyl group is preferably 1 to 20, and more preferably 1 to 12. The number of carbon atoms in the aryl sulfonyl group is preferably 6 to 20, and more preferably 6 to 12. The number of carbon atoms in the alkyloxy sulfonyl group is preferably 1 to 20, and more preferably 1 to 12. The number of carbon atoms in the aryloxy sulfonyl group is preferably 6 to 20, and more preferably 6 to 12. The number of carbon atoms in the alkyl sulfonyloxy group is preferably 1 to 20, and more preferably 1 to 12. The number of carbon atoms in the aryloxy sulfonyl is preferably 6 to 20, and more preferably 6 to 12.

In the cellulose ester of this invention, in the case where the hydrogen atom of the hydroxyl group portion of the cellulose is an fatty acid ester with an aliphatic acyl group, the number of carbon atoms in the aliphatic acyl group is 2 to 20, and specific examples thereof include acetyl, propionyl, butyryl, isobutyryl, valeryl, pivaroyl, hexanoyl, octanoyl, lauroyl, stearoyl and the like.

The aliphatic acyl group of this invention also refers to one which is further substituted, and examples of the benzene ring substituent group include those given as examples when the aromatic ring in the aromatic acyl group is a benzene ring.

When the esterified substituent group of cellulose ester is an aromatic ring, the number of the substituent groups X which are substituted on the aromatic ring should be 0 or 1 to 5, preferably 1 to 3, and 1 or 2 is particularly preferable. In addition, when the number of substituent groups substituted on the aromatic ring is 2 or more, the substituent groups may be the same or different from each other, and they may also bond with each other to form a condensed polycylic compound (such as naphthalene, indene, indan, phenanthrene, quinolene, isoquinolene, chromene, chromane, phthalazine, acridine, indole, indolin and the like).

The structure used in the cellulose ester of the present invention is a structure having a structure selected from at least one of substituted or unsubstituted aliphatic acyl group or substituted or unsubstituted aromatic acyl group, and these may be a single ester or a mixture of acid esters, and two types of cellulose may be mixed and used.

The cellulose ester relating to the invention is characterized in that the total acyl substitution degree is from 2.4 to 2.9.

Cellulose has three hydroxyl groups per a glucose unit, and the acyl substitution degree is a value representing the average number of acyl group bonded per glucose unit. Accordingly, the maximum value of the substituting degree is 3.0. These acyl groups may be equally substituted at the 2-, 3- and 6-position of the glucose unit or substituted with a distribution. The sum of the substitution degree is preferably from 1.5 to 1.95, more preferably from 1.7 to 1.95, and further preferably from 1.73 to 1.93. The acyl substitution degree at the 6-position is preferably 0.7 to 1.00, and more preferably from 0.85 to 0.98. It is preferable that the substitution degree at the 6-position is higher than that at the 2- or 3-position. Further, it is preferable that the acyl substitution degree at the 2-position is the same as that at 3-position or one of the acyl substitution degree at the 2-position and the acyl substitution degree at the 3-position is slightly higher than the other one. For example, it is preferable that the difference between the acyl substitution degree at the 2-position and the acyl substitution degree at the 3-position is within a range of 0 to +0.4.

The examples of the cellulose ester preferably employable in the invention include (a cellulose ester having the total substitution degree of 2.81 and the substitution degree at 6-position of 0.84), (a cellulose ester having the total substitution degree of 2.82 and the substitution degree at 6-position of 0.85), (a cellulose ester having the total substitution degree of 2.77 and the substitution degree at 6-position of 0.94), (a cellulose ester having the total substitution degree of 2.72 and the substitution degree at 6-position of 0.88), (a cellulose ester having the total substitution degree of 2.85 and the substitution degree at 6-position of 0.92), (a cellulose ester having the total substitution degree of 2.70 and the substitution degree at 6-position of 0.89), (a cellulose ester having the total substitution degree of 2.75 and the substitution degree at 6-position of 0.90), (a cellulose ester having the total substitution degree of 2.75 and the substitution degree at 6-position of 0.91), (a cellulose ester having the total substitution degree of 2.80 and the substitution degree at 6-position of 0.86), (a cellulose ester having the total substitution degree of 2.80 and the substitution degree at 6-position of 0.90), (a cellulose ester having the total substitution degree of 2.65 and the substitution degree at 6-position of 0.80), (a cellulose ester having the total substitution degree of 2.65 and the substitution degree at 6-position of 0.70), (a cellulose ester having the total substitution degree of 2.6 and the substitution degree at 6-position of 0.75), (a cellulose ester having the total substitution degree of 2.5 and the substitution degree at 6-position of 0.80), (a cellulose ester having the total substitution degree of 2.5 and the substitution degree at 6-position of 0.65), (a cellulose ester having the total substitution degree of 2.5 and the substitution degree at 6-position of 0.65), (a cellulose ester having the total substitution degree of 2.45 and the substitution degree at 6-position of 0.70), (a cellulose ester having the total substitution degree of 2.85 and the substitution degree at 6-position of 0.93), (a cellulose ester having the total substitution degree of 2.74 and the substitution degree at 6-position of 0.84), (a cellulose ester having the total substitution degree of 2.72 and the substitution degree at 6-position of 0.85), (a cellulose ester having the total substitution degree of 2.78 and the substitution degree at 6-position of 0.92), (a cellulose ester having the total substitution degree of 2.88 and the substitution degree at 6-position of 0.87), (a cellulose ester having the total substitution degree of 2.84 and the substitution degree at 6-position of 0.87), (a cellulose ester having the total substitution degree of 2.88 and the substitution degree at 6-position of 0.89), (a cellulose ester having the total substitution degree of 2.9 and the substitution degree at 6-position of 0.95), (a cellulose ester having the total substitution degree of 2.80 and the substitution degree at 6-position of 0.94), (a cellulose ester having the total substitution degree of 2.75 and the substitution degree at 6-position of 0.87), (a cellulose ester having the total substitution degree of 2.70 and the substitution degree at 6-position of 0.90), (a cellulose ester having the total substitution degree of 2.70 and the substitution degree at 6-position of 0.82), and (a cellulose ester having the total substitution degree of 2.70 and the substitution degree at 6-position of 0.82), (a cellulose ester having the total substitution degree of 2.70 and the substitution degree at 6-position of 0.77), (a cellulose ester having the total substitution degree of 2.95 and the substitution degree at 6-position of 0.90), (a cellulose ester having the total substitution degree of 2.95 and the substitution degree at 6-position of 0.95), (a cellulose ester having the total substitution degree of 2.96 and the substitution degree at 6-position of 0.98), (a cellulose ester having the total substitution degree of 2.95 and the substitution degree at 6-position of 0.95), (a cellulose ester having the total substitution degree of 2.98 and the substitution degree at 6-position of 0.98), (a cellulose ester having the total substitution degree of 2.92 and the substitution degree at 6-position of 0.97), (a cellulose ester having the total substitution degree of 2.92 and the substitution degree at 6-position of 0.92), are usable solely or in combination of two or more kinds thereof. In the case of the combination use, it is preferable to use a mixture of cellulose esters different from each other in the total substitution degree of from 0 to 0.5 is preferable, and a mixture of those different from each other in the total substitution degree of from 0.01 to 0.3 is more preferable, and a mixture of those different from each other in the total substitution degree of from 0.02 to 0.1 is further preferable. The total substitution degree is the sum of the substitution degree at the 2-, 3- and 6-positions.

It is desirable that a ratio of an acetyl group substitution degree in the substitution degree at 6-position to a substitution degrees of other than acetyl groups such as a propionyl group and a butyryl group is within a range of 0.03 to 4 to an acetyl group substitution degree of 1.

The cellulose ester constituting the optical film of the invention is preferably one selected from cellulose acetate, cellulose propionate, cellulose butylate, cellulose acetate propionate, cellulose acetate butylate, cellulose acetate phthalate and cellulose phthalate.

Among the above, cellulose propionate, cellulose butylate, cellulose acetate propionate and cellulose acetate butylate are particularly preferred.

The preferable cellulose resin contains the combined ester of lower fatty acids such as cellulose acetate propionate and cellulose acetate butylate which has acyl groups each having 2 to 4 carbon atoms and satisfies the following formulas (I) and (II) at the same time when X is the substitution degree of acetyl group and Y is the substitution degree of propionyl group or butylyl group. The substitution degree of the acetyl group and that of the butylyl group are determined according to ASTM-D817-96.

2.5≦X+Y≦2.9 Formula (I)

0≦X≦2.5 Formula (II)

Among them, cellulose acetate propionate is particularly preferable and that satisfying the relations of 0.5≦X≦2.5 and 0.1≦Y≦2.0, 2.5≦X+Y≦2.9 are preferable. It is allowed that cellulose esters each different from each other in the acyl substitution degree are mixed so that the mixture satisfies the above relations in total. A portion of cellulose not substituted by the acyl group is generally occupied by a hydroxyl group. Such the cellulose esters can be synthesized by a known method.

The cellulose ester preferably has a number average molecular weight of from 70,000 to 230,000, more preferably from 75,000 to 230,000, and further preferably from 78,000 to 120,000.

In the invention, a cellulose ester having a ratio of weight average molecular weight Mw to number average molecular weight Mn of from 1.3 to 5.5 is preferably employed, the ratio is more preferably from 1.5 to 5.0, further preferably from 1.7 to 3.0, and particularly preferably from 2.0 to 3.0.

The weight average molecular weight can be measured by the following method.

### (Molecular Weight Measuring Method)

The weight average molecular weight is measured by the use of a high liquid chromatography.

The following describes the measurement conditions:

Solvent: methylene chloride

Column: Shodex K806, K805 and K803G (Three pieces manufactured by Showa Denko K.K. were connected for use)

Column temperature: 25 degrees Celsius

Sample concentration: 0.1% by mass

Detector: RI Model 504 (manufactured by GL Science Co., Ltd.)

Pump: L6000 (manufactured by Hitachi Limited)

Flow rate: 1.0 ml/min.

Calibration curve: The calibration curve using 13 samples of the standard polystyrene STK standard polystyrene (manufactured by Toso Co., Ltd.) was employed, wherein Mw=1000000 through 500. These 13 samples were placed at an approximately equally spaced interval.

The viscosity average polymerization degree (polymerization degree) of the cellulose ester to be employed in the invention is preferably from 200 to 700, and more preferably from 250 to 500. A polarizing plate protective film excellent in the mechanical strength can be obtained when the polymerization degree is within the above range.

The viscosity average polymerization degree (DP) is determined by the following method.

Measurement of the Viscosity Average Polymerization degree (DP)

Zero point two grams of absolutely dried cellulose ester is precisely weighed and dissolved in 100 ml of a mixture solvent of methylene chloride and ethanol in a mixing ratio of 9:1 by weight. The falling time of the resultant solution was measured by an Ostwald viscometer at 25° C., and the polymerization degree is calculated by the following equations.

ηᵣₑₗ=T/Ts

[η]=(ln ηᵣₑₗ)/C

DP=[η]/Km

In the above, T is the falling time in second of the measured sample, Ts is the falling time in second of the solvent, C is the concentration of the cellulose ester in g/l and Km is 6×10⁻⁴.

As the cellulosic resin, a cellulose mixed fatty acid ester manufactured by the method described in Japanese Patent Unexamined Publication No. 2005-272749 is also used preferably. For example, disclosed in the above publication, cellulose acetate propionate having a acetyl group substitution degree (DSace) of 2.16 and a propionyl group substitution degree (DSacy) of 0.54 in Example 1; cellulose acetate propionate having a acetyl group substitution degree (DSace) of 1.82 and a propionyl group substitution degree (DSacy) of 0.78 in Example 2; cellulose acetate propionate having a acetyl group substitution degree (DSace) of 1.56 and a propionyl group substitution degree (DSacy) of 1.09 in Example 3; cellulose acetate propionate having a acetyl group substitution degree (DSace) of 1.82 and a propionyl group substitution degree (DSacy) of 0.78 in Example 4; and, cellulose acetate butylate having a acetyl group substitution degree (DSace) of 1.82 and a propionyl group substitution degree (DSacy) of 0.78 in Example 5 are used preferably. Also, disclosed in the above publication, cellulose acetate propionate having a acetyl group substitution degree (DSace) of 1.24 and a propionyl group substitution degree (DSacy) of 1.43 in Comparative Example 1; and cellulose acetate propionate having a acetyl group substitution degree (DSace) of 1.79 and a propionyl group substitution degree (DSacy) of 0.86 in Comparative Example 1 may be used.

As the cellulosic resin, cellulose ether acetate described in Japanese Patent Unexamined Publication No. 2005-283997 can also be used. As the cellulosic resin, lactic acid base copolymer described in Japanese Patent Unexamined Publication No. 11-240942, or cellulose graft copolymer which is described in Japanese Patent Unexamined Publication No. 6-287279, is obtained by the ring breakage graft copolymerization of lactide and cellulose ester or cellulose ether under the existence of an esterification catalyst and has biodegradability and thermoplasticity, can be also used. Further, a graft copolymer described in Japanese Patent Unexamined Publication No. 2004-359840 in which main chain is cellulose derivatives and graft chain is polylactic acid, can also be used preferably. In the graft copolymer, the mass ratio (cellulose derivatives/polylactic acid) may be made 95/5 to 5/95. As the cellulose derivatives at this time, cellulose acetate propionate, cellulose diacetate, cellulose triacetate, cellulose acetate butylate, etc. may be employed. The graft copolymer can be used alone or a mixture with other cellulosic resin such as cellulose ester.

In addition, an example of the cellulosic resin includes cellulose derivatives-mixed graft polymer described in Registration No. 3715100 which is obtained by the open ring-mixed graft polymerization of lactone and lactide by the addition of a ring opening polymerization catalyst of cyclic ester under the existence of cellulose derivatives and has biodegradability. Especially, lactone is preferably at least one selected from a group consisting of β-propiolactone, δ-valerolactone, ε-caprolactone, α,α-dimethyl-β-propiolactone, β-ethyl-δ-valerolactone, α-methyl-ε-caprolactone, β-methyl-ε-caprolactone, γ-methyl-ε-caprolactone, and 3,3,5-trimethyl-ε-caprolactone. Examples of cellulose derivatives, include cellulose ester, such as cellulose diacetate, cellulose acetate butylate, cellulose acetate propionate, a cellulose acetate phtarate, and cellulose nitrate; and cellulose ether, such as ethyl cellulose, methyl cellulose, hydroxypropylcellulose, and hydroxypropyl methylcellulose. These can be manufactured by the method described in Registration No. 3715100.

The alkali-earth metal content of the cellulose resin to be employed in the invention is 1 to 200 ppm, preferably within the range of from 1 to 50 ppm. When the content exceeds 50 ppm, the contamination on the die lip is increased or the film tends to be broken on the occasion of the heat stretching or the slitting after the stretching. The film tends to be broken even when the content is less than 1 ppm; the reason of such the phenomenon is not cleared yet. It is also not desirable to reduce the content to less than 1 ppm because the load to the washing process becomes too large. The content is more preferably within the range of from 1 to 30 ppm. The alkali-earth metal content is the total content of calcium and magnesium, which can be measured by an X-ray photoelectron spectroscopic analyzer (XPS).

The remaining sulfuric acid content in the cellulose resin to be employed in the invention is preferably from 0.1 to 45 ppm in terms of sulfur. It is supposed that the sulfuric acid is contained in a salt state. A remaining sulfuric acid content exceeding 45 ppm is not desirable since the contamination on the die lip is increased and the film tends to be broken on the occasion of the heat stretching or the slitting after the stretching. Tough smaller sulfuric acid content is preferable; it is undesirable to reduce the content to less than 0.1 ppm since the load on the washing process becomes too large and the film tends to be broken. Though it is supposed that such the phenomenon is caused by any influence of the increasing of washing times; the reason is not cleared yet. The remaining sulfuric acid content is more preferably within the range of from 0.1 to 30 ppm. The remaining sulfuric acid content can be measured according to ASTM-D817-96.

The free acid content in the cellulose resin to be employed in the invention is preferably from 1 to 500 ppm. When the free acid content exceeds 500 ppm, the adhering material on the die lip is increased and the film tends to be broken. The content of less than 1 ppm is difficultly attained by a process of washing. The content is more preferably from 1 to 100 ppm. The breaking of the film further difficultly occurs in such the range of the free acid content. The content is particularly preferably within the range of from 1 to 70 ppm. The free acid content can be measured according to ASTM-D817-96. The free acid content in the optical film is preferably from 1 to 500 ppm, though the content is usually less than 3,000 ppm.

The alkali-earth metal content and the remaining sulfuric acid content can be made to within the above range by sufficient washing compared to that in the case of the solution casting method. By such the treatment, the adhesion of the resin onto the die lip and the film excellent in the flatness can be obtained. Thus the film having suitable in the dimension stability, mechanical strength, transparency, anti-humid ability, Rt value and Ro value can be obtained.

The raw cellulose for the cellulose ester to be employed in the invention may be either wood pulp or cotton linter. The wood pulp may be conifer pulp or broad leaved tree pulp, and the conifer pulp is preferred. The cotton linter is preferably employed from the viewpoint of peeling ability on the occasion of film forming. Cellulose esters produced from them can be employed solely or in a suitably mixed state.

For example, cellulose ester derived form the cotton linter, that derived from the conifer pulp and that derived from the broad leaved tree pulp can be employed in a ratio of 100:0:0, 90:10:0, 85:15:0, 50:50:0, 20:80:0, 10:90:0, 0:100:0, 0:0:100, 80:10:10, 85:0:15 and 40:30:30.

In the invention, a cellulose ether type resin, a vinyl type resin including a poly(vinyl acetate) type resin and a poly(vinyl alcohol) type resin, a cyclic olefin resin, a polyester type resin including an aromatic polyester, an aliphatic polyester and a copolymer thereof, or an acryl type resin including a copolymer thereof may be contained in the optical film in addition to the cellulose ester. The content of the resin other than the cellulose ester is preferably from 0.1 to 30% by weight.

### (UV Absorbent)

The UV absorbent relating to the present invention is a UV absorbent having a weight average molecular weight of 490 to 50,000, and preferably a compound having at least two benzotriazole skeletons as the UV absorbing skeleton. It is preferable that the UV absorbent contains a compound having a weight average molecular weight of 490 to 2,000 and a compound having a weight average molecular weight of 2,000 to 50,000.

The UV absorbent relating to the present invention is described in detail below.

As the UV absorbent, ones excellent in the absorbing ability for UV rays of wavelength of less than 370 nm and having low absorption for visible rays of not less than 400 nm are preferable from the viewpoint of the degradation prevention of the polarizing plate and the displaying apparatus caused by UV rays, and from the viewpoint of displaying ability of the liquid crystal. For example, an oxybenzophenone type compound, a benzotriazole type compound, a salicylate type compound, a benzophenone type compound, a cyanoacrylate type compound, a triazine type compound and a nickel complex type compound are employable. The UV absorbents described in Japanese Patent O.P.I. Publication No. 10-182621 and Japanese Patent O.P.I. Publication No. 8-337574, the polymer UV absorbents described in Japanese Patent O.P.I. Publication No. 6-148430, the polymer UV absorbents described in Japanese Patent O.P.I. Publication No. 2002-169020, and the polymer UV absorbents described in Japanese Patent O.P.I. Publication No. 2002-31715, in addition, the UV absorbents represented by Formula (I) described in Formula (1) of Japanese Patent O.P.I. Publication No. 9-194740 are also employable for the polarizing plate protective film of the present invention. Further, it is preferable to contain the polyester base UV absorbents represented by the following Formula (a).

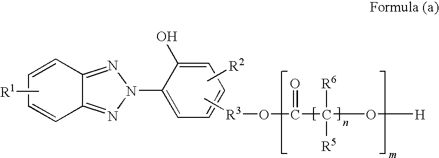

Wherein R¹ is hydrogen, halogen, or an alkyl group having a carbon number of 1 to 10, R² is hydrogen or an alkyl group having a carbon number of 1 to 10, R³ is an alkylene group having a carbon number of 1 to 10, R⁴ to R⁵ is hydrogen or an alkyl group having a carbon number of 1 to 10, n is an integer of 4 to 8, and m is 1 to 20.

The polyester base ultraviolet absorber can be manufactured by the method of causing ring-opening-addition polymerization of lactone into an ultraviolet absorption nature compound as described in Registration 3714574. Further, it is also preferable to contain the polyester base ultraviolet absorber represented by the following Formula (b). This polyester base ultraviolet absorber can be also manufactured by the method of causing ring-opening-addition polymerization of lactone into an ultraviolet absorption nature compound as described in Registration 3714575.

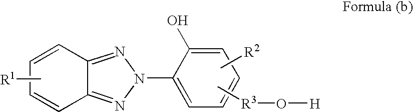

Wherein R¹ is hydrogen, halogen, or an alkyl group having a carbon number of 1 to 10, R² is hydrogen or an alkyl group having a carbon number of 1 to 10, R³ is an alkylene group having a carbon number of 1 to 10.

Among these UV absorbents, ones having a weight average molecular weight within the range of 490 to 50,000 is necessary for displaying the effects of the present invention. When the weight average molecular weight is less than 490, the UV absorbent tend to be oozed out from the film surface and the film tends to be colored accompanied with aging, though the UV absorbent of the molecular weight of not more than 490 is usually employed. When the weight average molecular weight exceeds 50,000, the compatibility of the UV absorbent with the resin of the film tends to be considerably lowered.

It is also preferable embodiment that the UV absorbent relating to the present invention contains UV absorbent (A) having a weight average molecular weight of from 490 to 2,000 and UV absorbent (B) having a weight average molecular weight of from 2,000 to 50,000. The mixing ratio of UV absorbent (A) to (B) is suitably selected from the range of from 1:99 to 99:1.

Example of the UV absorbent having a weight average molecular weight being within the range of the present invention and having at least two benzotriazole skeletons is preferably a benzotriazolephenol compound represented by the following Formula (1).

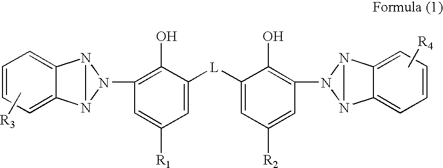

In Formula (1), R₁ and R₂ are each a hydrogen atom or a substituted or unsubstituted alkyl group having 1 to 20 carbon atoms, and R₃ and R₄ are each a hydrogen atom, a halogen atom or an alkylene group having 1 to 4 carbon atoms.

Examples of the atom or group of the substituent of the alkyl group include a halogen atom such as a chlorine atom, a bromine atom and a fluorine atom, a hydroxyl group, a phenyl group which may be substituted with an alkyl group of a halogen atom.

Concrete examples of the bisbenzotriazolephenol compound represented by Formula (1) are as follows, but the compound is not limited to the followings.
1) RUVA-100/110 manufactured by Ootsuka Kagaku Co., Ltd.
2) RUVA-206 manufactured by Ootsuka Kagaku Co., Ltd.
3) Tinuvin-360 manufactured by Ciba Specialty Chemicals Co., Ltd.
4) Adecastab LA-31 manufactured by Asahi Denka Co., Ltd.
5) Adecastab LA-31RG manufactured by Asahi Denka Co., Ltd.

Moreover, it is preferable that at least one of the UV absorbents is a copolymer of a UV absorbing monomer having a molar absorption coefficient of not less than 4,000 at 380 nm and an ethylenic unsaturated monomer, and the ethylenic unsaturated monomer having a hydrophilic group.

According to the present invention, the optical film, in which the foregoing problems are solved, can be obtained by that the film contains the UV absorbing copolymer which is the copolymer of the UV absorbing monomer having a molar absorption coefficient of not less than 4,000 at 380 nm and the ethylenic unsaturated monomer and has a weight average molecular weight of 490 to 50,000.

When the molar absorption coefficient is not less than 4,000 at 380 nm, the UV absorbing ability is suitable and satisfactory UV cutting effect can be obtained. Therefore, the problem of yellow coloring of the optical compensating film itself is solved and the transparency of the film is improved.

The monomer to be employed for the UV absorbing copolymer in the present invention preferably has a molar absorption coefficient at 380 nm of not less than 4,000, more preferably not less than 8,000, and further preferably not less than 10,000. When the molar absorption coefficient at 380 nm is less than 4,000, a large adding amount of the UV absorbent is necessary for obtaining the desired UV absorbing ability so that the transparency of the film is considerably lowered by increasing in the haze or precipitation of the UV absorbent and the strength of the film is lowered.

The ratio of the absorbing coefficient at 380 nm to that at 400 nm of the UV absorbing monomer to be employed for the UV absorbing copolymer is preferably not less than 20.

In the present invention, it is preferable that the monomer having the UV absorbing ability as higher as possible is contained in the UV absorbing copolymer for inhibiting the light absorption at 400 nm near the visible region and obtaining the required UV absorbing ability.

a. UV Absorbing Monomer

The UV absorbing monomer (UV absorbent) preferably has a molar absorption coefficient at 380 nm of less than 4,000, and a ratio of the absorption coefficient at 380 nm to that at 400 nm is not less than 20.

As the UV absorbing monomer, the following compounds have been known, for example, a salicylic acid type UV absorbent such as phenyl salicylate and p-tert-butyl salicylate, a benzophenone type UV absorbent such as 2,4-dihydroxybenzophenone and 2,2′-dihydroxy-4,4′-dimethoxybenzophenone, a benzotriazole type UV absorbent such as 2-(2′-hydroxy-3′-tert-butyo-5′-methylphenyl)-5-chlorobenzotriazole, 2-(2′-hydroxy-3′,5′-di-tert-butylphenyl-5-chlorobenzotriazole and 2-(2′-hydroxy-3′,5′-di-tert-amylphenyl-benzotriazole, a dicyanoacrylate type UV absorbent such as 2′-ethylhexyl-2-cyano-3,3-diphenyl acrylate and ethyl-2-cyano-3-(3′,4′-methylenedioxyphenyl)acrylate, a triazine type UV absorbent such as 2-(2′-hydroxy-4′-hexyloxyphenyl)-4,6-diphenyltriazine and the compounds described in Japanese Patent O.P.I. Publication Nos. 58-185677 and 59-149350.

It is preferable in the present invention that basic skeletons are suitable selected from the foregoing various types of UV absorbent, and a substituent having an ethylenic unsaturated bond is introduced in each of the skeletons for forming polymerizable compounds, and then ones having a absorption coefficient of not less than 4,000 at 380 nm are selected from the resultant compounds. In the present invention, the benzotriazole type compounds are preferable for the UV absorbing monomer from the viewpoint of the storage stability. Particularly preferable UV absorbing monomer is ones represented by the following Formula (3).

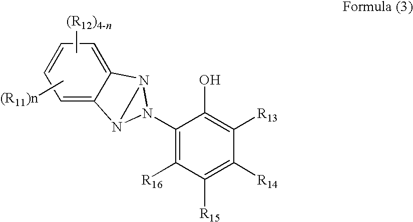

In Formula (3), the substituents represented by R₁₁ through R₁₆ each may have a substituent except that a specific limitation is applied.

In Formula (3), one of groups represented by R₁₁ through R₁₆ has the above-described polymerizable group as a partial structure.

In the above formula, L is a di-valent bonding group or a simple bonding hand, and R₁ a hydrogen atom or an alkyl group. R₁ is preferably a hydrogen atom or an alkyl group having 1 to 4 carbon atoms. Though the group containing the foregoing polymerizable group may be any one of the groups represented by R₁₁ through R₁₆, the group represented by R₁₁, R₁₃, R₁₄ or R₁₅ is preferable, and the group represented by R₁₄ is particularly preferable.

In Formula (3), R₁₁ is a halogen atom, an oxygen atom, a nitrogen atom or a group substituting on the benzene ring through a sulfur atom. As the halogen atom, a fluorine atom, a chlorine atom and a bromine atom are applicable, and the chlorine atom is preferable.

Examples of the group substituting on the benzene ring through an oxygen atom include a hydroxyl group, an alkoxy group such as a methoxy group, an ethoxy group, a t-butoxy group and a 2-ethoxyethoxy group, an aryloxy group such as a phenoxy group, a 2,4-di-t-amylphenoxy group and a 4-(4-hydroxyphenyl-sulfonyl)phenoxy group, a heterocycloxy group such as a 4-pyridyloxy group and 2-hexahydropyrranyloxy group, a carbonyloxy group, for example, an alkylcarbonyloxy group such as an acetyloxy group, a trifluoroacetyloxy group and a pivaloyloxy group, and an arylcarbonyloxy group such as a benzoyloxy group and a pentafluorobenzoyloxy group, a urethane group, for example, an alkylurethane group such as an N-dimethylurethane, and an arylurethane group such as an N-phenylurethane and an N-(p-cyanophenyl)urethane group, a sulfoxy group, for example, an alkylsulfoxy group such as a methanesulfonyloxy group, a trifluoromethanesulfonyloxy group an n-dodecanesulfonyloxy group, and an arylsulfonyloxy group such as a bebzenesulfonyloxy group and a p-toluenesulfonyloxy group. An alkoxy group having 1-6 carbon atoms is preferable and an alkyl group having 2-4 carbon atoms is particularly preferable.

Examples of the group substituting on the benzene ring through a nitrogen atom include a nitro group, an amino group, for example, an alkylamino group such as a dimethylamino group, a cyclohexylamino group and an n-dodecylamino group, and an arylamino group such as an anilino group and p-t-octylanilino group, a sulfonylamino group, for example, an alkylsulfonylamino group such as a methanesulfonylamino group, a heptafluoropropanesulfonylamino group and a hexadecylsulfonylamino group, and an arylsulfonylamino group such as a p-toluenesulfonylamino group and a pentafluorobenzenesulfonylamino group, a sulfamoylamino group, for example, an alkylsulfamoylamino group such as an N,N-dimethylsulfamoylamino group, and an arylsulfamoylamino group such as an N-phenylsulfamoylamino group, an acylamino group, for example, an alkylcarbonylamino group such as an acetylamino group and a myristoylamino group, and an arylcarbonylamino group such as a benzoylamino group, and a ureido group, for example, an alkylureido group such as an N,N-dimethylaminoureido group, and an arylureido group such as an N-phenylureido group and an N-(p-cyanophenyl)ureido group. Among them, the aminoacyl group is preferable.

Examples of the group substituting on the benzene ring through a sulfur atom include an alkylthio group such as a methylthio group and t-octylthio group, an arylthio group such as a phenylthio group, a heterocyclic-thio group such as a 1-phenylterazole 5-thio group and a 5-methyl-1,3,4-oxadiazole-2-thio group, a sulfinyl group, for example, an alkylsulfinyl group such as a methanesulfinyl group and a trifluoromethanesulfinyl group, and an arylsulfinyl group such as a p-toluenesulfinyl group, a sulfamoyl group, for example, an alkylsulfamoyl group such as a dimethylsulfamoyl group and a 4-(2,4-di-t-amylphenoxy)butylaminosulfamoyl group, and an arylsulfamoyl group such as a phenylsulfamoyl group. The sulfinyl group is preferable and an alkylsulfinyl group having 4 to 12 carbon atoms is particularly preferable.

In Formula (3), n is an integer of 1 to 4, and preferably 1 or 2. When n is 2 or more, plural groups represented by R₁₁ may be the same as or different from each other. Though the substituting position of the substituent represented by R₁₁ is not specifically limited, 4- or 5-position is preferable.

In Formula (3), R₁₂ is a hydrogen atom or an aliphatic group such as an alkyl group, an alkenyl group and an alkynyl group, an aromatic group such as a phenyl group and a p-chlorophenyl group, or a heterocyclic group such as a 2-tetrahydrofuryl group, a 2-thiophenyl group, a 4-imidazolyl group, an indoline-1-yl group and a 2-pyridyl group. R₁₂ is preferably a hydrogen atom or an alkyl group.

In Formula (3), R₁₃ is a hydrogen atom, an aliphatic group, an aromatic group or a heterocyclic group. R₁₃ is preferably a hydrogen atom or an alkyl group having 1 to 12 carbon atoms, or a branched alkyl group such as an i-propyl group, a t-butyl group and a t-amyl group is preferable, which is excellent in the durability.

In Formula (3), R₁₄ is an oxygen atom or a group substituting on the benzene ring through an oxygen atom or a nitrogen atom, concretely a group the same as that the group substituting on the benzene ring through an oxygen atom or a nitrogen atom represented by R₁₁. R₁₄ is preferably an acylamino group or an alkoxy group.

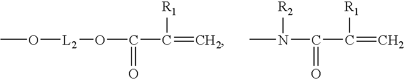

When the polymerizable group is contained in R₁₄ as a partial structure, R₁₄ is preferably the above.

In the above formula, L₂ is an alkylene group having 1 to 12 carbon atoms, and preferably a strait-chain alkylene group having 3 to 6 carbon atoms, branched-chain or cyclic alkylene group. R₁ is a hydrogen atom or a methyl group, R₂ is an alkyl group having 1 to 12, preferably 2 to 6, carbon atoms.

In Formula (3), R₁₅ is a hydrogen atom, an aliphatic group, an aromatic group or a heterocyclic group. R₁₁ is preferably a hydrogen atom or an alkyl group having 1 to 12 carbon atoms, and particularly preferably a branched-chain alkyl group such as an i-propyl group, a t-butyl group and a t-amyl group.

In Formula (3), R₁₆ is a hydrogen atom, an aliphatic group, an aromatic group or a heterocyclic group, and preferably a hydrogen atom.

Examples of UV absorbing monomer preferably employable in the present invention are listed below, but the monomer is not limited to the examples.

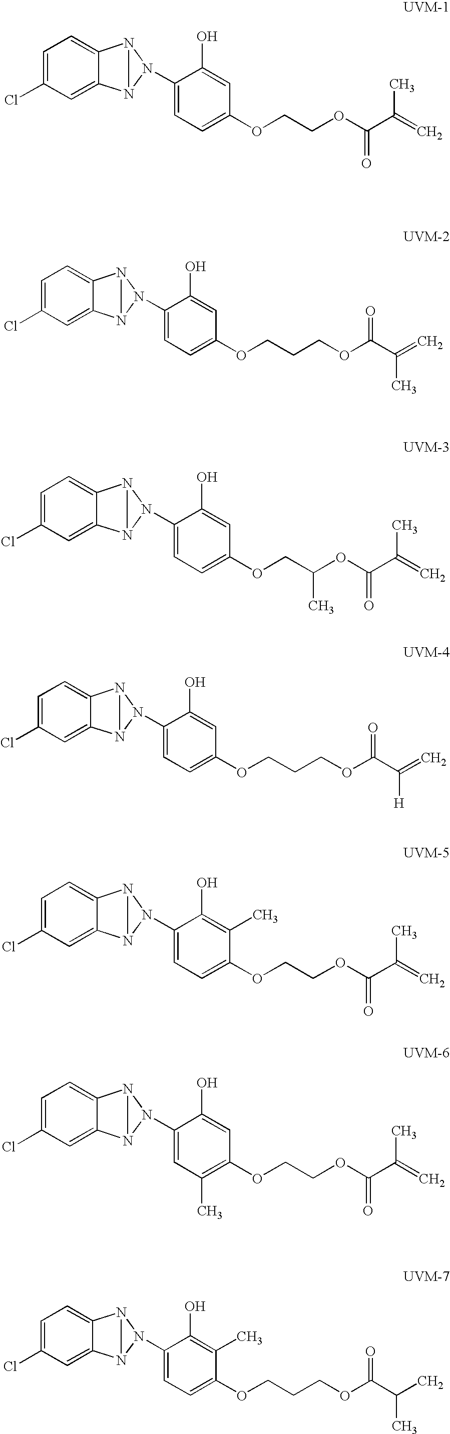

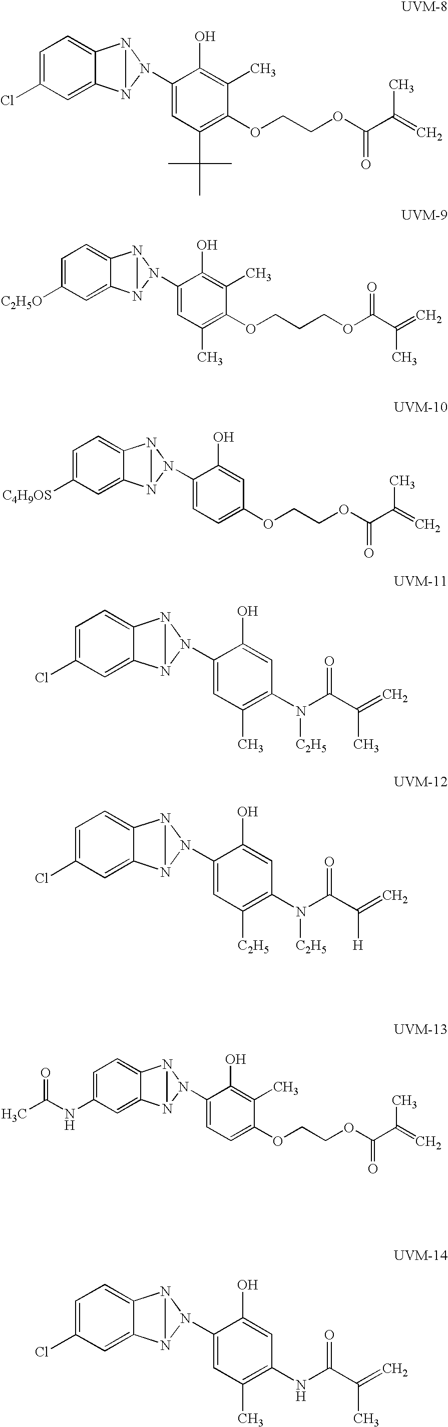

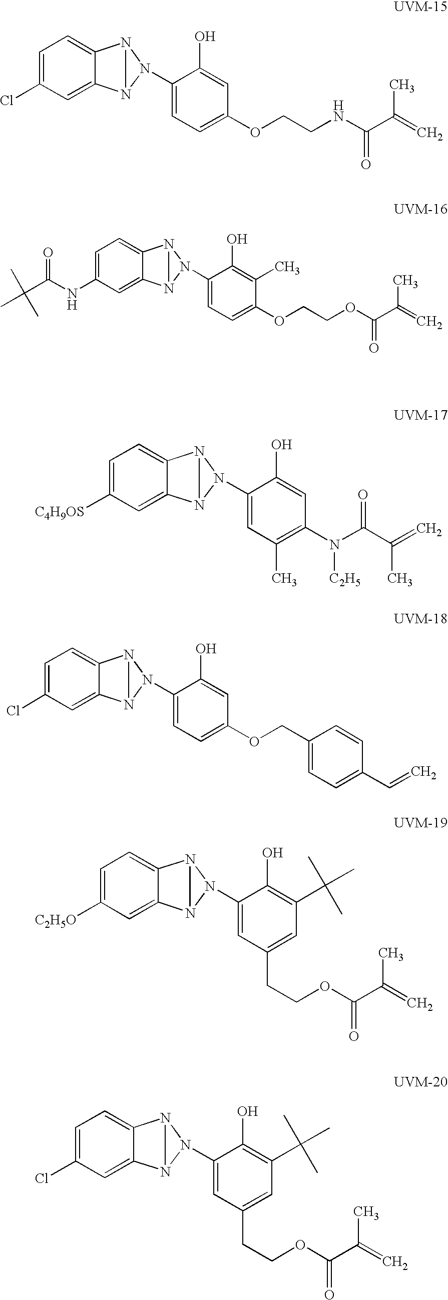

b. Description of Polymer

The UV absorbing polymer to be employed in the present invention is a copolymer of the UV absorbing monomer and the ethylenic unsaturated monomer, which is characterized in that the weight average molecular weight is within the range of 490 to 50,000.

The haze is reduced by the use of the UV absorbent in the state of copolymer and the optical film excellent in the transparency can be obtained. In the present invention, the weight average molecular weight of the copolymer is within the range of 490 to 50,000, preferably 2,000 to 20,000, and more preferably 7,000 to 15,000. When the weight average molecular weight is less than 490, the copolymer tends to be oozed out on the film surface and colored during the passing of time. When the weight average molecular weight is more than 50,000, the compatibility of the copolymer with the resin tends to be lowered.

Examples of the ethylenic unsaturated monomer capable of copolymerizing with the UV absorbing monomer include methacrylic acid and a ester thereof such as methyl methacrylate, ethyl methacrylate, propyl methacrylate, butyl methacrylate, i-butyl methacrylate, t-butyl methacrylate, octyl methacrylate, cyclohexyl methacrylate, 2-hydroxyhexyl methacrylate, 2-hydroxypropyl methacrylate, tetrahydroxyfurfuryl methacrylate, benzyl methacrylate, dimethylaminoethyl methacrylate and diethylaminoethyl methacrylate, and acrylic acid and an ester thereof such as methyl acrylate, ethyl acrylate, propyl acrylate, butyl acrylate, i-butyl acrylate, t-butyl acrylate, octyl acrylate, cyclohexyl acrylate, 2-hydroxyethyl acrylate, 2-hydroxypropyl acrylate, tetrahydrofurfuryl acrylate, 2-ethoxyethyl acrylate, Diethylene glycol ethoxylate acrylate, 3-methoxybutyl acrylate, benzyl acrylate and dimethylaminoethyl acrylate, an alkyl vinyl ether such as methyl vinyl ether, ethyl vinyl ether and butyl vinyl ether, an alkyl vinyl ester such as vinyl formate, vinyl butylate, vinyl capronate and vinyl stearate, acrylonitrile, vinyl chloride and styrene.

Among the ethylenic unsaturated monomers, an acrylate and a methacrylate each having a hydroxyl group or an ether bond such as 2-hydroxyethyl methacrylate, 2-hydroxypropyl methacrylate, tetrahydrofurfuryl methacrylate, 2-hydroxyethyl acrylate, 2-hydroxypropyl acrylate, tetrahydrofurfuryl acrylate, 2-ethoxyethyl acrylate, diethylene glycol ethoxylate acrylate and 3-methoxybutyl acrylate are preferable. These monomers can be copolymerized solely or in combination with the UV absorbing monomer.

The ratio of the UV absorbing monomer to the copolymerizable ethylenic unsaturated monomer is determined considering the compatibility of the formed copolymer with the transparent resin, the influence on the transparency and the mechanical strength of the optical film. It is preferably to combine them so that the copolymer contains 20 to 70%, more preferably 30 to 60%, by weight of the UV absorbent monomer. When the content of the UV absorbing monomer is less than 20% by weight, a large adding amount of the UV absorbent is necessary for obtaining desired UV absorbing ability so that the transparency of the film is considerably lowered by increasing in the haze or precipitation of the UV absorbent and the strength of the film tends to be lowered. When the content of the UV absorbing monomer is more than 70% by weight, the compatibility with the transparent resin tends to lowered and the production efficiency of the film is degraded.

c. Description of Polymerization Method

In the present invention, the method for polymerizing the UV absorbing copolymer is not specifically limited and known methods such as radical polymerization, anion polymerization and cation polymerization can be widely applied. As the initiator for the radical polymerization, an azo compound and a peroxide compound such as azobisisobutylnitrile (AIBN), a diester of azobisisobutylic acid and benzoyl peroxide, are employable. The solvent for polymerization is not specifically limited, and examples of usable solvent include an aromatic hydrocarbon type solvent such as toluene and chlorobenzene, a halogenized hydrocarbon type solvent such as dichloroethane and chloroform, a an ether type solvent such as tetrahydrofuran and dioxane, an amide type solvent such as dimethylformamide, an alcohol type solvent such as methanol, an ester type solvent such as methyl acetate and ethyl acetate, a ketone type solvent such as acetone, cyclohexanone and methyl ethyl ketone, and an aqueous solvent. Solution polymerization in which the polymerization is carried out in a uniform system, precipitation polymerization in which the formed polymer is precipitated and emulsion polymerization in which the polymerization is carried out in a micelle state are also performed according to selection of the solvent.

The weight average molecular weight of the UV absorbing copolymer can be controlled by known molecular weight controlling methods. For controlling the molecular weight, for example, a method can be applied in which adding a chain transfer agent such as carbon terachloride, laurylmercptane and octyl thioglycolate is employed. The polymerization is usually performed at a temperature of from a room temperature to 130° C., and preferably 50 to 100° C.

The UV absorbing copolymer is mixed with the transparence resin constituting the optical film preferably in a ratio of 0.01 to 40%, more preferably 0.1 to 10%, by weight. On this occasion, the mixing ratio is not limited when the haze is not more than 0.5; the haze is preferably not more than 0.2. It is more preferable that formed optical film has a haze of not more than 0.2 the transparency at 380 nm of not more than 10%.

Moreover, it is also preferable that at least one of the UV absorbents contains a polymer derived from a UV absorbing monomer represented by Formula (2).

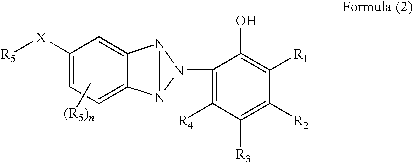

In the above formula, n is an integer of 0 to 3, when n is 2 or more, plural groups represented by R₅ may be the same as or different from each other and may be bonded together with to form a 5- through 7-member ring.

R₁ through R₅ are each a hydrogen atom, a halogen atom or a substituent. Examples of the halogen atom include a fluorine atom, a chlorine atom, a bromine atom and an iodine atom, and preferably the fluorine atom and the chlorine atom. Examples of the substituent include an alkyl group such as a methyl group, an ethyl group, an isopropyl group, a hydroxyethyl group, a methoxymethyl group, a trifluoromethyl group and a t-butyl group, an alkenyl group such as a vinyl group, an allyl group and a 3-butene-1-yl group, an aryl group such as a phenyl group, a naphthyl group, a p-tolyl group and a p-chlorophenyl group, a heterocyclic group such as a pyridyl group, a benzimidazolyl group, a benzothiazolyl group and a benzoxazolyl group, an alkoxy group such as a methoxy group, an ethoxy group, an isopropoxy group and an n-butoxy group, an aryloxy group such as a phenoxy group, a heterocycloxy group such as a 1-phenyltetrazole-5-oxy group, a 2-tetrahydropyranyloxy group, an acyloxy group such as an acetoxy group, pivaloyloxy group and a benzoyloxy group, an acyl group such as an acetyl group, an isopropanoyl group and a butyloyl group, an alkoxycarbonyl group such as a methoxycarbonyl group and an ethoxycarbonyl group, an aryloxycarbonyl group such as a phenoxycarbonyl group, a carbamoyl group such as a methylcarbamoyl group, an ethylcarbamoyl group and a dimethylcarbamoyl group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a nitro group, a sulfonamido group such as a methanesulfonamido group and a benzenesulfonamido group, a sulfamoylamino group such as a dimethylsulfamoylamino group, a sulfonyl group such as a methanesulfonyl group, a butanesulfonyl group and a phenylsulfonyl group, a sulfamoyl group such as an ethylsulfamoyl group and dimethylsulfamoyl group, a sulfonylamino group such as a methanesulfonylamino group and a benzenesulfonylamino group, a ureido group such as a 3-methylureido group, a 3,3-dimethylureido group and a 1,3-dimethylureido, an imido group such as a phthalimido group, a silyl group such as a trimethylsilyl group, a triethylsilyl group and t-butyldimethylsilyl group, an alkylthio group such as a methylthio group, an ethylthio group and an n-butylthio group, an arylthio group such as a phenylthio group, and the alkyl group and aryl group are preferable.

In Formula (2), the groups represented by R₁ through R₅ each may have a substituent when the group can be substituted, and adjacent R₁ through R₄ may be bonded to for a 5- to 7-member ring.

R₆ is a hydrogen atom, an alkyl group, an alkenyl group, an alkynyl group, an aryl group or a heterocyclic group. The alkyl group is, for example, a methyl group, an ethyl group, a propyl group, an isopropyl group, an n-butyl group, an isobutyl group, a t-butyl group, an amyl group, an isoamyl group and a hexyl group. The alkyl group may further have a halogen atom or a substituent. The halogen atom is, for example, a fluorine atom, a chlorine atom, a bromine atom and an iodine atom. Examples of the substituent include an aryl group such as a phenyl group, a naphthyl group, a p-tolyl group and a p-chlorophenyl group, an acyl group such as an acetyl group, a propanoyl group and butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbamoyl group and ethoxycarbonyl group, and an aryloxycarbonyl group such as phenoxycarbonyl group.

As the cycloalkyl group, a saturated cyclic hydrocarbon group such as a cyclopentyl group, a cyclohexyl group, a norbornyl group and adamantyl group can be exemplified. Such the groups may be unsubstituted or substituted.

Examples of the alkenyl group include a vinyl group, an allyl group, a 1-methyl-2-propenyl group, a 3-butenyl group, a 2-butenyl group, a 3-methyl-2-butenyl group and an oreyl group, and the vinyl group, and the 1-methyl-2-propenyl group is preferable.

Examples of the alkynyl group include an ethynyl group, a butynyl group, a phenylethynyl group, a propalgyl group, a 1-methyl-2-propynyl group, a 2-butynyl group and a 1,1-dimethyl-2-propynyl group, and the ethynyl group and the propalgyl group are preferable.

Examples of the aryl group include a phenyl group, a naphthyl group and an anthranyl group. The aryl group may have a halogen atom or a substituent. As the halogen atom, a fluorine atom, a chlorine atom, a bromine atom and an iodine atom can be exemplified. Examples of the substituent include an alkyl group such as a methyl group, an ethyl group, an isopropyl group, a hydroxyethyl group, a methoxymethyl group, a trifluoromethyl group and a t-butyl group, an acyl group such as an acetyl group, a propanoyl group and a butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylamino group, an acylamino group such as an acetylamino group and a propionyl amino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbonyl group and an ethoxycarbonyl group, and an aryloxycarbonyl group such as a phenoxycarbonyl group.

As the heterocyclic group, a pyridyl group, a benzimidazolyl group, a benzothiazolyl group and a benzoxazolyl group can be exemplified. R₆ is preferably the alkyl group.

In Formula (2), X is a —COO— group, a —CONR₇— group, a —OCO— group or an —NR₇CO— group.

R₇ is a hydrogen atom, an alkyl group, a cycloalkyl group an aryl group or a heterocyclic group. The alkyl group is, for example, a methyl group, an ethyl group, a propyl group, an isopropyl group, an n-butyl group, an isobutyl group, a t-butyl group, an amyl group, an isoamyl group or a hexyl group. The alkyl group may further have a halogen atom or a substituent. The halogen atom is, for example, a fluorine atom, a chlorine atom, a bromine atom or an iodine atom. Examples of the substituent include an aryl group such as a phenyl group, a naphthyl group, a p-tolyl group and a p-chlorophenyl group, an acyl group such as an acetyl group, a propanoyl group and butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbamoyl group and ethoxycarbonyl group, and an aryloxycarbonyl group such as phenoxycarbonyl group.

As the cycloalkyl group, a saturated cyclic hydrocarbon group such as a cyclopentyl group, a cyclohexyl group, a norbornyl group and adamantyl group can be exemplified. Such the groups may be unsubstituted or substituted.

Examples of the aryl group include a phenyl group, a naphthyl group and an anthranyl group. The aryl group may further have a halogen atom or a substituent. As the halogen atom, a fluorine atom, a chlorine atom, a bromine atom and an iodine atom can be exemplified. Examples of the substituent include an alkyl group such as a methyl group, an ethyl group, an isopropyl group, a hydroxyethyl group, a methoxymethyl group, a trifluoromethyl group and a t-butyl group, an acyl group such as an acetyl group, a propanoyl group and a butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylamino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbonyl group and an ethoxycarbonyl group, and an aryloxycarbonyl group such as a phenoxycarbonyl group.

As the heterocyclic group, a pyridyl group, a benzimidazolyl group, a benzothiazolyl group and a benzoxazolyl group can be exemplified. R₇ is preferably the hydrogen atom.

In the present invention, the polymerizable group is a unsaturated ethylenic polymerizable group or a di-functional condensation-polymerizable group, and preferably the unsaturated ethylenic polymerizable group. Concrete examples of the unsaturated ethylenic polymerizable group include a vinyl group, an allyl group, an acryloyl group, a methacryloyl group, a styryl group, an acrylamido group, a methacrylamido group, a vinyl cyanide group, a 2-cyanoacryloxy group, a 1,2-epoxy group, a vinylbenzyl group and a vinyl ether group and preferably the vinyl group, the acryloyl group, the methacryloyl group, the acrylamido group and the methacrylamido group. The UV absorbing monomer having the polymerizable group as the partial structure thereof is the monomer in which the polymerizable group is bonded directly or through two or more bonding groups to the UV absorbent, for example an alkylene group such as a methylene group, a 1,2-ethylene group, a 1,3-propylene group, a 1,4-butylene group and a cyclohexane-1,4-diyl group, an alkenylene group such as an ethane-1,2-diyl group and a butadiene-1,4-diyl group, an alkynylene group such as a etyne-1,2-diyl group, a butane-1,3-diine-1,4-diyl, a bonding group derived from a compound including an aromatic group such as a substituted or unsubstituted benzene, a condensed polycyclic hydrocarbon, an aromatic heterocyclic rings, a combination of aromatic hydrocarbon rings and a combination of aromatic heterocyclic rings, and bonding by a hetero atom such as an oxygen atom, a sulfur atom, a nitrogen atom, a silicon atom and a phosphor atom. The bonding group is preferably the alkylene group and the bonding by the hetero atom. These bonding groups may be combined for forming a composite bonding group. The weight average molecular weight of the polymer derived from the UV absorbing monomer is 2,000 to 30,000, and preferably 5,000 to 20,000.

The weight average molecular weight of the UV absorbing copolymer can be controlled by known molecular weight controlling methods. For controlling the molecular weight, for example, a method can be applied in which a chain transfer agent such as carbon terachloride, laurylmercptane and octyl thioglycolate is employed. The polymerization is usually performed at a temperature of from a room temperature to 130° C., and preferably 50 to 100° C.

The UV absorbing polymer to be employed in the present invention is preferably a copolymer of the UV absorbing monomer and another polymerizable monomer. Examples of the other monomer capable of polymerizing include a unsaturated compound, for example, a styrene derivative such as styrene, α-methylstyrene, o-methylstyrene, m-methylstyrene, p-methylstyrene and vinylnephthalene, an acrylate derivative such as methyl acrylate, ethyl acrylate, propyl acrylate, butyl acrylate, i-butyl acrylate, t-butyl acrylate, octyl acrylate, cyclohexyl acrylate and benzyl acrylate, a methacrylate derivative such as methyl methacrylate, ethyl methacrylate, propyl methacrylate, butyl methacrylate, i-butyl methacrylate, t-butyl methacrylate, octyl methacrylate, cyclohexyl methacrylate and benzyl methacrylate, an alkyl vinyl ether such as methyl vinyl ether, ethyl vinyl ether and butyl vinyl ether, an alkyl vinyl ester such as vinyl formate, vinyl acetate, vinyl butylate, vinyl capronate and vinyl stearate, crotonic acid, maleic acid, fumaric acid, itaconic acid, acrylonitrile, methacrylonitrile, vinyl chloride, vinylidene chloride, acrylamide and methacrylamide. Methyl acrylate, methyl methacrylate and vinyl acetate are preferred.

It is also preferable that the component other than the UV absorbing monomer in the polymer derived from the UV absorbing monomer contains a hydrophilic ethylenic unsaturated monomer.

As the hydrophilic ethylenic unsaturated monomer, a hydrophilic compound having a polymerizable unsaturated double bond in the molecular thereof is employable without any limitation. For example, a unsaturated carboxylic acid such as acrylic acid and methacrylic acid, an acrylate and methacrylate each having a hydroxyl group or an ether bond such as 2-hydroxyethyl methaceylate, 2-hydroxypropyl methacrylate, tetrahydrfurfuryl methacrylate, 2-hydroxyethyl acrylate, 2-ydroxypropyl acrylate, 2,3-dihydroxy-2-methylpropyl methacrylate, tetrahydrofurfuryl acrylate, 2-ethoxyethyl acrylate, diethylene glycol ethoxylate acrylate and 3-methoxybutylbutyl acrylate, acrylamide, an N-substituted (meth)acrylamido such as N,N-dimethyl(meth)acrylate, N-vinylpyrrolidone and N-vinyloxazolidone are employable.

As the hydrophilic ethylenic unsaturated monomer, a (meth)acrylate having a hydroxyl group or a carboxyl group in the molecule thereof is preferable, and 2-hydroxyethyl methacrylate, 20hydroxypropyl methacrylate, 2-hydroxyethyl acrylate and 2-hydroxypropyl acrylate are particularly preferable.

These polymerizable monomers can be copolymerized solely or in combination of two or more kinds together with the UV absorbing monomer.

In the present invention, the method for polymerizing the UV absorbing copolymer is not specifically limited and known methods such as radical polymerization, anion polymerization and cation polymerization can be widely applied. As the initiator for the radical polymerization, an azo compound and a peroxide compound such as azobisisobutylnitrile (AIBN), a diester of azobisisobutylic acid, benzoyl peroxide and hydrogen peroxide are employable. The solvent for polymerization is not specifically limited, and examples of usable solvent include an aromatic hydrocarbon type solvent such as toluene and chlorobenzene, a halogenized hydrocarbon type solvent such as dichloroethane and chloroform, a an ether type solvent such as tetrahydrofuran and dioxane, an amide type solvent such as dimethylformamide, an alcohol type solvent such as methanol, an ester type solvent such as methyl acetate and ethyl acetate, a ketone type solvent such as acetone, cyclohexanone and methyl ethyl ketone, and an aqueous solvent. Solution polymerization in which the polymerization is carried out in a uniform system, precipitation polymerization in which the formed polymer is precipitated, emulsion polymerization in which the polymerization is carried out in a micelle state and suspension polymerization carried out in a suspended state can be performed according to selection of the solvent.

The using ratio of the UV absorbing monomer, the polymerizable monomer capable of polymerizing with the UV absorbing monomer and the hydrophilic unsaturated monomer is suitably determined considering the compatibility of the obtained UV absorbing copolymer with the other transparent polymer and the influence on the transparency and the mechanical strength of the optical compensating film.

The content of the UV absorbing monomer in the polymer derived from the UV absorbing monomer is preferably 1 to 70%, and more preferably 5 to 60%, by weight. When the content of the UV absorbent monomer in the UV absorbing polymer is less than 1%, addition of a large amount of the UV absorbing polymer is necessary for satisfying the desired UV absorbing ability so that increasing in the haze or lowering in the transparency and the mechanical strength by the precipitation is caused. On the other hand, when the content of the UV absorbing monomer in the UV absorbing polymer exceeds 70% by weight, the transparent optical compensating film is difficultly obtained sometimes since the compatibility of the polymer with another polymer is lowered.

The hydrophilic ethylenic unsaturated monomer is preferably contained in the UV absorbing copolymer in a ratio of from 0.1 to 50% by weight. When the content is less than 0.1%, the improvement effect on the compatibility of the hydrophilic ethylenic unsaturated monomer cannot be obtained and when the content is more than 50% by weight, the isolation and purification of the copolymer becomes impossible. More preferable content of the hydrophilic ethylenic unsaturated monomer is from 0.5 to 20% by weight. When the hydrophilic group is substituted to the UV absorbing monomer itself, it is preferable that the total content of the hydrophilic UV absorbing monomer and the hydrophilic ethylenic unsaturated monomer is within the above-mentioned range.

For satisfying the content of the UV absorbing monomer and the hydrophilic monomer, it is preferable that an ethylenic unsaturated monomer having no hydrophilicity is further copolymerized additionally to the above two monomers.

Two or more kinds of each of the UV absorbing monomer and hydrophilic or non-hydrophilic ethylenic unsaturated monomer may be mixed and copolymerized.

Typical examples of the UV absorbing monomer to be preferably employed in the present invention are listed below, but the monomer is not limited to these samples.

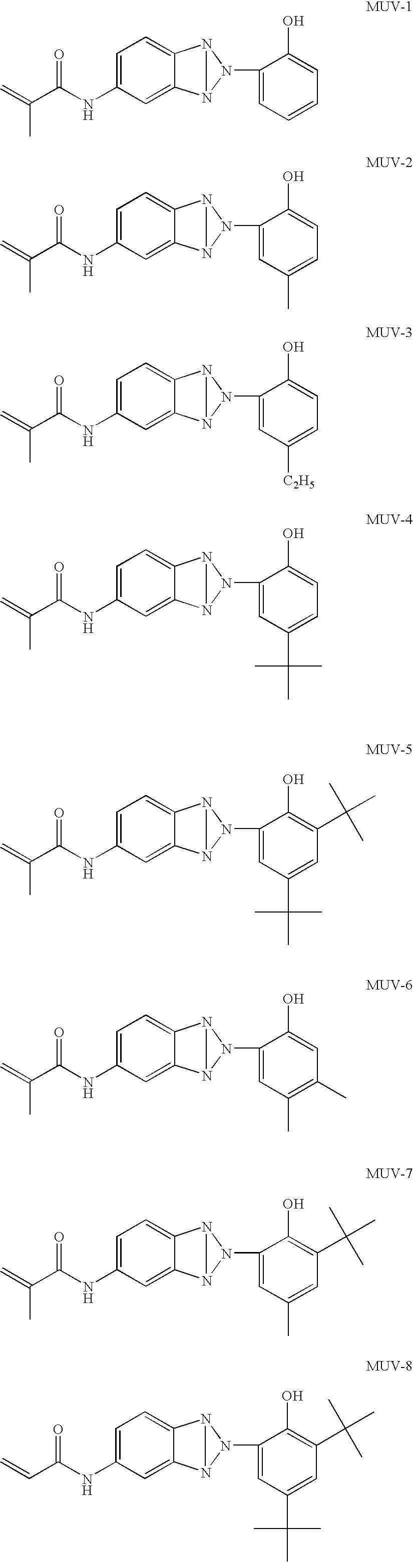

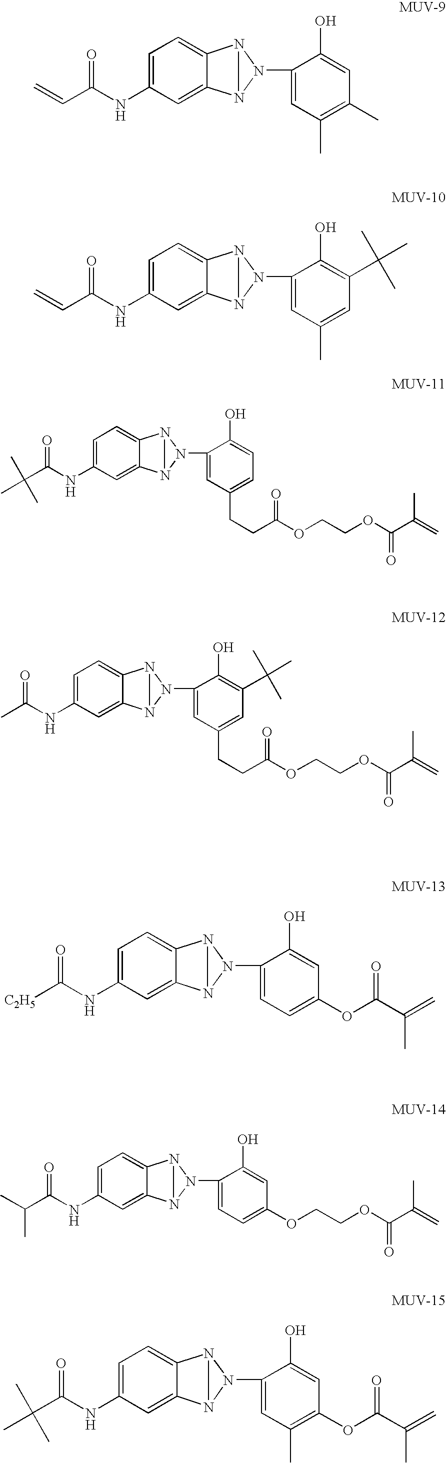

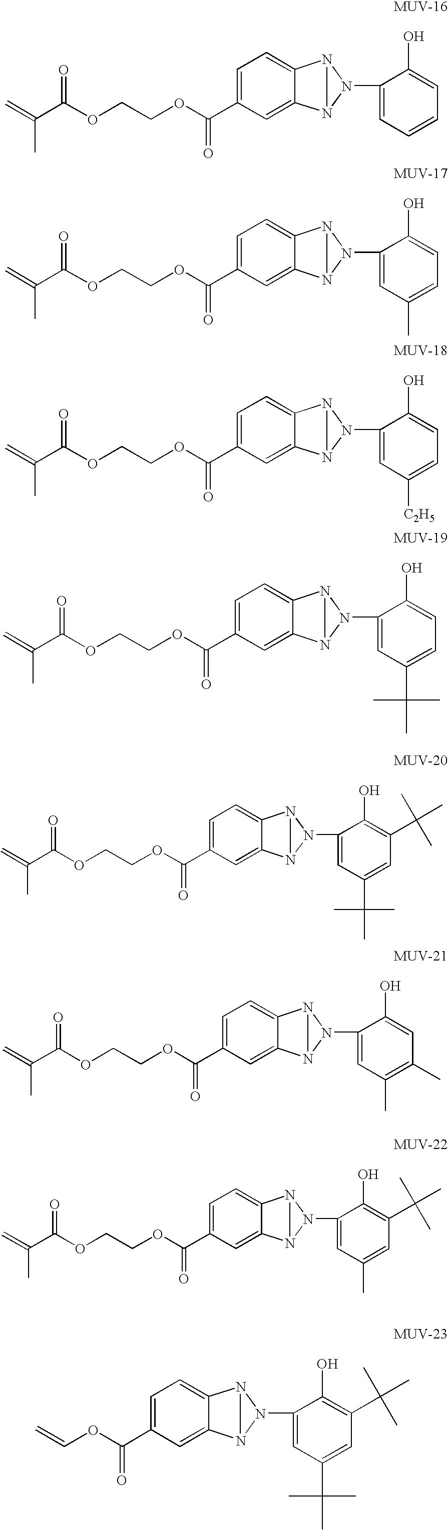

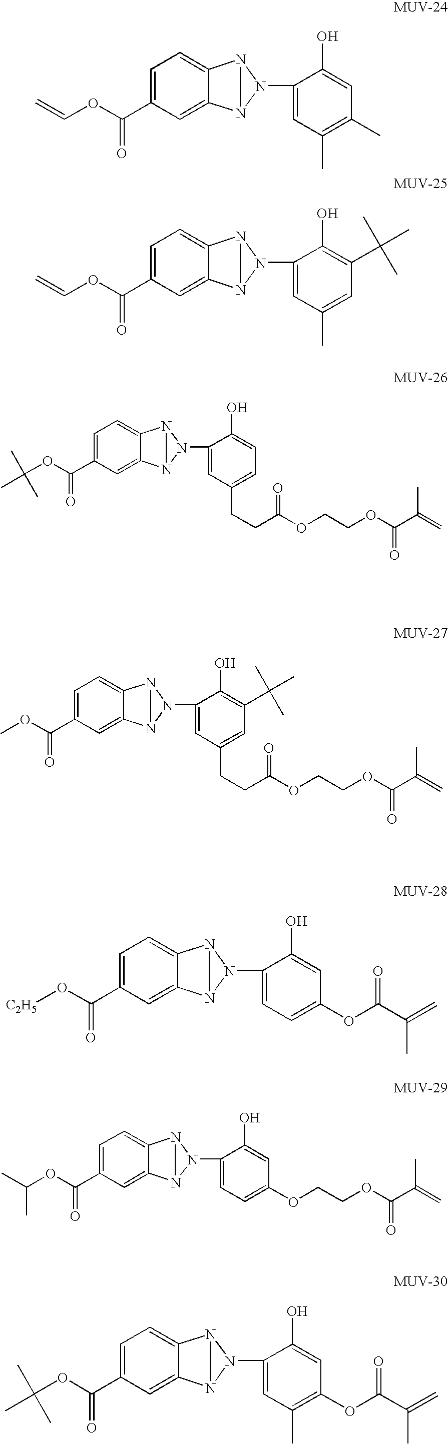

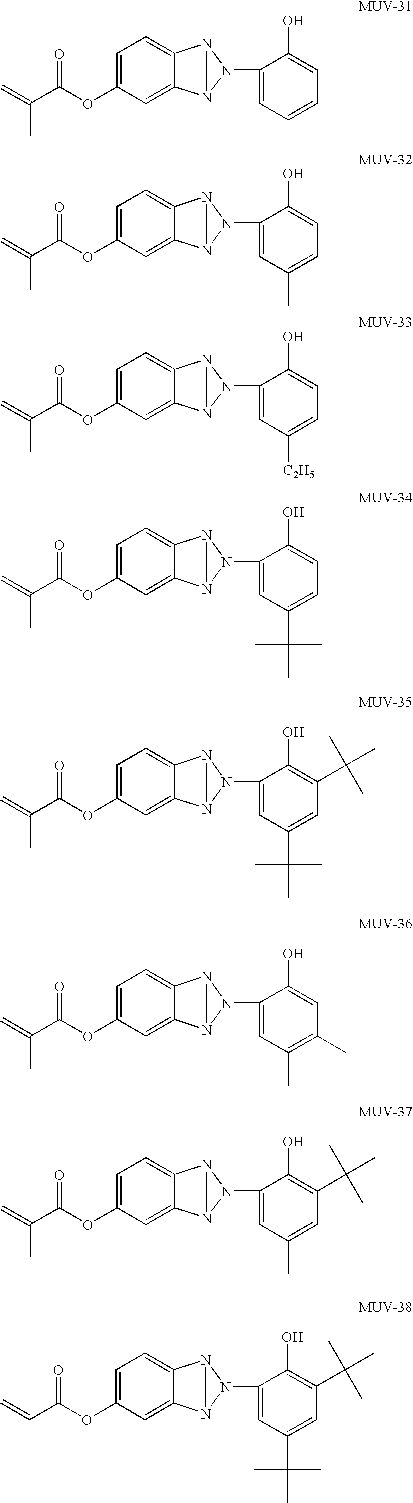

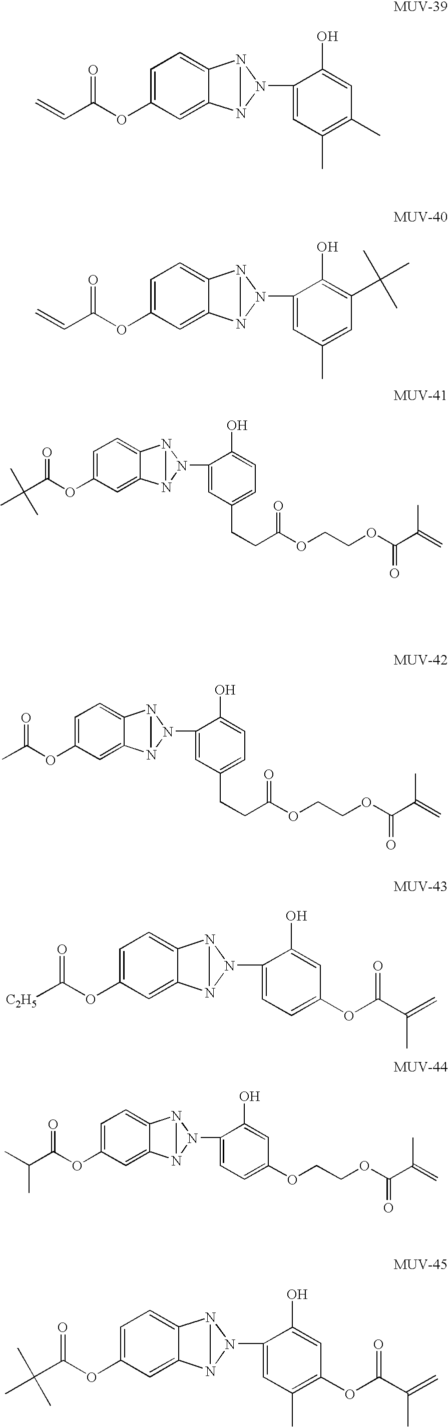

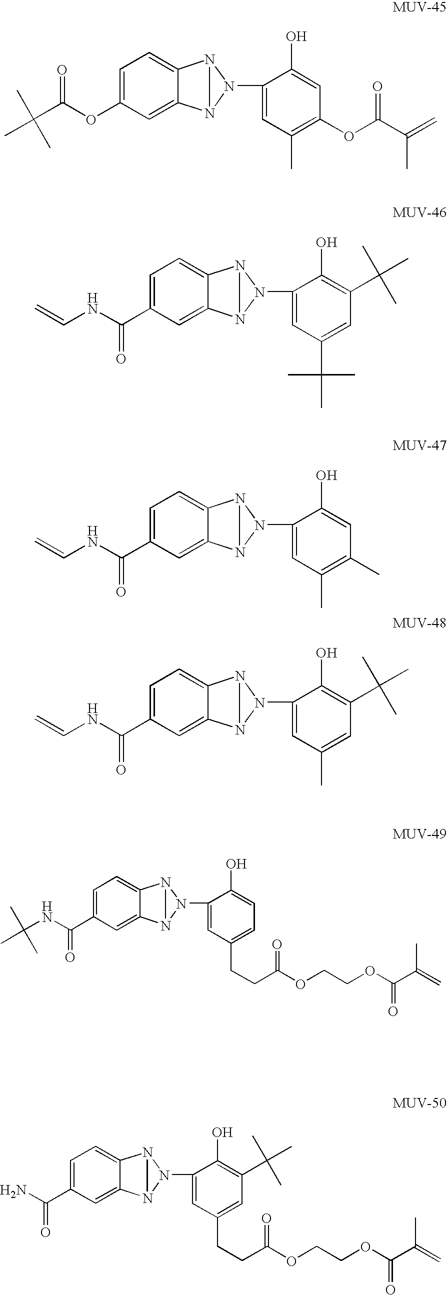

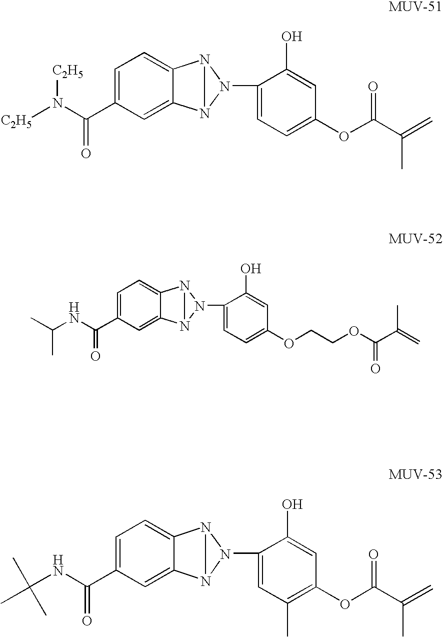

The UV absorbents, UV absorbing monomers and their intermediates to be employed in the present invention can be synthesized by referring published documents. For example U.S. Pat. Nos. 3,072,585, 3,159,646, 3,399,173, 3,761,272, 4,028,331 and 5,683,861, European Patent No. 86,300,416, Japanese Patent O.P.I. Publication Nos. 63-227575 and 63-185969, “Polymer Bulletin” V. 20 (2), 169-176, and “Chemical Abstracts V. 109, No. 191389 can be referred for synthesizing.

The UV absorbent and the UV absorbing polymer to be used in the present invention can be employed together with a low or high molecular weight compound or an inorganic compound according to necessity on the occasion of mixing with the other transparent polymer. For example, it is one of preferable embodiments that the UV absorbent polymer and another relatively low molecular weight UV absorbent are simultaneously mixed with the other transparent polymer. Moreover, simultaneously mixing of an additive such as an antioxidant, a plasticizer and a flame retardant is also one of preferable embodiments.

The UV absorbent or the UV absorbing polymer to be employed in the present invention may be added in a state of kneaded with the rein or a solidified state by drying a solution of that together with the resin, though the adding method is not specifically limited.

Though the using amount of the UV absorbent and the UV absorbing polymer is varied depending on the kind of compound and the employing conditions, the amount of the UV absorbent is preferably 0.1 to 5.0 g, more preferably 0.1-3.0 g, further preferably 0.4 to 2.0 g, and particularly preferably 0.5 to 1.5 g, per square meter of the optical film. In the case of the UV polymer, the adding amount is preferably 0.1 to 10 g, more preferably 0.6 to 9.0 g, further preferably 1.2 to 6.0 g, and particularly preferably 1.5 to 3.0 g, per square meter of the optical film.

As described above, ones are preferable, which have superior absorbing ability to UV rays of not more than 380 nm for preventing degradation of the liquid crystal and low absorbing ability to visible light of not less than 400 nm for displaying ability of the liquid crystal display. In the present invention, the transparency at a wavelength of 380 nm is preferably not more than 8%, more preferably not more than 4%, and particularly preferably not more than 1%.

As UV absorbent monomers available on the market, 1-(2-bezotriazole)-2-hydroxy-5-(2-vinyloxycarbonylethyl)-benzene UVM-1 and a reactive type UV absorbent 1-(2-benzotriazole)-2-hydroxy-5-(2-methacryloyloxyethyl)-benzene UVA-93, each manufactured by Ootsuka Kagaku Co., Ltd., and similar compounds are employable in the present invention. They are preferably employed solely or in a state of polymer or copolymer but not limited to them. For example, a polymer UV absorbent available on the market PUVA-30M, manufactured by Ootsuka Kagaku Co., Ltd., is preferably employed. The UV absorbent may be used in combination of two or more kinds thereof.

### (Plasticizer)

The addition of a plasticizer in combination with the foregoing polymer to the polarizing plate protective film of the present invention is desired for improving the film properties such as mechanical properties, softness and anti-moisture absorbing ability. The object of the addition of the plasticizer in the melt-cascading method according to the present invention further includes to make the melting point of the film constituting materials to lower than the glass transition point of the independent cellulose and to make the viscosity of the film constituting material containing the plasticizer to lower than that of the cellulose resin at the same temperature.

Here, in the present invention, the melting point of the film constituting material is the temperature of the heated material at the time when the fluidity of the material is appeared.

The independent cellulose resin not fluidized at a temperature lower than the glass transition point since the cellulose resin becomes film state. However, the elasticity or viscosity of the cellulose resin is lowered by heating at a temperature of higher than the glass transition point so that the cellulose resin is fluidized. It is preferable that the plasticizer to be added has a melting point or glass transition point lower than that of the cellulose resin for melting the film constituting material and satisfying the above objects.

Though the plasticizer relating to the present invention is not specifically limited, the plasticizer has a functional group capable of interacting by a hydrogen bond with the cellulose derivative or the other additives so that the haze or the bleeding out or evaporation of the plasticizer from the film does not occur.

Examples of such the functional group include a hydroxyl group, an ether group, a carbonyl group, an ester group, a residue of carboxylic acid, an amino group, an imino group, an amido group, a cyano group, a nitro group, a sulfonyl group, a residue of sulfonic acid, a phosphonyl group and a residue of phosphoric acid. The carbonyl group, ester group and phosphonyl group are preferable.

Examples of preferably usable plasticizer include a phosphate type plasticizer, a phthalate type plasticizer, a trimelitate type plasticizer, a pyromelitate type plasticizer, a polyvalent alcohol ester type plasticizer, a glycolate type plasticizer, a citrate type plasticizer, an aliphatic acid ester type plasticizer, a calboxylate type plasticizer and a polyester type plasticizer, and the polyvalent alcohol ester type plasticizer, polyester type plasticizer and citrate type plasticizer are particularly preferable. The addition of these plasticizers to the UV absorbent having a molecular weight of 490 to 50,000 is preferable for the compatibility.

The poly-valent alcohol ester is the ester of a di- or more-valent alcohol and a mono-carboxylic acid and preferably has an aromatic ring or a cycloalkyl ring in the molecular thereof.

The poly-valent alcohol is represented by the following Formula (4).

R₁—(OH)ₙ Formula (4)

In the above, R₁ is an n-valent organic group, and n is an integer of 2 or more.

Examples of preferable poly-valent alcohol include adonitol, arabitol, ethylene glycol, Diethylene glycol, triethylene glycol, tetraethylene glycol, 1,2-propanediol, 1,3-propanediol, dipeopylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol; trimethylolpropane, trimethylolethane and xylitol, but the present invention is not limited to them. Particularly, triethylene glycol, tetraethylene glycol, triethylol propane and xylitol are preferred.

Among them, the poly-valent alcohol esters using a poly-valent alcohol having 5 or more, particularly 5 to 20 carbon atoms are preferable.

As the monocarboxylic acid to be used in the poly-valent alcohol ester, a known aliphatic monocarboxylic acid, alicyclic monocarboxylic acid and aromatic monocarboxylic acid can be employed though the monocarboxylic acid is not limited. The alicyclic monocarboxylic acid and aromatic monocarboxylic acid are preferable for improving the moisture permeability ability and storage ability.

Examples of the preferable monocarboxylic acid are listed below but the present invention is not limited to them.

A straight or side chain fatty monocarboxylic acid having 1 to 32 carbon atoms is preferably employed. The number of carbon atoms is more preferably 1 to 20, and particularly preferably 1 to 10. The addition of acetic acid is preferable for raising the compatibility with the cellulose derivative, and the mixing of acetic acid with another carboxylic acid is also preferable.

As the preferable aliphatic monocarboxylic acid, a saturated fatty acid such as acetic acid, propionic acid, butylic acid, valeric acid, caproic acid, enantic acid, caprylic acid, pelargonic acid, capric acid, 2-ethyl-hexane carboxylic acid, undecylic acid, lauric acid, dodecylic acid, myristic acid, pentadecylic acid, palmitic acid, heptadecylic acid, stearic acid, nonadecanic acid, arachic acid, behenic acid, lignocelic acid, cerotic acid, heptacosanic acid, montanic acid, melisic acid and lacceric acid, and a unsaturated fatty acid such as undecylenic acid, oleic acid, sorbic acid, linolic acid, linolenic acid and arachidonic acid can be exemplified.

Examples of preferable alicyclic carboxylic acid include cyclopentene carboxylic acid, cyclohexane carboxylic acid, cyclooctane carboxylic acid and derivatives thereof.

Examples of preferable aromatic carboxylic acid include ones formed by introducing an alkyl group onto the benzene ring of benzoic acid such as benzoic acid and toluic acid, an aromatic monocarboxylic acid having two or more benzene rings such as biphenylcarboxylic acid, naphthalene carboxylic acid and tetralin carboxylic acid and derivatives of them, and benzoic acid is particularly preferable.

The molecular weight of the poly-valent alcohol is preferably 300 to 3,000, and more preferably 350 to 1,500 though the molecular weight is not specifically limited. Larger molecular weight is preferable for low volatility and smaller molecular weight is preferable for the moisture permeability and the compatibility with the cellulose derivative.

The carboxylic acid to be employed in the poly-valent alcohol ester may be one kind or a mixture of two or more kinds of them. The hydroxyl group in the polyvalent alcohol may be entirely esterified or partially leaved.

Concrete compounds of the poly-valent alcohol ester are listed below.

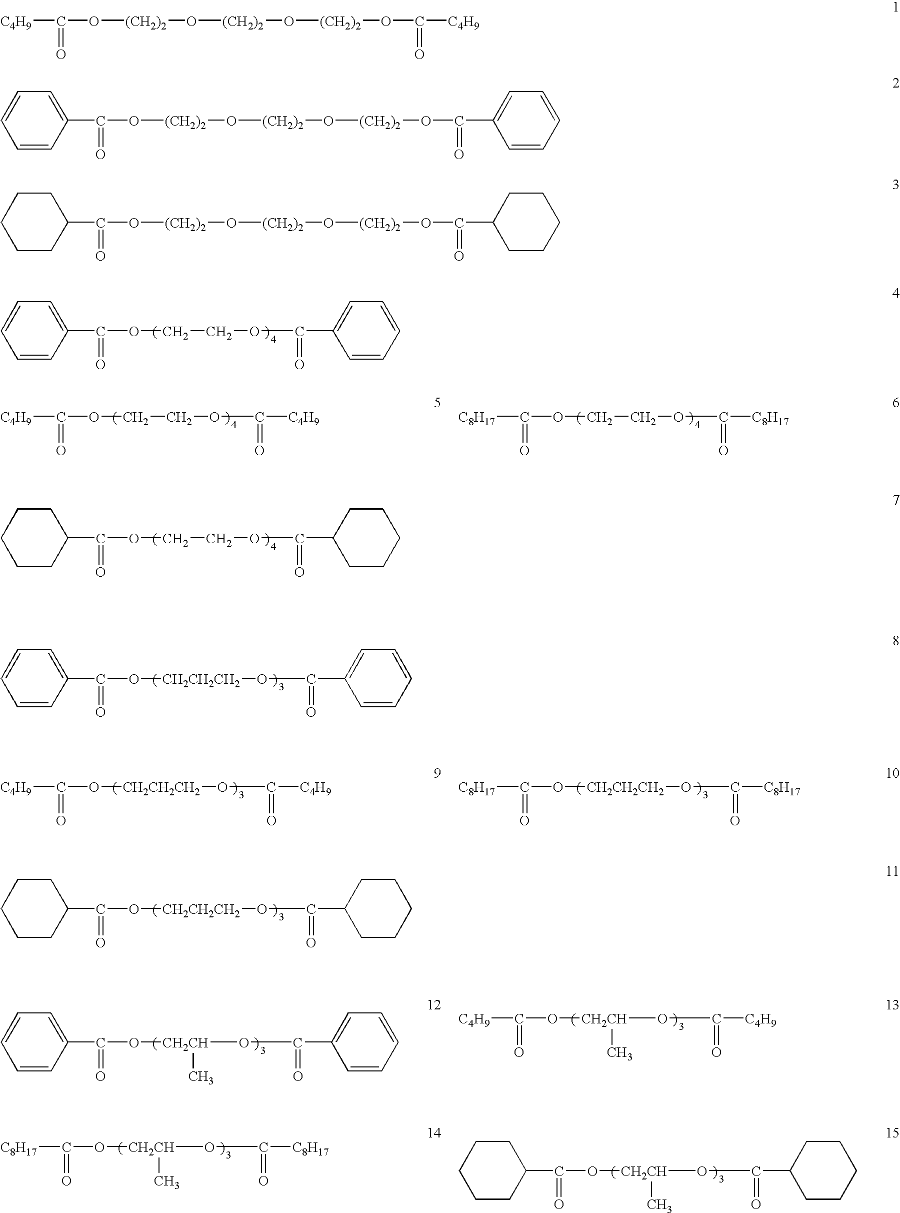

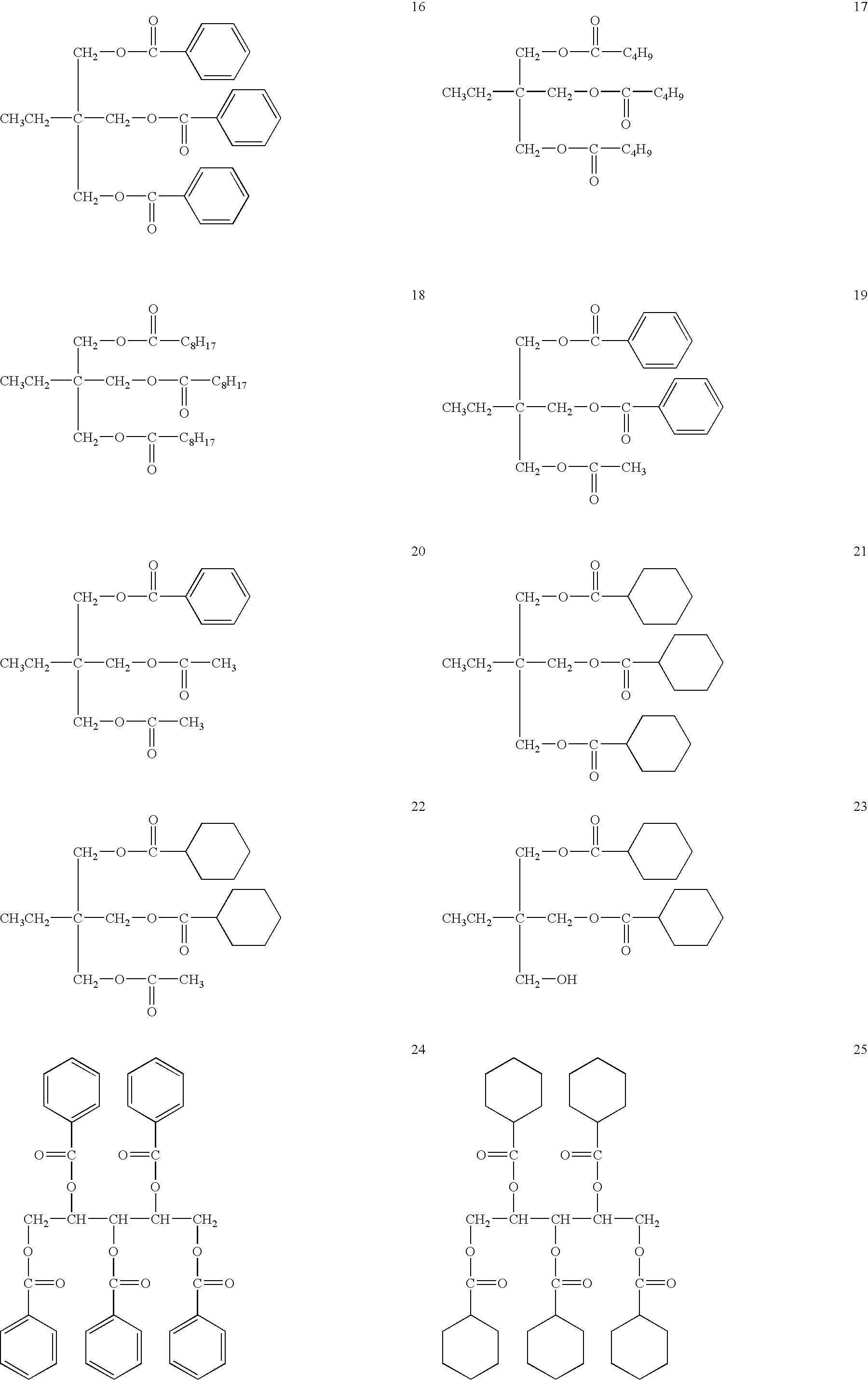

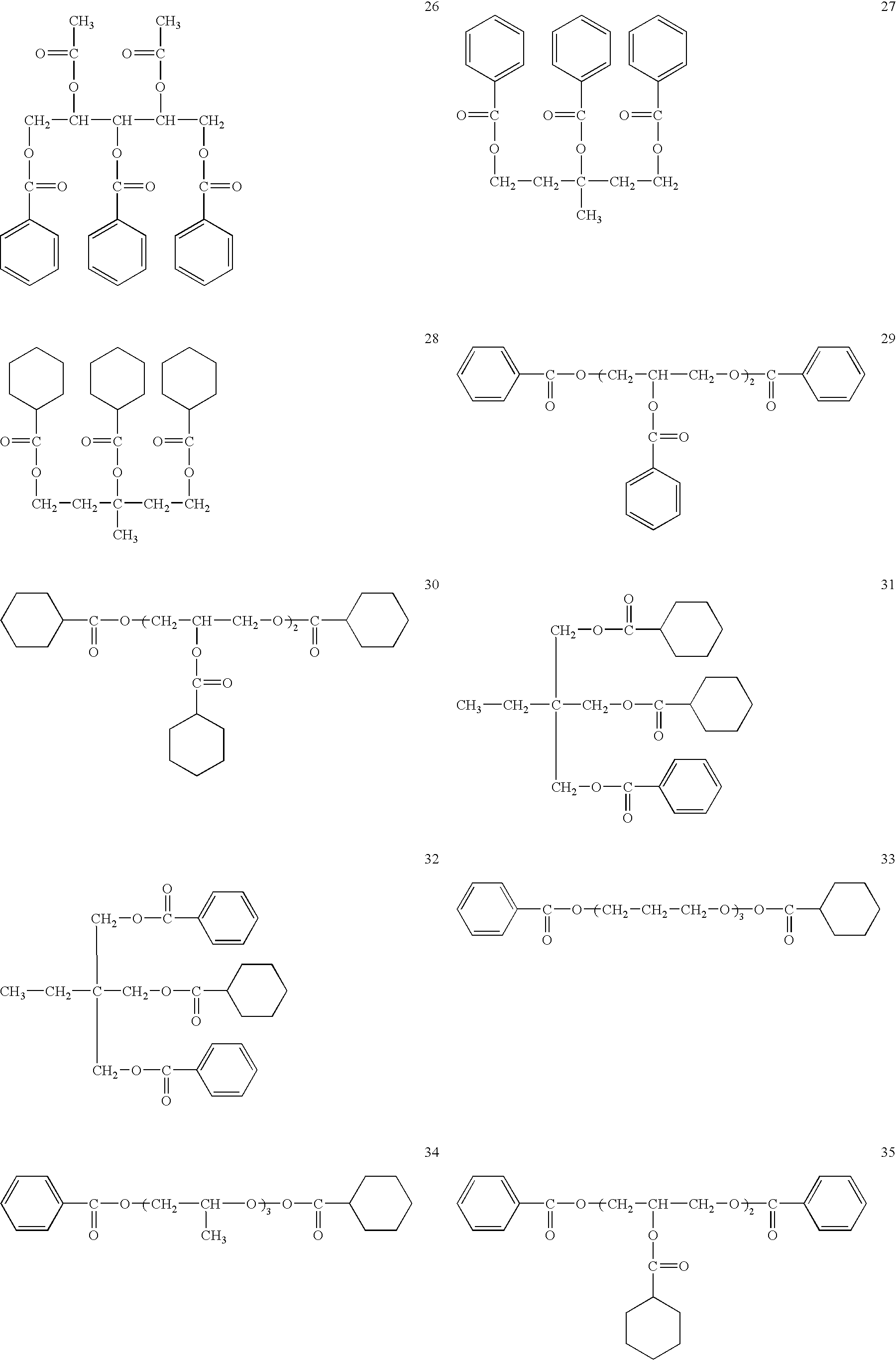

Moreover, a polyester type plasticizer having a cycloalkyl group in the molecule thereof is preferably employed. For example, compounds represented by the following Formula (5) are preferable though the polyester type plasticizer is not specifically limited.

B-(G-A)ₙ-G-B Formula (5)

In the above formula, B is a benzene monocarboxylic acid residue, G is an alkylene glycol residue having 2 to 12 carbon atoms, an aryl glycol residue having 6 to 12 carbon atoms or an oxyalkylene glycol residue having 4 to 12 carbon atoms, A is an alkylenecarboxylic acid residue having 4 to 12 carbon atoms or an aryldicarboxylic acid residue having 6 to 12 carbon atoms, and n is an integer of 0 or more.

The polyester type plasticizer is constituted by the benzene monocarboxylic acid residue represented by B, the alkylene glycol residue, the aryl glycol residue or the oxyalkylene glycol residue represented by G, and an alkylenecarboxylic acid residue or an aryldicarboxylic acid residue represented by A; the plasticizer can be obtained by a reaction similar to that for obtaining usual polyester type plasticizer.

As the benzene monocarboxylic acid component of the polyester type plasticizer employed in the present invention, for example, benzoic acid, p-tert-butylbenzoic acid, o-toluic acid, m-toluic acid, p-toluic acid, dimethylbenzoic acid, ethylbenzoic acid, n-propylbenzoic acid, aminobenzoic acid and acetoxybenzoic acid are applicable. They can be employed solely or in combination.

Examples of the alkylene glycol with 0.2 to 12 carbon atoms as the component of the polyester type plasticizer of the present invention include ethylene glycol, 1,2-propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol and 1,12-octadecanediol. These glycols are employed solely or in mixture of two or more kinds thereof.

Examples of the oxyalkylene glycol component with 4-12 carbon atoms forming the terminal aromatic ester structure include Diethylene glycol, triethylene glycol, tetraethylene glycol, dipropylene glycol and tripropylene glycol. These glycols can be employed solely or in combination of two or more kinds.

Examples of the alkylenedicarboxylic acid component with 4-12 carbon atoms forming the terminal aromatic ester structure include succinic acid, maleic acid, fumaric acid, glutaric acid, adipic acid, azelaic acid, sebacic acid and dodecanedicarboxylic acid. These acids can be employed solely or in a combination of two or more kinds. The examples of the arylenedicarboxylic acid component having 6 to 12 carbon atoms include phthalic acid, tetraphthalic acid, 1,5-naphthalenedicarboxylic acid and 1,4-naphthalenedicarboxylic acid.

The suitable number average molecular weight of the polyester type plasticizer to be employed in the present invention is preferably 250 to 2,000, and more preferably 300 to 1,500. The acid value of that is 0.5 mg KOH/g or less, and the hydroxy group value of that is 25 mg KOH/g. More preferably, the acid value is 0.3 mg KOH/g or less, and the hydroxyl group value is 15 mg KOH/g or less.

Examples of synthesizing of the aromatic terminal ester type plasticizer are described below.

### Sample No. 1 (Sample of Aromatic Terminal Ester)

In a reaction vessel, 365 parts (2.5 moles) of adipic acid, 418 parts (5.5 moles) of 1,2-propylene glycol, 610 parts of (5 moles) of benzoic acid and 0.30 parts of tetraisopropyl titanate as a catalyst were charged at once and stirred in nitrogen gas stream, and heated at a temperature of 130 to 250° C. until the acid value becomes not more than 2 while formed water was continuously removed and excessive mono-valent alcohol was refluxed by a reflux condenser. After that, distillate was removed under a reduced pressure of not more than 1.33×10⁴ Pa, finally not more than 4×10² Pa at a temperature of 200 to 230° C., and then the content of the vessel was filtered to obtain an aromatic terminal ester having the following properties.

Viscosity (mPa·s at 25° C.): 815
Acid value: 0.4

### Sample No. 2 (Sample of Aromatic Terminal Ester)

An aromatic terminal ester having the following properties was obtained in the same manner as in Sample 1 except that 365 parts (2.5 moles) of adipic acid, 610 parts (5 moles) of benzoic acid, 583 parts (5.5 moles) of diethylene glycol and 0.45 parts of tetraisopropyl titanate as a catalyst were employed.

Viscosity (mPa·s at 25° C.): 90
Acid value: 0.05

### Sample No. 3 (Sample of Aromatic Terminal Ester)

An aromatic terminal ester having the following properties was obtained in the same manner as in Sample 1 except that 410 parts (2.5 moles) of phthalic acid, 610 parts moles) of benzoic acid, 737 parts (5.5 moles) of dipropylene glycol and 0.40 parts of tetraisopropyl titanate as a catalyst were employed.

Viscosity (mPa·s at 25° C.): 43,400
Acid value: 0.2

Concrete compounds of the aromatic terminal ester type plasticizer are listed below; the present invention is not limited to the listed compounds.

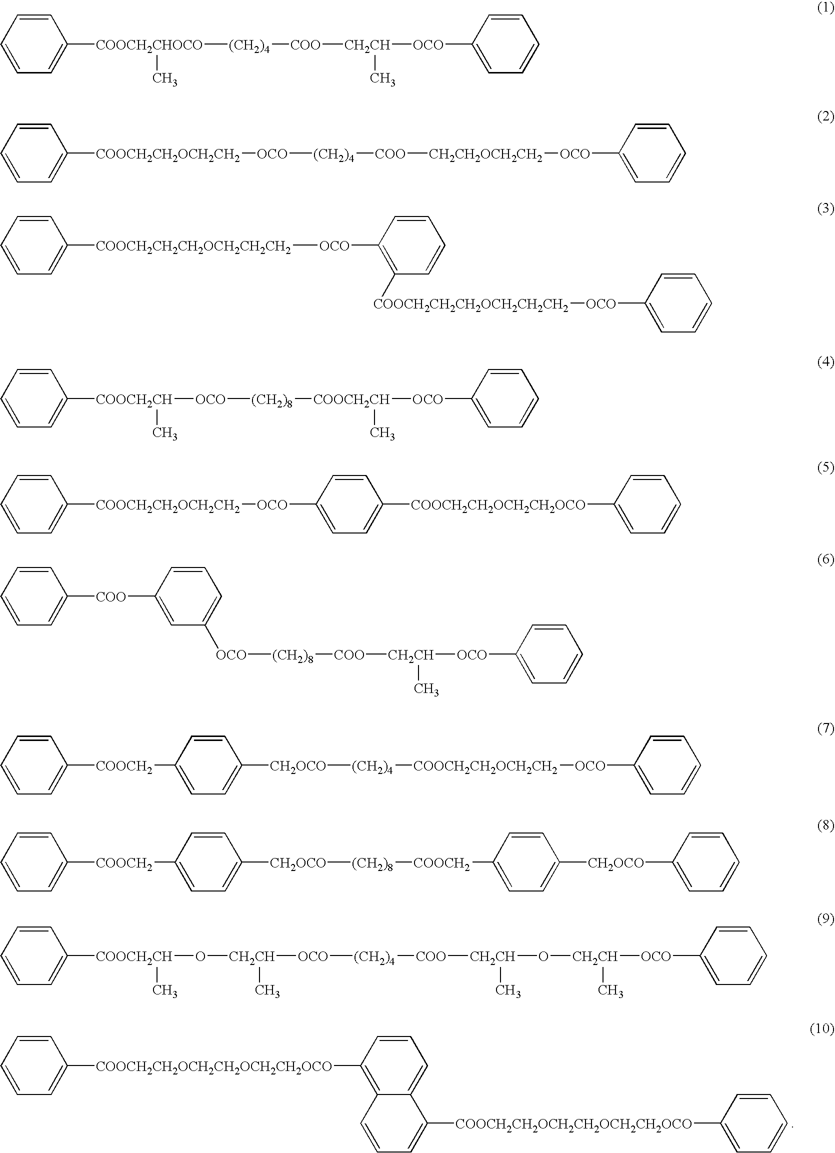

The content of the polyester type plasticizer in the optical film is preferably 1 to 20%, and particularly preferably 3 to 11%, by weight.

The optical film of the present invention preferably contains also a plasticizer other than the above-described plasticizer.

The dissolving out of the plasticizer can be reduced by containing two or more kinds of the plasticizer. Tough the reason of such the effect is not cleared; it is supposed that the dissolving out is inhibited by the interaction between the two kinds of the plasticizer and the cellulose resin.

A glycolate type plasticizer having an aromatic ring or a cycloalkyl ring is employed even though there is no specific limitation on the glycolate type plasticizer. Provided as glycolate type plasticizers are, for example, butylphthalyl glycolate, ethylphthalylethyl glycolate, and methylphthalylethyl glycolate.

Examples of phthalate type plasticizer include diethyl phthalate, dimethoxethyl phthalate, dimethyl phthalate, dioctyl phthalate, dibutyl phthalate, di-2-ethylhexyl phthalate, dioctyl phthalate, dicyclohexyl phthalate and dicyclohexyl terephthalate.

Moreover, a phthalate dimer represented by Formula (1) described in Japanese Patent O.P.I. Publication No. 11-349537 is preferably employed. In concrete, Compound 1 and Compound 2 described in paragraphs 23 and 26 of the patent document are preferably employable.

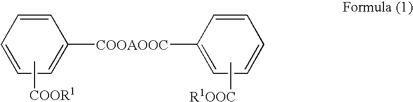

A: —(CH₂)ₙ— or —(CH₂CH₂O)ₙ—
n: Integer of 1-10
R¹ An alkyl group having the number of carbon atoms of 1-12, which may be substituted by an alkoxycarbonyl group

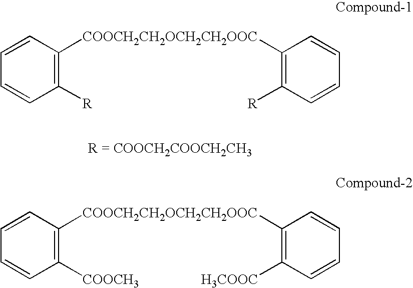

The phthalate type dimer compound is a compound represented by Formula (1), which can be obtained by dehydrating esterification reaction by heating a mixture of two phthalic acids and a di-valent alcohol. The average molecular weight of the phthalate type dimer or the bisphenol type compound having a hydroxyl group at the terminal thereof is preferably 250 to 3,000, and particularly preferably 300 to 1,000. When the molecular weight is less than 250, problems are caused in the thermal stability and the volatility and the mobility of the plasticizer. When the molecular weight exceeds 3,000, the compatibility and the plasticizing ability of the plasticizer are lowered and the processing suitability, transparency and the mechanical property of the aliphatic cellulose ester type resin are received bad influences.

As the citrate type plasticizer, acetyltrimethyl citrate, acetyltriethyl citrate and acetyltributyl acetate can be exemplified without any limitation, and the citrate compounds represented by Formula (6) are preferred.

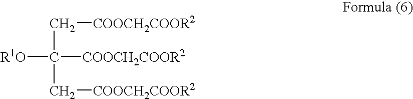

[Where R¹ is a hydrogen atom or an aliphatic acyl group, and R² is an alkyl group.]

In Formula (6), the aliphatic acyl group represented by R¹ is preferably one having 1 to 12, particularly 1 to 5, carbon atoms though the acyl group is not specifically limited. In concrete, a formyl group, an acetyl group, a propionyl group, a butylyl group, a varelyl group, a parmitoyl group and oleyl group can be exemplified. The alkyl group represented by R² is not specifically limited and may be one having a straight chain or a branched chain. The alkyl group is preferably one having 1 to 24, and particularly 1 to 4, carbon atoms. In concrete, a methyl group, an ethyl group, an n-propyl group, an isopropyl group, an n-butyl group, an isobutyl group, a sec-butyl group and a t-butyl group are exemplified. Particularly, one in which R¹ is a hydrogen atom, R² is a methyl group or an ethyl group, and one in which R¹ is an acetyl group and R² is a methyl group or an ethyl group are preferable as the plasticizer for the cellulose ester type resin.

<Production of Citrate Compound in which R¹ is a Hydrogen Atom>

Among the citrate compounds usable in the present invention, ones in which R¹ is a hydrogen atom can be produced by known methods. As the known method, for example, a method described in British Patent No. 931,781 is applicable, in which phthalyl glycolate is produced from a halfester of phallic acid and an alkyl α-halogenized acetate. In concrete, an amount of larger than the stoichiometric amount, preferably 1 to 10 moles, and more preferably 2 to 5 moles of an alkyl monohalogenized acetate corresponding to R² such as a methyl monochloroacetate trisodium citrate or ethyl monochloroacetate reacts with tripotassium acetate or citric acid, hereinafter referred to as citric acid raw material, preferably 1 mole of trisodium citrate. The presence of water in the reaction system lowers the yield of the objective compound. Therefore, dehydrated material is employed as long as possible. For the reaction, a chain or a cyclic aliphatic tertiary amine such as trimethylamine, triethylamine, tri-n-propylamine, triisopropylamine, tri-n-butylamine and dimethylcyclohexylamine can be employed as a catalyst. Among them, triethylamine is preferred. The using amount of the catalyst is 0.01 to 1.0 moles, preferably 0.2 to 0.5 moles, per mole of the raw material citric acid. The reaction is performed at a temperature of 60 to 150° C. for a time of 1 to 24 hours. A solvent such as toluene, benzene xylene and methyl ethyl ketone may be employed, though it is not essential. After the reaction, for example, byproducts and the catalyst are removed by adding water, and the oil layer is washed by water. And then the leaving raw compounds are separated by distillation to isolate the objective compound.

<Production of Citrate Compound in which R¹ is an Aliphatic Acyl Group>

The citrate compounds of the present invention in which R¹ is an aliphatic acyl group and R² is an alkyl group can be produced by employing the foregoing compound in which R¹ is a hydrogen atom. Namely, 1 mole of the citrate compound reacts with 1 to 10 moles a halogenized acyl compound corresponding to the aliphatic acyl group represented by R¹ such as formyl chloride or an acetyl chloride. As a catalyst, 0.1 to 2 moles of a basic compound such as pyridine can be employed per moles of the citrate compound. The reaction can be performed without any solvent for a time of 1 to 5 hours at a temperature of 80 to 100° C. After the reaction, water and a water insoluble organic solvent such as toluene are added to the reacting mixture so that the objective compound is dissolved in the organic solvent, and then the organic solvent layer is separated from the aqueous layer and the organic solvent layer is washed. Thereafter, the objective compound can be isolated by a usual method such as distillation.

The citrate compound employed in the present invention is particularly preferable because occurrences of the chalking and the line-shaped defects in the active radiation hardenable resin layer are inhibited when it is employed in the combination with the UV absorbent having a weight average molecular weight of 490 to 50,000.

The content of the citrate compound in the film is preferably 1 to 30%, and particularly 2 to 20%, by weight.

As the phosphate type plasticizer, for example, triphenyl phosphate, tricresyl phosphate, cresyl diphenyl phosphate, octyl diphenyl phosphate, diphenyl biphenyl phosphate, trioctyl phosphate and tributyl phosphate are employable, and as the phthalate type plasticizer, for example, diethyl phthalate, dimethoxyethyl phthalate, dimethyl phthalate, dioctyl phthalate, dibutyl phthalate, di-2-ethylhexyl phthalate and dicyclohexyl phthalate are employable. In the present invention, it is preferable that the content of the phosphate type plasticizer is not more than 40%, and more preferably not more than 1%, by weight of the entire amount of plasticizer. No addition of the phosphate type plasticizer is further preferable.

Ethylene glycol ester type plasticizer: In concrete, this type of plasticizer includes an ethylene glycol ester type plasticizer such as ethylene glycol diacetate and ethylene glycol dibutylate, a ethylene glycol cycloalkyl ester type plasticizer such as ethylene glycol dicyclopropylcarboxylate, ethylene glycol dicyclohexylcarboxylate, and an ethylene glycol aryl ester plasticizer such as ethylene glycol dibenzoate and ethylene glycol 4-methylbenzoate. In the above compounds, the alkylate group, the cycloalkylate group and the allylate group may be the same or different, and may further have a substituent. A mixed ester of the alkylate group, the cycloalkylate group and the allylate group is allowed. These substituents may be bonded with together by a covalent bond. The ethylene glycol moiety may have a substituent, and may be partially or regularly bonded with a polymer in a form of pendant. Moreover, the plasticizer may be included as a partial structure of an additive such as an antioxidant, an acid scavenger and a UV absorbent.

Glycerol ester type plasticizer: In concrete, this type of plasticizer includes a glycerol alkyl ester such as triacetine, tributine, glycerol diacetate caprylate and glycerol oleate propionate, a glycerol cycloalkyl ester such as glycerol tricycropropylpropionate and glycerol tricyclohexylcarboxylate, a glycerol aryl ester such as glycerol tribenzoate and glycerol 4-methylbenzoate, a diglycerol alkyl ester such as diglycerol tetraacetylate, diglycerol tetrapropionate, diglycerol acetate tricaprylate and diglycerol tetralaurate, diglycerol tetracyclobutylcarboxylate and diglycerol tetrapentylcarboxylate, and a diglycerol aryl ester such as diglycerol-tetrabenzoate and diglycerol 3-methylbenzoate. In the above compounds, the alkylate group, the cycloalkycarboxylate group and the allylate group may be the same or different, and may further have a substituent. A mixed ester of the alkylate group, the cycloalkylcarboxylate group and the allylate group is allowed. These substituents may be bonded with together by a covalent bond. The ethylene glycol moiety may have a substituent, and may be partially or regularly bonded with a polymer in a form of pendant. Moreover, the plasticizer may be included as a partial structure of an additive such as an antioxidant, an acid scavenger and a UV absorbent.

Dicarboxylate type plasticizer: In concrete, this type of plasticizer includes an alkyl alkyldicarboxylate type plasticizer such as dodecyl marinate (C1), dioctyl adipate (C4) and dibutyl sebacate (C8), a cycloalkyl alkyldicarboxylate type plasticizer such as dicyclopentyl succinate and cyclohexyl adipate, an aryl alkyldicarboxylate plasticizer such as diphenyl succinate and di-4-methylphenyl glutamate, an alkyl cycloalkyldicarboxylate such as Dihexyl 1,4-cyclohexanedicarboxylate and decyl bicyclo[2.2.1]heptane-2,3-dicarboxylate, a cycloalkyl cycloalkyldicarboxylate type plasticizer such as dicyclohexyl 1,2-cyclobutanedicarboxylate and dicyclopropyl 1,2-cyclohexyldicarboxylate, an aryl cycloalkyldicarboxylate type plasticizer such as diphenyl 1,1-cyclopropyldicarboxylate and di-2-naphthyl 1,4-cyclohexanedicarboxylate, an alkyl aryldicarboxylate type plasticizer such as diethyl phthalate, dimethyl phthalate, dioctyl phthalate, dibutyl phthalate and di-2-ethylhexyl phthalate, a cycloalkyl aryldicarboxylate type plasticizer such as dicyclopropyl phthalate and dicyclohexyl phthalate, and an aryl aryldicarboxylate type plasticizer such as diphenyl phthalate and di-4-methylphenyl phthalate. In the above compounds, the alkoxy group and the cycloalkoxy group may be the same or different, and may have a substituent and the substituent may further have a substituent. A mixed ester of the alkoxy group and the cycloalkoxy group is allowed. These substituents may be bonded with together by a covalent bond. The aromatic ring of phthalic acid may have a substituent, and may be a polymer such as a dimer, trimer and a tetramer. A part of the phthalate may be partially or regularly bonded with a polymer in a form of pendant. Moreover, the phthalate may be included as a partial structure of an additive such as an antioxidant, an acid scavenger and a UV absorbent.

Polyvalent-carboxylate type plasticizer: In concrete, this type of plasticizer includes an alkyl alkylpolycarboxylate type plasticizer such as tridodecyl tricabalate and tributyl meso-butane-1,2,3,4-tetre carboxylate, a cycloalkyl alkylpolycarboxylate type plasticizer such as tricyclohexyl tricarbalate, tricyclopropyl 2-hydroxy-1,2,3-propane-tricarboxylate, an aryl alkylpolycarboxylate type plasticizer such as triphenyl 2-hydroxy-1,2,3-propanetricarboxylate and tetra-3-methylphenyl tetrahydrofuran-2,3,4,5-tetracarboxylate, an alkyl cycloalkylpolycarboxylate type plasticizer such as tetrahexyl 1,2,3,4-cyclobutane-teracarboxylate and tetrabutyl 1,2,3,4-cyclopentane-tetracarboxylate, a cycloalkyl cycloalkylpolycarboxylate type plasticizer such as tetracyclopropyl 1,2,3,4-cyclobutane-tetracarboxylate and tricyclohexyl 1,3,5-cyclohexyl-tricarboxylate, an aryl cycloalkylpolycarboxylate and hexa-4-methylphenyl 1,2,3,4,5,6-cyclohexylhexacarboxylate, an alkyl arylpolycarboxylate type plasticizer such as tridodecyl benzene-1,2,4-tricarboxylate and tetraoctyl benzene-1,2,4,5-tetracarboxylate, a cycloalkyl arylpolycarboxylate type plasticizer such as tricyclopentylbenzene-1,3,50tricarboxylate and tetracyclohexyl benzene-1,2,3,5-tetracarboxylate, and a aryl arylpolycarboxylate type plasticizer such as triphenyl benzene-1,3,5-tetracarboxylate and hexa-4-methylphenyl benzene 1,2,3,4,5,6-hexacarboxylate. In the above compounds, the alkoxy group and the cycloalkoxy group may be the same or different, and may have a substituent and the substituent may further have a substituent. A mixed ester of the alkoxy group and the cycloalkoxy group is allowed. These substituents may be bonded with together by a covalent bond. The aromatic ring of phthalic acid may have a substituent, and may be a polymer such as a dimer, trimer and a tetramer. A part of the phthalate may be partially or regularly bonded with a polymer in a form of pendant. Moreover, the phthalate may be included as a partial structure of an additive such as an antioxidant, an acid scavenger and a UV absorbent.

Polymer plasticizer: In concrete, this type of plasticizer includes an aliphatic hydrocarbon type polymer, an alicyclic hydrocarbon type polymer, an acryl type polymer such as poly(ethyl acrylate) and poly(methyl methacrylate), a vinyl type polymer such as poly(vinyl isobutyl ether) and poly(N-vinylpyrrolidone), a styrene type polymer such as polystyrene and poly(4-hydroxystyrene), a polyester such as poly(butylene succinate), poly(ethylene terephthalate) and poly(ethylene naphthalate), a polyether such as poly(ethylene oxide) and poly(propylene oxide), polyamide, polyurethane and polyurea. The preferable number average molecular weight of these compounds is approximately from 1,000 to 500,000, and particularly from 5,000 to 200,000. The molecular weight of less than 1,000 causes a problem in the volatility, and that of more than 500,000 causes degradation in the plasticizing ability and bad influences are appeared in the mechanical properties of the cellulose ester derivative composition. These polymer plasticizers may be either a homopolymer composed of one kind of repeating unit or a copolymer having plural kinds of repeating unit. Two or more kinds of the polymer may be employed in combination and another additive such as another plasticizer, an antioxidant, an acid scavenger, a UV absorbent, a slipping agent and a matting agent may be contained.

The polarizing plate protective film of the present invention can also contain an ester compound described in Registration No. 3421769. Further, as the ester type plasticizer, methyl diglycol butyl diglycol adipate, benzylmethyl diglycol adipate, benzylbutyl diglycol adipate, ethoxycarbonyl methyl dibutyl citrate, etc. are preferably used.

The polarizing plate protective film of the present invention preferably contains a benzooxasol compound described in Registration No. 3690060. The benzooxasol compound has a structure represented by the following formula.

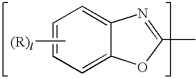

(Here, in the formula, R represents an alkyl group, 1 is 0 to 4 and represents a functional group number of R to substitute a benzene ring.) Especially, the benzooxasol compound represented by the following formula is preferable.

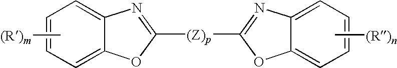

(Here, in the formula, R′ and R″ represent an alkyl group, respectively. R′ and R″ may be the same to each other or different from each other. m and n is 0 to 4 and represent a functional group number of R′ and R″ to substitute a benzene ring. Z is one kind group or more selected from 1,3-phenylene, 1,4-phenylene, 2,5-furan, 2,5-thiophene, 2,5-pyrrole, 4,4′-biphenyl, and 4,4′-stilbene. p is 0 or 1.) In the formula, concrete examples of R, R′ and R″ include hydrogen, methyl, ethyl, propyl, butyl, isopropyl, and tertiary butyl, and these may be used one kind or more. Among them, methyl and tertiary butyl are desirable, and methyl is especially desirable. R′ and R″ may be the same to each other or different from each other, further, the same benzene ring may be substituted with plural groups. Concrete examples of z include 1,3-phenylene, 1,4-phenylene, 2,5-furan, 2,5-thiophene, 2,5-pyrrole, 4,4′-biphenyl, and 4,4′-stilbene, however, 2,5-thiophene and 4,4′-stilbene are desirable and among them, especially 4,4′-stilbene is desirable. Concrete examples of R′ and R″ include hydrogen, methyl, ethyl, propyl, butyl, isopropyl, and tertiary butyl, and these are used by one or more kinds. Among them, methyl and tertiary butyl are desirable, and methyl is especially desirable. R′ and R″ may be the same to each other or different from each other, further, the same benzene ring may be substituted with plural groups. Concrete examples of the benzooxasol compound used in the present invention include 1,3-phenylenebis-2-benzo oxazoline, 1,4-phenylenebis-2-benzo oxazoline, 2,5-bis(benzooxasol-2-yl) thiophene, 2,5-bis(5-tertiary butyl benzooxasol-2-yl) thiophene, 4,4′-bis(benzooxasol-2-yl) stilbene, and 4-(benzooxasol-2-yl)-4′-(5-methyl benzooxasol-2-yl) stilbene. Among them, 2,5-bis(5-tertiary butylbenzooxasol-2-yl) thiophene and 4-(benzooxasol-2-yl)-4′-(5-methyl benzooxasol-2-yl) stilbene are desirable, and especially 4-(benzooxasol-2-yl)-4′-(5-methyl benzooxasol-2-yl) stilbene is desirable. The content of the benzooxasol compound is 0.001 to 10 parts by weight to 100 parts by weight of cellulosic resin, and preferably 0.01 to 3 parts by weight.

The polarizing plate protective film of the present invention preferably contains the below-mentioned acryl polymer.

Although there is no particular restriction on this polymer, it preferably contains the polymer having a weight average molecular weight of 500 or more and 30000 or less, obtained by polymerization of the ethylenic unsaturated monomer, for example. This acryl polymer is preferably an acryl polymer including an aromatic ring on the side chain or an acryl polymer including a cyclohexyl group on the side chain.

The compatibility between the cellulose ester and this polymer can be improved when the composition of the polymer is controlled by the one having a weight average molecular weight of 500 or more without exceeding 30000. Especially when the acryl polymer, the acryl polymer including an aromatic ring on the side chain or an acryl polymer including a cyclohexyl group on the side chain preferably has a weight average molecular weight of 500 through 10000, it is possible to provide excellent transparency of the polarizing plate protective film subsequent to film formation, low moisture permeability and excellent performances as a polarizing plate protective film, in addition to the aforementioned advantage.

Since this polymer has a weight average molecular weight of 500 or more without exceeding 30000, it is estimated to be located somewhere between the oligomer and low-molecular polymer. When producing such a polymer, the molecular weight cannot be easily controlled by the conventional polymerization. In this case, it is preferred to use a method capable of ensuring the uniform molecular weight without much increasing the molecular weight. Such a preferred polymerization method is exemplified by: a method of using the peroxide polymerization initiator such as cumene peroxide and t-butylhydroperoxide; a method of using a greater amount of polymerization initiator than in the conventional way; a method of using a chain transfer agent such as a mercapto compound and carbon tetrachloride in addition to the polymerization initiator; a method of using a polymerization terminator such as benzoquinone and dinitrobenzene in addition to the polymerization initiator; and a method for bulk polymerization based on a compound including one thiol group and secondary hydroxyl group or a polymerization catalyst using this compound and organic metal compound as disclosed in the Japanese Non-Examined Patent Publication 2000-128911 or 2000-344823. These methods are all preferably used. The method according to the aforementioned Japanese Non-Examined Patent Publication is used in particular preference.

The following lists up the monomers as monomer units constituting the polymer advantageous to the present invention, without the present invention being restricted thereto:

Ethylenic unsaturated monomer units constituting the polymer obtained by polymerization of the ethylenic unsaturated monomer are: a vinyl ester such as vinyl acetate, vinyl propionate, vinyl butyrate, vinyl valerate, vinyl pivalate, vinyl caproate, vinyl caprate, vinyl laurate, vinyl myristate, vinyl palmitate, vinyl stearate, vinyl cyclohexane carboxylate, vinyl octoate, vinyl methacrylate, vinyl crotonate, vinyl sorbate, vinyl benzoate and vinyl cinnamate; an acrylic acid ester such as methyl acrylate, ethyl acrylate, propyl acrylate (i-, n-), butyl acrylate (n-, i-, s-, t-), pentyl acrylate (n-, i-, s-), hexyl acrylate (n-, i-), heptyl acrylate (n-, i-), octyl acrylate (n-, i-), nonyl acrylate (n-, i-), myristyl acrylate (n-, i-), cyclohexyl acrylate, (2-ethylhexyl)acrylate, benzyl acrylate, phenetyl acrylate, (ε-caprolactone) acrylate, (2-hydroxy ethyl)acrylate, (2-hydroxy propyl)acrylate, (3-hydroxy propyl)acrylate, (4-hydroxy butyl)acrylate, (2-hydroxy butyl)acrylate, -p-hydroxy methylphenyl acrylate, and -p-(2-hydroxy ethyl)phenyl acrylate; a methacrylic acid ester such as the one with the aforementioned acrylate replaced by methacrylate; and an unsaturated acid such as acrylic acid, methacrylic acid, maleic anhydride, crotonic acid and itaconic acid. The polymer made of the aforementioned monomers can be either copolymer or homopolymer. The preferably used polymer is a vinyl ester homopolymer, a vinyl ester copolymer or a copolymer between vinyl ester and acrylic acid or methacrylic acid ester.

In the present invention, the acryl polymer is defined as an acrylic acid or methacrylic acidalkyl ester homopolymer or copolymer without monomer unit containing an aromatic ring or cyclohexyl group. The acryl polymer having an aromatic ring on the side chain refers to the acryl polymer containing the acrylic acid or methacrylic acid ester monomer unit provided with aromatic ring. The acryl polymer having a cyclohexyl group on the side chain refers to the acryl polymer containing the acrylic acid or methacrylic acid ester monomer unit equipped with cyclohexyl group.

The acrylic acid ester monomer without aromatic ring or cyclohexyl group is exemplified by methyl acrylate, ethyl acrylate, propyl acrylate (i-, n-), butyl acrylate (n-, i-, s-, t-), pentyl acrylate (n-, i-, s-), hexyl acrylate (n-, i-), heptyl acrylate (n-, i-), octyl acrylate (n-, i-), nonyl acrylate (n-, i-), myristyl acrylate (n-, i-), (2-ethylhexyl)acrylate, (ε-caprolactone) acrylate, (2-hydroxy ethyl)acrylate, (2-hydroxy propyl)acrylate, (3-hydroxy propyl)acrylate, (4-hydroxy butyl)acrylate, (2-hydroxy butyl)acrylate, (2-methoxy ethyl)acrylate, and (2-ethoxy ethyl)acrylate, or these substances with the acrylate thereof replaced by methacrylate.

The acryl polymer is a homopolymer or copolymer of the aforementioned monomer. It preferably contains 30% by mass or more of the acrylic acid methyl ester monomer unit, and 40% by mass or more of the methacrylic acid methyl ester monomer unit. The homopolymer of methyl acrylate or methyl methacrylate is particularly preferred.

The acrylic acid or methacrylic acid ester monomer containing the aromatic ring is exemplified by phenyl acrylate, phenyl methacrylate, (2- or 4-chlorophenyl)acrylate, (2- or 4-chlorophenyl)methacrylate, (2-, 3- or 4-ethoxycarbonylphenyl)acrylate, (2-, 3- or 4-ethoxycarbonylphenyl)methacrylate, (o-, m- or p-tolyl)acrylate, (o-, m- or p-tolyl)methacrylate, benzyl acrylate, benzyl methacrylate, phenethyl acrylate, phenethyl methacrylate, and (2-naphthyl)acrylate. Benzyl acrylate, benzyl methacrylate, phenethyl acrylate, and phenethyl methacrylate can preferably be used.

The acryl polymer having aromatic ring on the side chain preferably contains 20 through 40% by mass of the acrylic acid or methacrylic acid ester monomer unit having the aromatic ring, and 50 through 80% by mass of acrylic acid or methacrylic acid methyl ester monomer unit. The aforementioned polymer preferably contains 2 through 20% by mass of acrylic acid or methacrylic acid ester monomer unit containing the hydroxyl group.

The acrylic acid ester monomer containing the cyclohexyl group is exemplified by cyclohexyl acrylate, cyclohexyl methacrylate, (4-methyl cyclohexyl)acrylate, (4-methyl cyclohexyl)methacrylate, (4-ethyl cyclohexyl)acrylate, and (4-ethyl cyclohexyl)methacrylate. The acrylic acid cyclohexyl and methacrylic acid cyclohexyl can preferably be employed.

The acryl polymer having a cyclohexyl group on the side chain preferably includes 20 through 40%, and 50 through 80% by mass of acrylic acid or methacrylic acid ester monomer unit containing a cyclohexyl group. The aforementioned polymer preferably includes 2 through 20% by mass of the acrylic acid or methacrylic acid ester monomer unit containing the hydroxyl group.

The polymer and acryl polymer obtained by polymerization of the aforementioned ethylenic unsaturated monomer; acryl polymer having the aromatic ring on the side chain; and acryl polymer having the cyclohexyl group on the side chain all provide excellent compatibility with the cellulose resin.

The acrylic acid or methacrylic acid ester monomer having the aforementioned hydroxyl group is based on the structural unit of a copolymer, not homopolymer. In this case, acrylic acid or methacrylic acid ester monomer unit including the hydroxyl group preferably accounts for 2 through 20% by mass in the acryl polymer.

In the present invention, the polymer including a hydroxyl group on the side chain can be preferably utilized. Similarly to the case of the aforementioned monomer, acrylic acid or methacrylic acid ester is preferably used as the monomer unit having a hydroxyl group, and is exemplified by (2-hydroxy ethyl)acrylate, (2-hydroxy propyl)acrylate, (3-hydroxy propyl)acrylate, (4-hydroxy butyl)acrylate, (2-hydroxy butyl)acrylate, p-hydroxy methylphenyl acrylate, p-(2-hydroxy ethyl)phenyl acrylate, or the same wherein the aforementioned acrylic acid is replaced by the methacrylic acid. Use of the acrylic acid-2-hydroxy ethyl acrylate, and 2-hydroxy ethyl methacrylate is preferred. Preferably 2 through 20% by mass, more preferably 2 through 10% by mass of the acrylic acid ester or methacrylic acid ester monomer unit having a hydroxyl group in the polymer is included in the polymer.

It goes without saying that the aforementioned polymer including 2 through 20% by mass of monomer unit containing the aforementioned hydroxyl group provides excellent miscibility with the cellulose ester, outstanding retentivity and dimensional stability, minimized moisture permeability, and prominent dimensional stability, superb adhesiveness with polarizer as a polarizing plate protective film and improved durability of the polarizing plate.

There is no restriction to the method for allowing at least one of the terminals of the principal chain of the acryl polymer to have a hydroxyl group, if such a method ensures a hydroxyl group to be provided on the terminal of the principle chain in particular. Such a method is exemplified by: the method of using such a radical polymerization initiator including a hydroxyl group as azobis (2-hydroxy ethylbutylate); the method of using such a chain transfer agent having a hydroxyl group as 2-mercaptoethanol; the method of using a polymerization terminator having a hydroxyl group; the method of ensuring the hydroxyl group to be provided on the terminal by living ion polymerization; and the method of bulk polymerization based on polymerization catalyst through the use of a compound containing one thiol group and secondary hydroxyl group or through the combined use of this compound and organic metal compound, as disclosed in the Japanese Non-Examined Patent Publication 2000-128911 or 2000-344823. Use of the method disclosed in the Japanese Non-Examined Patent Publication is preferred in particular. The polymer manufactured by the method disclosed therein is available on the market under the trade name of Actflow Series manufactured by Soken Kagaku Co., Ltd. This is preferably used. The polymer having a hydroxyl group on the aforementioned terminal and/or the polymer having a hydroxyl group on the side chain provides a substantial improvement of the compatibility and transparency of the polymer.

A polymer using styrene is preferably used as the ethylenic unsaturated monomer exhibiting negative double refractivity in the direction of drawing because it is more effective for manifestation of negative refractivity. Such styrene is exemplified by styrene, methyl styrene, dimethyl styrene, trimethyl styrene, ethyl styrene, isopropyl styrene, chloromethyl styrene, methoxy styrene, acetoxystyrene, chlorostyrene, dichloro styrene, bromostyrene, and vinyl methyl benzoate ester, without being restricted thereto. Polymerization can be made with the monomers mentioned as the aforementioned unsaturated ethylenic monomers, or two or more aforementioned polymers can be used to achieve compatibility with the cellulose resin for the purpose of controlling the double refraction.

Further, a cellulose ester film according to the present invention preferably contains: the polymer X having a weight average molecular weight of 2000 or more without exceeding 30000, the aforementioned polymer X having been obtained by copolymerization between the ethylenic unsaturated monomer Xa without containing an aromatic ring and a hydrophilic group in the molecule, and the ethylenic unsaturated monomer Xb containing the hydrophilic group without an aromatic ring in the molecule; and the polymer Y having a weight average molecular weight of 500 or more without exceeding 3000, the aforementioned polymer Y having been obtained by polymerization of ethylenic unsaturated monomer Ya without aromatic ring.

<Polymer X and Polymer Y>

Various methods are known and anyone can also be adopted as a way of adjusting Ro and Rth of the present invention. However, from a point of transparency, it is desirable that a cellulose ester film contains a polymer X having an average molecular weight of 5000 to 30000 and obtained by copolymerization of an ethylenic unsaturated monomer Xa not having an aromatic ring and a hydrophilic group in a molecule thereof and an ethylenic unsaturated monomer Xb having a hydrophilic group and not having an aromatic ring in a molecule thereof, preferably contains a polymer Y having an average molecular weight of 500 to 3000 and obtained by polymerization of an ethylenic unsaturated monomer Ya not having an aromatic ring.

Generally, among monomers, it is well know that a substance which has an aromatic ring especially in a main chain has a positive birefringence property like a birefringence property of a cellulose ester. And it is desirable to add a material having a negative birefringence property in a film, because it does not negate a retardation value Rth of a cellulose ester film.

A polymer X used in the present invention is a polymer having a weight average molecular weight of 5000 or more without exceeding 30000, obtained by copolymerization between an ethylenic unsaturated monomer Xa without containing aromatic ring and hydrophilic group in its molecule and an ethylenic unsaturated monomer Xb containing a hydrophilic group without an aromatic ring in its molecule.

Preferably, Xa is an acryl monomer or a methacryl monomer each not having an aromatic ring and a hydrophilic group in a molecule thereof and Xb is an acryl monomer or a methacryl monomer each having a hydrophilic group and not having an aromatic ring in a molecule thereof.

A polymer X used in the present invention is preferably expressed by the following General Formula (1).

-(Xa)m-(Xb)n-(Xc)p- General Formula (1)

More preferably, it is a polymer expressed by the following General Formula (1-1).

—[CH₂—C(—R₁)(—CO₂R₂)]m-[CH₂—C(—R₃)(—CO₂R—OH)-]n-[Xc]p- General Formula (1-1)

(where R₁ and R₃ in the Formula represent H or CH₃, R₂ represents an alkyl group or a cycloalkyl each having carbon atoms of 1-12, and R₄ denote —CH₂ or —C₂H₄ or —C₃H₆—. Xc represents a monomer unit polymerizable with Xa and Xb, and m n and p indicate a mole composition ratio. Here, m≠0, n≠0, and m+n+p=100)

The following lists up monomers as a monomer unit constituting the polymer X in the present invention without being restricted thereto.

In X, a hydrophilic group means a hydroxyl group and a group which has an ethylene oxide chain.

The ethylenic unsaturated monomer Xa without containing either aromatic ring or hydrophilic group in a molecule is exemplified by methyl acrylate, ethyl acrylate, propyl acrylate (i-, n-), butyl acrylate (n-, i-, s-, t-), pentyl acrylate (n-, i-, s-), hexyl acrylate (n-, i-), heptyl acrylate (n-, i-), octyl acrylate (n-, i-), nonyl acrylate (n-, i-), myristyl acrylate (n-, i-), (2-ethylhexyl)acrylate, (ε-caprolactone) acrylate, (2-hydroxy ethyl)acrylate, and (2-ethoxy ethyl)acrylate. Among them, methyl acrylate, ethyl acrylate, methyl methacrylate, ethyl methacrylate or propyl methacrylate (i-, n-) is preferably used.

The ethylenic unsaturated monomer Xb containing the hydrophilic group without an aromatic ring in the molecule is preferably an acrylic acid or methacrylic acid ester as a monomer unit having a hydroxyl group. The preferred one is exemplified by (2-hydroxy ethyl)acrylate, (2-hydroxy propyl)acrylate, (3-hydroxy propyl)acrylate, (4-hydroxy butyl)acrylate, and (2-hydroxy butyl)acrylate, or these substances with the acrylate thereof replaced by methacrylate of these, (2-hydroxy ethyl)acrylate, (2-hydroxy ethyl)methacrylate, (2-hydroxy propyl)acrylate, and (3-hydroxy propyl)acrylate are more preferably used.

If a monomer as Xc is a copolymerizable ethylenic unsaturated monomer other than Xa and Xb, the monomer is not limited, however, it is desirable that the monomer has not an aromatic ring.

The mole composition ratio m:n of Xa and Xb is preferably in the range of 99:1 to 65:35, more preferably in the range of 95:5 to 75:25. The mole composition ratio “p” of Xc is 0 to 10. Xc may be a plurality of monomer units.

If the mole composition ratio Xa is greater, compatibility with the cellulose ester will be improved but retardation value Rt along the film thickness will be increased. Further, the mole composition ratio of Xb exceeds the above range, haze may be caused at the time of film production. It may desirable to optimize these and determine the mole composition ratio of Xa and Xb.

The polymer X preferably has a weight average molecular weight of 5000 or more without exceeding 30000, more preferably a weight average molecular weight of 8000 or more without exceeding 25000.

If the molecular weight is greater than 5000, there are such advantages as smaller dimensional variation of the cellulose ester film at a high temperature and humidity and smaller curl as a polarizing plate protective film. When the weight average molecular weight does not exceeds 30000, compatibility with cellulose ester will be improved, refraining a problem as bleed-out at a high temperature and high humidity or an optical haze immediately after formation of the film.

The weight average molecular weight of polymer X in the present invention can be adjusted by the known method for molecular weight adjustment. Such a method for molecular weight adjustment can be exemplified by the method of adding a chain transfer agent such as carbon tetrachloride, laurylmercaptan, and octyl thioglycolate. The polymerization temperature is kept within the range from room temperature through 130 degrees Celsius, preferably from 50 through 100 degrees Celsius. This temperature or polymerization reaction time can be adjusted.

The weight average molecular weight can be measured according to the following method:

(Method of Measuring the Molecular Weight)

The weight average molecular weight Mw is measured by gel permeation chromatography.

The following describes the measurement conditions:

Solvent: methylene chloride

Column: Shodex K806, K805 and K803G (Three pieces manufactured by Showa Denko K.K. were connected for use)

Column temperature: 25 degrees Celsius

Sample concentration: 0.1% by mass

Detector: RI Model 504 (manufactured by GL Science Co., Ltd.)

Pump: L6000 (manufactured by Hitachi Limited)

Flow rate: 1.0 ml/min.

Calibration curve: The calibration curve using 13 samples of the standard polystyrene STK standard polystyrene (manufactured by Toso Co., Ltd.) was employed, wherein Mw=1000000 through 500. These 13 samples were placed at an approximately equally spaced interval.

The polymer Y used in the present invention is a polymer having a weight average molecular weight of 500 or more without exceeding 3000, being produced by polymerization of ethylenic unsaturated monomer Ya without aromatic ring. If the polymer has a weight average molecular weight of 500 or more, it is desirable, because the amount of the remaining monomer will be reduced. If the weight average molecular weight is 3000 or less, it is desirable, because the performance for reducing the level of retardation Rt can be maintained. Ya is preferably an acryl monomer or a methacryl monomer each not having an aromatic ring.

A polymer Y used in the present invention is preferably expressed by the following General Formula (2).

-(Ya)k-(Yb)q- General Formula (2)

More preferably, it is preferably a polymer expressed by the following General Formula (2-1).

—[CH₂—C(—R₅)(—CO₂R₆)]k-[Yb]q- General Formula (2-1)

(where R₅ in the Formula represents H or CH₃, R₆ represents an alkyl group or a cycloalkyl each having carbon atoms of 1-12, and Yb represents a monomer unit polymerizable with Ya, and k and q indicate a mole composition ratio. Here, k≠0, and k+q=100)

If a monomer as Yb is a copolymerizable ethylenic unsaturated monomer with Ya, the monomer is not limited. Yb may be plural. k+q=100, q is preferably 0 to 30.

The ethylenic unsaturated monomer Ya constituting the polymer Y obtained by polymerization of the ethylenic unsaturated monomer without containing an aromatic ring is exemplified by: an acrylic acid ester such as methyl acrylate, ethyl acrylate, propyl acrylate (i-, n-), butyl acrylate (n-, i-, s-, t-), pentyl acrylate (n-, i-, s-), hexyl acrylate (n-, i-), heptyl acrylate (n-, i-), octyl acrylate (n-, i-), nonyl acrylate (n-, i-), myristyl acrylate (n-, i-), cyclohexyl acrylate, (2-ethylhexyl)acrylate, (ε-caprolactone) acrylate, (2-hydroxyethyl)acrylate, (2-hydroxypropyl)acrylate, (3-hydroxypropyl)acrylate, (4-hydroxybutyl)acrylate, (2-hydroxybutyl)acrylate; a methacrylic acid ester such as the one with the aforementioned acrylate replaced by methacrylate; and an unsaturated acid such as acrylic acid, methacrylic acid, maleic anhydride, crotonic acid and itaconic acid.

A monomer as Yb is not specifically limited, if the monomer is an ethylenic unsaturated monomer copolymerizable with Ya. The monomer as Yb is exemplified by: a vinyl ester such as vinyl acetate, vinyl propionate, vinyl butyrate, vinyl valerate, vinyl pivalate, vinyl caproate, vinyl caprate, vinyl laurate, vinyl myristate, vinyl palmitate, vinyl stearate, vinyl cyclohexane carboxylate, vinyl octoate, vinyl methacrylate, vinyl crotonate, vinyl sorbate, and vinyl cinnamate. Yb may be plural.

When producing such a polymer X and Y, the molecular weight cannot be easily controlled by the conventional polymerization. In this case, it is preferred to use a method capable of ensuring the uniform molecular weight without much increasing the molecular weight. Such a preferred polymerization method is exemplified by: a method of using the peroxide polymerization initiator such as cumene peroxide and t-butyl hydroperoxide; a method of using a greater amount of polymerization initiator than in the conventional way; a method of using a chain transfer agent such as a mercapto compound and carbon tetrachloride in addition to the polymerization initiator; a method of using a polymerization terminator such as benzoquinone and dinitrobenzene in addition to the polymerization initiator; and a method for bulk polymerization based on a compound including one thiol group and secondary hydroxyl group or a polymerization catalyst using this compound and organic metal compound as disclosed in the Japanese Non-Examined Patent Publication 2000-128911 or 2000-344823. These methods are all preferably used. Especially, for the polymer Y, a polymerization method which uses a compound having a thiol group and a hydroxyl group of a 2nd class in a molecule as a chain transfer agent, is desirable. In this case, at a terminal end of the polymer Y, it has a hydroxyl group resulting from a polymerization catalyst and a chain transfer agent and thioether. With this terminal residue group, the compatibility of Y and cellulose ester can be adjusted.

The hydroxyl group value of the polymer X is preferably 30 through 150 μg KOH/gi.

(Method of Measuring the Hydroxyl Group Value)

The hydroxyl group value was measured according to the JIS K 0070 (1992). The hydroxyl group value can be defined as the value in terms of mg of the potassium hydroxide required to neutralize the acetic acid bonded with the hydroxyl group, when 1 g of the sample is acetylated. To put it more specifically, the following steps were taken: weighing X g (about 1 g) of sample accurately; putting it into a flask; adding 20 ml of acetylation reagent (pyridine added to 20 ml of acetic anhydride to get 400 ml) accurately thereto; providing the outlet of the flask with an air cooling tube; healing the solution in a glycerine bath having a temperature of 95 through 100 degrees Celsius; cooling the solution after the lapse of one hour and 30 minutes; and adding 1 ml of purified water 1 ml through the air cooling tube so that the acetic anhydride was decomposed into acetic acid. This was followed by the step of titration by a potential difference titration apparatus using a 0.5 mol/L potassium hydroxide ethanol solution. The inflection point of the titration curve having been obtained was defined as a terminal point. Then titration was carried out in an idle test wherein a sample was not put therein. Thus, the inflection point of the titration curve was obtained, and the hydroxyl group value was calculated according to the following Equation.

Hydroxyl group value={(B−C)−f×28.05/X}+D

where B denotes the amount (ml) of 0.5 mol/L potassium hydroxide ethanol solution used in the idle test, C indicates the amount (ml) of 0.5 mol/L potassium hydroxide ethanol solution used in the titration, f shows the factor of 0.5 mol/L potassium hydroxide ethanol solution, D represents an acid value, and 28.05 is equivalent to a half of 56.11 as 1 mol potassium hydroxide.

The above-mentioned polymer X and polymer Y each excels in compatibility with a cellulose ester. Also these polymers have neither evaporation nor volatilization, these polymers are excellent in manufacturing efficiency, and their permanence properties as a protection film for polarizing plates are preferable, and their water vapour permeability is small, and thy are excellent in dimensional stability.

The contents of the polymers X and Y in the cellulose ester film preferably meet the following Formulae (i) and (ii): assuming that the content of the polymer X is Xg (% by mass=the mass of the polymer X/the mass of the cellulose ester×100), and that of the polymer Y is Yg (% by mass),

5≦Xg+Yg≦35 (% by mass) Formula (i)

0.05≦Yg/(Xg+Yg)≦0.4 Formula (ii)

where Formula (i) is preferably in the range from 10 through 25% by mass.

When the total amount of the polymers X and Y must be 5% by mass or more; a sufficient reduction in retardation value Rt can be achieved. Further, when the total amount is 35% by mass or less; the adhesiveness of the polarizer PVA will be excellent.

The polymers X and Y as materials constituting the aforementioned doping solution can be directly added and dissolved. Alternatively, they can be put into the doping solution after having been dissolved in the organic solvent for dissolving the cellulose ester. Film formation of the transparent support B using the doping solution obtained from this procedure can be performed in the same way as that for the aforementioned transparent support A. This provides the stretched cellulose ester film of the present invention.

The polarizing plate protective film of the present invention preferably contains the below-mentioned polyester polymer.

### (Polyester Type Polymer Represented by Formula (A) or (B))

As a polyester type polymer used as a retardation reduction agent, a polyester expressed with the following general formula (A) or (B), for example is desirable.

B₁-(G-A-)ₘG-B₁ General formula (A)

(In the formula, B₁ is a monocarboxylic component, G is a di-valent alcohol component and A is a di-basic acid component. The components B₁, G and A each contains no aromatic ring, and m represents repeating number.)

B₂-(A-G-)ₙA-B₂ General formula (B)

(In the formula, B₂ is a monoalcohol component, G is a di-valent alcohol component and A is a di-basic acid component. The components B₂, G and A each contains no aromatic ring, and n represents repeating number.)

In Formula A and B, B₁ is a monocarboxylic component, B₂ is a monoalcohol component, G is a di-valent alcohol component and A is a di-basic acid component; the polyester is synthesized by these components. The components B₁, B₂, G and A are each characterized in that these components contain no aromatic ring, and m and n are each represents repeating number.

As the carboxylic acid represented by B₁, a known aliphatic or alicyclic monocarboxylic acid can be used without any limitation.

Though the followings can be described as examples of preferable monocarboxylic acid, the invention is not limited to them.

As the aliphatic monocarboxylic acid, an aliphatic acid having a straight chain or a branched chain each containing from 1 to 32 carbon atoms is preferably applied. The number of the carbon atoms is preferably from 1 to 20 and more preferably from 1 to 12. The inclusion of acetic acid is preferable because the compatibility with the cellulose ester is increased and mixing of acetic acid and another monocarboxylic acid is also preferable.

Examples of preferable monocarboxylic acid include a saturated aliphatic acid such as formic acid, acetic acid, propionic acid, butylic acid, valeric acid, capronic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachinic acid, behenic acid, lignocelic acid, cerotic acid, heptaconic acid, montanic acid, melicic acid and laccelic acid, and a unsaturated aliphatic acid such as undecylenic acid, oleic acid, sorbic acid, linolic acid, linolenic acid and arachidonic acid.

As the alcohol component represented by B₂, a known alcohol can be applied without any limitation. For example, a saturated or unsaturated aliphatic alcohol having a straight or branched chain containing from 1 to 32 carbon atoms can be applied. The number of the carbon atoms is preferably from 1 to 20 and more preferably from 1 to 12.

As the di-valent alcohol represented by G, the followings can be cited but the invention is not limited to them. Examples of the di-valent alcohol include ethylene glycol, diethylene glycol, 1,2-propylene glycol, 1,3-propylene glycol, 1,2-butylene glycol, 1,3-butylene glycol, 1,4-butylene glycol, 1,5-pentanediol, 1,6 hexanediol, 1,5-pentylene glycol, diethylene glycol, triethylene glycol and tetraethylene glycol. Among them, ethylene glycol, 1,2-propylene glycol, 1,3-propylene glycol, 1,2-butylene glycol, 1,3-butylene glycol, 1,4-butylene glycol, 1,4-hexandiol, diethylene glycol and triethylene glycol are preferable, and 3-propylene glycol, 1,4-butylene glycol, 1,6-hexanediol and diethylene glycol are further preferably applied.

As the di-basic acid (dicarboxylic acid) represented by A, aliphatic and alicyclic di-basic acids such as malonic acid, succinic acid, glutaric acid, adipic acid, pimelic acid, suberic acid, azelaic acid, sebacic acid, undecanedicarboxylic acid and dodecanedicarboxylic acid are preferably applicable. Particularly, at least one selected from ones having from 4 to 12 carbon atoms is used. Two or more kinds of the carboxylic acid may be used in combination.

m and n are each the repeating number which is preferably from 1 to 170.

The polarizing plate protective film of the present invention preferably contains a polyester expressed with the following general formula (C) or (D), for example is desirable.

B₁-(G-A-)ₘG-B₁ General formula (C)

(In the formula, B₁ is a monocarboxylic component having carbon atoms of 1 to 12, G is a di-valent alcohol component having carbon atoms of 2 to 12 and A is a di-basic acid component having carbon atoms of 2 to 12. The components B₁, G and A each contains no aromatic ring, and m represents repeating number.)

B₂-(A-G-)ₙA-B₂ General formula (D)

(In the formula, B₂ is a monoalcohol component having carbon atoms of 1 to 12, G is a di-valent alcohol component having carbon atoms of 2 to 12 and A is a di-basic acid component having carbon atoms of 2 to 12. The components B₂, G and A each contains no aromatic ring, and n represents repeating number.)

In Formula (C) and (D), B₁ is a monocarboxylic component, B₂ is a monoalcohol component, G is a di-valent alcohol component having carbon atoms of 2 to 12 and A is a di-basic acid component having carbon atoms of 2 to 12; the polyester is synthesized by these components. The components B₁, G and A each contains no aromatic ring, and m and n are each represents repeating number.

B₁ and B₂ are synonymous with B₁ and B₂ in the above-mentioned general formula (A) or (B).

G and A are an alcoholic compositions having carbon atoms of 2 to 12 and a di-base acid composition having carbon atoms of 2 to 12 in G and A in the above-mentioned general formula (A) or (B).

The weight average molecular weight of the polyester is preferably not more than 20,000 and more preferably not more than 10,000. The polyester having a weight average molecular weight of from 500 to 10,000 shows good compatibility with the cellulose ester and is not evaporated in the film forming process.

The condensation polymerization of the polyester is carried out by an ordinary method. For example, the polyester can be easily synthesized by a method by directive reaction of the di-basic acid with the glycol, a thermally melting condensation method by polyesterization reaction or ester-exchanging reaction of the di-basic acid or its alkyl ester such as methyl ester of the di-basic acid with the glycol, or a method by dehydrohalogenation reaction of a acid chloride of such the acid with the glycol. The polyester having a weight average molecular weight not so large is preferably synthesized by the direct reaction method. The polyester having a molecular weight distribution rising in the low molecular weight side shows very high compatibility with the cellulose ester so that the cellulose ester film having low moisture permeability and high transparency can be obtained. A known method can be applied without any limitation for controlling the molecular weight. For example, the molecular weight can be controlled under a suitable reacting condition by controlling the adding amount of a mono-valent acid or alcohol in a method for blocking the terminal of the molecular by the mono-valent acid or the mono-valent alcohol. In such the case, the use of the mono-valent acid is preferable from the viewpoint of the stability of the polymer. For the acid, ones which are difficultly distillated out from the system during the polymerization-condensation reaction and easily distillated out after the reaction such as acetic acid, propionic acid and butylic acid are selected. These acids may be used in a mixed state. In the case of the direct reaction, the molecular weight can be controlled by stopping the reaction suitable timing according to the amount of water distillated out from the system during the reaction. Moreover, the control can be carried out by biasing the charging mole number of the glycol or the di-basic acid or by controlling the reaction temperature.

It is desirable to contain the polyester in 1 to 40% by mass for cellulose ester, and it is desirable to contain the polyester expressed with a general formula (C) or (D) in 2 to 30% by mass. Especially, it is desirable to contain 5 to 15% by mass.

By the use of the film added with a polyester, a polarizing plate having less fluctuation due to high temperature and high humidity can be obtained.

These plasticizers may be employed solely or in combination of two or more kinds thereof. The total content of the plasticizer in the film of less than 1% by weight is not preferable because the moisture permeation lowering effect becomes insufficient, and that of more than 30% by weight tends to cause problems in the compatibility and the bleeding out and the degradation in the physical property of the film. Therefore, the content is preferably from 1 to 30%, more preferably from 5 to 25%, and particularly preferably from 8 to 20%, by weight.

### (Mixing of Cellulose Resin and Additive)

It is preferable that the cellulose ester is blended with the additives such as the plasticizer and the UV absorbent before melting by heat.

For mixing the additives with the cellulose resin, a method is applicable, in which the cellulose resin is dissolved in a solvent and the additives are dissolved or finely dispersed in the resultant solution, and then the solvent is removed. For removing the solvent, known methods can be applied. For example, a drying in liquid method, a drying in gas method, a solvent co-precipitation method, a freeze drying method and a solution cascading method are applicable. The mixture of the cellulose resin and the additives can be made in a state of powder, granules, pelts and film.

As described above, the mixing of the additives is performed in the solution of the cellulose resin, and the mixing may be performed simultaneously with the precipitation and solidification of the cellulose resin in the course of the production thereof.

In the drying in liquid method, a solution of the cellulose resin and the additives is dispersed into an emulsion state by addition of an aqueous solution of a surfactant such as sodium laurate. And then the solvent is removed under an ordinal or reduced pressure so that a dispersion of the cellulose resin mixed with the additives can be obtained. Moreover, centrifugal separation or decantation is preferably applied for removing the solvent. For the emulsification, various methods can be applied and the use of a emulsifying apparatus by ultrasonic waves, high speed rotation sharing force or high pressure is preferable.

In the emulsifying dispersion by the ultrasonic waves, a batch process and a continuous process can be applied. The batch process is useful for preparing relatively small amount of sample, and the continuous process is suitable for preparing a large amount of sample. In the continuous process, for example, an apparatus such as UH-600SR, manufactured by MST Co., Ltd., can be employed. In the case of the continuous process, the applying time of the ultrasonic waves can be calculated by (dispersing chamber volume)/(flowing rate)×(number of cycling times). When plural ultrasonic wave sources are employed, the applying time is the sum of the applying times of each of the sources. The applying time of the ultrasonic waves is practically not more than 10,000 seconds. When the applying time is over 10,000 seconds, the load on the production process becomes too large and the emulsification time should be shortened by selection of the emulsifying agent in practice. Therefore, the application for longer than 10,000 seconds is unnecessary. The application time of the ultrasonic waves is preferably from 10 to 2,000 seconds.

As the emulsifying apparatus by high speed shearing force, for example, Dispermixer, Homomier and Ultramixer are employable. The type of such the mixer can be selected depending on the viscosity of the liquid to be dispersed.

For the emulsifying by high pressure, for example, LAB2000, manufactured by SMT Co., Ltd., is employable. The emulsifying and dispersing ability of that is depending on the pressure applied to the sample. The pressure is preferably within the range of from 10⁴ kPa to 5×10⁵ kPa.

An anionic surfactant, a cationic surfactant, an amphoteric surfactant and a polymer surfactant can be used as the surfactant, which are selected depending on the kind of solvent or the diameter of the objective emulsion.

In the drying in gas method, the solution containing the cellulose resin and the additives is splayed and dried by using a splay dryer such as GS310, Yamato Kagaku Co., Ltd.

In the solvent co-precipitation method, the solution containing the cellulose resin and the additives is poured into a poor solvent to precipitate the cellulose resin and the additives. The poor solvent is one capable of arbitrarily mixing with the solvent for the cellulose resin. The poor solvent may be a mixed solvent. It is also allowed that the poor solvent is added into the solution of the cellulose resin and the additives.

The precipitated mixture of the cellulose resin and the additives can be separated by filtering and drying.

In the mixture of the cellulose resin and the additives, the particular diameter of the additives is preferably not more than 1 μm, more preferably not more than 500 nm, and particularly preferably not less than 200 nm. Smaller diameter is preferable since the distribution of the mechanical and optical properties of the molten composition can be made uniform.

The mixture of the cellulose resin and the additives and the additive to be added on the occasion of melting by heat is preferably dried before or during the melting by heat. The drying means to remove the moisture absorbed by any raw materials, water or the solvent used for preparing the mixture of the cellulose resin and the additives and a solvent mixed in the additives on the occasion synthesizing thereof.

For removing the water and the solvent, known drying methods such as a heating method, a pressure reducing method, a method by heating under reduced pressure can be applied, and the process can be performed under atmosphere of air or nitrogen as an inactive gas. The drying by the known methods is preferably performed at a temperature range in which the materials are not decomposed for holding the quality of the film.

The amount of remaining water or solvent after the drying process is not less than 10%, preferably not less than 5%, more preferably not less than 1%, and further preferably not less than 0.1%, by weight of the total weight of the materials for constituting the film. The drying temperature is preferably a temperature of not less than 100° C. and less than the Tg of the material to be dried. For avoiding fusion of the material, it is preferably that the drying temperature is within the range of from 100° C. to (Tg−5) ° C., and more preferably from 110° C. to (Tg−20) ° C. The drying time is preferably from 0.5 to 24 hours, more preferably from 1 to 18 hours, and further preferably from 1.5 to 12 hours. When the time is smaller than the above range, the drying degree is tends to be low or too long time is required. When the material to be dried has a Tg, the material is made to difficultly handle by the fusion thereof if the material is heated at the drying temperature higher than the Tg thereof.

The drying process may be separated into two steps, for example, a step of storing the material in a preliminary drying process and a step of drying just before melting which is performed within the period from just before to 1 week before melting for forming the film.

### (Additive)

As the additive, an antioxidant, an acid capturing agent, a photo-stabilizer, a peroxide substance decomposing agent, a radical capturing agent, a metal inactivator, a metal compound such as a matting agent, a retardation controlling agent, a dye and a pigment may be employed additionally to the foregoing plasticizer and the UV absorbent. Other than the above, an additive which cannot be classified into the above additives may be employed when it has the above function.

The additives are employed for preventing oxidation of the film constituting material, capturing an acid formed by decomposition of the material and inhibiting or preventing the decomposition reaction caused by the radical species so as to inhibiting the deterioration of the material such as the coloring, decreasing in the molecular weight including a not cleared decomposing reaction and occurrence of volatile component, and for giving a function such as moisture permeating ability and a slipping ability.

Besides, the decomposition reaction in the film constituting materials is considerably progressed when the material is molten by heating, and the decomposition reaction some time causes coloring or degradation in the strength of the film constituting material. Moreover, undesirable volatile component tends to occur by the decomposition reaction of the film constituting materials.

The film constituting material preferably contains the above additives on the occasion of melting by heat, such the material is superior in the inhibition of the lowering in the strength caused by the degradation and decomposition of the material and in the keeping of the peculiar strength of the material.

The presence of the additives is effective for inhibiting the formation of a colored substance in the visible light region and for inhibiting or preventing undesirable properties of the optical film such as low transparency and high haze value caused by mixing of the volatile component. The polarizing plate protective film of the present invention preferably has a haze value of 1% or less, more preferably 0.5% or less.

With regard to the color of the polarizing plate protective film of the present invention, b* value being an index of yellow is desirably in the range of −5 to 10, more desirably −1 to 8, and still more desirably −1 to 5. The b* value can be measured by the use of a spectrocolorimetry meter CM-3700d (manufactured by Konica Minolta Sensing Company Ltd.) with a light source of D65 (color temperature: 6504K) at a view angle of 10°.

A degradation reaction caused by oxygen in the air occurs some times in the storage or in the film forming process of the film constituting materials. In such the case, it is preferable to decrease the oxygen concentration in the air together with the stabilizing effect of the additive. The decreasing in the oxygen concentration can be performed by know methods, for example, the use of inactive gas such as nitrogen and argon, the air exhaustion operation for making reduced pressure to vacuum, and the processing in a closed environment. At least one of the above three methods can be applied together with the use of the foregoing additives. The degradation of the materials can be inhibited by reducing the probability of contacting the materials with oxygen in the air, such the process is preferable for in object of the invention.

In the polarizing plate protective film of the present invention, the presence of the additives in the film constituting material is preferable from the viewpoint of the improving of the storage durability for the polarizing plate of the present invention or the polarizing element constituting the polarizing plate.

In the display employing the polarizing plate of the invention, since the above additives exist in the polarizing plate protective film of the present invention, the storage stability of a polarizing plate protective film with the passage of time can be improved from a viewpoint of controlling above-mentioned degradation and deterioration. Also in the improvement of a display quality of a liquid crystal display, it excels in the point that an optical compensation design provided with a polarizing plate protective film can exhibit its function over a long period of time.

Hereafter, additives are explained in full detail.

### (Antioxidant)

The antioxidant to be employed in the present invention is described below.

As the antioxidant, a phenol type antioxidant, a phosphoric acid type antioxidant, a sulfur type antioxidant, a stabilizer against heat processing and an oxygen scavenger are employable, and among them the phenol type antioxidant, and particularly an alkyl-substituted phenol type antioxidant are preferable. The coloring and the lowering in the strength of the formed product caused by the heating and the oxidation on the occasion of the formation can be prevented without any decreasing in the transparence and the anti-heating ability. These antioxidants may be employed solely or in combination of two or more kinds thereof. The adding amount can be optionally determined within the range in which the object of the present invention is not disturbed, and is preferably from 0.001 to 5, and more preferably from 0.01 to 1, parts by weight per 100 parts by weight of the polymer relating to the present invention.

As the antioxidant, a hindered phenol antioxidant is preferred, which includes 2,6-dialkylphenol derivatives described in U.S. Pat. No. 4,839,405, columns 12 to 14. Such the compounds include ones represented by the following Formula (7).

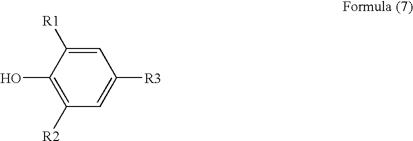

In the above formula, R1, R2 and R3 are each a substituted or unsubstituted alkyl group. Concrete examples of the hindered phenol compound include n-octadecyl 3-(3,5-di-t-butyl-4-hydroxyphenyl)propionate, n-octadecyl 3-(3,5-di-t-butyl-4-hydroxyphenyl)acetate, n-octadecyl 3,5-di-t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neododecyl 3-(3,5-di-t-butyl-4-hydroxyphenyl)propionate, dodecyl β-(3,5-di-t-butyl-4-hydroxyphenyl)propionate, ethyl α-(4-hydroxy-3,5-di-t-butylphenyl)isobutylate, octadecyl α-(4-hydroxy-3,5-di-t-butylphenyl)isobutylate, octadecyl α-(4-hydroxy-3,5-di-t-butyl-4-hydroxyphenyl)propionate, 2-(n-octyl)ethyl 3,5-di-t-butyl-4-hydroxybenzoate, 2-(n-octyl)ethyl 3,5-di-t-butyl-4-hydroxyphenylacetate, 2-(n-octadecylthio)ethyl 3,5-di-t-butyl-4-hydroxyphenyl-acetate, 2-(n-octadecylthio)ethyl 3,5-di-t-butyl-4-hydroxybenzoate, 2-(2-hydroxyethylthio)ethyl 3,5-di-t-butyl-4-hydroxybenzoate, diethylglycol bis-(3,5-di-t-butyl-4-hydroxyphenyl)propionate, 2-(n-octadecylthio)ethyl 3-(3,5-di-t-butyl-4-hydroxyphenyl)propionate, stearylamido N,N-bis[ethylene 3-(3,5-di-t-butyl-4-hydroxyphenyl)propionate], n-butylimino N,N-bis-[ethylene 3-(3,5-di-t-butyl-4-hydroxyphenyl)propionate], 2-(2-stearoyloxyethylthio)ethyl 3,5-di-t-butyl-4-hydroxybenzoate, 2-(2-stearoyloxyethylthio)ethyl 7-(3-methyl-5-t-butyl-4-hydroxyphenyl)heptanoate, 1,2-propylene glycol bis-[3-(3,5-di-t-butyl-4-hydroxyphenyl)propionate], ethylene glycol bis-[3-(3,5-di-t-butyl-4-hydroxyphenyl)-propionate], neopentyl glycol bis-[3-(3,5-di-t-butyl-4-hydroxyphenyl)propionate], ethylene glycol bis-(3,5-di-t-butyl-4-hydroxyphenylacetate), glycerol 1-n-octadecanoate-2,3-bis-(3,5-di-t-butyl-4-hydroxyphenylacetate), pentaerythrytol tetrakis[3-(3′,5′-di-t-butyl-4′-hydroxyphenyl)propionate], 1,1,1-trimethylolethane tris[3-(3,5-di-t-butyl-hydroxyphenyl)propionate], sorbitol hexa-[3-(3,5-di-t-butyl-4-hydroxyphenyl)propionate], 2-hydroxyethyl 7-(3-methyl-5-t-butyl-4-hydroxyphenyl)propionate, 2-stearoyloxyethyl 7-(3-methyl-5-t-butyl-4-hydroxyphenyl)-heptanoate, 1,6-n-hexanediol bis-[(3′,5′-di-t-butyl-4-hydroxyphenyl)propionate] and pentaerythrytol tetrakis(3,5-di-t-butyl-4-hydroxycinnamate). The above-described type hindered phenol antioxidant is, for example, available on the market under the commercial name of Irganox 1076 and Irganox 1010 of Ciba Specialty Chemicals.

Moreover, a compound which has a phenol structure and a phosphite structure in a molecule is also used preferably. For example, the compound represented by following general formula (I) can be used preferably.

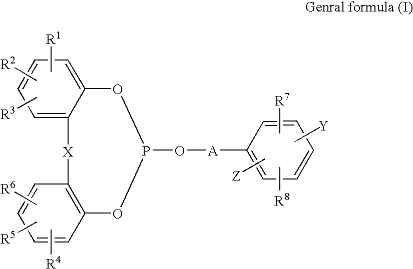

Among the compound which is used for a cellulosic resin film of the present invention and has a phenol structure and a phosphite structure in a molecule, as concrete examples of the compound especially used preferably, the phosphite represented with the above-mentioned general formula (I) is listed up.

In the phosphite represented with the above-mentioned general formula (I), substituents R¹, R², R⁴, R⁵, R⁷ and R⁸ independently represent a hydrogen atom, an alkyl group having 1 to 8 carbon atoms, a cycloalkyl group having 5 to 8 carbon atoms, an alkylcycloalkyl group having a total carbon atom number 6 to 12, an aralkyl group having a total carbon atom number 7 to 12 or a phenyl group. It is preferred that R¹, R² and R⁴ independently represent an alkyl group having 1 to 8 carbon atoms, a cycloalkyl group having 5 to 8 carbon atoms or an alkylcycloalkyl group having a total carbon atom number 6 to 12, and R⁵ represents a hydrogen atom, an alkyl group having 1 to 8 carbon atoms or a cycloalkyl group having 5 to 8 carbon atoms.

In the above, examples of the alkyl group having 1 to 8 carbon atoms include methyl, ethyl, n-propyl, i-propyl, n-butyl, i-butyl, sec-butyl, t-butyl, t-pentyl, i-octyl, t-octyl and 2-ethylhexyl. Examples of the cycloalkyl group having 5 to 8 carbon atoms include cyclopentyl, cyclohexyl, cycloheptyl and cycloctyl. Examples of the alkylcycloalkyl group having a total carbon atom number 6 to 12 include 1-methylcyclopentyl, 1-methylcyclohexyl and 1-methyl-4-isopropylcyclohexyl. Examples of the aralkyl group having a total carbon atom number 7 to 12 include benzyl, α-methylbenzyl and α,α-dimethylbenzyl.

R¹ and R⁴ are preferably a t-alkyl group (e.g., t-butyl, t-pentyl or t-octyl), cyclohexyl, or 1-methylcyclohexyl. R² is preferably alkyl having 1 to 5 carbon atoms, e.g., methyl, ethyl, n-propyl, i-propyl, n-butyl, i-butyl, sec-butyl, t-butyl or t-pentyl, and more preferably methyl, t-butyl or t-pentyl. R⁵ is preferably a hydrogen atom, or alkyl having 1 to 5 carbon atoms, e.g., methyl, ethyl, n-propyl, i-propyl, n-butyl, i-butyl, sec-butyl, t-butyl or t-pentyl.

R³ and R⁶ represent a hydrogen atom or an alkyl group having 1 to 8 carbon atoms. Examples of the alkyl group having 1 to 8 carbon atoms are the same alkyl group denoted above. These are preferably a hydrogen atom or an alkyl group having 1 to 5 carbon atoms, and more preferably a hydrogen atom or methyl.

X represents a single bond, a sulfur atom, methylene or methylene having an alkyl group having 1 to 8 carbon atoms or a cycloalkyl group having 5 to 8 carbon atoms. Herein, examples of the alkyl group having 1 to 8 carbon atoms or the cycloalkyl group having 5 to 8 carbon atoms are the same as those denoted in R¹, R² and R⁴ above. X is preferably a single bond, a methylene group or a methylene group substituted with methyl, ethyl, n-propyl, i-propyl, n-butyl, i-butyl or t-butyl.

A represents an alkylene group having 2 to 8 carbon atoms or *—COR¹⁰—, in which R¹⁰ represents a single bond or an alkylene group having 1 to 8 carbon atoms and * represents a bond combining with the oxygen atom. Herein, examples of the alkylene group having 1 to 8 carbon atoms include ethylene, propylene, butylene, pentamethylene, hexamethylene, octamethylene, 2,2-dimethyl-1,3-propylene. R¹⁰ is preferably a single bond or ethylene.

Y and Z represents a hydroxyl group, an alkoxy group having 1 to 8 carbon atoms or an aralkyloxy group having a total carbon atom number of 7 to 12, and the other a hydrogen atom or an alkyl group having 1 to 8 carbon atoms. Herein, examples of the alkyl group having 1 to 8 carbon atoms include those denoted in the alkyl group having 1 to 8 carbon atoms of R¹, R² and R⁴ above, and examples of the alkoxy group having 1 to 8 carbon atoms are an alkoxy group whose alkyl is the same as those denoted in the alkyl group having 1 to 8 carbon atoms of R¹, R² and R⁴ above. Examples of the aralkyloxy group having a total carbon atom number of 7 to 12 are an aralkyloxy group whose aralkyl is the same as those denoted in the aralkyl group having 7 to 12 previously.

The phosphite represented by the above-mentioned general formula (I) can be manufactured, for example, by making a bisphenol represented by the following general formula (II), 3 phosphorus halide and a hydroxy compound represented by the following general formula (III) to react.

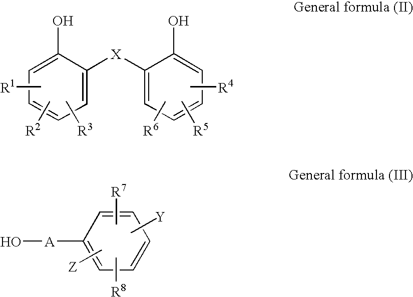

In the formula, R1, R2, R3, X, R4, R5, R6, R7, R8, A, Y, and Z each has the same meaning as stated above.

As the bisphenol (II), for example, 2,2′-methylene bis (4-methyl-6-t-butyl phenol), 2,2′-methylene bis(4-ethyl-6-t-butyl phenol), 2,2′-methylene bis(4-n-propyl-6-t-butyl phenol), 2,2′-methylene bis(4-i-propyl-6-t-butyl phenol), 2,2′-methylene bis(4-n-butyl-6-t-butyl phenol), 2,2′-methylene bis(4-i-butyl-6-t-butyl phenol), 2,2′-methylene bis(4,6-di-t-butyl phenol), 2,2′-methylene bis(4-t-pentyl-6-t-butyl phenol), 2,2′-methylene bis(4-nonyl-6-t-butyl phenol), 2,2′-methylene bis(4-t-octyl-6-t-butyl phenol), 2,2′-methylene bis(4-methyl-6-t-pentylphenol), 2,2′-methylene bis(4-methyl-6-cyclohexylphenol), 2,2′-methylene bis[4-methyl-6-(alpha-methylcyclohexyl)phenol], 2,2′-methylene bis(4-methyl-6-nonyl phenol), 2,2′-methylene bis (4-methyl-6-t-octylphenol), 2,2′-methylene bis(4,6-di-t-pentylphenol), 2,2′-methylene bis[4-nonyl-6-(alpha-methylbenzyl)phenol] 2,2′-methylene bis[4-nonyl-6-(alpha and alpha-dimethylbenzyl)phenol] 2,2′-ethylidenebis(4-methyl-6-butyl phenol) may be employed.

In the case that A is alkylene having 2 to 8 carbon atoms, typical examples of the hydroxy compound (III) include, for example, 2-(3-t-butyl-4-hydroxyphenyl)ethanol, 2-(3-t-pentyl-4-hydroxyphenyl)ethanol, 2-(3-t-octyl-4-hydroxyphenyl)ethanol, 2-(3-cyclohexyl-4-hydroxyphenyl)ethanol, 2-[3-(1-methylcyclohexyl)-4-hydroxyphenyl]ethanol, 2-(3-t-butyl-4-hydroxy-5-methylphenyl)ethanol, 2-(3-t-pentyl-4-hydroxy-5-methylphenyl)ethanol, 2-(3-t-octyl-4-hydroxy-5-methylphenyl)ethanol, 2-(3-cyclohexyl-4-hydroxy-5-methylphenyl)ethanol, 2-[3-(1-methylcyclohexyl)-4-hydroxy-5-methylphenyl]ethanol, 2-(3-t-butyl-4-hydroxy-5-ethylphenyl)ethanol, 2-(3-t-pentyl-4-hydroxy-5-ethylphenyl)ethanol, 2-(3-t-octyl-4-hydroxy-5-ethylphenyl)ethanol, 2-(3-cyclohexyl-4-hydroxy-5-ethylphenyl)ethanol, and 2-[3-(1-methylcyclohexyl)-4-hydroxy-5-ethylphenyl]ethanol.

In the case where A is a *—COR¹⁰— group, typical examples of the hydroxy compound (III) include, for example, 3-t-butyl-2-hydroxybenzoic acid, 3-t-butyl-4-hydroxybenzoic acid, 5-t-butyl-2-hydroxybenzoic acid, 3-t-pentyl-4-hydroxybenzoic acid, 3-t-octyl-4-hydroxybenzoic acid, 3-cyclohexyl-4-hydroxybenzoic acid, 3-(1-methylcyclohexyl)-4-hydroxybenzoic acid, 3-t-butyl-2-hydroxy-5-methylbenzoic acid, 3-t-butyl-4-hydroxy-5-methylbenzoic acid, 5-t-butyl-2-hydroxy-3-methylbenzoic acid, 3-t-pentyl-4-hydroxy-5-methylbenzoic acid, 3-t-octyl-4-hydroxy-5-methylbenzoic acid, 3-cyclohexyl-4-hydroxy-5-methylbenzoic acid, 3-(1-methylcyclohexyl)-4-hydroxy-5-methylbenzoic acid, 3-t-butyl-4-hydroxy-5-ethylbenzoic acid, 3-t-pentyl-4-hydroxy-5-ethylbenzoic acid, 3-t-octyl-4-hydroxy-5-ethylbenzoic acid, 3-cyclohexyl-4-hydroxy-5-ethylbenzoic acid.

Concrete examples of the compound represented by such Formula (I) are shown below.

Compound 1: 6-[3-(3-tert-butyl-4-hydroxy-5-methylphenyl) propoxy]-2,4,8,10-Thet Lakis tert-butyld and Dibenzo[d,f][1.3.2]dioxafosfepin

Compound 2: 6-[3-(3,5-di-tert-butyl-4-hydroxyphenyl)propoxy]-2,4,8,10-Thet Lakis tert-butyld and Dibenzo-[d,f][1.3.2]dioxafosfepin

The additive amount of the compound represented with Formula (I) to cellulosic resin is usually 0.001 to 10.0 parts by weight per one kind of added compounds to 100 parts by weight of cellulose ester, preferably 0.01 to 5.0 parts by weight, and more preferably 0.1 to 3.0 parts by weight.

It is also desirable that the polarizing plate protective film of the present invention contains a phosphite type compound. When the phosphite type compound is contained, a coloring protection effect is very remarkable even in a range of high forming temperature, and the color tone of an obtained polymer becomes good. As concrete examples of the phosphite type compound, the phosphite type compounds represented with the following Formulas (a), (b), and (c) are preferably used.

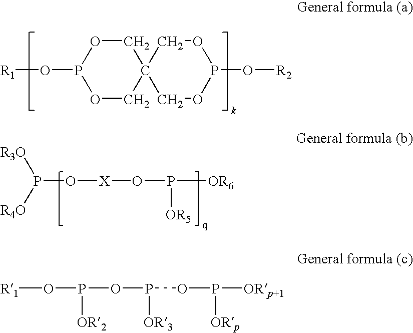

(Here, R1, R2, R3, R4, R5, R6, R′1, R′2, and R′3 . . . R′n and R′n+1 represents hydrogen or a group selected from the group consisting of an alkyl group having 4-23 carbon atoms, an aryl group, an alkoxy alkyl group, an aryloxy alkyl group, an alkoxy aryl group, an arylated alkyl group, an alkyl aryl group, a polyaryloxy alkyl group, a polyalkoxy alkyl group, and a polyalkoxy aryl group. Here, in the same formula of Formula (a), (b), and (c), all components do not become hydrogen. X in the phosphite type compound represented in Formula (b) represents a group selected from the group consisting of an aliphatic series chain, an aliphatic series chain having an aromatic nucleus in a side chain, an aliphatic series chain having an aromatic nucleus in a chain and a chain including two or more oxygen atoms which do not continue in the above-mentioned chain. Further, k and q represent 1 or more integers, and p represents 3 or more integers, respectively.)

The number of k and q of these phosphite system compounds is 1 to 10 preferably. When the number of k and q is made 1 or more, the volatility at the time of heating becomes small, and when it is made 10 or less, the compatibility with the cellulose acetate propionate of the present invention is improved. Further, the number of p is desirably 3 to 10. When the number of p is made 3 or more, the volatility at the time of heating becomes small, and when it is made 10 or less, the compatibility with the cellulose acetate propionate of the present invention is improved. Concrete examples of the desirable phosphite system compounds represented with the above-mentioned general formula (a) include compounds represented with following Formulas (d) to (g).

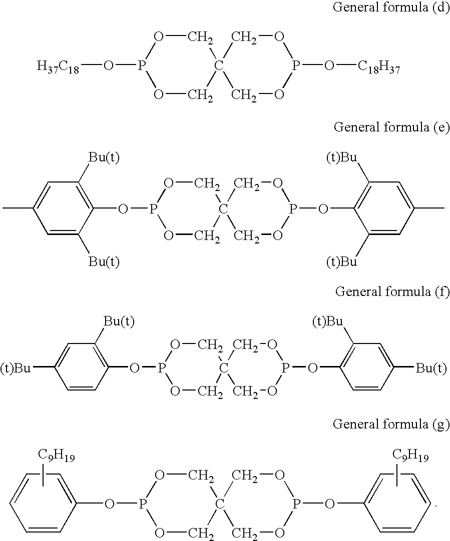

Further, concrete examples of the desirable phosphite system compounds represented with the above-mentioned general formula (b) include compounds represented with following Formulas (h), (i) and (j).

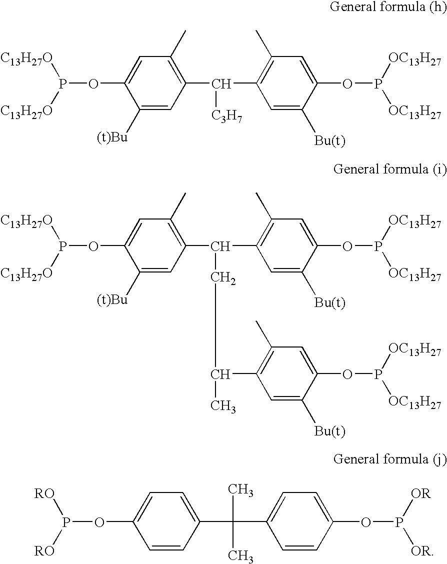

R: alkyl group having 12 to 15 carbon atoms

The blending amount of the phosphite system coloration inhibitor is desirably 0.005 to 0.5% by weight to the whole composition. When the blending amount is made 0.005% by weight or more, the coloring of the composition at the time of heating can be suppressed. The blending amount is preferably 0.01% by weight or more, more preferably 0.05% by weight or more. On the other hand, when the blending amount is made 0.5% by weight or less, the deterioration due to the decrease of a polymerization degree caused by the cutting of the chain of cellulose acetate propionate can be suppressed. The blending amount is preferably 0.2% by weight or less, more preferably 0.1% by weight or less.

In addition, it is desirable to contain a phosphonite compound.

Concrete examples of other antioxidants, include phosphorus system antioxidants, such as tris nonylphenyl phosphite, triphenyl phosphite, and tris(2,4-di-tert-butylphenyl) phosphate; sulfur system antioxidants, such as dilauryl-3,3′-thiodipropionate, dimyristyl-3,3′-thiodipropionate, distearyl-3,3′-thiodipropionate, and penta erisritiltetrakis(3-lauryl thiopropionate); heat-resistant processing stabilizers, such as 2-tert-butyl-6-(3-tert-butyl-2-hydroxy-5-methylbenzyl)-4-methylphenyl acrylate, and 2-[1-(2-hydroxy-3,5-di-tert-pentylphenyl)ethyl]-4,6-di-tert-pentylphenyl acrylate; oxygen scavengers, such as 3,4-dihydro-2H-1-benzopyran system compound described in Japanese Patent Publication No. 8-27508, 3,3′-spirodichroman system compound, 1,1-spiroindan system compound; compounds having a partial structure of a skeleton of morpholine, thiomorpholine, thiomorpholineoxide, thiomorpholinedioxide, or piperazine, and dialkoxybenzen system compound described in Japanese Patent Unexamined Publication No. 3-174150. The partial structure of these antioxidants may be made pendant to a part of polymer or to polymer with an orderly arrangement, and also may be introduced into a part of a molecular structure of additives, such as a plasticizer, an oxygen scavenger, and an ultraviolet absorber.

### (Acid Capturing Agent)

As the acid capturing agent, ones containing an acid capturing epoxy compound described in U.S. Pat. No. 4,137,201 are preferable. Such the epoxy compounds as the acid capturing agent have been known in the field of the art, and examples thereof include glycidyl ether of various polyethylene glycols, particularly a polyglycol driven by condensation of approximately 8 to 40 moles of ethylene glycol per mole of the polyglycol, diglycidyl ether of glycerol, an metal epoxy compound, for example, ones usually used in a vinyl polymer composition, an epoxide ether condensate, diglycidyl ether of bisphenol A namely 4,4′-dihydroxydiphenyldimethylmethane, an epoxide unsaturated fatty acid ester, particularly an ester of alkyl having 2-4 carbon atoms of a fatty acid having 2-22 carbon atoms such as butyl epoxystearate, and a triglyceride of one of various epoxide long chain fatty acids, for example, an epoxide soybean oil composition. The examples further include an epoxide of plant oil or another unsaturated natural oil. The epoxide oils are sometimes called as epoxide of natural glyceride or epoxide of unsaturated fatty acid and these fatty acids are each contains 12-22 carbon atoms. An epoxy group-containing epoxide resin compound available on the market EPON815c, manufacture by Miller-Stephenson Chemical Co., Ltd., and an epoxide ether oligomer condensation product represented by Formula (8) are particularly preferable.

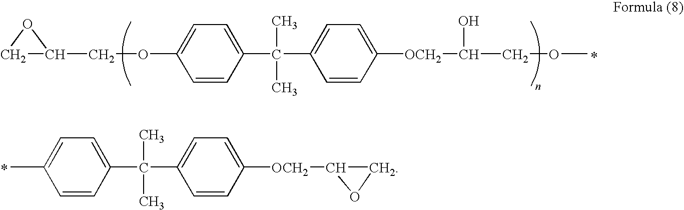

In the above formula, n is an integer of 0-12. Further employable acid capturing agent includes those described in Japanese Patent O.P.I. Publication No. 5-194788, paragraphs 87 to 105.

### (Photo-Stabilizer)

As the photo-stabilizer, a hindered amine photo-stabilizer (HALS) is employable, which is known compound and includes a 2,2,6,6-tetra-alkylpiperidine compound and its acid addition salt and a metal complex thereof, as described in U.S. Pat. No. 4,619,956, columns 5 to 11 and U.S. Pat. No. 4,839,405, columns 3 to 5. Such the compounds include a compound represented by Formula (9).

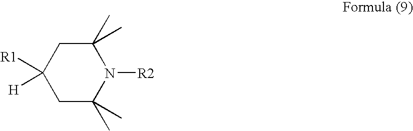

In the above formula, R1 and R2 are each a hydrogen atom or a substituent. Concrete examples of the hindered amine photo-stabilizer include 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, 1-(4-t-butyl-2-butenyl)-4-hydroxy-2,2,6,6-tetramethylpiperidine, 4-stearoyloxy-2,2,6,6-tetramethylpiperidine, 1-ethyl-4-saliciloyloxy-2,2,6,6-tetramethylpiperidine, 4-methacryloyloxy-1,2,2,6,6-pentamethylpiperidine, 1,2,2,6,6-pentamethylpiperidine-4-yl-β(3,5-di-t-butyl-4-hydroxyphenyl)-propionate, 1-benzyl-2,2,6,6-tetramethyl-4-piperidinylamleinate, (di-2,2,6,6-tetramethylpiperidine-4-yl)-adipate, (di-2,2,6,6-tetramethylpiperidine-4-yl)-sebacate, (di-1,2,3,6-tetramethyl-2,6-diethyl-piperidine-4-yl)-sebacate, (di-1-allyl-2,2,6,6-tetramethylpiperidine-4-yl)-phthalate, 1-acetyl-2,2,6,6-tetramethylpiperidine-4-yl-acetate, trimellitic acid ester of tri-(2,2,6,6-tetramethylpiperidine-4-yl), 1-acryloyl-4-benzyloxy-2,2,6,6-tetramthylpiperidine, di-(1,2,2,6,6-pentamethyl-piperidine-4-yl) dibutylmalonate, di-(1,2,3,6-tetramethyl-2,6-diethylpiperidine-4-yl) dibenzylmlonate, dimethyl-bis-(2,2,6,6-tetramethylpiperidine-4-oxy)-silane, tris-(1-propyl-2,2,6,6-tetramethylpiperidine-4-yl) phosphite, tris-(1-propyl-2,2,6,6-tetramethylpiperidine-4-yl) phosphate, N,N′-bis-(2,2,6,6-tetramethylpiperidine-4-yl)-hexamethylene-1,6-diamine, N,N′-bis-(2,2,6,6-tetramethylpiperidine-4-yl)-hexamethylene-1,6-di-acetoamide, 1-acetyl-4-(N-cyclohexylacetamido)-2,2,6,6-tetramethylpiperidine, 4-benzylamino-2,2,6,6-tetramethyl-piperidine, N,N′-bis-(2,2,6,6-tetramethylpiperidine-4-yl)-N,N′-dibutyl-adipamide, N,N′-bis-(2,2,6,6-tetramethylpiperidine-4-yl)-N,N′-dicyclohexyl-(2-hydroxypropylene), N,N′-bis-(2,2,6,6-tetramethylpiperidine-4-yl)-p-xylenediamine, 4-(bis-2-hydroxyethyl)amino-1,2,2,6,6-pentamethylpiperidine, 4-methacrylamido-1,2,2,6,6-pentamethylpiperidine and methyl α-cyano-β-methyl-β-[N-(2,2,6,6-tetramethylpiperidine-4-yl)]-amino-acrylate. Preferable hindered amine photo-stabilizer includes the following HALS-1 and HALS-2.

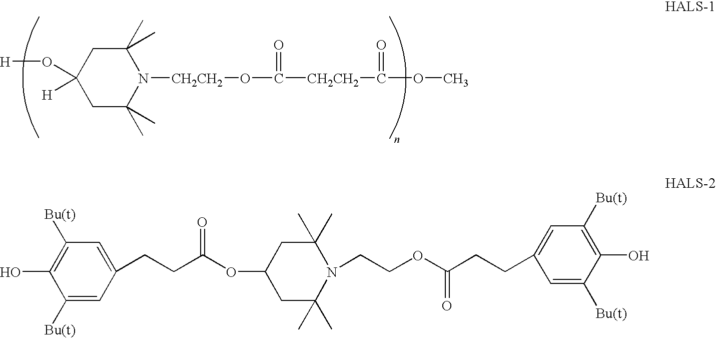

Further, the hindered amine compound described in General formula (1) in Japanese Patent Unexamined Publication No. 2004-352803 can also be preferably used for the polarizing plate protective film of the present invention.

These hindered amine photo-stabilizers may be employed solely or in combination of two or more kinds thereof. The hindered amine photo-stabilizer may be employed together with the additives such as the plasticizer, acid scavenger and UV absorbent, and may be introduced into a part of the structure of the additive. Though the adding amount of the photo-stabilizer is suitably determined within the range in which the object of the present invention is not disturbed, and is preferably from 0.01 to 10%, more preferably 0.01-5%, and particularly preferably 0.05-1%, by weight.

### (Fine Particle Agent)

To the polarizing plate protective film of the invention, a fine particle such as a matting agent can be added for giving the slipping ability or for improving the physical properties. As the fine particle, that of an inorganic compound or that of an organic compound can be employed. The shape of the fine particle includes spherical, rod-like, needle-like and irregular shaped.

Examples of the fine particle include inorganic fine particle of oxide, hydroxide, silicate, phosphate or carbonate of a metal such as silicone dioxide, titanium dioxide, aluminum oxide, zirconium oxide, calcium carbonate, kaolin, talk, baked calcium silicate, hydrated calcium silicate, aluminum silicate and calcium phosphate, and that of crosslinked polymer fine particle. Among them, silicone dioxide is preferable since the haze of the film can be lowered. The fine particle such as silicone dioxide is frequently treated by an organic compound, and such the particle is also preferable since the haze can be lowered.

Halosilane compounds, alkoxysilane compounds, silazane and siloxane are cited as the preferable organic compound for the surface treatment. Larger average diameter of the fine particles causes higher slipping ability and smaller average diameter is superior in the transparency. The average diameter of the fine particle is within the range of from 0.005 to 1.0 μm. The particle may be a primary particle or a secondary particle formed by aggregation of the primary particles. Preferable average diameter of the primary particle is from 10 to 300 nm, and more preferably from 10 to 100 nm. Irregularity or convexoconcave of from 0.01 to 10 μm can be formed on the film surface by such the fine particle. The content of the fine particle in the cellulose ester is preferably from 0.005 to 10%, and particularly preferably from 0.05 to 5%, by weight of the cellulose ester.

Examples of the silicone dioxide include Aerosil 200, 200V, 300, R972, R972V, R974, R202, R812, OX50 and TT600, each manufactured by Nihon Aerosil Co., Ltd., and Aerosil 200V, R972, R972V, R974, R202 and R812 are preferable. These fine particles can be used in combination of two or more kinds thereof. When two or more kinds of them are employed with together, they can be employed in an optional ratio. In such the case, fine particles different in the average diameter and the material, for example, Aerosil 200V and R972V can be employed within the range of from 0.1:99.9 to 99.9 to 0.1 in weight ratio.

The presence of the matting agent in the film may be applied for another object such as for raising the strength of the film.

The fine particles can be added by kneading with the cellulose ester, and further can be kneaded together with the plasticizer, hindered amine compound, hindered phenol compound and acid capturing agent. Moreover, one prepared by spraying the fine particles previously dispersed in a solvent such as methanol and ethanol to the cellulose ester and mixing and drying, and one prepared by adding and mixing the fine particles dispersed in the solvent into a solution of the cellulose ester dissolved in a solvent, principally methylene chloride or methyl acetate, and drying to solidify into a pellet-shape, may be used as the raw material for melt-casting. A part or the entire of the plasticizer, hindered amine compound, hindered phenol compound, phosphorous acid compound, UV absorbent and acid capturing agent are preferably contained into the cellulose ester solution.

Alternatively, fine particles may be added in such a way that 0.1 to 20 parts by weight of fine particles are dispersed into 10 to 100 parts by weight of a solvent, such as methanol, ethanol, isopropanol, and butanol, and the resultant dispersion is added to 100 parts by weight of cellulosic resin. Thereafter, the cellulosic resin is kneaded while the solvent is being removed, and the thus obtained thermoplastic resin composition may be used as a raw material (preferably in the form of pellet) containing the fine particles for the melt casting. The above dispersion can also be made to contain a surface active agent, a dispersant, and an antioxidant.

The pellet can be produced by the method described in Japanese Patent Unexamined Publication No. 2005-67174. That is, the pellet can be produced by a granulation method of cooling and solidifying melted polymer containing cellulosic resin and cutting it into pellets.

The raw material containing the fine particles by the above-mentioned method may be used alone or by being mixed suitably with another raw material which does not contain particles.

The film having a surface layer containing particles can be produced by the film formation with a plural layer simultaneously-extruding method or a plural layer sequentially-extruding method, whereby the surface layer containing fine particles having an average particle size of 0.01 to 1.0 μm can be structured on at least one surface of the film. In the case where the surface layer contains particles, layers constituting an inner layer of a film may also contain the above-mentioned particles.

### (Retardation Controlling Agent)

Optical compensation function can be given particularly to the polarizing plate protective film of the present invention for improving the quality of displayed image by adding a retardation controlling agent or providing a liquid crystal layer by forming a stretched layer for combining the retardation caused by the liquid crystal layer to the polarizing plate protective film. As the compound to be added for controlling the retardation, an aromatic compound having two or more aromatic rings such as that described in European Patent No. 911,656A2 may be employed. For example, the following rod-shaped compounds are applicable. Two or more kinds of the aromatic compound may be employed with together. The aromatic ring of the aromatic compound includes an aromatic heterocycle additionally to an aromatic hydrocarbon ring. The aromatic heterocycle is particularly preferable, and the heterocycle is usually unsaturated heterocycles. Among them, a 1,3,5-triazine ring is preferred.

### (Rod-Shaped Compound)

The optical film or the optical compensating film according to the present invention preferably contains a rod-shaped compound which has the maximum absorption wavelength (λₘₐₓ) in UV absorption spectrum at a wavelength of not longer than 250 nm.

The rod-shaped compound preferably has one or more, and preferably two or more, aromatic rings from the viewpoint of the retardation controlling function. The rod-shaped compound preferably has a linear molecular structure. The linear molecular structure means that the molecular structure of the rod-shaped compound is linear in the thermodynamically most stable structure state. The thermodynamically most stable structure can be determined by crystal structure analyzing or molecular orbital calculation. The molecular structure, by which the heat of formation is made minimum, can be determined on the calculation by, for example, a software for molecular orbital calculation WinMOPAC2000, manufactured by Fujitsu Co., Ltd. The linear molecular structure means that the angle of the molecular structure is not less than 140° in the thermodynamically most stable structure calculated as the above. The rod-shaped compound is preferably one displaying a liquid crystal property. The rod-shaped compound more preferably displays a crystal liquid property by heating (thermotropic liquid crystal property). The phase of the liquid crystal is preferably a nematic phase or a smectic phase.

As the rod-shaped compound, trans-1,4-cyclohexanedicarboxylic acid esters represented by the following Formula (10) are preferable.

Ar¹-L¹-Ar² Formula (10)

In Formula 10, Ar¹ and Ar² are each independently an aromatic group. The aromatic group includes an aryl group (an aromatic hydrocarbon group), a substituted aryl group, an aromatic heterocyclic group and a substituted heterocyclic group. The aryl group and the substituted alkyl group are more preferable than the aromatic heterocyclic group and the substituted aromatic heterocyclic group. The heterocycle of the aromatic heterocyclic group is usually unsaturated. The aromatic heterocyclic group is preferably a 5-, 6- or 7-member ring, and more preferably a 5- or 6-member ring. The heterocyclic ring usually has the largest number of double bond. The hetero atom is preferably a nitrogen atom, an oxygen atom or a sulfur atom and the nitrogen atom or the oxygen atom is more preferable. Examples of the aromatic heterocyclic ring include a furan ring, a thiophene ring, a pyrrole ring, an oxazole ring, in isoxazole ring, a thiazole ring, an isothiazole ring, an imidazole ring, a pyrazole ring, a furazane ring, a triazole ring, a pyrane ring, a pyridine ring, a pyridazine ring, a pyrimidine ring, a pyrazine ring and a 1,3,5-triazine ring. As the aromatic ring of the aromatic group, a benzene ring, a furan ring, a thiophene ring, a pyrrole ring, an oxazole ring, a thiazole ring, a thiazole ring, an imidazole ring, a triazole ring, a pyridine ring, a pyrimidine ring and pyrazine ring are preferable and the benzene ring is particularly preferable.

Examples of the substituent of the substituted aryl group and the substituted aromatic heterocyclic group include a halogen atom such as a fluorine chlorine atom, a chlorine atom, a bromine atom and an iodine atom, a hydroxyl group, a carboxyl group, a cyano group, an amino group, an alkylamino group such as a methylamino group, an ethylamino group, a utylamno group and a dimethylamino group, a nitro group, a sulfo group, a carbamoyl group, an alkylcarbamoyl group such as an N-methylcarbamoyl group and an N,N-dimethylcarbamoyl group, a sulfamoyl group, an alkylsulfamoyl group such as an N-methylsulfamoyl group, an N-ethylsulfamoyl group and an N,N-dimethylsulfamoyl group, a ureido group, an alkylureido group such as an N-methylureido group, an N,N-dimethylureido group and N,N,N-trimethylureido group, an alkyl group such as a methyl group, an ethyl group, a propyl group, a butyl group, a pentyl group, a heptyl group, an octyl group, an isopropyl group, an s-butyl group, a t-amyl group, a cyclohexyl group and a cyclopentyl group, an alkenyl group such as a vinyl group, an allyl group and a hexenyl group, an alkynyl group such as an ethynyl group and a butynyl group, an acyl group such as a formyl group, an acetyl group, a butylyl group, a hexanoyl group and a lauryl group, an acyloxy group such as an acetoxy group, a butylyloxy group, a hexanoyloxy group and lauryloxy group, an alkoxy group such as a methoxy group, an ethoxy group, a propoxy group, a butoxy group, a pentyloxy group, a heptyloxy group and an octyloxy group, an aryloxy group such as a phenoxy group, an alkoxycarbonyl group such as a methoxycarbonyl group, an ethoxycarbonyl group, a propoxycarbonyl group, a butoxycarbonyl group, a pentyloxycarbonyl group and a heptyloxycarbonyl group, an aryloxycarbonyl group such as a phenoxycarbonyl group, a an alkoxycarbonylamino group such as a butoxycarbonylamino group and a hexyloxycarbonylamino group, an alkylthio group such as a methylthio group, an ethylthio group, a propylthio group, butylthio group, a pentylthio group, a heptylthio group and an octylthio group, an arylthio group such as a thiophenyl group, an alkylsulfonyl group such as a methylsulfonyl group, an ethylsulfonyl group, a propylsulfonyl group, a butylsulfonyl group, a pentylsulfonyl group, a heptylsulfonyl group and an octylsulfonyl group, an amido group such as an acetoamido group, a butylamido group, a hexylamido group and an octylamido group, and a non-aromatic heterocyclic group such as a morpholyl group and a pyradinyl group.

As the substituent of the substituted aryl group and the substituted aromatic heterocyclic group, a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group are preferable. The alkyl moiety of the alkylamino group, the alkoxycarbonyl group, the alkoxy group and the alkylthio group, and the alkyl group each may further have a substituent. Examples of the substituent of the alkyl moiety or the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. The halogen atom, the hydroxyl group, an amino group, an alkylamino group, an acyl group, an acyloxy group, an acylamino group, an alkoxycarbonyl group and an alkoxy group are preferable as the substituent of the alkyl moiety or the alkyl group.

In Formula (10), L¹ is a di-valent bonding group selected from the group consisting of an alkylene group, an alkenylene group, an alkynylene group, a di-valent saturated heterocyclic group, an —O— atom, a —CO— group and a combination of them. The alkylene group may have a cyclic structure. As the cyclic alkylene group, a cyclohexylene group is preferable, and 1,4-cyclohexylene group is more preferable. As the chain-shaped alkylene group, a straight-chain alkylene group is more preferable than a branched-chain alkylene group. The number of carbon atoms of the alkylene group is preferably 1-20, more preferably 1-15, further preferably 1-10, further more preferably 1-8, and most preferably 1-6.

The alkenylene group and the alkynylene group each having a cyclic structure are more preferable than those having a chain structure, and a straight-chain structure is more preferably to a branched-chain structure. The number of carbon atom of the alkenylene group and the alkynylene group is preferably 2-10, more preferably 2-8, further preferably 2-6, and further more preferably 2-4, and most preferably 2, namely a vinylene or an ethynylene group. The di-valent saturated heterocyclic group is preferably from a 3- to 9-member heterocyclic ring. The hetero atom of the heterocyclic ring is preferably an oxygen atom, a nitrogen atom, a boron atom, a sulfur atom, a silicon atom, a phosphor atom or a germanium atom. Examples of the saturated heterocyclic ring include a piperidine ring, a piperazine rings a morpholine ring, a pyrrolidine ring, an imidazolidine ring, a tetrahydrofuran ring, a tetrahydropyrane ring, a 1,3-dioxane ring, a 1,4-dioxane ring, a terahydrothiophene ring, a 1,3-thiazolidine ring, a 1,3-oxazolidine ring, a 1,3-dioxoran ring, a 1,3-dithiosilane ring and a 1,3,2-dioxoboran ring. Particularly preferable di-valent saturated heterocyclic group is a piperazine-1,4-diylene group, a 1,3-dioxane-2,5-diylene group and a 1,3,2-dioxobororane-2,5-diylene group.

Examples of divalent bonding group composed of a combination of groups are listed as follows.

L-1: —O—CO-alkylene-CO—O—

L-2: —CO—O-alkylene-O—CO—

L-3: —O—CO-alkenylene-CO—O—

L-4: —CO—O-alkenylene-O—CO—

L-5: —O—CO-alkynylene-CO—O—

L-6: —CO—O-alkynylene-O—CO—

L-7: —O—CO-divalent saturated heterocyclic group-CO—

L-8: —CO—O— divalent saturated heterocyclic group —O—CO—

In the structure of Formula (10), the angle formed by Ar¹ and Ar² through L¹ is preferably not less than 140°. Compounds represented by Formula 11 are further preferable as the rod-shaped compound.

Ar¹-L²-X-L³-Ar² Formula (11)

In Formula (11), Ar¹ and Ar² are each independently an aromatic group. The definition and the example are the same as Ar¹ and Ar² in Formula (10).

In Formula (11), L² and L³ are each independently a di-valent bonding group selected from the group consisting of an alkylene group, an —O— atom, a —CO— group and a combination of them. The alkylene group having a chain structured is preferably to that having a cyclic structure, and a straight-chain structure is more preferably to a branched-chain structure. The number of carbon atoms in the alkylene group is preferably 1-10, more preferably from 1 to 8, further preferably from 1 to 6, further more preferably 1-4, and most preferably 1 or 2, namely a methylene group or an ethylene group. L² and L³ are particularly preferably an —O—CO— group or a —CO—O— group.

In Formula (11), X is 1,4-cyclohexylene group, a vinylene group or a ethynylene group. Concrete examples of the compound represented by Formula (10) are listed below.

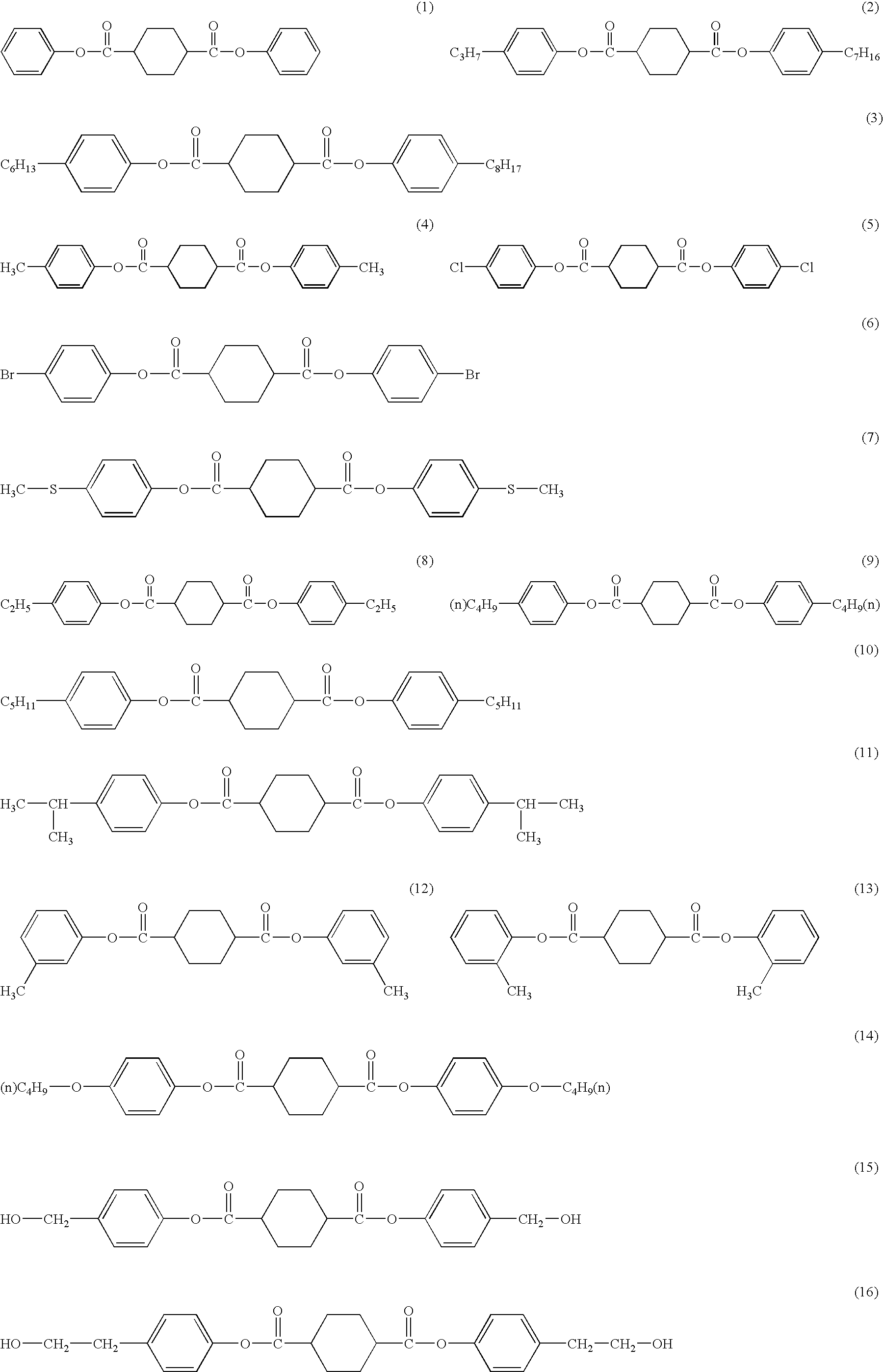

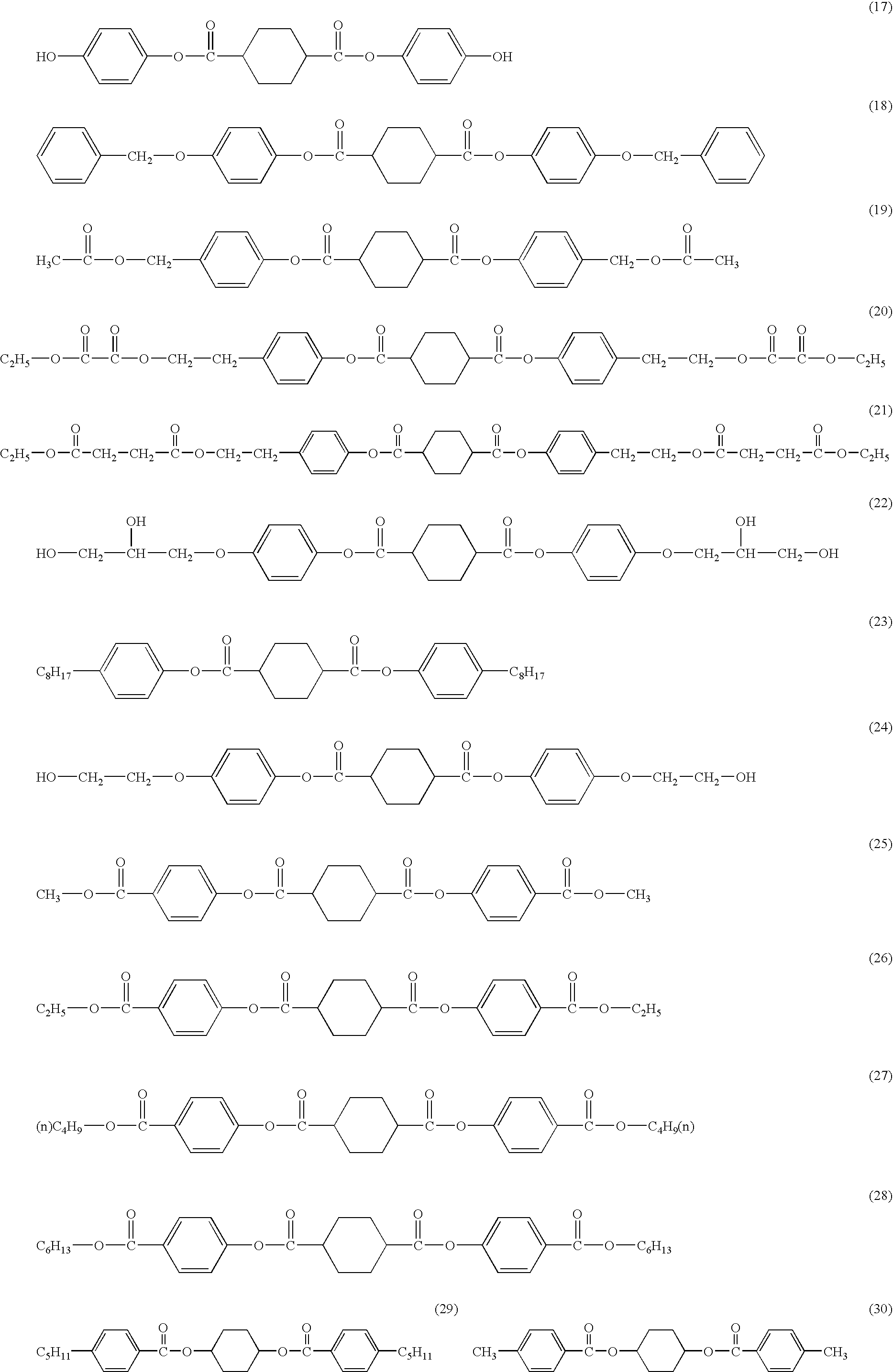

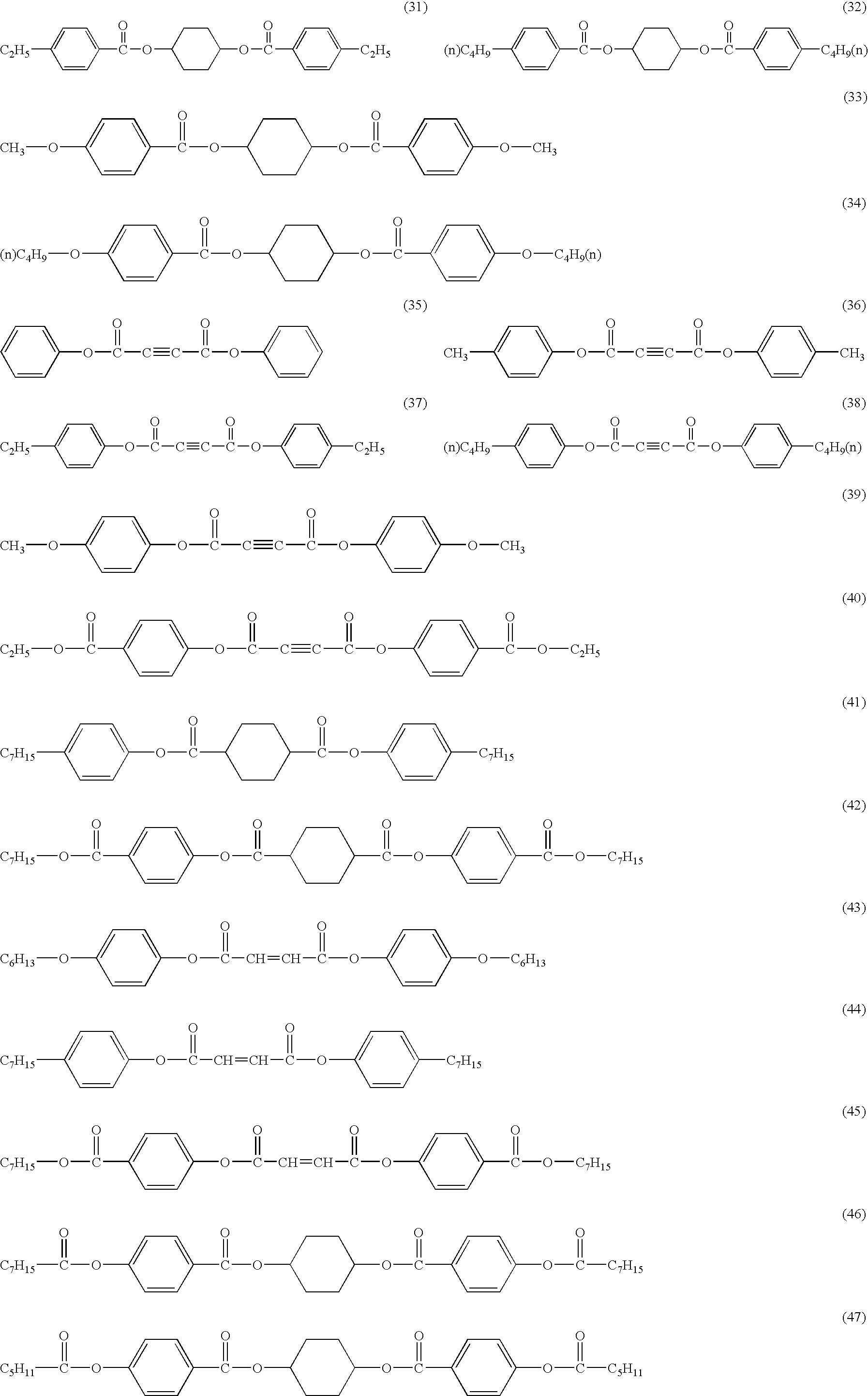

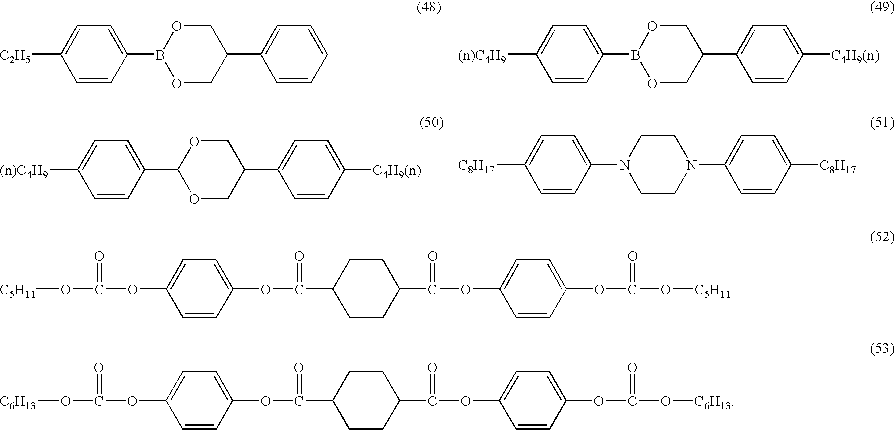

Exemplified compounds (1) to (34), (41), (42), (46), (47), (52) and (53) each has two asymmetric carbon atoms at 1- and 4-positions of the cyclohexane ring. However, Exemplified compounds (1), (4)-(34), (41), (42), (46), (47), (52) and (53) have no optical isomerism (optical activity) since they have symmetrical meso form molecular structure, and there are only geometric isomers thereof. Exemplified compound 1 in trans-form (1-trans) and that in cis-form (1-cis) are shown below.

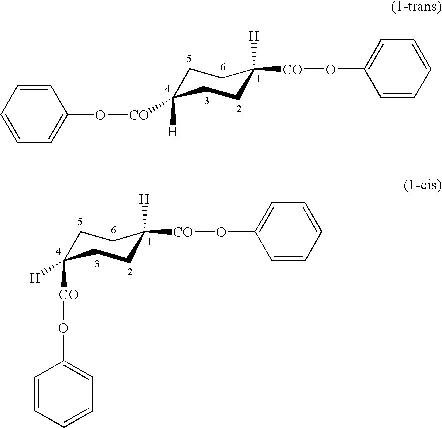

As above-mentioned, the rod-shaped compound preferably has a linear molecular structure. Therefore, the trans form is preferably to the cis-form. Exemplified compounds (2) and (3) have optical isomers additionally to the geometric isomers (four isomers in total). Regarding the geometric isomers, the trans-form is more preferable than the cis-form. There is no difference between the optical isomers and D-, L- and racemic-body are all employable. In Exemplified compounds (43) to (45), cis-form and trans-form are formed at the vinylene bond. The trans-form is preferable than the cis-form by the above-described reason.

Two kinds of the rod-shaped compounds each having the maximum absorption at a wavelength shorter than 250 nm may be employed in combination. “Mol. Cryst. Liq. Cryst.” vol. 53, p. 229, 1979, ibid. vol. 89, p. 93, 1982, ibid. vol. 145, p. 111, 1987, and ibid. vol. 170, p. 43, 1989, “J. Am. Chem. Soc.” Vol. 113, p. 1349, 1991, ibid. vol. 118, p. 5346, 1996, and ibid. vol. 92, p. 1582, 1970, “J. Org. Chem.” Vol. 40, p. 420, 1975, and “Tetrahedron” vol. 48, No. 16, p. 3437, 1992 can be cited as relating documents.

Moreover, phenyl benzoate derivatives can be preferably used for the polarizing plate protective film of the present invention.

### [Phenyl Benzoate Ester Compound]

Compounds represented by Formula (12) used in the present invention will be described in detail below.

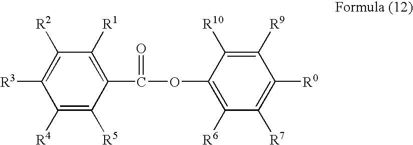

(In Formula, R⁰, R¹, R², R³, R⁴, R⁵, R⁶, R⁷, R⁹ and R¹⁰ each independently represent a hydrogen atom or a substituent, and at least one of R¹, R², R³, R⁴, and R⁵ represents an electron donating group.)

In Formula (12), R⁰, R¹, R², R³, R⁴, R⁵, R⁶, R⁷, R⁹, and R¹⁰ each independently represent a hydrogen atom or a substituent while substituent T which will be described below is applicable as the substituent.

At least one of R¹, R², R³, R⁴ and R⁵ is an electron donating group, more preferably, one of R¹, R³ and R⁵ is an electron donating group, and, still more preferably, R³ is an electron donating group.

The electron donating group means that σp value of Hammet is zero or less. The electron donating groups exhibiting σp value of zero or less described in Chem. Rev., 91, 165 (1991) are applicable and more preferable are those exhibiting σp value of −0.85-0. Examples of such electron donating group include: an alkyl group, an alkoxy group, an amino group and a hydroxyl group.

Preferable as an electron donating group are, for example, an alkyl group and an alkoxy group and more preferable is an alkoxy group (preferably having 1 to 12 carbon atoms, more preferably 1 to 8 carbon atoms, further more preferably 1 to 6 carbon atoms and specifically more preferably 1 to 4 carbon atoms).

As R¹, preferable is a hydrogen atom or an electron donating group; more preferable is an alkyl group, an alkoxy group, an amino group or a hydroxyl group; further more preferable is an alkyl group having 1 to 4 carbon atoms, an alkoxy group having 1 to 12 carbon atoms or a hydroxyl group; specifically more preferable is an alkoxy group (preferably having 1 to 12 carbon atoms, more preferably 1 to 8 carbon atoms, further more preferably 1 to 6 carbon atoms and specifically more preferably 1 to 4 carbon atoms); and most preferable is a methoxy group.

As R², preferable is a hydrogen atom, an alkyl group, an alkoxy group, an amino group or a hydroxyl group; more preferable is a hydrogen atom, an alkyl group or an alkoxy group, further more preferable is a hydrogen atom, an alkyl group (preferably having 1 to 4 carbon atoms and more preferably a methyl group) or an alkoxy group (preferably having 1 to 12 carbon atoms, more preferably 1 to 8 carbon atoms, further more preferably 1 to 6 carbon atoms, still more preferably 1 to 4 carbon atoms); specifically preferable is a hydrogen atom, a methyl group or a methoxy group; and most preferable is a hydrogen atom.

As R³, preferable is a hydrogen atom or an electron donating group; more preferable is a hydrogen atom, an alkyl group, an alkoxy group, an amino group or a hydroxyl group; further more preferable is an alkyl group or an alkoxy group; specifically more preferable is an alkoxy group (preferably having 1 to 12 carbon atoms, more preferably 1 to 8 carbon atoms, further more preferably 1 to 6 carbon atoms, still more preferably 1 to 4 carbon atoms); and most preferable is an n-propoxy group, an ethoxy group or a methoxy group.

As R⁴, preferable is a hydrogen atom or an electron donating group; more preferable is a hydrogen atom, an alkyl group, an alkoxy group, an amino group or a hydroxyl group; further more preferable is a hydrogen atom, an alkyl group having 1 to 4 carbon atoms or an alkoxy group having 1 to 12 carbon atoms (preferably having 1 to 8 carbon atoms, more preferably 1 to 6 carbon atoms, still more preferably 1 to 4 carbon atoms); specifically more preferable is a hydrogen atom, an alkyl group having 1 to 4 carbon atoms or an alkoxy group having 1 to 4 carbon atoms; most preferable is a hydrogen atom, a methyl group or a methoxy group.

As R⁵, preferable is a hydrogen atom, an alkyl group, an alkoxy group, an amino group or a hydroxyl group; more preferable is a hydrogen atom, an alkyl group or an alkoxy group, further more preferable is a hydrogen atom, an alkyl group (preferably having 1 to 4 carbon atoms and more preferably a methyl group) or an alkoxy group (preferably having 1 to 12 carbon atoms, more preferably 1 to 8 carbon atoms, further more preferably 1 to 6 carbon atoms, still more preferably 1 to 4 carbon atoms); specifically preferable is a hydrogen atom, a methyl group or a methoxy group; and most preferable is a hydrogen atom.

As each of R⁶, R⁷, R⁹, and R¹⁰, preferable is a hydrogen atom, an alkyl group having 1 to 12 carbon atoms, an alkoxy group having 1 to 12 carbon atoms or a halogen atom; more preferable is a hydrogen atom or a halogen atom; and further more preferable is a hydrogen atom.

R⁰ represents a hydrogen atom or a substituent, and preferable as R⁰ is a hydrogen atom, an alkyl group having 1 to 4 carbon atoms, an alkynyl group having 2 to 6 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, a carbonyl group or a halogen atom.

The compound represented by Formula (12) is preferably a compound represented by Formula (13).

In the following, the compound represented by Formula (13) will be described in detail.

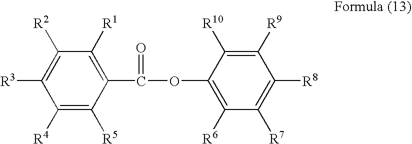

(In the formula, R¹, R², R³, R⁴, R⁵, R⁶, R⁷, R⁹, and R¹⁰ each independently represent a hydrogen atom or a substituent. At least one of R¹, R², R³, R⁴, and R⁵ represents an electron donating group. R⁸ represents a hydrogen atom, an alkyl group having 1 to 4 carbon atoms, an alkynyl group having 2 to 6 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, a carbonyl group or a halogen atom.)

R⁸ represents a hydrogen atom, an alkyl group having 1 to 4 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, a carbonyl group or a halogen atom, which may further have a substituent, if possible, and the substituent may be one of the substituent T which will be described below. Moreover, the substituent may further has a substituent.

As R⁸, preferable is an alkyl group having 1 to 4 carbon atoms, an alkynyl group having 2 to 12 carbon atoms, an aryl group having 6 to 12 carbon atoms, an alkoxy group having 1 to 12 carbon atoms, an alkoxycarbonyl group having 2 to 12 carbon atoms, an acylamino group having 2 to 12 carbon atoms, a cyano group, more preferable is an alkynyl group having 2 to 12 carbon atoms, an aryl group of 6 to 12 carbon atoms, an alkoxycarbonyl group of 2 to 12 carbon atoms, an acylamino group having 2 to 12 carbon atoms or a cyano group, still more preferable is an alkynyl group having 2 to 7 carbon atoms, an aryl group of 6 to 12 carbon atoms, an alkoxycarbonyl group of 2 to 6 carbon atoms, an acylamino group having 2 to 7 carbon atoms or a cyano group, and specifically preferable is a phenyl ethynyl group, a phenyl group, a p-cyanophenyl group, a p-methoxyphenyl group, a benzoylamino group, a n-propoxy carbonyl group, an ethoxycarbonyl group, a methoxycarbonyl group or a cyano group.

Among compounds represented by Formula (13), preferable is a compound represented by Formula (13-A).

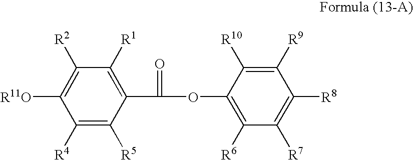

(In Formula, R¹, R², R⁴, R⁵, R⁶, R⁷, R⁹, and R¹⁰ each independently represent a hydrogen atom or a substituent. R⁸ represents a hydrogen atom, an alkyl group having 1 to 4 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, a carbonyl group or a halogen atom. R¹¹ represents an alkyl group having 1 to 12 carbon atoms.

In Formula (13-A), R¹, R², R⁴, R⁵, R⁶, R⁷, R⁸, R⁹, and R¹⁰ have the same meaning as R¹, R², R⁴, R⁵, R⁶, R⁷, R⁸, R⁹, and R¹⁰, respectively, in Formula (7), and the preferable ranges thereof are also the same.

In Formula (13-A), R¹¹ represents an alkyl group having 1 to 12 carbon atoms. The alkyl group represented by R¹¹ may be of a linear chain or a branched chain, and, also, may have a substituent. R¹¹ is preferably an alkyl group having 1 to 12 carbon atoms, more preferably an alkyl group having 1 to 8 carbon atoms, further more preferably an alkyl group having 1 to 6 carbon atoms, and specifically preferably an alkyl group having 1 to 4 carbon atoms (for example, a methyl group, an ethyl group, an n-propyl group, an iso-propyl group, an n-butyl group, an iso-butyl group and a tert-butyl group).

Among compounds represented by Formula (13), more preferable is a compound represented by Formula (13-B).

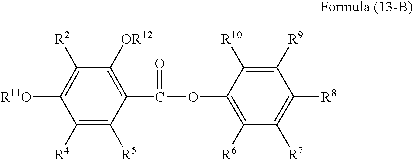

(In Formula, R², R⁴, R⁵, R⁶, R⁷, R⁹, and R¹⁰ each independently represent a hydrogen atom or a substituent. R⁸ represents a hydrogen atom, an alkyl group having 1 to 4 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, a carbonyl group or a halogen atom. R¹¹ represents an alkyl group having 1 to 12 carbon atoms. R¹² represents a hydrogen atom or an alkyl group having 1 to 4 carbon atoms.)

In Formula (13-B), R², R⁴, R⁵, R⁶, R⁷, R⁸, R⁹, R¹⁰ and R¹¹ have the same meaning as R², R⁴, R⁵, R⁶, R⁷, R⁸, R⁹, R¹⁰ and R¹¹, respectively, in Formula (13-A), and the preferable ranges thereof are also common.

In Formula (13-B), R¹² represents a hydrogen atom or an alkyl group having 1 to 4 carbon atoms, preferably a hydrogen atom or an alkyl group having 1 to 3 carbon atoms, more preferably a hydrogen atom, a methyl group or an ethyl group, further more preferably a hydrogen atom or a methyl group, and specifically preferably a methyl group.

Among compounds represented by Formula (13-B), preferable is a compound represented by Formula (14) or Formula (13-C).

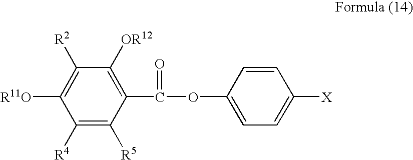

(In Formula, R², R⁴, R⁵, R¹¹ and R¹² have the same meaning as R², R⁴, R⁵, R¹¹ and R¹², respectively, in Formula (13-B), and the preferable ranges thereof are also the same. X represents an alkynyl group having 2 to 7 carbon atoms, an aryl group having 6 to 12 carbon atoms, an alkoxycarbonyl group having 2 to 6 carbon atoms, an acylamino group having 2 to 7 carbon atoms or a cyano group.)

In Formula (14), X represents an alkynyl group having 2 to 7 carbon atoms, an aryl group having 6 to 12 carbon atoms, an alkoxycarbonyl group having 2 to 6 carbon atoms, an acylamino group having 2 to 7 carbon atoms or a cyano group, preferably represents a phenyethynyl group, a phenyl group, a p-cyanophenyl group, a p-methoxyphenyl group, a benzoylamino group, an alkoxycarbonyl group having 2 to 4 carbon atoms or a cyano group, and more preferably represents a phenyl group, a p-cyanophenyl group, a p-methoxyphenyl group, an alkoxycarbonyl group having 2 to 4 carbon atoms or a cyano group.

Formula (13-C) will now is described below.

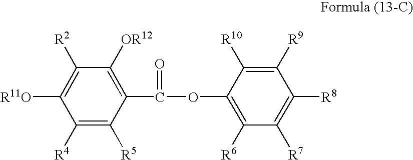

(In Formula, R², R⁴ and R⁵ have the same meaning as R², R⁴ and R⁵, respectively, in Formula (13-B), and the preferable ranges thereof are also the same, provided that one of R², R⁴ and R⁵ is a group represented by —OR¹³ wherein represents an alkyl group having 1 to 4 carbon atoms.)

In Formula (13-C), R², R⁴ and R⁵ have the same meaning as R², R⁴ and R⁵, respectively, in Formula (13-B), and the preferable ranges thereof are also the same, provided that one of R², R⁴ and R⁵ is a group represented by —OR¹³ wherein represents an alkyl group having 1 to 4 carbon atoms. Preferably, R⁴ or R⁵ is a group represented by —OR¹³ and more preferably, R⁴ is a group represented by —OR¹³.

R¹³ represents an alkyl group having 1 to 4 carbon atoms, more preferably an alkyl group having 1 to 3 carbon atoms, further more preferably an ethyl group or a methyl group, and specifically preferably a methyl group.

Among compounds represented by Formula (13-C), preferable is a compound represented by Formula (13-D).

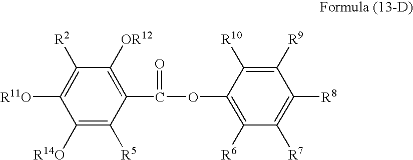

(In Formula, R², R⁵, R⁶, R⁷, R⁸, R⁹, R¹⁰, R¹¹ and R¹² have the same meaning as R¹, R⁵, R⁶, R⁷, R⁸, R⁹, R¹⁰, R¹¹ and R¹², respectively, in Formula (7-C), and the preferable ranges thereof are also the same. R¹⁴ represents an alkyl group having 1 to 4 carbon atoms.)

R¹⁴ represents an alkyl group having 1 to 4 carbon atoms, preferably represents an alkyl group having 1 to 3 carbon atoms, more preferably represents an ethyl group and a methyl group, and further more preferably represents a methyl group.

Among compounds represented by Formula (13-D), preferable is a compound represented by Formula (13-E).

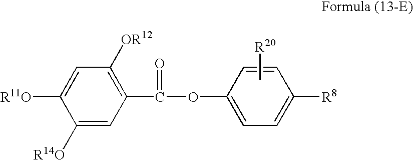

(In Formula, R⁸, R¹¹, R¹² and R¹⁴ have the same meaning as R⁸, R¹¹, R¹² and R¹⁴, respectively, in Formula (13-D), and the preferable ranges thereof are also the same. 9

R²⁰ represents a hydrogen atom or a substituent and as the substituent, substituents T which will be described below are applicable. R²⁰ may be bonded at any position of the benzene ring, provided that the benzene ring never has a plurality of R²⁰. As R²⁰, preferable is a hydrogen atom or a substituent having a number of constituting atoms of not more than 4 excluding the number of hydrogen atoms, more preferable is a substituent having a number of constituting atoms of not more than 3 excluding the number of hydrogen atoms, further more preferable is a substituent having a number of constituting atoms of not more than 2 excluding the number of hydrogen atoms, specifically preferable is a hydrogen atom, a methyl group, a methoxy group, a halogen atom, a formyl group, or a cyano group, and most preferable is a hydrogen atom.

The above-mentioned substituent T will now be described.

Examples of substituent T include: an alkyl group (preferably having 1 to 20 carbon atoms, more preferably having 1 to 12 carbon atoms, further more preferably having 1 to 8 carbon atoms, and examples of an alkyl group include: a methyl group, an ethyl group, an iso-propyl group, a tert-butyl group, an n-octyl group, an n-decyl group, an n-hexadecyl group, a cyclopropyl group, a cyclopentyl group and a cyclohexyl group); an alkenyl group (preferably having 2 to 20 carbon atoms, more preferably having 2 to 12 carbon atoms, further more preferably having 2 to 8 carbon atoms, and examples of an alkenyl group include: a vinyl group, an allyl group, a 2-butenyl group and a 3-pentenyl group); an alkynyl group (preferably having 2 to 20 carbon atoms, more preferably 2 to 12 carbon atoms, further more preferably having 2 to 8 carbon atoms, and examples of an alkynyl group include: a propargyl group and a 3-pentinyl group); an aryl group (preferably having 6 to 30 carbon atoms, more preferably having 6 to 20 carbon atoms, further more preferably having 6 to 12 carbon atoms, and examples of an aryl group include: a phenyl group, a p-methylphenyl group and a naphthyl group); a substituted or non-substituted amino group (preferably having 0 to 20 carbon atoms, more preferably having 0 to 10 carbon atoms, further more preferably having 0 to 6 carbon atoms, and examples of an amino group include: an amino group, a methylamino group, a dimethylamino group, a diethylamino group and a dibenzylamino group); an alkoxy group (preferably having 1 to 20 carbon atoms, more preferably having 1 to 12 carbon atoms, further more preferably having 1 to 8 carbon atoms, and examples of an alkoxy group include: a methoxy group, an ethoxy group and a butoxy group); an aryloxy group (preferably having 6 to 20 carbon atoms, more preferably having 6 to 16 carbon atoms, further more preferably having 6 to 12 carbon atoms, and examples of an aryloxy group include: a phenyloxy group and a 2-naphthyloxy group); an acyl group (preferably having 1 to 20 carbon atoms, more preferably having 1 to 16 carbon atoms, further more preferably having 1 to 12 carbon atoms, and examples of an acyl group include: an acetyl group, a benzoyl group, a formyl group and a pivaloyl group); an alkoxycarbonyl group (preferably having 2 to 20 carbon atoms, more preferably having 2 to 16 carbon atoms, further more preferably having 2 to 12 carbon atoms, and examples of an alkoxycarbonyl group include: a methoxycarbonyl group and an ethoxycarbonyl group); an aryloxycarbonyl group (preferably having 7 to 20 carbon atoms, more preferably having 7 to 16 carbon atoms, further more preferably having 7 to 10 carbon atoms, and examples of an aryloxycarbonyl group include: a phenyloxycarbonyl group); an acyloxy group (preferably having 2 to 20 carbon atoms, more preferably having 2 to 16 carbon atoms, further more preferably having 2 to 10 carbon atoms, and examples of an acyloxy group include: an acetoxy group and a benzoyloxy group); an acylamino group (preferably having 2 to 20 carbon atoms, more preferably having 2 to 16 carbon atoms, further more preferably having 2 to 10 carbon atoms, and examples of an acylamino group include: an acetylamino group and a benzoylamino group); an alkoxycarbonylamino group (preferably having 2 to 20 carbon atoms, more preferably having 2 to 16 carbon atoms, further more preferably having 2 to 12 carbon atoms, and examples of an alkoxycarbonylamino group include: a methoxycarbonylamino group); an aryloxycarbonylamino group (preferably having 7 to 20 carbon atoms, more preferably having 7 to 16 carbon atoms, further more preferably having 7 to 12 carbon atoms, and examples of an aryloxycarbonylamino group include: a phenyloxycarbonylamino group); a sulfonylamino group (preferably having 1 to 20 carbon atoms, more preferably having 1 to 16 carbon atoms, further more preferably having 1 to 12 carbon atoms, and examples of a sulfonylamino group include: a methanesulfonylamino group and abenzenesulfonylamino group); a sulfamoyl group (preferably having 0 to 20 carbon atoms, more preferably having 0 to 16 carbon atoms, further more preferably having 0 to 12 carbon atoms, and examples of a sulfamoyl group include: a sulfamoyl group, a methylsulfamoyl group, a dimethylsulfamoyl group and a phenylsulfamoyl group); a carbamoyl group (preferably having 1 to 20 carbon atoms, more preferably having 1 to 16 carbon atoms, further more preferably having 1 to 12 carbon atoms, and examples of a carbamoyl group include: a carbamoyl group, a methylcarbamoyl group, a diethylcarbamoyl group and a phenylcarbamoyl group); an alkylthio group (preferably having 1 to 20 carbon atoms, more preferably having 1 to 16 carbon atoms, further more preferably having 1 to 12 carbon atoms, and examples of an alkylthio group include: a methylthio group and an ethylthio group); an arylthio group (preferably having 6 to 20 carbon atoms, more preferably having 6 to 16 carbon atoms, further more preferably having 6 to 12 carbon atoms, and examples of an arylthio group include: a phenylthio group); a sulfonyl group (preferably having 1 to 20 carbon atoms, more preferably having 1 to 16 carbon atoms, further more preferably having 1 to 12 carbon atoms, and examples of an sulfonyl group include: a mesyl group and a tosyl group); a sulfinyl group (preferably having 1 to 20 carbon atoms, more preferably having 1 to 16 carbon atoms, further more preferably having 1 to 12 carbon atoms, examples of a sulfinyl group include: a methane sulfinyl group and a benzene sulfinyl group); an ureido group (preferably having 1 to 20 carbon atoms, more preferably having 1 to 16 carbon atoms, further more preferably having 1 to 12 carbon atoms, examples of an ureido group include: an ureido group, a methylureido group and a phenylureido group); a phosphoric acid amido group (preferably having 1 to 20 carbon atoms, more preferably having 1 to 16 carbon atoms, further more preferably having 1 to 12 carbon atoms, examples of a phosphoric acid amido group include: a diethyl phosphoric acid amido group and a phenyl phosphoric acid amide); a hydroxy group; a mercapto group; a halogen atom (for example, a fluorine atom, a chlorine atom, a bromine atom and an iodine atom); a cyano group; a sulfo group; a carboxyl group; a nitro group; a hydroxamic acid group; a sulfino group; a hydrazino group; an imino group; a heterocycle group (preferably having 1 to 30 carbon atoms, more preferably having 1 to 12 carbon atoms, examples of a hetero atom include: a nitrogen atom, an oxygen atom and a sulfur atom, and concrete examples include: an imidazolyl group, a pyridyl group, a quinolyl group, a furyl group, a piperidyl group, a morpholino group, a benzooxazolyl group, a benzimidazol group and a group benzthiazolyl); and a silyl group (preferably having 3 to 40 carbon atoms, more preferably having 3 to 30 carbon atoms and specifically preferably 3-24, and examples of a silyl group include: a trimethylsilyl group, a triphenylsilyl group). These substituents may further be substituted.

Two or more substituents, if any, may be the same or different from each other. Further, they may form a ring through mutual bondage wherever possible.

The following describes the specific examples of the compounds represented by Formula (12), however, the present invention is not limited thereto.

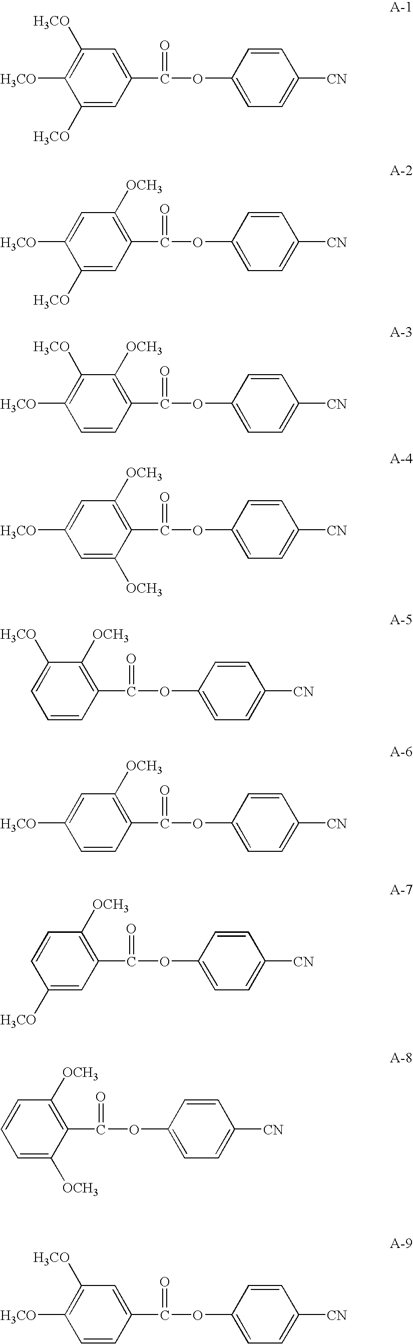

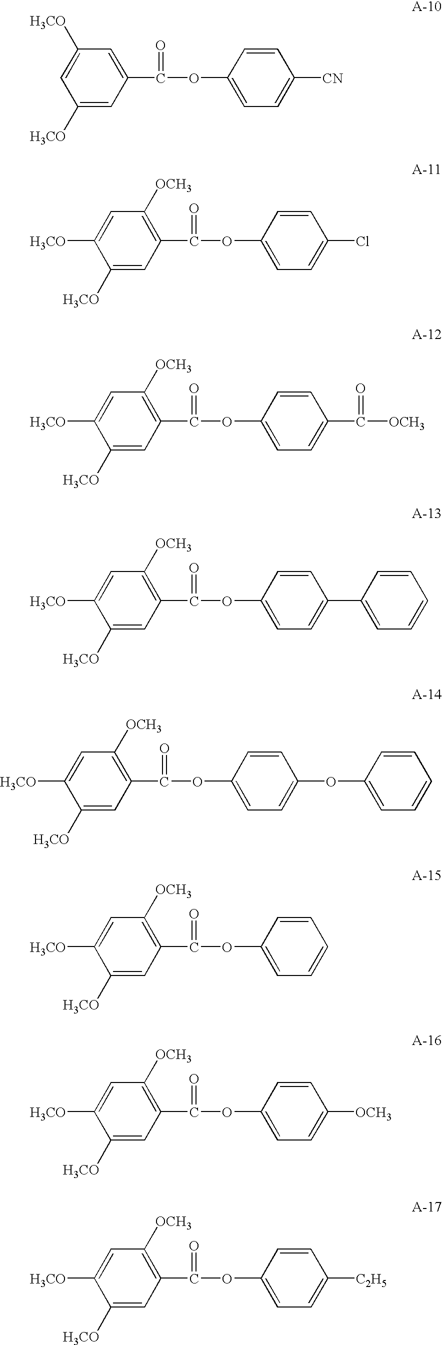

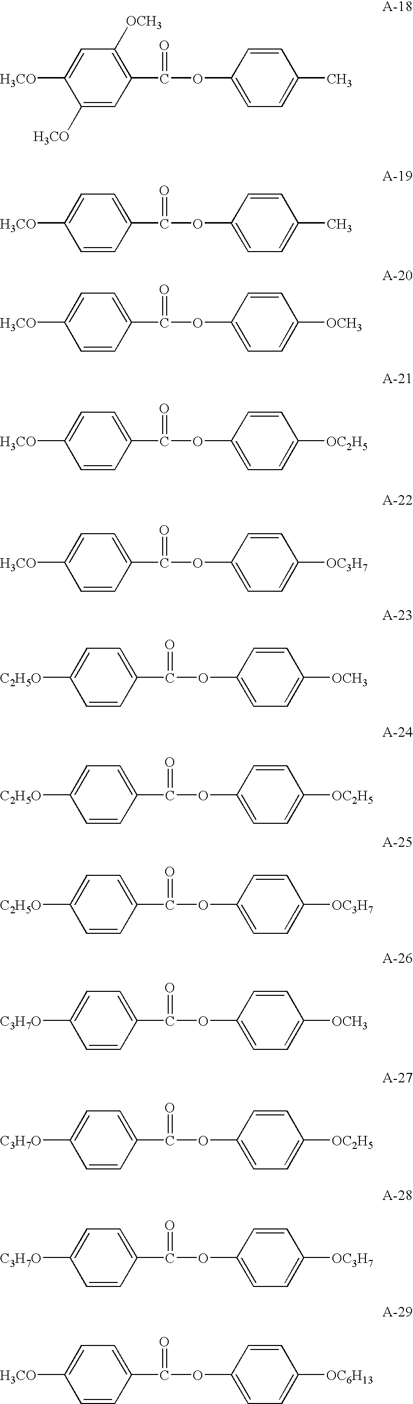

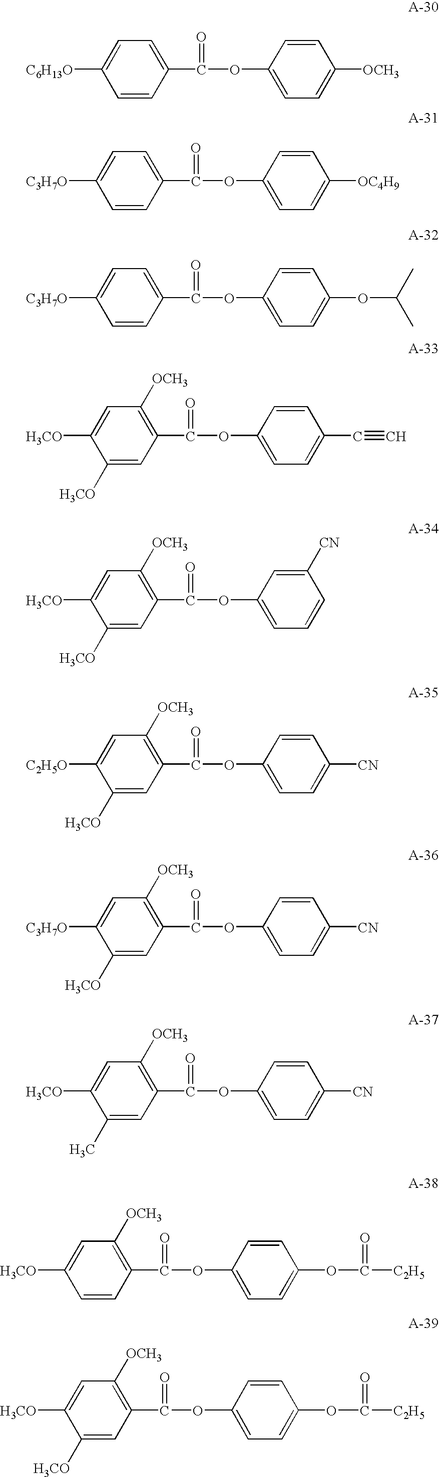

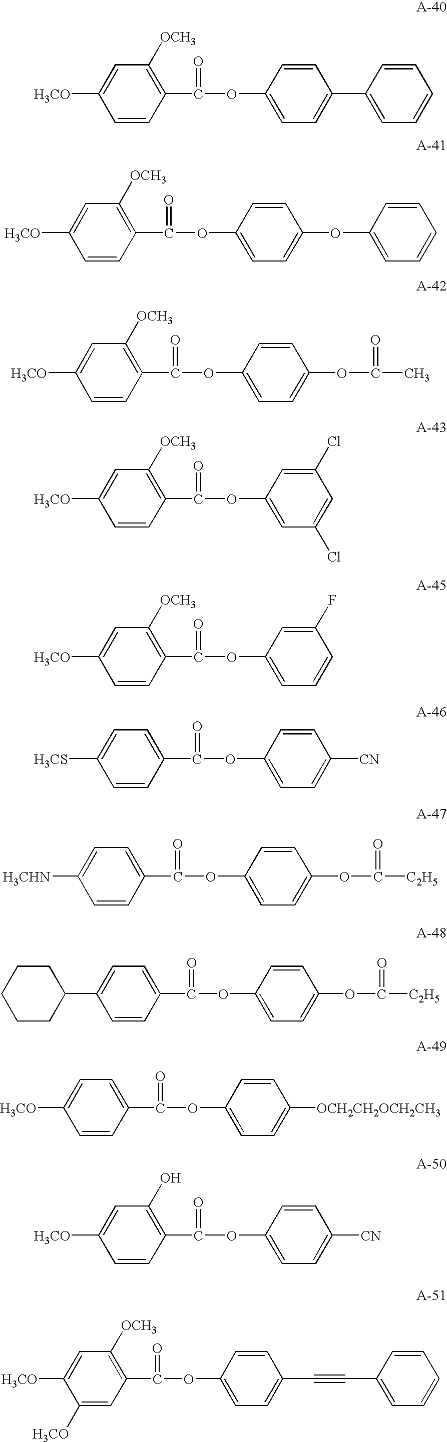

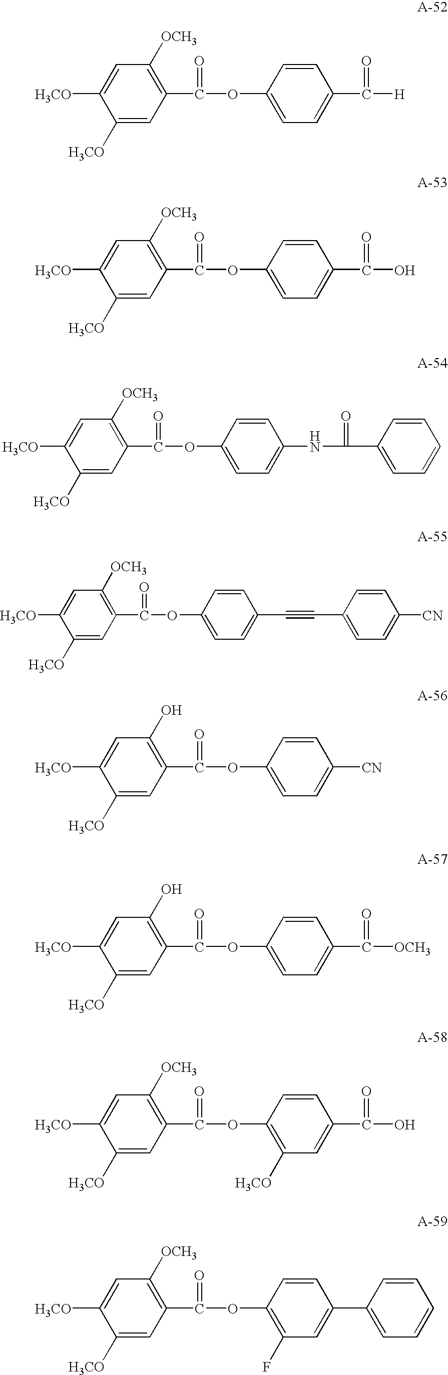

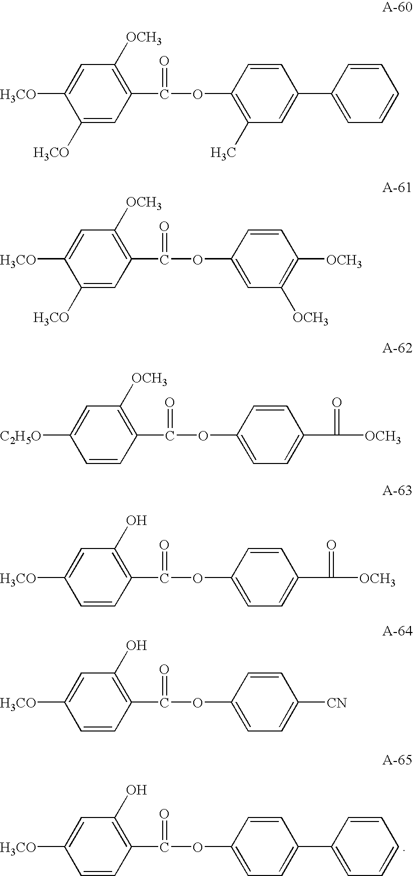

The compound expressed by Formula (12) can be synthesized by the general reaction to form an ester bond between a substituted benzoic acid and a phenol derivative, wherein any form of reaction can be used if only the reaction forms an ester bond. For example, it is possible to use the method for condensation with phenol-subsequent to functional conversion of the substituted benzoic acid into an acid halide. Further, it is also possible to use the method for dehydration and condensation of the substituted benzoic acid and phenol derivative utilizing a condensing agent or catalyst.

When the manufacturing process is taken into account, it is preferred to use the method for condensation with phenol subsequent to functional conversion of the substituted benzoic acid into an acid halide.

A hydrocarbon based solvent (preferably toluene and xylene), ether based solvent (preferably dimethyl ether, tetrahydrofuran, dioxane), ketone based solvent, ester based solvent, acetonitryl, dimethylformamide, and dimethyl acetoamide can be used as a reaction solvent. These solvents can be used independently or as a mixture. The preferable reaction solvents include toluene, acetonitryl, dimethylformamide and dimethylacetoamide.

The reaction temperature is preferably 0° C. through 150° C., more preferably 0° C. through 100° C., still more preferably 0° C. through 90° C., and particularly 20° C. through 90° C.

It is preferred in this reaction that a base is not used. However, when a base is used, either an organic or inorganic base can be employed. Of these, the organic base is preferably used, and is exemplified by pyridine and tertiary alkylamine (preferably triethylamine and ethyl diisopropylamine).

The following describes a specific method of synthesizing the compound, however, the present invention is not limited thereto:

### EXAMPLE OF SYNTHESIS 1

### Synthesis of Example Compound A-1

After heating 24.6 g (0.116 mol) of 3,4,5-trimethoxybenzoic acid, 100 ml of toluene and 1 ml of N—N-dimethylformamide to 60° C., 15.2 g (0.127 mol) of thionyl chloride was slowly added dropwise, and this mixture was heated at 60° C. for two hours. Then 15.1 g (0.127 mol) of 4-cyanophenol dissolved previously into 50 ml of acetonitryl was slowly added dropwise into this solution. After that, the solution was heated and stirred at 60° C. for 3 hours, and the reaction solution was cooled down to the room temperature. Then ethyl acetate and water were used to perform liquid separation, and sodium sulfate was used to remove water from the organic phase having been obtained. The solvent was distilled off under reduced pressure, and 100 ml of acetonitryl was added to the solid having been obtained, thereby recrystallizing the mixture. The acetonitryl solution was cooled down to the room temperature, and the crystal having been precipitated was recovered by filtration, whereby 11.0 g (yield 11%) of the target compound was obtained as a white crystal. In this case, the compound was identified by 1H-NMR (400 MHz) and mass spectrum.

1H-NMR (CDCl3) δ 3.50 (br, 9H), 7.37 (d, 2H), 7.45 (s, 2H), 7.77 (s, 2H),

Mass spectrum: m/z 314 (M+H)+,

The compound having been obtained has a melting point of 172° C. through 173° C.

### EXAMPLE OF SYNTHESIS 2

### Synthesis of Example Compound A-2

After heating 106.1 g (0.5 mol) of 2,4,5-trimethoxybenzoic acid, 340 ml of toluene and 1 ml of dimethylformamide to 60° C., 65.4 g (0.55 mol) of thionyl chloride was slowly added dropwise, and this mixture was heated for 2 hours at 65° C. through 70° C. Then 71.5 g (0.6 mol) of 4-cyanophenol previously dissolved into 150 ml of acetonitryl was slowly added dropwise into this solution. After that, the solution was heated and stirred at 80° C. through 85° C. for 2 hours, and the reaction solution was cooled down to the room temperature. Then ethyl acetate (1 L) and water were used to perform liquid separation, and sodium sulfate was used to remove water from the organic phase having been obtained. Approximately 500 ml of solvent was distilled off under reduced pressure, and 1 L of methanol was added to the solid having been obtained, thereby recrystallizing the mixture. The crystal having been precipitated was recovered by filtration, whereby 125.4 g (yield 80%) of the target compound was obtained as a white crystal. In this case, the compound was identified by 1H-NMR (400 MHz) and mass spectrum.

1H-NMR (CDCl3) δ 3.91 (s, 3H), 3.93 (s, 3H), 3.98 (s, 3H), 6.59 (s, 1H), 7.35 (d, 2H), 7.58 (s, 1H), 7.74 (d, 2H),

Mass spectrum: m/z 314 (M+H)+,

The compound having been obtained has a melting point of 116° C.

### EXAMPLE OF SYNTHESIS 3

### Synthesis of Example Compound A-3

After heating 10.1 g (47.5 mM) of 2,3,4-trimethoxybenzoic acid, 40 ml of toluene and 0.5 ml of dimethylformamide to 80° C., 6.22 g (52.3 mM) of thionyl chloride was slowly added dropwise, and this mixture was heated and stirred for 2 hours at 80° C. Then 6.2 g (52.3 mM) of 4-cyanophenol previously dissolved into 20 ml of acetonitryl was slowly added dropwise into this solution. After that, the solution was heated and stirred at 80° C. through 85° C. for 2 hours, and the reaction solution was cooled down to the room temperature. Then ethyl acetate and water were used to perform liquid separation, and sodium sulfate was used to remove water from the organic phase having been obtained. The solvent was distilled off under reduced pressure, and 50 ml of methanol was added, thereby recrystallizing the mixture. The crystal having been precipitated was recovered by filtration, whereby 11.9 g (yield 80%) of the target compound was obtained as a white crystal. In this case, the compound was identified by 1H-NMR (400 MHz) and mass spectrum.

1H-NMR (CDCl3): δ 3.50 (br, 9H), 7.37 (d, 2H), 7.45 (s, 2H), 7.77 (s, 2H),

Mass spectrum: m/z 314 (M+H)+,

The compound having been obtained has a melting point of 102° C. through 103° C.

### EXAMPLE OF SYNTHESIS 4

### Synthesis of Example Compound A-4

After heating 25.0 g (118 mM) of 2,4,6-trimethoxybenzoic acid, 100 ml of toluene and 1 ml of dimethylformamide to 60° C., 15.4 g (129 mM) of thionyl chloride was slowly added dropwise, and this mixture was heated and stirred for 2 hours at 60° C. Then 15.4 g (129 mM) of 4-cyanophenol previously dissolved into 50 ml of acetonitryl was slowly added dropwise into this solution. After that, the solution was heated and stirred at 80° C. through 85° C. for 4.5 hours, and the reaction solution was cooled down to the room temperature. Then ethyl acetate and water were used to perform liquid separation, and sodium sulfate was used to remove water from the organic phase having been obtained. The solvent was distilled off under reduced pressure, and 500 mL of methanol and 100 ml of acetonitryl were added, thereby recrystallizing the mixture. The crystal having been precipitated was recovered by filtration, whereby 10.0 g (yield 27%) of the target compound was obtained as a white crystal. In this case, the compound was identified by mass spectrum.

Mass spectrum: m/z 314 (M+H)+,

The compound having been obtained has a melting point of 172° C. through 173° C.

### EXAMPLE OF SYNTHESIS 5

### Synthesis of Example Compound A-5

After heating 15.0 g (82.3 mM) of 2,3-dimethoxybenzoic acid, 60 ml of toluene and 0.5 ml of dimethylformamide to 60° C., thionyl chloride 10.7 (90.5 mM) was slowly added dropwise, and this mixture was heated and stirred for 2 hours at 60° C. Then 10.8 g (90.5 mM) of 4-cyanophenol previously dissolved into 30 ml of acetonitryl was slowly added dropwise into this solution. After that, the solution was heated and stirred at 70° C. through 80° C. for 7 hours, and the reaction solution was cooled down to the room temperature. Then 90 ml of isopropyl alcohol was added, and the crystal having been precipitated was recovered by filtration, whereby 12.3 g (yield 53%) of the target compound was obtained as a white crystal. In this case, the compound was identified by mass spectrum.

Mass spectrum: m/z 284 (M+H)+,

The compound having been obtained has a melting point of 104° C.

### EXAMPLE OF SYNTHESIS 6

### Synthesis of Example Compound A-6

The compound A-6 was synthesized according to the same procedure as that in the Example of synthesis 5, except that 2,3-dimethoxybenzoic acid of the Example of synthesis 5 was replaced by 2,4-dimethoxybenzoic acid. The compound was identified by mass spectrum.

Mass spectrum: m/z 284 (M+H)+,

The compound having been obtained has a melting point of 134° C. through 136° C.

### EXAMPLE OF SYNTHESIS 7

### Synthesis of Example Compound A-7

After heating 25.0 g (137 mM) of 2,5-dimethoxybenzoic acid, 100 ml of toluene and 1.0 ml of dimethylformamide to 60° C., 18.0 (151 mM) of thionyl chloride was slowly added dropwise, and this mixture was heated and stirred for 2 hours at 60° C. Then 18.0 g (151 mM) of 4-cyanophenol previously dissolved in 50 ml of acetonitryl was slowly added dropwise into this solution. After that, the solution was heated and stirred at 70° C. through 80° C. for 7.5 hours, and the reaction solution was cooled down to the room temperature. Then ethyl acetate and saturated saline solution were used to perform liquid separation, and sodium sulfate was used to remove water from the organic phase having been obtained. The solvent was distilled off under reduced pressure, and silica gel column chromatography (hexane-ethyl acetate (9/1, V/V)) was used for purification, whereby 18.8 g (yield 48%) of the target compound was obtained as a white crystal. In this case, the compound was identified by mass spectrum.

Mass spectrum: m/z 284 (M+H)+,

The compound having been obtained has a melting point of 79° C. through 80° C.

### EXAMPLE OF SYNTHESIS 8

### Synthesis of Example Compound A-8

The compound A-8 was synthesized according to the same procedure as that in the Example of synthesis 5, except that 2,3-dimethoxybenzoic acid of the Example of synthesis 5 was replaced by 2,6-dimethoxybenzoic acid. The compound was identified by mass spectrum.

Mass spectrum: m/z 284 (M+H)+,

The compound having been obtained has a melting point of 130° C. through 131° C.

### EXAMPLE OF SYNTHESIS 9

### Synthesis of Example Compound A-11

The compound A-11 was synthesized according to the same procedure as that in the Example of synthesis 2, except that 71.5 g of 4-cyanophenol of the Example of synthesis 2 was replaced by 76.9 g of 4-chlorophenol. The compound was identified by 1H-NMR (400 MHz) and mass spectrum.

1H-NMR (CDCl3) δ 3.90 (s, 3H), 3.94 (s, 3H), 3.99 (s, 3H), 6.58 (s, 1H), 7.15 (d, 2H), 7.37 (d, 2H), 7.56 (s, 1H),

Mass spectrum: m/z 323 (M+H)+,

The compound having been obtained has a melting point of 127° C. through 129° C.

### EXAMPLE OF SYNTHESIS 10

### Synthesis of Example Compound A-12

After heating 45.0 g (212 mM) of 2,4,5-trimethoxybenzoic acid, 180 ml of toluene and 1.8 ml of dimethylformamide to 60° C., 27.8 g (233 mM) of thionyl chloride was slowly added dropwise, and this mixture was heated and stirred for 2.5 hours at 60° C. Then 35.4 g (233 mM) of methyl 4-hydroxybenzoate previously dissolved in 27 ml of dimethylformamide was slowly added dropwise into this solution. After that, the solution was heated and stirred at 80° C. for 3 hours, and the reaction solution was cooled down to the room temperature. Then 270 ml of methanol was added, and the crystal having been precipitated was recovered by filtration, whereby 64.5 g (yield 88%) of the target compound was obtained as a white crystal. In this case, the compound was identified by 1H-NMR (400 MHz) and mass spectrum.

1H-NMR (CDCl3) δ 3.95 (m, 9H), 3.99 (s, 3H), 6.57 (s, 1H), 7.28 (d, 2H), 7.57 (s, 1H) 8.11 (d, 2H),

Mass spectrum: m/z 347 (M+H)+,

The compound having been obtained has a melting point of 121° C. through 123° C.

### EXAMPLE OF SYNTHESIS 11

### Synthesis of Example Compound A-13

After heating 20.0 g (94.3 mM) of 2,4,5-trimethoxybenzoic acid, 100 ml of toluene and 1 ml of dimethylformamide to 60° C., 12.3 g (104 mM) of thionyl chloride was slowly added dropwise, and this mixture was heated and stirred for 3.5 hours at 60° C. Then 17.7 g (104 mM) of 4-phenyl phenol previously dissolved in 150 ml of toluene was slowly added dropwise into this solution. After that, the solution was heated and stirred at 80° C. for 3 hours, and the reaction solution was cooled down to the room temperature. Then 250 ml of methanol was added, and the crystal having been precipitated was recovered by filtration, whereby 21.2 g (yield 62%) of the target compound was obtained as a white crystal. In this case, the compound was identified by 1H-NMR (400 MHz) and mass spectrum.

1H-NMR (CDCl3) δ 3.93 (s, 3H), 3.96 (s, 3H), 3.99 (s, 3H), 6.59 (s, 1H), 7.26-7.75 (m, 10H),

Mass spectrum: m/z 365 (M+H)+,

The compound having been obtained has a melting point of 131° C. through 132° C.

### EXAMPLE OF SYNTHESIS 12

### Synthesis of Example Compound A-14

After heating 12.9 g (61 mM) of 2,4,5-trimethoxybenzoic acid, 50 ml of toluene and 0.6 ml of dimethylformamide to 60° C., 8.0 g (67 mM) of thionyl chloride was slowly added dropwise, and this mixture was heated and stirred for 3.5 hours at 60° C. Then 17.7 g (104 mM) of 4-phenoxyphenol previously dissolved in 25 ml of acetonitryl was slowly added dropwise into this solution. After that, the solution was heated and stirred at 80° C. for 3 hours, and the reaction solution was cooled down to the room temperature. Then 100 ml of methanol was added, and the crystal having been precipitated was recovered by filtration, whereby 21.6 g (yield 93%) of the target compound was obtained as a white crystal. In this case, the compound was identified by mass spectrum.

Mass spectrum: m/z 381 (M+H)+,

The compound having been obtained has a melting point of 91° C. through 92° C.

### EXAMPLE OF SYNTHESIS 13

### Synthesis of Example Compound A-15

The compound A-15 was synthesized according to the same procedure as that in the Example of synthesis 2, except that 71.5 g of 4-cyanophenol of the Example of synthesis 2 was replaced by 56.4 g of phenol. The compound was identified by 1H-NMR (400 MHz) and mass spectrum.

1H-NMR (CDCl3) δ 3.91 (s, 3H), 3.93 (s, 3H), 3.99 (s, 3H), 6.58 (s, 1H), 7.19-7.27 (m, 3H), 7.42 (m, 2H), 7.58 (s, 1H)

Mass spectrum: m/z 289 (M+H)+,

The compound having been obtained has a melting point of 105° C. through 108° C.

### EXAMPLE OF SYNTHESIS 14

### Synthesis of Example Compound A-16

The compound A-16 was synthesized according to the same procedure as that in the Example of synthesis 2, except that 71.5 g of 4-cyanophenol of the Example of synthesis 2 was replaced by 74.4 g of 4-methoxy phenol. In this case, the compound was identified by 1H-NMR (400 MHz) and mass spectrum.

1H-NMR (CDCl3) δ 3.84 (s, 3H), 3.92 (s, 3H), 3.93 (s, 3H), 3.99 (s, 3H), 6.58 (s, 1H), 6.92 (d, 2H), 7.12 (d, 2H), 7.42 (m, 2H), 7.58 (s, 1H),

Mass spectrum: m/z 319 (M+H)+,

The compound having been obtained has a melting point of 102° C. through 103° C.

### EXAMPLE OF SYNTHESIS 15

### Synthesis of Example Compound A-17

The compound A-17 was synthesized according to the same procedure as that in the Example of synthesis 2, except that 71.5 g of 4-cyanophenol of the Example of synthesis 2 was replaced by 73.3 g of 4-ethyl phenol. The compound was identified by 1H-NMR (400 MHz) and mass spectrum.

Mass spectrum: m/z 317 (M+H)+,

The compound having been obtained has a melting point of 70° C. through 71° C.

### EXAMPLE OF SYNTHESIS 16

### Synthesis of Example Compound A-24

After heating 27.3 g (164 mM) of 4-ethoxybenzoic acid, 108 ml of toluene and 1 ml of dimethylformamide to 60° C., 21.5 g (181 mM) of thionyl chloride was slowly added dropwise, and this mixture was heated and stirred for 2 hours at 60° C. Then 25.0 g (181 mM) of 4-ethoxy phenol previously dissolved into 50 ml of acetonitryl was slowly added dropwise into this solution. After that, the solution was heated and stirred at 80° C. for 4 hours, and the reaction solution was cooled down to the room temperature. Then 100 ml of methanol was added, and the crystal having been precipitated was recovered by filtration, whereby 30.6 g (yield 65%) of the target compound was obtained as a white crystal. In this case, the compound was identified by 1H-NMR (400 MHz) and mass spectrum.

1H-NMR (CDCl3) δ 1.48-1.59 (m, 6H), 4.05 (q, 2H), 4.10 (q, 2H), 6.89-7.00 (m, 4H), 7.10 (d, 2H), 8.12 (d, 2H),

Mass spectrum: m/z 287 (M+H)+,

The compound having been obtained has a melting point of 113° C. through 114° C.

### EXAMPLE OF SYNTHESIS 17

### Synthesis of Example Compound A-25

After heating 24.7 g (149 mM) of 4-ethoxybenzoic acid, 100 ml of toluene and 1 ml of dimethylformamide to 60° C., 19.5 g (164 mM) of thionyl chloride was slowly added dropwise, and this mixture was heated and stirred for 2 hours at 60° C. Then 25.0 g (165 mM) 4-propoxy phenol previously dissolved into 50 ml of acetonitryl was slowly added dropwise into this solution. After that, the solution was heated and stirred at 80° C. for 4 hours, and the reaction solution was cooled down to the room temperature. Then 100 ml of methanol was added, and the crystal having been precipitated was recovered by filtration. 100 ml of acetonitryl was added to the solid having been obtained, thereby recrystallizing the mixture. The crystal having been obtained was recovered by filtration, whereby 33.9 g (yield 76%) of the target compound was obtained as a white crystal. In this case, the compound was identified by 1H-NMR (400 MHz) and mass spectrum.

1H-NMR (CDCl3) δ 1.04 (t, 3H), 1.45 (t, 3H), 1.82 (q, 2H), 3.93 (q, 2H), 4.04 (q, 2H), 6.89-7.00 (m, 4H), 7.10 (d, 2H), 8.12 (d, 2H), mass spectrum: m/z 301 (M+H)+,

The compound having been obtained has a melting point of 107° C.

### EXAMPLE OF SYNTHESIS 18

### Synthesis of Example Compound A-27

The compound A-27 was synthesized according to the same procedure as that in the Example of synthesis 16 (Synthesis of A-24), except that 27.3 g of 4-ethoxybenzoic acid of the Example of synthesis 1 was replaced by 29.5 g of 4-propoxybenzoic acid. In this case, the compound was identified by mass spectrum.

Mass spectrum: m/z 301 (M+H)+,

The compound having been obtained has a melting point of 88° C. through 89° C.

### EXAMPLE OF SYNTHESIS 19

### Synthesis of Example Compound A-28

The compound A-28 was synthesized according to the same procedure as that in the Example of synthesis 17 (Synthesis of A-25), except that 24.7 g of 4-ethoxybenzoic acid of the Example of synthesis 1 was replaced by 26.8 g of 4-propoxybenzoic acid. In this case, the compound was identified by mass spectrum.

Mass spectrum: m/z 315 (M+H)+,

The compound having been obtained has a melting point of 92° C.

### EXAMPLE OF SYNTHESIS 20

### Synthesis of Example Compound A-40

After heating 20.0 g (109 mM) of 2,4-dimethoxybenzoic acid, 80 ml of toluene and 0.8 ml of dimethylformamide to 60° C., 14.4 g (121 mM) of thionyl chloride was slowly added dropwise, and this mixture was heated and stirred for 3.5 hours at 60° C. Then 20.5 g (121 mM) of 4-phenyl phenol previously dissolved into 50 ml of dimethylformamide was slowly added dropwise into this solution. After that, the solution was heated and stirred at 80° C. for 6 hours, and the reaction solution was cooled down to the room temperature. Then 100 ml of methanol was added, and the crystal having been precipitated was recovered by filtration, whereby 31.7 g (yield 86%) of the target compound was obtained as a white crystal. In this case, the compound was identified by mass spectrum.

Mass spectrum: m/z 335 (M+H)+,

The compound having been obtained has a melting point of 161° C. through 162° C.

### EXAMPLE OF SYNTHESIS 21

### Synthesis of Example Compound A-42

After heating 30.0 g (165 mM) of 2,4-dimethoxybenzoic acid, 120 ml of toluene and 1.2 ml of dimethylformamide to 60° C., 21.6 g (181 mM) of thionyl chloride was slowly added dropwise, and this mixture was heated and stirred for 2 hours at 60° C. Then 27.6 g (181 mM) of methyl 4-hydroxybenzoate previously dissolved into 40 ml of dimethylformamide was slowly added dropwise into this solution. After that, the solution was heated and stirred at 80° C. for 6 hours, and the reaction solution was cooled down to the room temperature. Then 140 ml of methanol was added, and the crystal having been precipitated was recovered by filtration, whereby 24.4 g (yield 47%) of the target compound was obtained as a white crystal. In this case, the compound was identified by 1H-NMR (400 MHz) and mass spectrum.

Mass spectrum: m/z 317 (M+H)+,

The compound having been obtained has a melting point of 122° C. through 123° C.

### EXAMPLE OF SYNTHESIS 22

### Synthesis of Example Compound A-51

20.7 g (50 mM) of 2,4,5-trimethoxybenzoic acid 4-iodophenyl, 5.61 g (55 mM) of ethynyl benzene, 27.8 ml (200 mM) of triethylamine and 40 ml of tetrahydrofuran was stirred in an atmosphere of nitrogen at the room temperature, and 114 mg (0.6 mM) of cuprous chloride, 655 mg (2.5 mM) of triphenyl phosphine and 351 mg (0.5 mM) of bis(triphenyl phosphine) palladium dichloride were added to this mixture. The mixture was heated and stirred at 60° C. for 6 hours. After that, the reaction solution was cooled down to the room temperature, and 400 ml of water was added. The crystal having been obtained was filtered, and 160 ml of methanol 160 ml was added for recrystallization, whereby 17.2 g (yield 89%) of the target compound was obtained as a yellowish white crystal.

In this case, the compound was identified by 1H-NMR (400 MHz) and mass spectrum.

1H-NMR (CDCl3) δ 3.92 (s, 3H), 3.95 (s, 3H) 4.00 (s, 3H) 6.58 (s, 1H), 7.22 (m, 2H), 7.32 (m, 3H), 7.53-7.62 (m, 5H),

Mass spectrum: m/z 389 (M+H)+,

The compound having been obtained has a melting point of 129° C. through 130° C.

### EXAMPLE OF SYNTHESIS 23

### Synthesis of Example Compound A-52

After heating 42.4 g (0.2 mol) of 2,4,5-trimethoxybenzoic acid, 26.8 g (0.22 mol) of 4-hydroxybenzaldehyde, 170 ml of toluene and 1.7 ml of N,N-dimethylformamide to 80° C., 26.0 g (0.22 mol) of thionyl-chloride was slowly added dropwise. The mixture was heated at 80° C. for 6 hours, and the reaction solution was cooled-down to the room temperature. After that, ethyl acetate, water and saturated saline solution were added for liquid separation. Water was removed from the organic phase having been obtained by sodium sulfate. After that, the solvent was distilled off under reduced pressure. 240 ml of isopropyl alcohol was added to the solid having been obtained, thereby recrystallizing the mixture. The solution was cooled down to the room temperature and the crystal having been obtained was recovered by filtration, whereby 40.8 g (yield 65%) of the target compound was obtained as a white crystal. In this case, the compound was identified by 1H-NMR (400 MHz) and mass spectrum.

1H-NMR (CDCl3) δ 3.92 (s, 3H), 3.95 (s, 3H) 4.00 (s, 3H), 6.58 (s, 1H), 7.34 (d, 2H), 7.59 (s, 1H), 8.17 (d, 2H),

Mass spectrum: m/z 317 (M+H)+,

The compound having been obtained has a melting point of 103° C. through 105° C.

### EXAMPLE OF SYNTHESIS 24

### Synthesis of Example Compound A-53

After adding 3.93 g (25.2 mM) of sodium dihydrogen phosphate dissolved in 5 ml of water was added dropwise into 40 g (126 mM) of 2,4,5-trimethoxybenzoic acid 4-formyl phenyl and 400 ml of acetonitryl, 18.3 g of 35% hydrogen peroxide solution was added to the mixture dropwise for 20 minutes. This was followed by the step of adding 14.1 g (126 mM) of 80% sodium chlorite (by Wako Junyaku Co. Ltd.) dissolved in 43 ml of water for 20 minutes, and stirring the mixture for 4.5 hours at the room temperature. After that, 100 ml of water was added and the mixture was cooled down to 10° C. The crystal having been obtained was filtered out and was recrystallized by addition of 500 ml of methanol, whereby 25.4 g (yield 60%) of the target compound was obtained as a white crystal.

The compound was identified by 1H-NMR (400 MHz) and mass spectrum.

1H-NMR (CDCl3) δ 3.92 (s, 3H), 3.95 (s, 3H) 4.00 (s, 3H), 6.59 (s, 1H), 7.40 (d, 2H), 7.57 (s, 1H), 7.96 (d, 2H), 10.0 (s, 1H),

Mass spectrum: m/z 333 (M+H)+,

The compound having been obtained has a melting point of 188° C. through 189° C.

### EXAMPLE OF SYNTHESIS 25

### Synthesis of Example Compound A-54

After heating 5.00 g (23.5 mM) of 2,4,5-trimethoxybenzoic acid, 5.52 g (23.5 mM) of benzoic acid (4-hydroxy) anilide, 50 ml of acetonitryl and 1.0 ml of N,N-dimethylformamide to 70° C., 3.4 g (28.5 mM) of thionyl chloride was slowly added, and the mixture was heated at 70° C. for 3 hours. The reaction solution was cooled down to the room temperature, and 50 ml of methanol was added thereafter. The crystal having been precipitated was recovered by filtration, whereby 8.1 g (yield 84%) of the target compound was obtained as a white crystal. In this case, the compound was identified by 1H-NMR (400 MHz) and mass spectrum.

1H-NMR (CDCl3) δ 3.92 (s, 3H), 3.95 (s, 3H) 4.00 (s, 3H), 6.60 (s, 1H), 7.12-8.10 (m, 10H),

Mass spectrum: m/z 408 (M+H)+,

The compound having been obtained has a melting point of 189° C. through 190° C.

### EXAMPLE OF SYNTHESIS 26

### Synthesis of Example Compound A-56

After heating 8.50 g (42.8 mM) of 2-hydroxy-4,5-dimethoxybenzoic acid, 5.62 g (42.8 mM) of 4-cyanophenol, 45 ml of toluene and 0.5 ml of N,N-dimethylformamide to 70° C., 5.6 g (47.1 mM) of thionyl chloride was slowly added dropwise, and this mixture was heated and stirred for 3 hours at 80° C. The reaction solution was cooled down to the room temperature. Then 50 ml of methanol was added, and the crystal having been precipitated was recovered by filtration, whereby 5.8 g (yield 45%) of the target compound was obtained as a white crystal. In this case, the compound was identified by 1H-NMR (400 MHz).

1H-NMR (CDCl3) δ 3.92 (s, 3H), 3.97 (s, 3H), 6.67 (s, 1H), 7.38 (m, 3H), 7.77 (d, 2H), 10.28 (s, 1H),

Mass spectrum: m/z 333 (M+H)+,

The compound having been obtained has a melting point of 145° C. through 146° C.

### EXAMPLE OF SYNTHESIS 27

### Synthesis of Example Compound A-57

After heating 8.50 g (42.8 mM) of 2-hydroxy-4,5-dimethoxybenzoic acid, 7.17 g (42.8 mM) of methyl 4-hydroxybenzoate, 45 ml of toluene and 0.5 ml of N,N-dimethylformamide to 70° C., 6.1 g (51.2 mM) of thionyl chloride was slowly added dropwise, and this mixture was heated and stirred for 3 hours at 80° C. Then the reaction solution was cooled down to the room temperature. Thus, 50 ml of methanol was added, and the crystal having been precipitated was recovered by filtration, whereby 6.9 g (yield 49%) of the target compound was obtained as a white crystal. In this case, the compound was identified by 1H-NMR (400 MHz).

1H-NMR (CDCl3) δ 3.92 (s, 3H), 3.97 (s, 6H), 6.55 (s, 1H), 7.31 (d, 2H), 7.41 (s, 1H), 8.16 (d, 2H), 10.41 (s, 1H),

Mass spectrum: m/z 333 (M+H)+,

The compound having been obtained has a melting point of 128° C.

### EXAMPLE OF SYNTHESIS 28

### Synthesis of Example Compound A-58

The compound A-58 was synthesized according to the same procedure as that in the Example of synthesis 2, except that dicyanophenol of the Example of synthesis 2 was replaced by vanillic acid. The compound having been obtained has a melting point of 201° C. through 203° C.

### EXAMPLE OF SYNTHESIS 29

### Synthesis of Example Compound A-62

The compound A-62 was synthesized according to the same procedure as that in the Example of synthesis 10, except that 2,4,5-trimethoxybenzoic acid of the Example of synthesis 10 was replaced by 4-ethoxy-2-methoxybenzoic acid. The compound having been obtained has a melting point of 88° C. through 89° C.

### EXAMPLE OF SYNTHESIS 30

### Synthesis of Example Compound A-63

The compound A-63 was synthesized according to the same procedure as that in the Example of synthesis 10, except that 2,4,5-trimethoxybenzoic acid of the Example of synthesis 10 was replaced by 4-hydroxy-2-methoxybenzoic acid. The compound having been obtained has a melting point of 108° C. through 113° C.

### EXAMPLE OF SYNTHESIS 31

### Synthesis of Example Compound A-65

The compound A-65 was synthesized according to the same procedure as that in the Example of synthesis 2, except that 2,4-dimethoxybenzoic acid of the Example of synthesis 2 was replaced by 4-hydroxy-2-methoxybenzoic acid. The compound having been obtained has a melting point of 142° C. through 144° C.

0.1 through 20 percent by mass of at least one of the compounds expressed by the Formulae (12), (13), (13-A) through (13-E) and (14) is preferably added to cellulose, wherein the amount of the aforementioned compound is more preferably 0.5 through 16 percent by mass, still more preferably 1 through 12 percent by mass, particularly 2 through 8 percent by mass, most preferably 3 through 7 percent by mass.

As a disc-shaped compound relating to the present invention, a compound having a 1,3,5-triazine ring can be preferably employed.

Among compounds having the 1,3,5-triazine ring, compounds represented by the following Formula (12) are preferable.

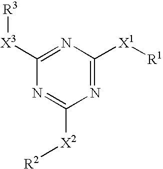

In Formula (12), X¹ is a single bond, an —NR₄— group, an —O— atom or an —S— atom; X² is a single bond, an —NR₅— group, an —O— atom or an —S— atom; X³ is a single bond, an —NR₆— group, an —O— atom or an —S— atom; R¹, R² and R³ are each an alkyl group, an alkenyl group, an aryl group or a heterocyclic group; and R₄, R₅ and R₆ are each a hydrogen atom, an alkyl group, an alkenyl group, an aryl group or a heterocyclic group. The compound represented by Formula (12) is particularly preferably a melamine compound.

In the melamine compound of Formula (12), it is preferable that the X¹, X² and X³ are each the —NR₄—, —NR₅— and —NR₆—, respectively, or the X¹, X² and X³ are each a single bond and the R¹, R² and R³ are each a heterocyclic group having a free valency at the nitrogen atom thereof. The —X¹—R¹, —X²—R² and —X³—R³ are preferably the same substituting group. The R¹, R² and R³ are particularly preferably an aryl group. The R₄, R₅ and R₆ are each particularly preferably a hydrogen atom.

The above alkyl group is more preferably a chain alkyl group than a cyclic alkyl group. A straight-chain alkyl group is more preferably to a branched-chain alkyl group.

The number of carbon atom of the alkyl group is preferably 1-30, more preferably 1-20, further preferably 1-10, further more preferably 1-8, and most preferably 1-6. The alkyl group may have a substituent.

Concrete examples of the substituent include a halogen atom, an alkoxy group such as a methoxy group, an ethoxy group and an epoxyethyloxy group, and a acyloxy group such as an acryloyl group and a methacryloyl group. The alkenyl group is more preferably a chain alkenyl group than a cyclic alkenyl group. A straight-chain alkenyl group is preferably to a branched-chain alkenyl group. The number of carbon atom of the alkenyl group is preferably 2-30, more preferably 2-20, further preferably 2-10, further more preferably 2-8, and most preferably 2-6. The alkyl group may have a substituent.

Concrete examples of the substituent include a halogen atom, an alkoxy group such as a methoxy group, an ethoxy group and an epoxyethyloxy group, and an acyloxy group such as an acryloyl group and a methacryloyl group.

The aryl group is preferably a phenyl group or a naphthyl group, and the phenyl group is particularly preferable. The aryl group may have a substituent.

Concrete examples of the substituent include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamido group, a carbamoyl group, an alkyl-substituted carbamoyl group, an alkenyl-substituted carbamoyl group, an aryl-substituted carbamoyl group, an amido group, an alkylthio group, an alkenylthio group, an arylthio group and an acyl group. The above alkyl group is the same as the foregoing alkyl group.

The alkyl moiety of the alkoxyl group, acyloxy group, alkoxycarbonyl group, alkyl-substituted sulfamoyl group, sulfonamido group, alkyl-substituted carbamoyl group, amido group, alkylthio group and acyl group is the same as the foregoing alkyl group.

The above alkenyl group is the same as the forgoing alkenyl group.

The alkenyl moiety of the alkenyloxy group, acyloxy group, alkenyloxycarbonyl group, alkenyl-substituted sulfamoyl group, sulfonamido group, alkenyl-substituted carbamoyl group, amido group, alkenylthio group and acyl group is the same as the foregoing alkenyl group.

Concrete examples of the aryl group include a phenyl group, an α-naphthyl group, a β-naphthyl group, a 4-methoxyphenyl group, a 3,4-diethoxyphenyl group, a 4-octyloxyphenyl group and a 4-dodecyloxyphenyl group.

The aryl moiety of the aryloxy group, acyloxy group, aryloxycarbonyl group, aryl-substituted sulfamoyl group, sulfonamido group, arylsubstituted carbamoyl group, amido group, arylthio group and acyl group is the same as the foregoing aryl group.

The heterocyclic group is preferably has aromaticity, when the X, X² and X³ are an —NR— group, an —O— atom or an —S— group.

The heterocycle in the heterocyclic group having aromaticity is usually an unsaturated heterocycle, preferably a heterocycle having highest number of double bond. The heterocycle is preferably a 5-, 6- or 7-member ring, more preferably the 5- or 6-member ring and most preferably the 6-member ring.

The heteroatom in the heterocycle is preferably a nitrogen atom, a sulfur atom or an oxygen atom, and the nitrogen atom is particularly preferable.

As the heterocycle having aromaticity, a pyridine ring such as a 2-pyridyl group and a 4-pyridyl group is particularly preferable. The heterocyclic group may have a substituent. Examples of the substituent are the same as the substituent of the foregoing aryl moiety.

When X¹, X² and X³ are each the single bond, the heterocyclic group preferably has a free valency at the nitrogen atom. The heterocyclic group having the free valency at the nitrogen atom is preferably 5-, 6- or 7-member ring, more preferably the 5- or 6-member ring, and most preferably the 5-member ring. The heterocyclic group may have plural nitrogen atoms.

The heterocyclic group may have a hetero-atom (such as an oxygen atom and a sulfur atom) other than the nitrogen atom. The heterocyclic group may have a substituent. Concrete examples of the heterocyclic group are the same as those of the aryl moiety.

Examples of the heterocyclic group having the free valency at the nitrogen atom are listed below.

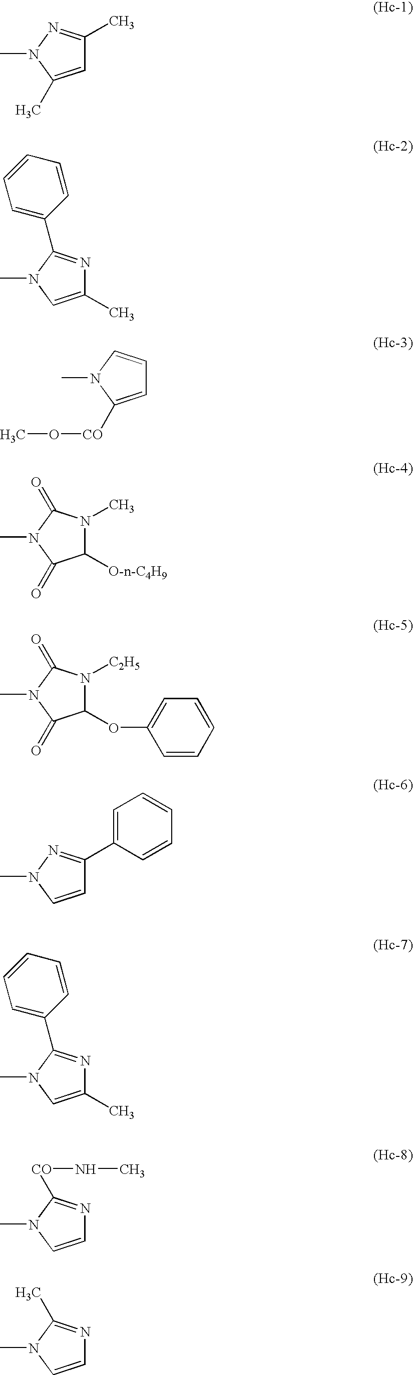

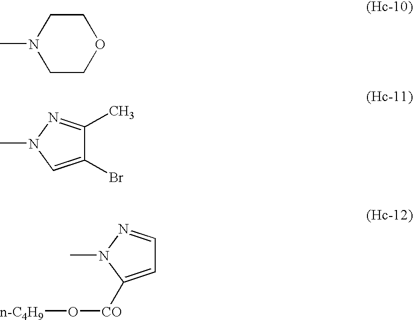

The molecular weight of the compound having a 1,3,5-triazine ring is preferably 300-2,000. The boiling point of these compounds is preferably not less than 260° C. The boiling point can be measured by a measuring apparatus available on the market such as TG/DTA100, manufactured by Seiko Denshi Kogyo Co., Ltd.

Concrete examples of the compound having the 1,3,5-triazine ring are shown below.

In the following, plural Rs each represent the same group.

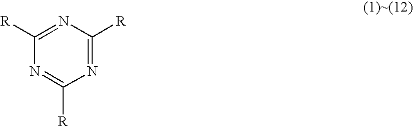

### (1) Butyl

(2) 2-methoxy-2-ethoxyethyl

### (3) 5-Undecenyl

### (4) Phenyl

(5) 4-ethoxycarbonylphenyl
(6) 4-butoxyphenyl
(7) p-biphenylyl
(8) 4-pyridyl
(9) 2-naphthyl
(10) 2-methylphenyl
(11) 3,4-dimethoxyphenyl
(12) 2-furyl

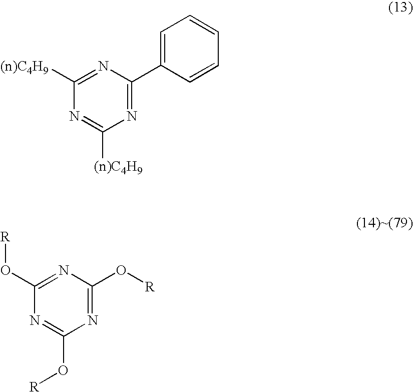

(14) phenyl
(15) 3-ethoxycarbonylphenyl
(16) 3-butoxyphenyl
(17) m-biphenyryl
(18) 3-phenylthiophenyl
(19) 3-chlorophenyl
(20) 3-benzoylphenyl
(21) 3-acetoxyphenyl
(22) 3-benzoyloxyphenyl
(23) 3-phenoxycarbonylphenol
(24) 3-methoxyphenyl
(25) 3-anilinophenyl
(26) 3-isobutyrylaminophenyl
(27) 3-phenoxycarbonylaminophenyl
(28) 3-(3-ethylureido)phenyl
(29) 3-(3,3-diethylureido)phenyl
(30) 3-methylphenyl
(31) 3-phenoxyphenyl
(32) 3-hydroxyphenyl
(33) 4-ethoxycarbonylphenyl
(34) 4-butoxyphenyl
(35) p-biphenyryl
(36) 4-phenylthiophenyl
(37) 4-chlorophenyl
(38) 4-benzoylphenyl
(39) 4-actoxyphenyl
(40) 4-benzoyloxyphenyl
(41) 4-phenoxycarbonylphenyl
(42) 4-methoxyphenyl
(43) 4-anilinophenyl
(44) 4-isobutyrylaminophenyl
(45) 4-phenoxycarbonylaminophenyl
(46) 4-(3-ethylureido)phenyl
(47) 4-(3,3-diethylureido)phenyl
(48) 4-methylphenyl
(49) 4-phenoxyphenyl
(50) 4-hydroxyphenyl
(51) 3,4-diethoxycarbonylphenyl
(52) 3,4-dibutoxyphenyl
(53) 3,4-diphenylphenyl
(54) 3,4-diphenylthiophenyl
(55) 3,4-dichlorophenyl
(56) 3,4-dibenzoylphenyl
(57) 3,4-diactoxyphenyl
(58) 3,4-dibenzoyloxyphenyl
(59) 3,4-diphenoxycarbonylphenyl
(60) 3,4-dimethoxyphenyl
(61) 3,4-dianilinophenyl
(62) 3,4-dimethylphenyl
(63) 3,4-diphenoxyphenyl
(64) 3,4-dihydroxyphenyl
(65) 2-naphthyl
(66) 3,4,5-triethoxycarbonylphenyl
(67) 3,4,5-tributoxyphenyl
(68) 3,4,5-triphenylphenyl
(69) 3,4,5-triphenylthiophenyl
(70) 3,4,5-trichlorophenyl
(71) 3,4,5-tribenzoylphenyl
(72) 3,4,5-triacetoxyphenyl
(73) 3,4,5-tribenzoyloxyphenyl
(74) 3,4,5-triphenoxycarbonylphenyl
(75) 3,4,5-trimethoxyphenyl
(76) 3,4,5-trianilinophenyl
(77) 3,4,5-trimethylphenyl
(78) 3,4,5-triphenoxyphenyl
(79) 3,4,5-trihydroxyphenyl

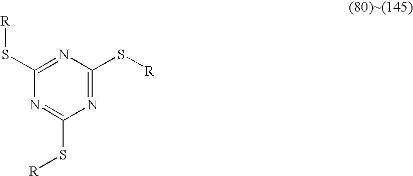

(80) phenyl
(81) 3-ethoxycarbonylphenyl
(82) 3-butoxyphenyl
(83) m-biphenyryl
(84) 3-phenylthiophenyl
(85) 3-chlorophenyl
(86) 3-benzoylphenyl
(87) 3-acetoxyphenyl
(88) 3-benzoyloxyphenyl
(89) 3-phenoxycarbonylphenol
(90) 3-methoxyphenyl
(91) 3-anilinophenyl
(92) 3-isobutyrylaminophenyl
(93) 3-phenoxycarbonylaminophenyl
(94) 3-(3-ethylureido)phenyl
(95) 3-(3,3-diethylureido)phenyl
(96) 3-methylphenyl
(97) 3-phenoxyphenyl
(98) 3-hydroxyphenyl
(99) 4-ethoxycarbonylphenyl
(100) 4-butoxyphenyl
(101) p-biphenyryl
(102) 4-phenylthiophenyl
(103) 4-chlorophenyl
(104) 4-benzoylphenyl
(105) 4-actoxyphenyl
(106) 4-benzoyloxyphenyl
(107) 4-phenoxycarbonylphenyl
(108) 4-methoxyphenyl
(109) 4-anilinophenyl
(110) 4-isobutyrylaminophenyl
(111) 4-phenoxycarbonylaminophenyl
(112) 4-(3-ethylureido)phenyl
(113) 4-(3,3-diethylureido)phenyl
(114) 4-methylphenyl
(115) 4-phenoxyphenyl
(116) 4-hydroxyphenyl
(117) 3,4-diethoxycarbonylphenyl
(118) 3,4-dibutoxyphenyl
(119) 3,4-diphenylphenyl
(120) 3,4-diphenylthiophenyl
(121) 3,4-dichlorophenyl
(122) 3,4-dibenzoylphenyl
(123) 3,4-diactoxyphenyl
(124) 3,4-dibenzoyloxyphenyl
(125) 3,4-diphenoxycarbonylphenyl
(126) 3,4-dimethoxyphenyl
(127) 3,4-dianilinophenyl
(128) 3,4-dimethylphenyl
(129) 3,4-diphenoxyphenyl
(130) 3,4-dihydroxyphenyl
(131) 2-naphthyl
(132) 3,4,5-triethoxycarbonylphenyl
(133) 3,4,5-tributoxyphenyl
(134) 3,4,5-triphenylphenyl
(135) 3,4,5-triphenylthiophenyl
(136) 3,4,5-trichlorophenyl
(137) 3,4,5-tribenzoylphenyl
(138) 3,4,5-triacetoxyphenyl
(139) 3,4,5-tribenzoyloxyphenyl
(140) 3,4,5-triphenoxycarbonylphenyl
(141) 3,4,5-trimethoxyphenyl
(142) 3,4,5-trianilinophenyl
(143) 3,4,5-trimethylphenyl
(144) 3,4,5-triphenoxyphenyl
(145) 3,4,5-trihydroxyphenyl

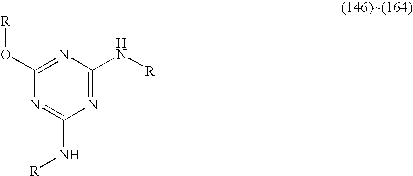

(146) phenyl
(147) 4-ethoxycarbonylphenyl
(148) 4-butoxyphenyl
(149) p-biphenyryl
(150) 4-phenylthiophenyl
(151) 4-chlorophenyl
(152) 4-benzoylphenyl
(153) 4-acetoxyphenyl
(154) 4-benzoyloxyphenyl
(155) 4-phenoxycarbonylphenol
(156) 4-methoxyphenyl
(157) 4-anilinophenyl
(158) 4-isobutyrylaminophenyl
(159) 4-phenoxycarbonylaminophenyl
(160) 4-(3-ethylureido)phenyl
(161) 4-(3,3-diethylureido)phenyl
(162) 4-methylphenyl
(163) 4-phenoxyphenyl
(164) 4-hydroxyphenyl

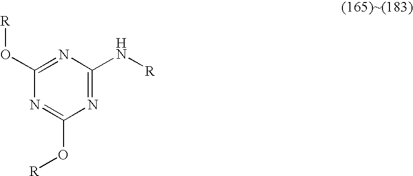

(165) phenyl
(166) 4-ethoxycarbonylphenyl
(167) 4-butoxyphenyl
(168) p-biphenyryl
(169) 4-phenylthiophenyl
(170) 4-chlorophenyl
(171) 4-benzoylphenyl
(172) 4-acetoxyphenyl
(173) 4-benzoyloxyphenyl
(174) 4-phenoxycarbonylphenol
(175) 4-methoxyphenyl
(176) 4-anilinophenyl
(177) 4-isobutyrylaminophenyl
(178) 4-phenoxycarbonylaminophenyl
(179) 4-(3-ethylureido)phenyl
(180) 4-(3,3-diethylureido)phenyl
(181) 4-methylphenyl
(182) 4-phenoxyphenyl
(183) 4-hydroxyphenyl.

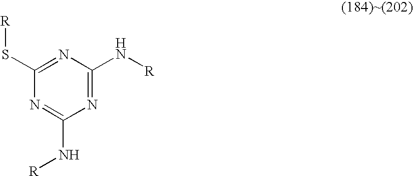

(184) phenyl
(185) 4-ethoxycarbonylphenyl
(186) 4-butoxyphenyl
(187) p-biphenyryl
(188) 4-phenylthiophenyl
(189) 4-chlorophenyl
(190) 4-benzoylphenyl
(191) 4-acetoxyphenyl
(192) 4-benzoyloxyphenyl
(193) 4-phenoxycarbonylphenol
(194) 4-methoxyphenyl
(195) 4-anilinophenyl
(196) 4-isobutyrylaminophenyl
(197) 4-phenoxycarbonylaminophenyl
(198) 4-(3-ethylureido)phenyl
(199) 4-(3,3-diethylureido)phenyl
(200) 4-methylphenyl
(201) 4-phenoxyphenyl
(202) 4-hydroxyphenyl

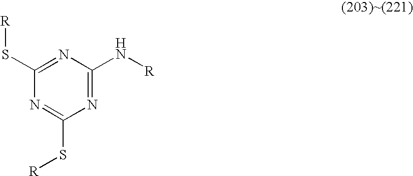

(203) phenyl
(204) 4-ethoxycarbonylphenyl
(205) 4-butoxyphenyl
(206) p-biphenyryl
(207) 4-phenylthiophenyl
(208) 4-chlorophenyl
(209) 4-benzoylphenyl
(210) 4-acetoxyphenyl
(211) 4-benzoyloxyphenyl
(212) 4-phenoxycarbonylphenol
(213) 4-methoxyphenyl
(214) 4-anilinophenyl
(215) 4-isobutyrylaminophenyl
(216) 4-phenoxycarbonylaminophenyl
(217) 4-(3-ethylureido)phenyl
(218) 4-(3,3-diethylureido)phenyl
(219) 4-methylphenyl
(220) 4-phenoxyphenyl
(221) 4-hydroxyphenyl

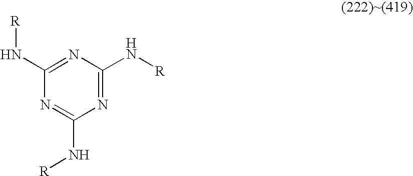

(222) phenyl
(223) 4-butylphenyl
(224) 4-2-methoxy-2-ethoxyethyl)phenyl
(225) 4-(5-nenenyl)phenyl
(226) p-biphenyryl
(227) 4-ethoxycarbonylphenyl
(228) 4-butoxyphenyl
(229) 4-methylphenyl
(230) 4-chlorophenyl
(231) 4-phenylthiophenyl
(232) 4-benzoylphenyl
(233) 4-aceoxyphenyl
(234) 4-benzoyloxyphenyl
(235) 4-phenoxycarbonylphenyl
(236) 4-methoxyphenyl
(237) 4-anilinophenyl
(238) 4-isobutyrylaminophenyl
(239) 4-phenoxycarbonylaminophenyl
(240) 4-(3-ethylureido)phenyl
(241) 4-(3,3-diethylureido)phenyl
(242) 4-phenoxyphenyl
(243) 4-hydroxyphenyl
(244) 3-butylphenyl
(245) 3-(2-methoxy-2-ethoxyethyl)phenyl
(246) 3-(5-nonenyl)phenyl
(247) m-biphenyryl
(248) 3-ethoxycarbonylphenyl
(249) 3-butoxyphenyl
(250) 3-methylphenyl
(251) 3-chlorophenyl
(252) 3-phenylthiophenyl
(253) 3-benzoylphenyl
(254) 3-actoxyphenyl
(255) 3-benzoyloxyphenyl
(256) 3-phenoxycarbonylphenyl
(257) 3-methoxyphenyl
(258) 3-anilinophenyl
(259) 3-isobutyrylaminophenyl
(260) 3-phenoxycarbonylaminophenyl
(261) 3-(3-ethylureido)phenyl
(262) 3-(3,3-diethylureido)phenyl
(263) 3-phenoxyphenyl
(264) 3-hydroxyphenyl
(265) 2-butylphenyl
(266) 2-(2-methoxy-2-ethoxyethyl)phenyl
(267) 2-(5-nonenyl)phenyl
(268) o-biphenyryl
(269) 2-ethoxycarbonylphenyl
(270) 2-butoxyphenyl
(271) 2-methylphenyl
(272) 2-chlorophenyl
(273) 2-phenylthiophenyl
(274) 2-benzoylphenyl
(275) 2-aceoxyphenyl
(276) 2-benzoyloxyphenyl
(277) 4-phenoxycarbonylphenyl
(278) 2-methoxyphenyl
(279) 2-anilinophenyl
(280) 2-isobutyrylaminophenyl
(281) 2-phenoxycarbonyl aminophenyl
(282) 2-(3-ethylureido)phenyl
(283) 2-(3,3-dimethylureido)phenyl
(284) 2-phenoxyphenyl
(285) 2-hydroxyphenyl
(286) 3,4-dibutylphenyl
(287) 3,4-di(2-methoxy-2-ethoxyethyl)phenyl
(288) 3,4-diphenylphenyl
(289) 3,4-diethoxycarbonylphenyl
(290) 3,4-didodecyloxyphenyl
(291) 3,4-dimethylphenyl
(292) 3,4-dichlorophenyl
(293) 3,4-dibenzoylphenyl
(294) 3,4-diacetoxyphenyl
(295) 3,4-dimethoxyphenyl
(296) 3,4-di-N-methylaminophenyl
(297) 3,4-diisobutyrylaminophenyl
(298) 3,4-diphenoxyphenyl
(299) 3,4-dihydroxyphenyl
(300) 3,5-dibutylphenyl
(301) 3,5-di(2-methoxy-2-ethoxyethyl)phenyl
(302) 3,5-diphenylphenyl
(303) 3,5-diethoxycarbonylphenyl
(304) 3,5-didodecyloxyphenyl
(305) 3,5-dimethylphenyl
(306) 3,5-dichlorophenyl
(307) 3,5-dibenzoylphenyl
(308) 3,5-diacetoxyphenyl
(309) 3,5-dimethoxyphenyl
(310) 3,5-di-N-methylaminophenyl
(311) 3,5-diisobutyrylaminophenyl
(312) 3,5-diphenoxyphenyl
(313) 3,5-dihydroxyphenyl
(314) 2,4-dibutylphenyl
(315) 2,4-di(2-methoxy-2-ethoxyethyl)phenyl
(316) 2,4-diphenylphenyl
(317) 2,4-diethoxycarbonylphenyl
(318) 2,4-didodecyloxyphenyl
(319) 2,4-dimethylphenyl
(320) 2,4-dichlorophenyl
(321) 2,4-dibenzoylphenyl
(322) 2,4-diacetoxyphenyl
(323) 2,4-dimethoxyphenyl
(324) 2,4-di-N-methylaminophenyl
(325) 2,4-diisobutyrylaminophenyl
(326) 2,4-diphenoxyphenyl
(327) 2,4-dihydroxyphenyl
(328) 2,3-dibutylphenyl
(329) 2,3-di(2-methoxy-2-ethoxyethyl)phenyl
(330) 2,3-diphenylphenyl
(331) 2,3-diethoxycarbonylphenyl
(332) 2,3-didodecyloxyphenyl
(333) 2,3-dimethylphenyl
(334) 2,3-dichlorophenyl
(335) 2,3-dibenzoylphenyl
(336) 2,3-diacetoxyphenyl
(337) 2,3-dimethoxyphenyl
(338) 2,3-di-N-methylaminophenyl
(339) 2,3-diisobutyrylaminophenyl
(340) 2,3-diphenoxyphenyl
(341) 2,3-dihydroxyphenyl
(342) 2,6-dibutylphenyl
(343) 2,6-di(2-methoxy-2-ethoxyethyl)phenyl
(344) 2,6-diphenylphenyl
(345) 2,6-diethoxycarbonylphenyl
(346) 2,6-didodecyloxyphenyl
(347) 2,6-dimethylphenyl
(348) 2,6-dichlorophenyl
(349) 2,6-dibenzoylphenyl
(350) 2,6-diacetoxyphenyl
(351) 2,6-dimethoxyphenyl
(352) 2,6-di-N-methylaminophenyl
(353) 2,6-diisobutyrylaminophenyl
(354) 2,6-diphenoxyphenyl
(355) 2,6-dihydroxyphenyl
(356) 3,4,5-tributylphenyl
(357) 3,4,5-tri(2-methoxy-2-ethoxyethyl)phenyl
(358) 3,4,5-triphenylphenyl
(359) 3,4,5-triethoxycarbonylphenyl
(360) 3,4,5-tridodecyloxyphenyl
(361) 3,4,5-trimethylphenyl
(362) 3,4,5-trichlorophenyl
(363) 3,4,5-tribenzoylphenyl
(364) 3,4,5-triacetoxyphenyl
(365) 3,4,5-trimethoxyphenyl
(366) 3,4,5-tri-N-methylaminophenyl
(367) 3,4,5-triisobutyrylaminophenyl
(368) 3,4,5-triphenoxyphenyl
(369) 3,4,5-trihydroxyphenyl
(370) 2,4,6-tributylphenyl
(371) 2,4,6-tri(2-methoxy-2-ethoxyethyl)phenyl
(372) 2,4,6-triphenylphenyl
(373) 2,4,6-triethoxycarbonylphenyl
(374) 2,4,6-tridodecyloxyphenyl
(375) 2,4,6-trimethylphenyl
(376) 2,4,6-trichlorophenyl
(377) 2,4,6-tribenzoylphenyl
(378) 2,4,6-triacetoxyphenyl
(379) 2,4,6-trimethoxyphenyl
(380) 2,4,6-tri-N-methylaminophenyl
(381) 2,4,6-triisobutyrylaminophenyl
(382) 2,4,6-triphenoxyphenyl
(383) 2,4,6-trihydroxyphenyl
(384) pentafluorophenyl
(385) pentachlorophenyl
(386) pentamethoxyphenyl
(387) 6-N-methylsulfamoyl-8-methoxy-2-naphthyl
(388) 5-N-methylsulfamoyl-2-naphthyl
(389) 6-N-phenylsulfamoyl-2-naphtyl
(390) 5-ethoxy-7-N-methylsulfamoyl-2-naphthyl
(391) 3-methoxy-2-naphthyl
(392) 1-ethoxy-2-naphthyl
(393) 6-N-phenylsulfamoyl-8-methoxy-2-naphthyl
(394) 5-methoxy-7-N-phenylsulfamoyl-2-naphthyl
(395) 1-(4-methylphenyl)-2-naphthyl
(396) 6,8-di-N-methylsulfamoyl-2-naphthyl
(397) 6-N-2-acetoxyethylsulfamoyl-8-methoxy-2-naphthyl
(398) 5-acetoxy-7-N-phenylsulfamoyl-2-naphthyl
(399) 3-benzoyloxy-2-naphthyl
(400) 5-acetylamino-1-naphthyl
(401) 2-methoxy-1-naphthyl
(402) 4-phenoxy-1-naphthyl
(403) 5-N-methylsulfamoyl-1-naphthyl
(404) 3-N-methylcarbamoyl-4-hydroxy-1-naphthyl
(405) 5-methoxy-6-N-ethylsulfamoyl-1-naphthyl
(406) 7-tetradecyloxy-1-naphthyl
(407) 4-(4-methylphenoxy)-1-naphthyl
(408) 6-N-methylsulfamoyl-1-naphthyl
(409) 3-N,N-dimethylcarbamoyl-4-methoxy-1-naphthyl
(410) 5-methoxy-6-N-benzylsulfamoyl-1-naphthyl
(411) 3,6-di-N-phenylsulfamoyl-1-naphthyl
(412) methyl
(413) ethyl
(414) butyl
(415) octyl
(416) dodecyl
(417) 2-butoxy-2-ethoxyethyl
(418) benzyl
(419) 4-methoxybenzyl

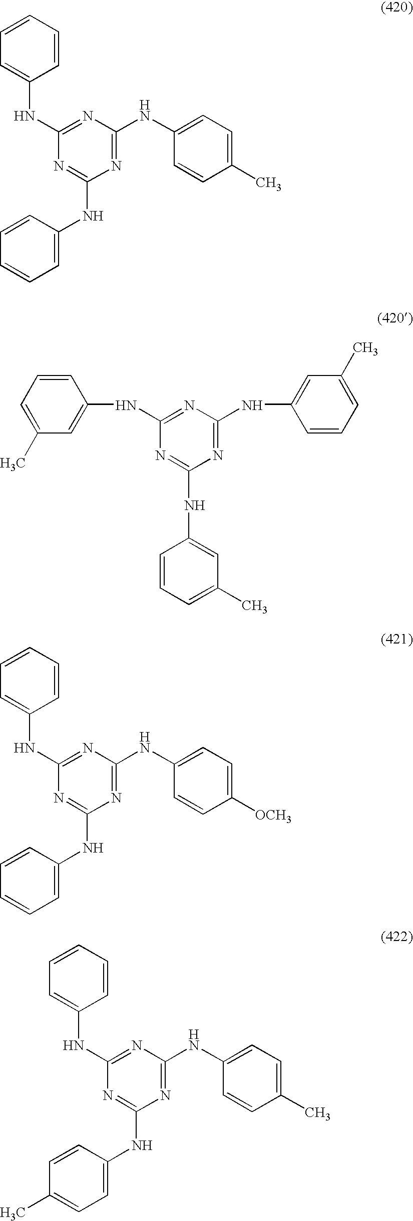

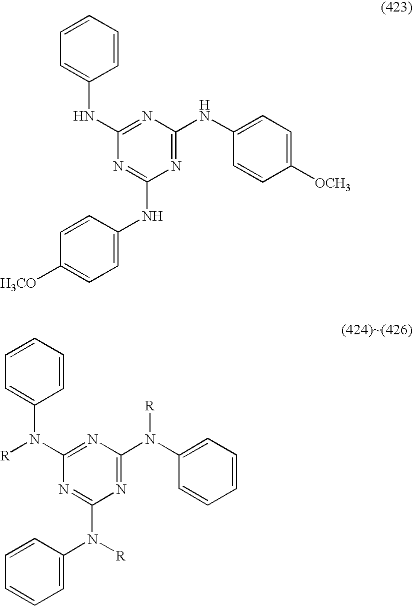

(424) methyl
(425) phenyl
(426) butyl

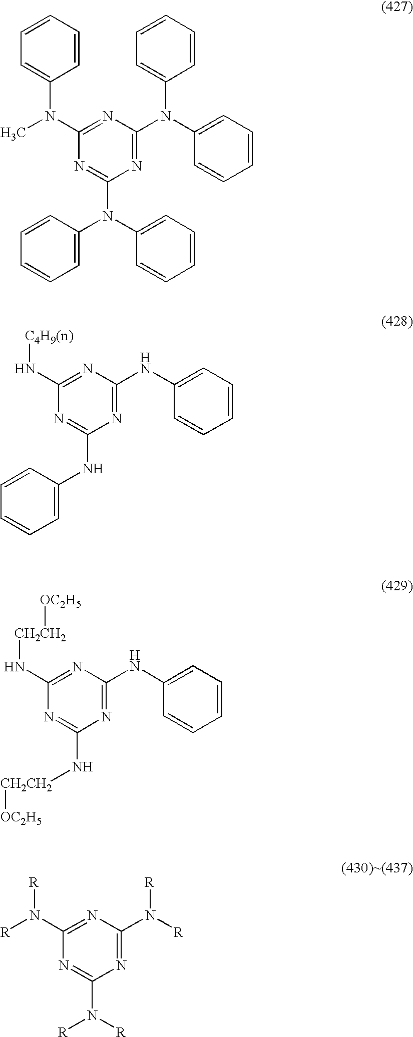

(430) methyl
(431) ethyl
(432) butyl
(433) octyl
(434) dodecyl
(435) 2-butoxy-2-ethoxyethyl
(436) benzyl
(437) 4-methoxybenzyl

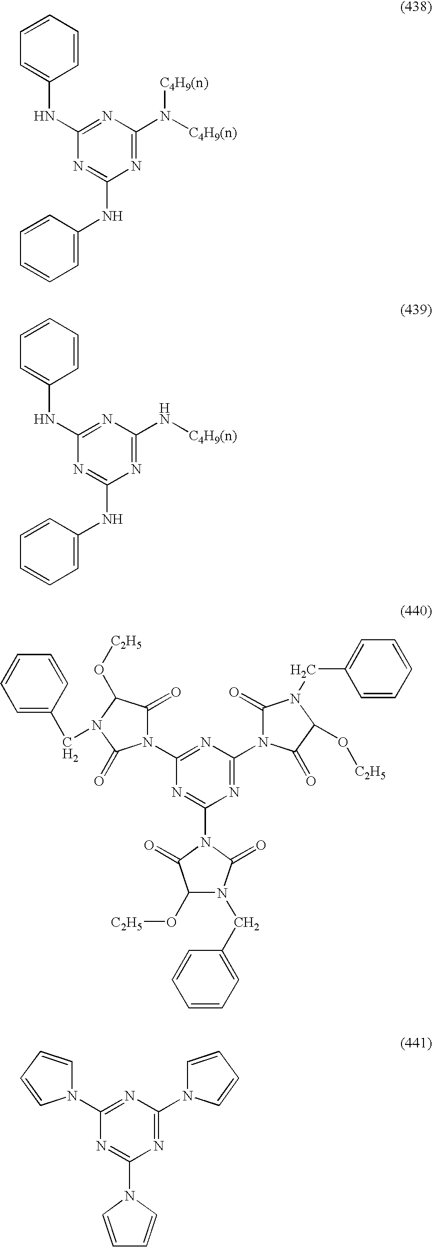

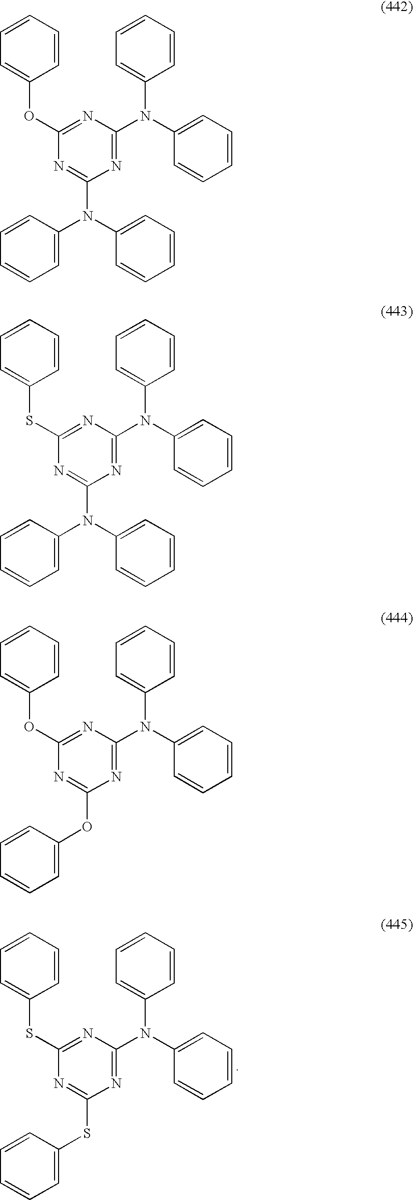

In the present invention, employed as a compound having a 1,3,5-triazine ring may be melamine polymers. It is preferable that the above melamine polymers are synthesized employing a polymerization reaction of the melamine compounds represented by Formula (16) below with carbonyl compounds.

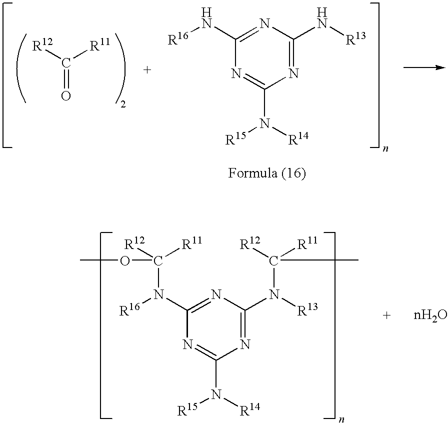

In the above synthesis reaction scheme, R¹¹, R¹², R¹³, R¹⁴, R¹⁵, and R¹⁶ each represent a hydrogen atom, an alkyl group, an alkenyl group, an aryl group or a heterocyclyl group.

The above alkyl group, alkenyl group, aryl group, and heterocyclyl group, as well as those substituents are as defined for each group and also the substituents described in above Formula (4).

The polymerization reaction of melamine compounds with carbonyl compounds is performed employing the same synthesis method as for common melamine resins (for example, a melamine-formaldehyde resin). Further, employed may be commercially available melamine polymers (being melamine resins).

The molecular weight of melamine polymers is preferably 2,000-400,000. Specific examples of repeating units of melamine polymers are shown below.

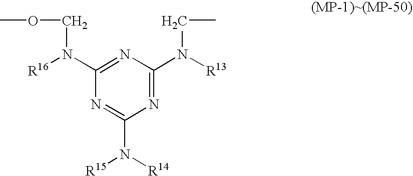

### MP-1: R¹³, R¹⁴, R¹⁵, R¹⁶: CH₂OH

### MP-2: R¹³, R¹⁴, R¹⁵, R¹⁶: CH₂OCH₃

### MP-3: R¹³, R¹⁴, R¹⁵, R¹⁶: CH₂O-i-C₄H₉

### MP-4: R¹³, R¹⁴, R¹⁵, R¹⁶: CH₂O-n-C₄H₉

### MP5: R¹³, R¹⁴, R¹⁵, R¹⁶: CH₂NHCOCH═CH₂

### MP-6: R¹³, R¹⁴, R¹⁵, R¹⁶: CH₂NHCO(CH₂)₇CH═CH(CH₂)₇CH₃

### MP-7: R¹³, R¹⁴, R¹⁵: CH₂OH; R¹⁶ CH₂OCH₃

### MP-8: R¹³, R¹⁴, R¹⁶: CH₂OH; R¹⁵: CH₂OCH₃,

### MP-9: R¹³, R¹⁴: CH₂OH; R¹⁵, R¹⁶: CH₂OCH₃

### MP-10: R¹³, R¹⁶: CH₂OH; R¹⁴, R¹⁵: CH₂OCH₃

### MP-11: R¹³: CH₂OH; R¹⁴, R¹⁵, R¹⁶: CH₂OCH₃

### MP-12: R¹³, R¹⁴, R¹⁶: CH₂OCH₃; R¹⁵: CH₂OH

### MP-13: R¹³, R¹⁶: CH₂OCH₃; R¹⁴, R¹⁵: CH₂OH

### MP-14: R¹³, R¹⁴, R¹⁵: CH₂OH; R¹⁶: CH₂O-i-C₄H₉

### MP-15: R¹³, R¹⁴, R¹⁶: CH₂OCH₃; R¹⁵: CH₂O-i-C₄H₉

### MP-16: R¹³, R¹⁴: CH₂OH; R¹⁵, R¹⁶: CH₂O-i-C₄H₉

### MP-17: R¹³, R¹⁶: CH₂OH; R¹⁴, R¹⁵: CH₂O-i-C₄H₉

### MP-18: R¹³: CH₂OH; R¹⁴ R¹⁵, R¹⁶: CH₂O-i-C₄H₉

### MP-19: R¹³, R¹⁴, R¹⁶: CH₂O-i-C₄H₉; R¹⁵: CH₂OH

### MP-20: R¹³, R¹⁶: CH₂O-i-C₄H₉; R¹⁴, R¹⁵: CH₂OH

### MP-21: R¹³, R¹⁴, R¹⁵: CH₂OH; R¹⁶: CH₂O-n-C₄H₉

### MP-22: R¹³, R¹⁴, R¹⁶: CH₂OH; R¹⁵: CH₂O-n-C₄H₉

### MP-23: R¹³, R¹⁴: CH₂OH; R¹⁵, R¹⁶: CH₂O-n-C₄H₉

### MP-24: R¹³, R¹⁶: CH₂OH; R¹⁴, R¹⁵: CH₂O-n-C₄H₉

### MP-25: R¹³: CH₂OH; R¹⁴ R¹⁵, R¹⁶: CH₂O-n-C₄H₉

### MP-26: R¹³, R¹⁴, R¹⁶: CH₂O-n-C₄H₉; R¹⁵: CH₂OH

### MP-27: R¹³, R¹⁶: CH₂O-n-C₄H₉; R¹⁴, R¹⁵: CH₂OH

MP-28: R¹³, R¹⁴: CH₂OH; R¹⁵: CH₂OCH₃; R¹⁶: CH₂O-n-C₄H₉
MP-29: R¹³, R¹⁴: CH₂OH; R¹⁵: CH₂-n-C₄H₉; R¹⁶: CH₂OCH₃
MP-30: R¹³, R¹⁶: CH₂OH; R¹⁴: CH₂OCH₃; R¹⁵: CH₂O-n-C₄H₉
MP-31: R¹³: CH₂OH; R¹⁴, R¹⁵: CH₂OCH₃; R¹⁶: CH₂O-n-C₄H₉
MP-32: R¹³: CH₂OH; R¹⁴, R¹⁶: CH₂OCH₃; R¹⁵: CH₂O-n-C₄H₉
MP-33: R¹³: CH₂OH; R¹⁴: CH₂OCH₃; R¹⁵, R¹⁶: CH₂O-n-C₄H₉
MP-34: R¹³: CH₂OH; R¹⁴, R¹⁵: CH₂O-n-C₄H₉; R¹⁶: CH₂OCH₃
MP-35: R¹³, R¹⁴: CH₂OCH₃; R¹⁵: CH₂OH; R¹⁶: CH₂O-n-C₄H₉
MP-36: R¹³, R¹⁶: CH₂OCH₃; R¹⁴: CH₂OH; R¹⁵: CH₂O-n-C₄H₉
MP-37: R¹³: CH₂OCH₃; R¹⁴, R¹⁵: CH₂OH; R¹⁶: CH₂O-n-C₄H₉
MP-38: R¹³, R¹⁶: CH₂O-n-C₄H₉; R¹⁴: CH₂OCH₃; R¹⁵: CH₂OH
MP-39: R¹³: CH₂OH; R¹⁴: CH₂OCH₃; R¹⁵: CH₂O-n-C₄H₉; R¹⁶: CH₂NHCOCH═CH₂
MP-40: R¹³: CH₂OH; R¹⁴: CH₂OCH₃; R¹⁵: CH₂NHCOCH═CH₂; R¹⁶: CH₂O-n-C₄H₉
MP-41: R¹³: CH₂OH; R¹⁴: CH₂O-n-C₄H₉; R¹⁵: CH₂NHCOCH═CH₂; R¹⁶: CH₂OCH₃
MP-42: R¹³: CH₂OCH₃; R¹⁴: CH₂OH; R¹⁵: CH₂O-n-C₄H₉; R¹⁶: CH₂NHCOCH═CH₂
MP-43: R¹³: CH₂OCH₃; R¹⁴: CH₂OH; R¹⁵: CH₂NHCOCH═CH₂; R¹⁶: CH₂O-n-C₄H₉
MP-44: R¹³: CH₂O-n-C₄H₉; R¹⁴: CH₂OCH₃; R¹⁵: CH₂OH; R¹⁶: CH₂NHCOCH═CH₂
MP-45: R¹³: CH₂OH; R¹⁴: CH₂OCH₃; R¹⁵: CH₂NHCO(CH₂)₇CH═CH(CH₂)₇CH₃; R¹⁶: CH₂NHCOCH═CH₂
MP-46: R¹³: CH₂OH; R¹⁴: CH₂OCH₃; R¹⁵: CH₂NHCO═CH₂; R₁₆: CH₂NHCO(CH₂)₇CH═CH(CH₂)₇CH₃
MP-47: R¹³: CH₂OH; R¹⁴: CH₂NHCO(CH₂)₇CH═CH(CH₂)₇CH₃; R¹⁵: CH₂NHCOCH═CH₂; R¹⁶: CH₂OCH₃
MP-48: R¹³: CH₂OCH₃; R¹⁴: CH₂OH; R¹⁵: CH₂NHCO(CH₂)₇CH═CH(CH₂)₇CH₃; R¹⁶: CH₂NHCOCH═CH₂
MP-49: R¹³: CH₂OCH₃; R¹⁴: CH₂OH; R¹⁵: CH₂NHCOCH═CH₂; R¹⁶: CH₂NHCO(CH₂)₇CH═CH(CH₂)₇CH₃
MP-50: R¹³: CH₂NHCO(CH₂)₇CH═CH(CH₂)₇CH₃; R¹⁴: CH₂OCH₃; R¹⁵: CH₂OH; R¹⁶: CH₂NHCOCH═CH₂

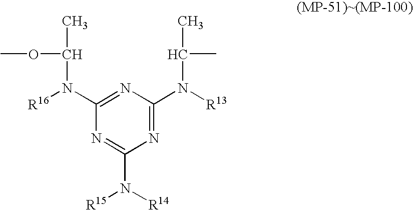

### MP-51: R¹³, R¹⁴, R¹⁵, R¹⁶: CH₂OH

### MP-52: R¹³, R¹⁴, R¹⁵, R¹⁶: CH₂OCH₃

### MP-53: R¹³, R¹⁴, R¹⁵, R¹⁶: CH₂O-i-C₄H₉

### MP-54: R¹³, R¹⁴, R¹⁵, R¹⁶: CH₂O-n-C₄H₉

### MP-55: R¹³, R¹⁴, R¹⁵, R¹⁶: CH₂NHCOCH═CH₂

### MP-56: R¹³, R¹⁴, R¹⁵, R¹⁶: CH₂NHCO(CH₂)₇CH═CH(CH₂)₇CH₃

### MP-57: R¹³, R¹⁴, R¹⁵: CH₂OH; R¹⁶: CH₂OCH₃

### MP-58: R¹³, R¹⁴, R¹⁵: CH₂OH; R¹⁵: CH₂OCH₃,

### MP-59: R¹³, R¹⁴: CH₂OH; R¹⁵, R¹⁶: CH₂OCH₃

### MP-60: R¹³, R¹⁶: CH₂OH; R¹⁴, R¹⁵: CH₂OCH₃

### MP-61: R¹³: CH₂OH; R¹⁴, R¹⁵, R¹⁶: CH₂OCH₃

### MP-62: R¹³, R¹⁴, R¹⁶: CH₂OCH₃; R¹⁵: CH₂OH

### MP-63: R¹³, R¹⁶: CH₂OCH₃; R¹⁴, R¹⁵: CH₂OH

### MP-64: R¹³, R¹⁴, R¹⁵: CH₂OH; R¹⁶: CH₂O-i-C₄H₉

### MP-65: R¹³, R¹⁴, R¹⁶: CH₂OCH₃; R¹⁵: CH₂O-i-C₄H₉

### MP 66: R¹³, R¹⁴: CH₂OH; R¹⁵, R¹⁶: CH₂O-i-C₄H₉

### MP-67: R¹³, R¹⁶: CH₂OH; R¹⁴, R¹⁵: CH₂O-i-C₄H₉

### MP-68: R¹³: CH₂OH; R¹⁴, R¹⁵, R¹⁶: CH₂O-i-C₄H₉

### MP-69: R¹³, R¹⁴, R¹⁶: CH₂O-i-C₄H₉; R¹⁵: CH₂OH

### MP-70: R¹³, R¹⁶: CH₂O-i-C₄H₉; R¹⁴, R¹⁵: CH₂OH

### MP-71: R¹³, R¹⁴, R¹⁵: CH₂OH; R¹⁶: CH₂O-n-C₄H₉

### MP-72: R¹³, R¹⁴, R¹⁶: CH₂OH; R¹⁵: CH₂O-n-C₄H₉

### MP-73: R¹³, R¹⁴: CH₂OH; R¹⁵, R¹⁶: CH₂O-n-C₄H₉

### MP-74: R¹³, R¹⁶: CH₂OH; R¹⁴, R¹⁵: CH₂OH-n-C₄H

MP-75: R¹³: CH₂OH; R¹⁴ R¹⁵, R¹⁶: CH₂-n-C₄H₉

### MP-76: R¹³, R¹⁴, R¹⁶: CH₂O-n-C₄H₉; R¹⁵: CH₂OH

MP-77: R¹³, R¹⁴, R¹⁶: CH₂O-n-C₄H₉; R¹⁴, R¹⁵: CH₂OH
MP-78: R¹³, R¹⁴: CH₂OH; R¹⁵: CH₂OCH₃; R¹⁶: CH₂O-n-C₄H₉
MP-79: R¹³, R¹⁴: CH₂OH; R¹⁵: CH₂-n-C₄H₉; R¹⁶: CH₂OCH₃
MP-80: R¹³, R¹⁶: CH₂OH; R¹⁴: CH₂OCH₃; R¹⁵: CH₂O-n-C₄H₉
MP-81: R¹³: CH₂OH; R¹⁴, R¹⁵: CH₂OCH₃; R¹⁶: CH₂-n-C₄H₉
MP-82: R¹³: CH₂OH; R¹⁴, R¹⁶: CH₂OCH₃; R¹⁵: CH₂-n-C₄H₉
MP-83: R¹³: CH₂OH; R¹⁴: CH₂OCH₃; R¹⁵, R¹⁶: CH₂O-n-C₄H₉
MP-84: R¹³: CH₂OH; R¹⁴, R¹⁵: CH₂-n-C₄H₉; R¹⁶: CH₂OCH₃
MP-85: R¹³, R¹⁴: CH₂OCH₃; R¹⁵: CH₂OH; R¹⁶: CH₂O-n-C₄H₉
MP-86: R¹³, R¹⁶: CH₂OCH₃; R¹⁴: CH₂OH; R¹⁵: CH₂O-n-C₄H₉
MP-87: R¹³: CH₂OCH₃; R¹⁴, R¹⁵: CH₂OH; R¹⁶: CH₂O-n-C₄H₉
MP-88: R¹³, R¹⁶: CH₂O-n-C₄H₉; R¹⁴: CH₂OCH₃; R¹⁵: CH₂OH
MP-89: R¹³: CH₂OH; R¹⁴: CH₂OCH₂CH₃; R¹⁵: CH₂O-n-C₄H₉; R¹⁶: CH₂NHCOCH═CH₂
MP-90: R¹³: CH₂OH; R¹⁴: CH₂OCH₃; R¹⁵: CH₂NHCOCH═CH₂; R¹⁶ CH₂O-n-C₄H₉
MP-91: R¹³: CH₂OH; R¹⁴: CH₂O-n-C₄H₉; R¹⁵: CH₂NHCOCH═CH₂; R¹⁶: CH₂OCH₃
MP-92: R¹³: CH₂OCH₃; R¹⁴: CH₂OH; R¹⁵: CH₂O-n-C₄H₉; R¹⁶: CH₂NHCOCH═CH₂
MP-93: R¹³: CH₂OCH₃; R¹⁴: CH₂OH; R¹⁵: CH₂NHCOCH═CH₂; R¹⁶: CH₂O-n-C₄H₉
MP-94: R¹³: CH₂O— n-C₄H₉; R¹⁴: CH₂OCH₃; R¹⁵: CH₂OH; R¹⁵: CH₂NHCOCH═CH₂
MP-95: R¹³: CH₂OH; R¹⁴: CH₂OCH₃; R¹⁵: CH₂NHCO(CH₂)₇CH═CH(CH₂)₇CH₃; R¹⁶: CH₂NHCOCH═CH₂
MP-96: R¹³: CH₂OH; R¹⁴: CH₂OCH₃; R¹⁵: CH₂NHCO═CH₂; R₁₆: CH₂NHCO(CH₂)₇CH═CH(CH₂)₇CH₃
MP-97: R¹³: CH₂OH; R¹⁴: CH₂NHCO(CH₂)₇CH═CH(CH₂)₇CH₃; R¹⁵: CH₂NHCOCH═CH₂; R¹⁶: CH₂OCH₃
MP-98: R¹³: CH₂OCH₃; R¹⁴: CH₂OH; R¹⁵: CH₂NHCO(CH₂)₇CH═CH—(CH₂)₇CH₃; R¹⁶: CH₂NHCOCH═CH₂
MP-99: R¹³: CH₂OCH₃; R¹⁴: CH₂OH; R¹⁵: CH₂NHCOCH═CH₂; R¹⁶: CH₂NHCO(CH₂)₇CH═CH(CH₂)₇CH₃
MP-100: R¹³: CH₂NHCO(CH₂)₇CH═CH(CH₂)₇CH₃; R¹⁴: CH₂OCH₃; R¹⁵: CH₂OH; R¹⁶: CH₂NHCOCH═CH₂

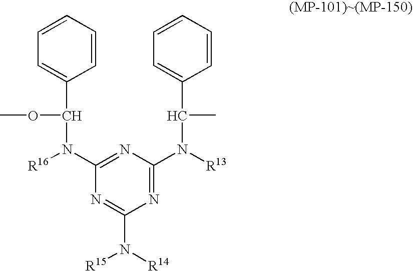

### MP-101: R¹³, R¹⁴, R¹⁵, R¹⁶: CH₂OH

### MP-102: R¹³, R¹⁴, R¹⁵, R¹⁶: CH₂OCH₃

### MP-103: R¹³, R¹⁴, R¹⁵, R¹⁶: CH₂O-i-C₄H₉

### MP-104: R¹³, R¹⁴, R¹⁵, R¹⁶: CH₂O-n-C₄H₉

### MP-105: R¹³: R¹⁴, R¹⁵, R¹⁶: CH₂NHCOCH═CH₂

### MP-106: R¹³, R¹⁴, R¹⁵, R¹⁶: CH₂NHCO(CH₂)₇CH═CH(CH₂)₇CH₃

### MP-107: R¹³, R¹⁴, R¹⁵: CH₂OH; R¹⁶: CH₂OCH₃

### MP-108: R¹³, R¹⁴, R¹⁶: CH₂OH; R¹⁵: CH₂OCH₃,

### MP-109: R¹³, R¹⁴: CH₂OH; R¹⁵, R¹⁶: CH₂OCH₃

### MP-110: R¹³, R¹⁶: CH₂OH; R¹⁴, R¹⁵: CH₂OCH₃

### MP-111: R¹³: CH₂OH; R¹⁴, R¹⁵, R¹⁶: CH₂OCH₃

### MP-112: R¹³, R¹⁴, R¹⁶: CH₂OCH₃; R¹⁵: CH₂OH

### MP-113: R¹³, R¹⁶: CH₂OCH₃; R¹⁴, R¹⁵: CH₂OH

MP-114: R¹³, R¹⁴, R¹⁵: CH₂OH; R¹⁶: CH₂-i-C₄H₉

### MP-115: R¹³, R¹⁴, R¹⁶: CH₂OH; R¹⁵: CH₂O-i-C₄H₉

### MP-116: R¹³, R¹⁴: CH₂OH; R¹⁵, R¹⁶: CH₂O-i-C₄H₉

### MP-117: R¹³, R¹⁶: CH₂OH; R¹⁴, R¹⁵: CH₂O-i-C₄H₉

### MP-118: R¹³: CH₂OH; R¹⁴, R¹⁵, R¹⁶: CH₂O-i-C₄H₉

### MP-119: R¹³, R¹⁴, R¹⁶: CH₂O-i-C₄H₉; R¹⁵: CH₂OH

### MP-120: R¹³, R¹⁶: CH₂O-i-C₄H₉; R¹⁴, R¹⁵: CH₂OH

### MP-121: R¹³, R¹⁴, R¹⁵: CH₂OH; R¹⁶: CH₂O-n-C₄H₉

### MP-122: R¹³, R¹⁴, R¹⁶: CH₂OH; R¹⁵: CH₂O-n-C₄H₉

### MP-123: R¹³, R¹⁴: CH₂OH; R¹⁵, R¹⁶: CH₂O-n-C₄H₉

### MP-124: R¹³, R¹⁶: CH₂OH; R¹⁴, R¹⁵: CH₂O-n-C₄H₉

### MP-125: R¹³: CH₂OH; R¹⁴, R¹⁵, R¹⁶: CH₂O-i-C₄H₉

### MP-126: R¹³, R¹⁴, R¹⁶: CH₂O-n-C₄H₉; R¹⁵: CH₂OH

### MP-127: R¹³, R¹⁶: CH₂O-n-C₄H₉; R¹⁴, R¹⁵: CH₂OH

MP-128: R¹³, R¹⁴: CH₂OH; R¹⁵: CH₂OCH₃; R¹⁶: CH₂O-n-C₄H₉
MP-129: R¹³, R¹⁴: CH₂OH; R¹⁵: CH₂-n-C₄H₉; R¹⁶: CH₂OCH₃
MP-130: R¹³, R¹⁶: CH₂OH; R¹⁴: CH₂OCH₃; R¹⁵: CH₂O-n-C₄H₉

### MP-131: R¹³: CH₂OH; R¹⁴: CH₂OCH₃; R¹⁶: CH₂O-n-C₄H₉

MP-132: R¹³: CH₂OH; R¹⁴, R¹⁶: CH₂OCH₃; R¹⁵: CH₂O-n-C₄H₉
MP-133: R¹³: CH₂OH; R¹⁴: CH₂OCH₃; R¹⁵, R¹⁶: CH₂O-n-C₄H₉
MP-134: R¹³: CH₂OH; R¹⁴, R¹⁵: CH₂O-n-C₄H₉; R¹⁶: CH₂OCH₃
MP-135: R¹³, R¹⁴: CH₂OCH₃; R¹⁵: CH₂OH; R¹⁶: CH₂O-n-C₄H₉
MP-136: R¹³, R¹⁶: CH₂OCH₃; R¹⁴: CH₂OH; R¹⁵: CH₂O-n-C₄H₉
MP-137: R¹³: CH₂OCH₃; R¹⁴, R¹⁵: CH₂OH; R¹⁶: CH₂O-n-C₄H₉

### MP-138: R¹³, R¹⁶: CH₂O-n-OCH₃; R¹⁵: CH₂OH

MP-139: R¹³: CH₂OH; R¹⁴: CH₂OCH₃; R¹⁵: CH₂O-n-C₄H₉; R¹⁶: CH₂NHCOCH═CH₂
MP-140: R¹³: CH₂OH; R¹⁴: CH₂OCH₃; R¹⁵: CH₂NHCOCH═CH₂; R¹⁶ CH₂O-n-C₄H₉
MP-141: R¹³: CH₂OH; R¹⁴: CH₂O-n-C₄H₉; R¹⁵: CH₂NHCOCH═CH₂; R¹⁶: CH₂OCH₃
MP-142: R¹³: CH₂OCH₃; R¹⁴: CH₂OH; R¹⁵: CH₂O-n-C₄H₉; R¹⁶: CH₂NHCOCH═CH₂
MP-143: R¹³: CH₂OCH₃; R¹⁴: CH₂OH; R¹⁵: CH₂NHCOCH═CH₂; R¹⁶: CH₂O-n-C₄H₉
MP-144: R¹³: CH₂O-n-C₄H₉; R¹⁴: CH₂OCH₃; R¹⁵: CH₂OH; R¹⁶: CH₂NHCOCH═CH₂
MP-145: R¹³: CH₂OH; R¹⁴: CH₂OCH₃; R¹⁵: CH₂NHCO(CH₂)₇CH═CH(CH₂)₇CH₃; R¹⁶: CH₂NHCOCH═CH₂
MP-146: R¹³: CH₂OH; R¹⁴: CH₂OCH₃; R¹⁵: CH₂NHCO═CH₂; R₁₆: CH₂NHCO(CH₂)₇CH═CH(CH₂)₇CH₃
MP-147: R¹³: CH₂OH; R¹⁴: CH₂NHCO(CH₂)₇CH═CH(CH₂)₇CH₃; R¹⁵ CH₂NHCOCH═CH₂; R¹⁶: CH₂OCH₃
MP-148: R¹³: CH₂OCH₃; R¹⁴: CH₂OH; R¹⁵: CH₂NHCO(CH₂)₇CH═CH(CH₂)₇CH₃; R¹⁶: CH₂NHCOCH═CH₂
MP-149: R¹³: CH₂OCH₃; R¹⁴: CH₂OH; R¹⁵: CH₂NHCOCH═CH₂; R¹⁶: CH₂NHCO(CH₂)₇CH═CH(CH₂)₇CH₃
MP-150: R¹³: CH₂NHCO(CH₂)₇CH═CH(CH₂)₇CH₃; R¹⁴: CH₂OCH₃; R¹⁵: CH₂OH; R¹⁶: CH₂NHCOCH═CH₂

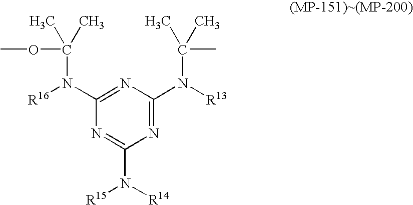

### MP-151: R¹³, R¹⁴, R¹⁵, R¹⁶: CH₂OH

### MP-152: R¹³, R¹⁴, R¹⁵, R¹⁶: CH₂OCH₃

### MP-153: R¹³, R¹⁴, R¹⁵, R¹⁶: CH₂O-i-C₄H₉

### MP-154: R¹³, R¹⁴, R¹⁵, R¹⁶: CH₂O-n-C₄H₉

### MP-155: R¹³, R¹⁴, R¹⁵, R¹⁶: CH₂NHCOCH═CH₂

### MP-156: R¹³, R¹⁴, R¹⁵, R¹⁶: CH₂NHCO(CH₂)₇CH═CH(CH₂)₇CH₃

### MP-157: R¹³, R¹⁴, R¹⁵: CH₂OH; R¹⁶: CH₂OCH₃

### MP-158: R¹³, R¹⁴, R¹⁶: CH₂OH; R¹⁵: CH₂OCH₃,

### MP-159: R¹³, R¹⁴: CH₂OH; R¹⁵, R¹⁶: CH₂OCH₃

### MP-160: R¹³, R¹⁶: CH₂OH; R¹⁴, R¹⁵: CH₂OCH₃

### MP-161: R¹³: CH₂OH; R¹⁴, R¹⁵, R¹⁶: CH₂OCH₃

### MP-162: R¹³, R¹⁴, R¹⁶: CH₂OCH₃; R¹⁵: CH₂OH

### MP-163: R¹³, R¹⁶: CH₂OCH₃; R¹⁴, R¹⁵: CH₂OH

### MP164: R¹³, R¹⁴, R¹⁵: CH₂OH; R¹⁶: CH₂O-i-C₄H₉

### MP-161: R¹³, R¹⁴, R¹⁶: CH₂OH; R¹⁵: CH₂O-i-C₄H₉

### MP-166: R¹³, R¹⁴: CH₂OH; R¹⁵, R¹⁶: CH₂O-i-C₄H₉

### MP-167: R¹³, R¹⁶: CH₂OH; R¹⁴, R¹⁵: CH₂O-i-C₄H₉

### MP-168: R¹³: CH₂OH; R¹⁴, R¹⁵, R¹⁶: CH₂O-i-C₄H₉

### MP-169: R¹³, R¹⁴, R¹⁶: CH₂O-i-C₄H₉; R¹⁵: CH₂OH

### MP-170: R¹³, R¹⁶: CH₂O-i-C₄H₉; R¹⁴, R¹⁵: CH₂OH

### MP-171: R¹³, R¹⁴, R¹⁵: CH₂OH; R¹⁶: CH₂O-n-C₄H₉

### MP-172: R¹³, R¹⁴, R¹⁶: CH₂OH; R¹⁵: CH₂O-n-C₄H₉

### MP-173: R¹³, R¹⁴: CH₂OH; R¹⁵, R¹⁶: CH₂O-n-C₄H₉

### MP-174: R¹³, R¹⁶: CH₂OH; R¹⁴, R¹⁵: CH₂O-n-C₄H₉

### MP-175: R¹³: CH₂OH; R¹⁴, R¹⁵, R¹⁶: CH₂O-n-C₄H₉

### MP-176: R¹³, R¹⁴, R¹⁶: CH₂O-n-C₄H₉; R¹⁵: CH₂OH

### MP-177: R¹³, R¹⁶: CH₂O-n-C₄H₉; R¹⁴, R¹⁵: CH₂OH

MP-178: R¹³, R¹⁴: CH₂OH; R¹⁵: CH₂OCH₃; R¹⁶: CH₂O-n-C₄H₉
MP-179: R¹³, R¹⁴: CH₂OH; R¹⁵: CH₂-n-C₄H₉; R¹⁶: CH₂OCH₃
MP-180: R¹³, R¹⁶: CH₂OH; R¹⁴: CH₂OCH₃; R¹⁵: CH₂O-n-C₄H₉
MP-181: R¹³: CH₂OH; R¹⁴, R¹⁵: CH₂OCH₃; R¹⁶: CH₂O-n-C₄H₆
MP-182: R¹³: CH₂OH; R¹⁴, R¹⁶: CH₂OCH₃; R¹⁵: CH₂O-n-C₄H₉
MP-183: R¹³: CH₂OH; R¹⁴: CH₂OCH₃; R¹⁵, R¹⁶: CH₂O-n-C₄H₉
MP-184: R¹³: CH₂OH; R¹⁴, R¹⁵: CH₂O-n-C₄H₉; R¹⁶: CH₂OCH₃
MP-185: R¹³, R¹⁴: CH₂OCH₃; R¹⁵: CH₂OH; R¹⁶: CH₂O-n-C₄H₉
MP-186: R¹³, R¹⁶: CH₂OCH₃; R¹⁴: CH₂OH; R¹⁵: CH₂O-n-C₄H₃
MP-187: R¹³: CH₂OCH₃; R¹⁴, R¹⁵: CH₂OH; R¹⁶: CH₂O-n-C₄H₉
MP-188: R¹³, R¹⁶: CH₂O-n-C₄H₃; R¹⁴: CH₂OCH₃; R¹⁵: CH₂OH
MP-189: R¹³: CH₂OH; R¹⁴: CH₂OCH₃; R¹⁵: CH₂O-n-C₄H₉; R¹⁶: CH₂NHCOCH═CH₂
MP-190: R¹³: CH₂OH; R¹⁴: CH₂OCH₃; R¹⁵: CH₂NHCOCH═CH₂; R¹⁶: CH₂O-n-C₄H₉
MP-191: R¹³: CH₂OH; R¹⁴: CH₂O-n-C₄H₉; R¹⁵: CH₂NHCOCH═CH₂; R¹⁶: CH₂OCH₃
MP-192: R¹³: CH₂OCH₃; R¹⁴: CH₂OH; R¹⁵: CH₂O-n-C₄H₉; R¹⁶: CH₂NHCOCH═CH₂
MP-193: R¹³: CH₂OCH₃; R¹⁴: CH₂OH; R¹⁵: CH₂NHCOCH═CH₂; R¹⁶: CH₂O-n-C₄H₉
MP-194: R¹³: CH₂O-n-C₄H₉; R¹⁴: CH₂OCH₃; R¹⁵: CH₂OH; R¹⁶: CH₂NHCOCH═CH₂
MP-195: R¹³: CH₂OH; R¹⁴: CH₂OCH₃; R¹⁵: CH₂NHCO(CH₂)₇CH═CH(CH₂)₇CH₃; R¹⁶: CH₂NHCOCH═CH₂
MP-196: R¹³: CH₂OH; R¹⁴: CH₂OCH₃; R¹⁵: CH₂NHCO═CH₂; R₁₆: CH₂NHCO(CH₂)₇CH═CH(CH₂)₇CH₃
MP-197: R¹³: CH₂OH; R¹⁴: CH₂NHCO(CH₂)₇CH═CH(CH₂)₇CH₃; R¹⁵: CH₂NHCOCH═CH₂; R¹⁶: CH₂OCH₃
MP-198: R¹³: CH₂OCH₃; R¹⁴: CH₂OH; R¹⁵: CH₂NHCO(CH₂)₇CH═CH(CH₂)₇CH₃; R¹⁶: CH₂NHCOCH═CH₂
MP-199: R¹³: CH₂OCH₃; R¹⁴: CH₂OH; R¹⁵: CH₂NHCOCH═CH₂; R¹⁶: CH₂NHCO(CH₂)₇CH═CH(CH₂)₇CH₃
MP-200: R¹³: CH₂NHCO(CH₂)₇CH═CH(CH₂)₇CH₃; R¹⁴: CH₂OCH₃; R¹⁵: CH₂OH; R¹⁶: CH₂NHCOCH═CH₂

In the present invention, employed may be copolymers in which at least two types of the above repeating units are combined.

Further, simultaneously employed may be at least two types of compounds having a 1,3,5-triazine ring. Also simultaneously employed may be at least two types of disk shaped compounds (for example, compounds having a 1,3,5-triazine ring and compounds having a porphyrin skeleton).

The amount of these additives is preferably 0.2-30% by weight with respect to the polarizing plate protective film, but is particularly preferably 1-20% by weight.

### (Polymer Materials)

Suitable polymer materials, other than cellulose esters, and oligomers may be selected and mixed with the optical film of the present invention. The above polymer materials and oligomers which exhibit excellent compatibility with cellulose ester are preferred. When modified to film, the resulting transmittance is preferably at least 80 percent, more preferably 90 percent, but is still more preferably at least 92 percent. The purpose of mixing at least one of polymer materials and oligomers other than cellulose ester is to enhance physical properties during thermal fusion, viscosity control, and the final treated film. In this case, they may include other additives described above.

### (Film Formation)

The optical film of the present invention is commonly prepared as follows. For example, a mixture of cellulose resins and additives, which has been subjected to hot air drying or vacuum drying, is subjected to melt extrusion in the form of film employing a T-type die, and the resulting film is allowed to adhere onto a cooling drum employing an electrostatic application method, cooled, and solidified, whereby it is possible to obtain a film which is not stretched. It is preferable that the temperature of the cooling drum is maintained in the range of 90-150° C.

Melt extrusion is performed employing a uniaxial extruder and a biaxial extruder. Further, the uniaxial extruder may be linked downstream of the biaxial extruder. In view of the mechanical and optical characteristics of the resulting film, it is preferable to employ a uniaxial extruder. Further, it is preferable that a raw material charging and melting processes which are performed employing, for example, a raw material tank, raw material charging section, and the interior of the extruder are subjected to replacement by inert gases such as nitrogen or a decrease in pressure.

The temperature during the above extrusion of the present invention is preferably in the range of 150-250° C., but is more preferably in the range of 200-240° C.

The content of volatile components during melting of film constituting materials is commonly 0.1 percent by weight or less, preferably 0.5 percent by weight or less, more preferably 0.2 percent by weight or less, but is more preferably 0.1 percent by weight or less. In the present invention, weight decrease was determined from 30 to 350° C., employing a differential thermal weight measurement instrument (TG/DTA200, produced by Seiko Electronic Industry Co.) and the resulting weight was designated as the content of volatile components.

The optical film of the present invention is prepared in such a manner that a melted resinous composition is extruded to form a film, which cooled via a cooled roller.

It is preferable that there are no or few concave portions such as die lines on the film surface of the present invention. It is ideal that there is no concave portions such as die lines. However, in practice, it is difficult to completely eliminate such portions, and occasionally, quite a few portions remain. In cases in which concave portions are present on the surface and when Δd represents the depth of the concave portion, Δd is preferably 0.5 μm or less, more preferably 0.3 μm or less, still preferably 0.1 μm or less, still more preferably 0.05 μm or less, but is most preferably 0.01 μm or less.

As described below, it is preferable that the optical film of the present invention is stretched in the width direction or in the cast direction.

The stretched film is subjected to slitting of both edges and then wound. Since a part of cellulose resin and additives in slit edge portions (return materials) may decompose due to heat at the time of melting and forming a film, it may be preferable to discard these slit edge portions in this case without recycling and the return materials are not used as a part of raw materials. However, return materials in which cellulose resin and additives rarely decompose may be used again or recycled as a part of raw materials. The ratio of the recycled materials incorporated in melt materials is preferably 1-50 percent. It is preferable that the slit edge portions are cut into small pieces of 1-30 mm and are employed to prepare a melt composition. If desired, after re-drying, the resulting materials are recycled as a part of raw materials. The slit portions may be converted into pellets and employed to prepare a melt composition. Further, it is preferable that slit portions are stored until re-melt so that no moisture absorption occurs. In order to achieve the above, it is preferable that processes such as conveying of film edge portions from the slitting section, the cutting process and storage process are performed in ambience of low humidity or in the absence of water and under dehumidified air. Further, it is preferable that oxygen concentration is lowered. The oxygen concentration is commonly at most 10 percent, is preferably at most 5 percent, is more preferably at most 1 percent, but is most preferably at most 0.1 percent. For example, it is preferable that processes are performed in an ambience of dehumidified nitrogen. It is preferable that the processes from melt-extrusion to slitting are conducted at a low humidity or at an ambience of no moisture. Further, it is preferable that oxygen concentration is lowered. It is particularly preferable that the ambience of the melt-extrusion section is maintained at a combination of low humidity and lowered oxygen concentration.

In cases in which in a stretching process, stretching is performed while exposed to steam, or treated returning materials are recycled, it is preferable that the returning materials, of which moisture has been removed, is recycled as a part of the raw material.

It is also possible to prepare a laminated cellulose ester film by co-extruding compositions incorporating cellulose ester resins in which the concentration of the above plasticizers, UV absorbents, and minute particles differ. For example, it is possible to prepare a cellulose ester film having a constitution of a skin layer/a core layer/a skin layer. For example, minute particles are incorporated in the skin layer in an greater amount or only in the skin layer. It is possible to incorporate plasticizers and UV absorbents in a greater amount in the core layer than the skin layer or incorporate them only in the core layer. Further, it is possible to change the types of plasticizers and UV absorbents in the core layer and skin layer. For example, it is possible to incorporate low volatile plasticizers and/or UV absorbents in the skin layer and to incorporate excellent plasticizers or excellent UV absorbs in the core layer. Tg of the skin layer may be different from that of the core layer, but Tg of the core layer is preferably lower than that of the skin layer. Further, the viscosity of the skin layer of the melt material during melt extrusion may be different from that of the core layer and it is acceptable that the viscosity of the skin layer>the viscosity of the core layer or the viscosity of the core layer≧the viscosity of the skin layer.

By employing a co-extrusion method, it is possible to result in distribution of the concentration of additives such as a plasticizer in the thickness direction and to decrease their content in the surface. On the other hand, by performing single layer extrusion, it is possible to obtain a uniform film in which the concentration of additives decreases in the thickness direction, whereby it is preferably employed.

The film width of the present invention is preferably 1 to 4 m, is more preferably 1.3 to 3 m, but is still more preferably 1.4 to 2 m. The thickness is preferably 10 to 500 μm, is more preferably 20 to 200 μm, is still more preferably 30 to 150 μm, but is most preferably 60 to 120 μm. The length per roll is preferably 300 to 6,000 m, is more preferably 500 to 5,000 m, but is more preferably 1,000 to 4,000 m. When wound, knurling is applied to at least one edge and preferably both edges. The width is commonly 3 to 50 mm, but is preferably 5 to 30 mm, while the height is commonly 5 to 500 μm, but is preferably 8 to 200 μm, is more preferably 10 to 50 μm. One sided or double-sided knurling may be employed.

### (Stretching Operation)

The preferred stretching operation of the optical film of the present invention will now be described.

It is preferable that the optical film of the present invention is subjected to phase difference control employing the stretching operation described below, whereby it is possible to achieve the phase difference in the preferred range by stretching 1.0-2.0 times in one direction of the cast cellulose ester and 1.01 to 2.5 times in the direction at right angles to it in the interior of the film surface.

For example, it is possible to successively or simultaneously perform stretching in the longitudinal direction and the direction at right angles to it in the interior of the film surface, namely across the width of the film. During the above stretching, when the stretching ratio in one direction is excessively small, it is not possible to achieve sufficient phase difference, while when it is excessively large, it becomes difficult to perform stretching, whereby breakage occasionally occurs.

In cases in which stretching is performed in the melt cast direction, when width-wise contraction is excessively large, the refractive index of the film in the thickness direction becomes excessively large. In this case, improvement is achieved by minimizing the width-wise contraction of the film or by performing width-wise stretching. In cases in which width-wise stretching is performed, a distribution of the resulting index occasionally results width-wise. This occasionally occurs in the use of the tenter method. This is phenomenon which is formed in such a manner that by performing width-wise stretching, contraction force is generated in the central portion of the film, while the edge portion is fixed and is assumed to be so-called boing phenomenon. Even in this case, it is possible to retard the boing phenomenon by performing the above casting direction stretching and to minimize the width-wise phase difference distribution.

Further, by stretching in the biaxial directions, being at right angles to each other, it is possible to decrease the thickness variation of the resulting film. When the thickness variation of an optical film is excessively large, uneven phase difference results, and when employed in liquid crystal displays, problems of non-uniformity such as coloration occasionally occur.

It is preferable that the thickness variation of the optical film of the present invention is controlled in the range of ±3 percent and further ±1 percent. To achieve the above purposes, a method is effective in which stretching is performed in the biaxial directions which are in right angles to each other. It is preferable that stretching magnification in the biaxial directions which are in right angles to each other is finally preferably in the range of 1.0 to 2.0 times in the cast direction and in the range of 1.01 to 2.5 times in the width direction and more preferably in the range of 1.01 to 1.5 times in the cast direction and in the range of 1.05 to 2.0 times in the width direction.

As a phase different film, in order to control retardation in the plane or thickness direction, it may be possible to perform free edge uniaxial stretching in the cast direction or the width direction, or unbalanced biaxial stretching in which stretching is performed in the width direction while contraction is performed in the cast direction. The stretching magnification in the contraction direction is preferably at a factor of 0.7 to 1.0.

In the case of use of cellulose ester resulting in positive birefringence for stress, by performing width-wise stretching, it is possible to provide delayed phase axis of the optical film in the width direction. In this case, in the present invention, in order to enhance listed quality, it is preferable that the delayed phase axis of the optical film is in the width direction and to satisfy (stretching magnification in the width direction)>(stretching magnification in the cast direction).

A film, which has been formed by extruding a melt resinous composition and subsequently cooling the resulting extruded material employing a cooling roller, is subjected to preliminary heat treatment prior to stretching, preferably at 50 to 200° C., more preferably at 50 to 180° C., still more preferably 60 to 160° C., but most preferably at 70 to 150° C., and preferably for 5 seconds to 3 minutes, more preferably for 10 seconds to 2 minutes, but most preferably for 15 to 90 seconds. It is preferable that the above heat treatment is performed between just prior to holding a film employing a tenter and just prior to the start of stretching. It is particularly preferable that the heat treatment is performed between holding the film employing the tenter and just prior to the start of film stretching.

Stretching is preferably performed at 5 to 300 percent/minute, more preferably at 10 to 200 percent/minute, but still more preferably at 15 to 150 percent/minute. Such stretching is preferably performed at 80 to 180° C., more preferably at 90 to 160° C., but still more preferably at 100 to 150° C. It is preferable that stretching is performed employing a tenter while both ends of the film are held.

The stretching angle is preferably 2° to 10°, more preferably 3° to 7°, but most preferably 3° to 5°. The stretching rate may be constant or may vary.

It is preferable that the ambient temperature during the tenter process exhibits minimal distribution. Variation across the width is preferably within ±5° C., more preferably within ±2° C., still more preferably within ±1° C., but most preferably within ±0.5° C. It is preferable that in the tenter process, a heat treatment is performed preferably in the range of a heat conductivity of 20 to 130×10³ J/m² hr, more preferably in the range of 40 to 130×10³ J/m² hr, but most preferably in the range of 42 to 84×10³ J/m² hr.

During film casting, the conveyance rate in the longitudinal direction is preferably 10 to 200 m/minute, but is more preferably 20 to 120 m/minute.

The film conveying tension during the casting process in the tenter varies depending on temperature, but is preferably 120 to 200 N/m, is more preferably 140 to 200 N/m, but is most preferably 140 to 160 N/m.

In order to minimize undesired film elongation during the casting process, it is preferable to arrange a tension reduction roller prior to or after the tenter.

It is preferable that biaxial stretching in the present invention is performed by applying tension in the longitudinal direction (the conveying direction) during roll conveyance. It is preferable that as a method to apply tension in the conveying direction, conveying rollers which differ in their peripheral rate are employed, or two paired nipping rollers are employed and tension is applied between them.

It is preferable that one or both of the above nipping rollers are covered with rubber. When the moisture content of stretched film is relatively high, the film tends to slip, whereby it is preferable to use nipping rollers covered with rubber. Listed as rubber materials are natural rubber and synthetic rubber (such as neoprene rubber, styrene-butadiene rubber, silicone rubber, urethane rubber, butyl rubber, nitrile rubber, or chloroprene rubber). The thickness of the rubber covering is preferably 1 to 50 mm, is more preferably 2 to 40 mm, but is most preferably 3 to 30 mm. The diameter of a nipping roller is preferably 5 to 100 cm, is more preferably 10 to 50 cm, but is most preferably 15 to 40 cm. A preferred nip roller is such that its interior is hollow so that it is possible to regulate the temperature from its interior.

When two paired nipping rollers are employed, it is preferable that stretching is performed in such a manner that the temperature in the span of the two paired nipping rollers is 5 to 50° C. higher than the temperature of the nipping roller on the inlet side. It is preferable that the distance of the span of two paired nipping rollers is 1 to 10 times the film width prior to stretching but is preferably 2 to 8 times. It is preferable to employ two paired nipping rollers arranged as above and to perform stretching in such a manner that the temperature at both edges is 5 to 50° C. higher than in the central portion.

Further, in this case, it is preferable to perform stretching so that stretching rate S per second preferably satisfies 0.2WL1≦S≦2WL1, more preferably 0.3 WL1≦S≦1.8WL1, but still more preferably 0.4WL1≦S≦1.5WL1, wherein WL1 represents the width of the film with respect to the conveying direction prior to stretching. By setting the span distance in the above range and controlling the stretching rate, it is possible to obtain a stretched film of minimal uneven film thickness and uneven retardation. It is desired to maintain the stretching temperature between the spans of two paired nipping rollers at specified temperature. To achieve the above, it is preferable that the space between two paired nipping rollers is placed in a thermostat so that during film stretching, the specified temperature is maintained. It is preferable to control the temperature of the film by feeding temperature-controlled air from the upper and lower sides of the film. In this case, it is possible to make the width-wise temperature uniform, but the temperature at both edges is preferably 1 to 50° C. higher than the central portion, but more preferably 5 to 40° C. higher. It is still more preferable that stretching is performed so that the temperature of both edges is 10 to 35° C. higher than in the central portion. By performing stretching while width-wise temperature distribution is achieved, it is possible to decrease the distribution of the width-wise retardation (Ro and Rt). It is possible to achieve the temperature increase of the edge portions employing a method in which a heat radiating source, such as an infrared heater or a halogen lamp is employed or slits which feed heated air are locally arranged. Incidentally, the temperature at the stretching portions is preferably 100 to 180° C. at the central portion in the film width direction, is more preferably 110 to 170° C., but is still more preferably 120 to 160° C. It is particularly preferable that the central portion between nipping rollers is at the temperature in the above range.

Stretching is performed so that the temperature between two paired nipping rollers is 5 to 50° C. higher than the temperature on the nipping rollers of the inlet side, more preferably 7 to 40° C., but still more preferably 10 to 30° C. Temperature between two paired nipping rollers, as described herein, refers to the average temperature of the ½ part of the central portion of the nipping roller span. During typical stretching, the temperature in the longitudinal direction is maintained to be uniform during stretching, but it is possible to provide the above temperature distribution. Namely, when the entire interior of a stretching zone is uniformly maintained, stretching is achieved over the entire portion of the stretching zone. Namely, stretching is initiated from the nipping roller on the inlet side. However, the film is fixed on the nipping roller, whereby it is not possible to perform width-wise neck-in. However, when removed from that, neck-in is rapidly initiated. In such a manner, width-wise stress varies discontinuously, whereby width-wise stress marks tend to be generated, resulting in thickness marks and Re marks. In the present invention, by making the temperature higher than that of the nipping roller on the inlet side, it is possible to set backward the stretching initiation point from the nipping rollers. As a result, the stretching initiation point is not restricted by the nipping rollers, whereby discontinuous stress variation, as described above, does not occur to minimize Re marks and thickness marks due to stress marks. It is preferable that such a temperature distribution in the longitudinal direction is provided to the central portion across the width and at least one of edge portions. It is possible to easily control the temperature of the inlet nipping rollers in such a manner that at least one nipping roller is modified to a temperature controlling roller. For example, a hollow roller is employed and temperature-controlled liquid is re-circulated in the interior, or a heat source such as IR heater is placed in the interior and its output is controlled.

The nip pressure of nipping rollers is preferably 0.5 to 20 t per meter, more preferably 1 to 10 t, but is still more preferably 2 to 7 t. In the present invention, stretching is performed preferably in the temperature range of 50 to 150° C., more preferably in the range of 60 to 140° C., but is still more preferably in the range of 70 to 130° C. It is common that temperature is uniformly maintained in the width direction and in the longitudinal direction, but in the present invention, it is preferable that a temperature difference is provided for one of them. The above temperature difference is preferably 1 to 20° C., is more preferably 2 to 17° C., but is still more preferably 2 to 15° C. The glass transition point (Tg) of a moisture containing film is lowered, whereby it is possible to perform stretching employing weak stress. However, neck-in tends to occur to result in uneven stretching. In order to minimize such a drawback, it is effective to provide the temperature distribution described below.

### (Temperature Distribution in the Longitudinal Direction)

In nipping roller stretching, stress tends to concentrate in the outlet (namely, a stretching initiation point) of the nipping roller on the upstream side, whereby stretching is mainly performed there and uniform stretching is hardly performed. In order to perform uniform stretching over the entire region, it is preferable that the temperature just after the upstream nipping rollers is controlled to be lower by the above temperature than the average temperature (namely the temperature at the center of the stretching portion in the longitudinal direction). It is possible to achieve such a temperature distribution as follows. A nip roller on the upstream side is modified to a temperature controlling roller and the temperature of the modified roller is lowered. Alternatively, it is possible to employ divided heat sources (heat radiating sources such as an IR heater or a plurality of heated air blowing apertures).

### (Temperature Distribution in the Width Direction)

In the case of stretching at a small aspect ratio, uneven stretching in the width direction tends to result. Namely, both edges are more easily stretched than the central portion. Accordingly, it is preferable that the temperature of both edges is the above temperature higher than the central portion in the width direction. It is possible to achieve such temperature distribution employing divided heat sources (being heat radiating sources such as an IR heater or a plurality of heated air blowing apertures) arranged along the width direction.

The above stretching is performed preferably within 1 to 30 seconds, more preferably within 2 to 25 seconds, but still more preferably within 3-20 seconds.

After stretching, it is preferable that residual distortion is relaxed employing a heat treatment. The heat treatment is commonly performed at 80 to 200° C., preferably at 100 to 180° C., but still more preferably at 130 to 160° C. In the above case, the heat treatment is performed preferably in the range of a heat conductivity of 20 to 130×10³ J/m² hr, more preferably in the range of 40 to 130×10³ J/m² hr, but most preferably in the range of 42 to 84×10³ J/m² hr. By doing so, the residual distortion is eliminated, whereby dimensional stability at high temperature such as 90° C., or high temperature and high humidity such as 80° C. and 90 percent RH is improved.

After stretching, the film is cooled to room temperature. It is preferable that the stretched film is cooled while it is subjected to width holding by the tenter. Relaxation is preferably performed in such a manner that the width hold by the tenter is reduced preferably by 1 to 10 percent, more preferably by 2 to 9 percent, but still more preferably by 2 to 8 percent with respect to the film width after stretching. A practical cooling rate is preferably 10 to 300° C. per minute, more preferably 30 to 250° C. per minute, but still more preferably 50 to 200° C. per minute. Cooling to room temperature may be performed under tenter holding. However, it is preferable that on the way, holding is terminated and roll conveying is employed. Thereafter, roll winding is performed.

The optical film of the present invention, produced as above, exhibits the following characteristics.

### (Optical Characteristics)

In the polarizing plate protective film of the present invention, it is preferable that retardation value Ro, defined by Formula (I) below, is in the range of 0 to 300 nm and retardation value Rt, defined by Formula (II) below, is in the range of −600 to 600 nm. Further, value Ro is more preferably in the range of 0 to 80 nm and value Rt is more preferably in the range of −400 to 400 nm, while value Ro is most preferably in the range of 0 to 40 nm and value Rt is most preferably on the range of −200 to 200 nm.

In cases in which the polarizing plate protective film of the present invention is employed as a phase difference film, especially as a λ/4 plate, birefringence in the wavelength range of 400 to 700 nm increases as the wavelength increases, the retardation value (R450) in the plane direction determined at a wavelength of 450 nm is 80 to 125 nm, and the retardation value (R590) in the plane direction determined at a wavelength of 590 nm is 120 to 160 nm. In this case, it is more preferable that R590−R450≧5 nm, while it is most preferable that R590−R450≧10 nm. It is preferable that R450 is 100 to 120 nm; retardation value R550 in the in-plane direction determined at a wavelength of 550 m is 125 to 142 nm; R590 is 130 to 152; and R590−R550≧2 nm. It is more preferable that R590−R550≧5 nm, while it is most preferable that R590−R550≧10 nm. Further, it is also preferable that R550−R450≧10 nm.

Ro=(nx−ny)×d Formula (I)

Rt={(nx+ny)/2−nz}×d Formula (II)

wherein nx represents the refractive index in the direction in which the refractive index in the film plane is maximum, ny represents the refractive index in the film plane in the direction in right angles to nx, nz represents the refractive index in the thickness direction of film, and d represents the film thickness.

By controlling the retardation value to the above range, it is possible to sufficiently satisfy optical performance of phase difference film for polarizing plates.

It is preferable that refractive index nx in the delayed phase axis direction in the plane determined at a wavelength of 590 nm of the film of the present invention, refractive index ny in the direction in right angles to the delayed phase axis in the plane, and refractive index nz in the thickness direction satisfy the relationship of 0.3≦(nx−nz)/(nx−ny)≦2, but it is more preferably that they satisfy the relationship of 1≦(nx−nz)/(nx−ny)≦2.

Further, the difference between refractive index nx in the delayed phase axis direction and refractive index ny in the advanced phase direction in the film plane of the polarizing plate protective film of the present invention is preferably 0 to 0.0050, but is more preferably 0.0010 to 0.0030. Further, the absolute value of (Nx+Ny)/2−Nz is preferably at most 0.005.

Ratio Rt/Ro is preferably −10 to 10, is more preferably −2 to 2, is still more preferably −1.5 to 1.5, but is most preferably −1 to 1. The more preferred range is selected depending on utilization and then employed.

Moisture dependence of value Ro and value Rt of polarizing plate protective film determined at a wavelength of 590 nm is preferably 2%/% RH and 3%/% RH in terms of the absolute value, respectively, in the range of 30° C. 15% RH to 30° C. 85% RH.

It is preferable that value Rt (Rt450) determined at a wavelength of 450 nm and value Rt (Rt650) determined at a wavelength of 650 nm satisfy the relationship of the following formula.

0≦|Rth450−Rth650|≦35 (nm)

Temperature dependence of value Ro and value Rt in the range of 5 to 85° C. is at most 5%/° C. and at most 6%/° C. in terms of the absolute value, respectively.

In the polarizing plate protective film of the present invention, moisture dependence of value Ro and value Rt in the range of 30° C. 15% RH to 0.30° C. 85% RH is at most 2%/% RH and 3%/% RH in terms of the absolute value, respectively.

Humidity dependence of value Ro and value Rt from 15% RH to 85% RH from 15° C. to 40° C. is preferably as small as possible. For the value of each temperature at 50% RH, humidity dependence is preferably at most 2%.% RH and 3%/% RH in terms of the absolute value, respectively. Specifically, humidity dependence from 30° C. 15% RH to 30° C. 85% RH is preferably at most 2%/% RH and at most 3%/% RH in terms of the absolute value, respectively, but is most preferably at most 1.5%/% RH and 2.5%/% RH, respectively.

It is preferable that these exhibit smaller difference of the equilibrium moisture content at the different moisture conditions. For example, at two moisture ambiences of 30° C., 15% RH and 30° C., 85% RH, difference WH of the equilibrium moisture content, represented by the formula below, is preferably at most 2.5%, is more preferably at most 2%, is still more preferably at most 1.5%, is further more preferably at most 1%, but is most preferably at most 0.5%.

WH=equilibrium moisture content at 30° C. and 85% RH−equilibrium moisture content at 30° C. and 15% RH

In order to minimize variation of the equilibrium moisture content, the following methods are effective; the content of plasticizers is increased, additives such as hydrophobic plasticizers or resins incorporating an aromatic ring, a cycloalkyl ring, or a norbornene ring, and relatively high heat treatment temperature after stretching is set (for example 110 to 180° C.).

Further, temperature dependence of value Ro and value Rt from 5° C. to 85° C. from 15% to 85% is preferably as small as possible. For the value at 30° C., the variation of value Ro is preferably within ±5%/° C., while the variation of value Rt is preferably within ±6%/° C. Between 5° C. 55% RH and 85° C. 55% RH, the variation of value Ro is preferably within ±3%/° C. and the variation of value Rt is preferably within ±4%/° C., the variation of value Ro is more preferably within ±1%/° C. and the variation of value Rt is more preferably within ±2%/° C., while the variation of value Ro is most preferably within ±0.5/° C. and the variation of value Rt is most preferably within ±1%/° C.

In the polarizing plate protective film of the present invention, with respect to Ro which is determined by allowing the above film to stand at 55% RH and 23° C. for 24 hours, value Ro which is determined by allowing the above film to stand at 23° C. and 55% RH for 24 hours after being allowed to stand at −30 to 80° C. and 10 to 80% RH for 600 hours is preferably within ±10% but is more preferably within ±3%. In the same manner, with respect to Rt which is determined by allowing the above film to stand at 55% RH and 23° C. for 24 hours, value Rt which is determined by allowing the above film to stand at 23° C. and 55% RH for 24 hours after being allowed to stand at −30 to 80° C. and 10 to 80% RH for 600 hours is preferably within ±10% but is more preferably within ±3%. It is more preferable that even after allowing the above film to stand over a long period such as at least 1,000 hours, the variation is within the above range.

It is preferable that the polarizing plate protective film of the present invention exhibits increasing phase difference in the range of wavelength of 400-700 nm, as the wavelength increases. Specifically, when retardation in the film plane determined at each wavelength of 450 nm, 590 nm, and 650 nm is R450, R590, and R650, respectively, it is preferable that the following relationship is satisfied.

0.5<R450/R590<1.0

1.0<R650/R590<1.5

It is more preferable that the following relationship is satisfied.

0.7<R450/R590<0.95,

1.01<R650/R590<1.2.

It is most preferable that the following relationship is satisfied.

0.8<R450/R590<0.93

1.02<R650/R590<1.1

Birefringence at wavelengths of 450, 590, and 650 nm at an ambience of 23° C. and 55% RH was determined employing an automatic birefringence meter KOBURA-21ADH (produced by Oji Keisoku Co.), and the resulting values were designated as R450, R590, or R650, respectively. Further, with regard to the retardation in the thickness direction, it is preferable to exhibit a larger retardation value as the wavelength increases. It is desirable that the retardation ratio in the thickness direction at each wavelength of 450, 590 and 650 nm is similar to that of the above in-plane retardation.

Retardation values (Ro and Rt) and each distribution were determined as follows. Wavelength 590 nm birefringence of a sample at intervals of one centimeter in the width direction was automatically determined at 23° C. and 55% RH, employing an automatic birefringence meter KOBURA-21ADH (produced by Oji Keisoku Co.). The standard deviation of the resulting retardation in the in-plane direction and the thickness direction was obtained employing the (n−1) method. The variation coefficient (CV) of the retardation distribution was obtained and used as an index. In practical measurement, 130 were set as n.

Variation coefficient (CV)=standard deviation/retardation average

When C (md) represents a photoelastic coefficient in the longitudinal direction of a polarizing plate protective film and C (td) represents a photoelastic coefficient in the width direction of the same, each value is preferably in the range of 1×10⁻⁸-1×10⁻¹⁴ Pa⁻¹, but is particularly preferably in the range of 1×10⁻⁹-1×10⁻¹³ Pa⁻¹. The photoelastic coefficient is determined as follows. While applying load to a film, retardation (Ro) in the film plane is determined, and Δn (═R/d) is obtained by dividing the resulting retardation by film thickness (d). While varying applied load, Δn is determined. Subsequently, a load versus Δn curve is prepared and the resulting slope is designated as the photoelastic coefficient. By applying load to a film in the longitudinal direction or in the width direction, it is possible to obtain each value. Retardation (R) in the film plane was determined at a wavelength of 590 nm, employing a retardation measurement instrument (KOBURA 31PR, produced by Oji Keisokuki Co., Ltd.).

It is preferable that photoelastic coefficient C (md) is nearly equal to C (td), or C (td) is greater than C (md).

The delayed phase axis or advanced phase axis of the polarizing plate protective film of the present invention exists in the film plane. Angle θ1 to the casting direction is preferably −1° to +1°, but is more preferably −0.5° to +0.5°. It is possible to define above θ1 as the orientation angle. It is possible to determine θ1 employing an automatic birefringence meter KOBURA-21ADH (produced by Oji Keisokuki Co., Ltd.).

By allowing θ1 to satisfy the above relationship, it is possible to contribute to achieve high luminance of displayed images and to retard or prevent light leakage, as well as to further achieve faithful color reproduction in color liquid crystal display devices.

Other physical properties of the polarizing plate protective film of the present invention will now be described.

### (Moisture Vapor Transmittance)

The moisture vapor transmittance of the polarizing plate protective film of the present invention is preferably 1 to 250 g/m²·24 hours at 25° C. and 90% RH, is more preferably 10 to 200 g/m²·24 hours, but is most preferably 20 to 180 g/m²·24 hours. It is possible to determine the above moisture vapor transmittance employing the method described in JIS Z 0208.

### (Equilibrium Moisture Content)

The equilibrium moisture content of polarizing plate protective film is preferably 0.1 to 3 percent at 25° C. and 60 percent relative humidity, is more preferably 0.3 to 2 percent, but is most preferably 0.5 to 1.5 percent.

It is possible to determine the equilibrium moisture content employing the Carl Fischer method measurement instruments (such as Carl Fischer moisture measurement instrument CA-05, produced by Mitsubishi Chemical Co., Ltd.; water vaporizing device: VA-05; internal liquid: AQUAMICRON CXμ, external liquid: AQUAMICRON AX, nitrogen flow rate: 200 ml/minute, and heating temperature 150° C.). In practice, a sample which has been humidity-conditioned at 25° C. and relative humidity 60 percent for at least 24 hours is accurately weighed in an amount of 0.6-1.0 g and is subjected to determination employing a measurement instrument. Subsequently, it is possible to obtain the equilibrium moisture content based on the resulting weight of water.

In order to secure adhesion to polyvinyl alcohol (being a polarizer), the moisture content of the polarizing plate protective film of the present invention is preferably 0.3 to 15 g/m², but is more preferably 0.5 to 10 g/m². When it is larger than 15 g/m², retardation variation tends to increase due to temperature and humidity variations.

### (Dimensional Stability)

The polarizing plate protective film according to the present invention is preferably excellent in dimensional stability.

### (Dimensional Variation Ratio of Polarizing Plate Protective Film in the Width Direction and Longitudinal Direction)

When polarizing plate protective film is stretched in the width direction, it is preferable that stretching is conducted at conditions to control the resulting dimensional variation ratio within a certain range.

When dimensional variation ratio in the TD direction and the MD direction prior to and after the treatment at a dry condition of 90° C. for 24 hours is represented by Std and Smd, respectively, −0.4%<Std or Smd<0.4% is preferred; −0.2%<Std or Smd<0.2% is more preferred; −0.1%<Std or Smd<0.1% is further more preferred; and −0.05%<Std or Smd
<0.05% is particularly preferred.

When dimensional variation ratio in the TD direction and the MD direction prior to and after treatment at high temperature and high humidity conditions of 80° C. and 90% RH for 24 hours is represented by Std and Smd, respectively, in the same manner as above, −0.4%<Std or Smd<0.4% is preferred; −0.2%<Std or Smd<0.2% is more preferred; −0.1%<Std or Smd<0.1% is further more preferred; and −0.05%<Std or Smd<0.05% is particularly preferred.

### (Determination of Dimensional Variation Ratio)

After conditioning the moisture of the film in the room conditioned at 23° C. and 55 percent relative humidity for 24 hours, marks were made at about 10 cm intervals in the width direction and the longitudinal direction employing a cutter, and distance (L1) was determined. Subsequently, the resulting film was stored in a thermostat conditioned at the specified temperature and humidity for 24 hours. After humidity conditioning the film in a room conditioned at 23° C. and relative humidity 55 percent for 24 hours, the marked distance (L2) was determined. The dimensional variation ratio was evaluated based on the formula below.

Dimensional variation ratio (%)={(L2−L1)/L1}×100

### (Hygroscopic Expansion Coefficient)

It is preferable that the hygroscopic expansion coefficient of the polarizing plate protective film of the present invention is in the specified range. The hygroscopic expansion coefficients in the width direction (TD) and the longitudinal direction (MD) may be the same or different. Specifically, the hygroscopic expansion coefficient at 60° C. and 90 percent relative humidity is preferably in the range of −1 to 1 percent, is more preferably in the range of −0.5 to 0.5 percent, is still more preferably in the range of −0.2 to 0.2 percent, but is most preferably 0 to 0.1 percent.

### <Determination of Hygroscopic Expansion Ratio>

After conditioning the moisture of the film in a room conditioned at 23° C. and 55 percent relative humidity for 24 hours, marks were made at about 20 cm intervals in the width direction and the longitudinal direction employing a cutter, and distance (L3) was determined. Subsequently, the resulting film was stored in a thermostat conditioned at 60° C. and 90% for 24 hours. After removing the film from the thermostat, the marked distance (L4) was determined within two minutes. The hygroscopic expansion coefficient was evaluated based on the formula below.

Hygroscopic expansion coefficient (%)={(L4−L3)/L3}×100

### (Thermal Contraction Initiating Temperature)

The thermal contraction initiating temperature of the polarizing plate protective film of the present invention is preferably in the range of 130 to 220° C., is more preferably 135 to 200° C., but is still more preferably 140 to 190° C. It is possible to determine the thermal contraction initiating temperature employing TMA (a thermal mechanical analyzer). In practice, while heating a film sample, the length of the sample is determined and the temperature is recorded when the sample is subjected to contraction by two percent. The thermal contraction initiating temperature varies depending on the stretching factor. However, it is preferable that a sample in the higher stretching ratio direction exhibits a thermal contraction initiating temperature within the above range.

The higher the thermal contraction initiating temperature becomes, the more preferable due to minimal dimensional change caused by heat. However, when the thermal contraction initiating temperature becomes excessively high, melt temperature during casting becomes higher. As a result, it occasionally becomes difficult to maintain smoothness of the film surface due to decomposition of resins during melting and an increase in melt viscosity. The thermal contraction initiating temperature varies depending on film Tg and distortions remaining in the cast film, whereby it is possible to adjust the thermal contraction initiating temperature by controlling those. Particularly, in order to minimize distortions remained in film, it is preferable to control stretching conditions (such as a stretching ratio, stretching temperature, or stretching rate), relaxation conditions after stretching, and thermal treatment conditions.

### <Determination of Thermal Initiating Temperature>

Film is cut along the direction to be determined to prepare a sample in a size of 35 mm in length and 3 mm in width. Both edges are chucked at 25 mm intervals in the longitudinal direction. By employing a TMA measurement instrument (THERMOMECHANICAL ANALYZER TYPE TMA2940, produced by TA Instruments Co.) under application of a force of 0.04 N, dimensional change is determined while increasing temperature from 30° C. to 200° C. at a rate of 3° C./minute. The length at 30° C. is taken as a standard and temperature at which contraction of 500 μm from the standard occurs is designated as the contraction initiating temperature.

### <Heat Conductivity>

The heat conductivity of the film of the present invention is preferably 0.1 to 15 W/(m·K), but is more preferably 0.5 to 11 W/(m·K). It is preferable that in order to control the heat conductivity of film, resins of higher heat conductivity are blended or high heat conductive particles are added. It is also possible to prepare film in such a manner that a high heat conductive layer is applied or coextruded. Listed as high heat conductive particles may be particles composed of aluminum nitride, silicon nitride, boron nitride, magnesium nitride, silicon carbide, aluminum oxide, zinc oxide, magnesium oxide, carbon, diamond, and metals. It is preferable to employ transparent particles so that transparency of film is maintained. In cases in which cellulose acetate film is employed as a polymer film, the content of high heat conductive particles is preferably in the range of 5 to 100 parts by weight with respect to 100 parts by weight of cellulose acetate. When the content is less than 5 parts by weight, heat conductivity is not sufficiently enhanced, while exceeding 50 parts by weight results in difficulty in production aspect and brittle film. Further, the average diameter of high heat conductive particles is preferably 0.05 to 80 μm, more preferably 0.1 to 10 μm. The shape of the employed particles may be either spherical or acicular.

### (Tear Strength)

The tear strength of the polarizing plate protective film according to the present invention is preferably 2-55 g at 30° C. and 85 percent relative humidity so that ease of handling in the casting process employing melt extrusion is not deteriorated.

When polarizing plate protective film is stretched in the width direction, it is preferable that stretching is performed at conditions to control the ratio of the tear strength in the machine conveying direction (hereinafter referred to as MD direction) and the width direction (hereinafter referred to as TD direction) in a certain range. When Htd and Hmd each represent tear strength in the TD direction and the MD direction, respectively, their ratio is preferably 0.5<Htd/Hmd<2, is more preferably 0.6<Htd/Hmd<1, is still more preferably, 0.8<Htd/Hmd<1, but is most preferably 0.9<Htd/Hmd<1.

### <Determination of Tear Strength>

After conditioning the humidity of polarizing plate protective film in a room conditioned at 23° C. and 55 percent relative humidity, the resulting film was cut into 50×64 mm pieces. Subsequently, the tear strength was determined based on ISO 6383/2-1983.

### (Dynamic Friction Coefficient)

The dynamic friction coefficient of the film surface of the present invention is preferably at most 1.0, is more preferably at most 0.8, is still more preferably at most 0.4, is still more preferably at most 0.35, is further still more preferably at most 0.30, but is most preferably at most 0.25. As noted above, minute unevenness is formed by adding minute particles to a resinous film and by providing a minute particle containing layer, whereby it is possible to decrease the dynamic friction coefficient.

### (Elastic Modulus)

The elastic modulus of the polarizing plate protective film of the present invention in the width direction (TD) and the longitudinal direction (MD) may be the same or different. Specifically, the elastic modulus is preferably in the range of 1 to 5 GPa, is more preferably in the range of 1.8 to 4, GPa, but is particularly preferably in the range of 1.9 to 3 GPa. The ratio of the elastic modulus in the MD direction to the elastic modulus in the TD direction may be made to 0.3≦(the elastic modulus in the MD direction/the elastic modulus in the TD direction≦3, preferably 0.5≦(the elastic modulus in the MD direction/the elastic modulus in the TD direction≦2. The elastic modulus in each of the MD and TD directions can be controlled by stretching conditions such as a stretching ratio, a stretching temperature and a stretching speed and relaxing after the stretching.

### (Stress at Break)

It is preferable that the stress at break of the polarizing plate protective film of the present invention is maintained in the range of 50-200 MPa. By maintaining the stress at beak in the above range, dimensional stability and flatness are improved. It is possible to control the stress at break utilizing stretching ratio and stretching temperature.

It is preferable to control the stress at break within the range of 70 to 150 MPa, but it is more preferable to control it within the range of 80 to 100 MPa.

### (Elongation at Break)

The elongation at break of the polarizing plate protective film of the present invention is preferably 10 to 120 percent. Particularly, in a film prior to stretching, in any direction in the film plane, elongation at break is preferably in the range of 40 to 100 percent, is more preferably in the range of 50 to 100 percent, but is most preferably in the range of 60 to 90 percent. It is possible to control the elongation at break by controlling the content of additives, resin blending, addition of polymer plasticizers such as polyester and urethane, stretching temperature, stretching ratio, thermal treatments after stretching, and relaxation conditions.

Elongation at break in the stretching direction tends to decrease compared to that prior to stretching, while as the stretching factor increases, it decreases. In the direction at right angles to the stretching direction at a maximum factor on the film plane, it is preferable to maintain the elongation at break prior to film stretching.

The elongation at break of the cellulose ester film in the direction at right angles to the stretched direction at the maximum factor on the film plane is preferably 20 to 120 percent, but is more preferably 30 to 100 percent. The elongation at break of the film of the present invention in the stretched direction at the maximum factor is preferably 10 to 100 percent, is more preferably 12 to 60 percent, but is further more preferably 15 to 30 percent.

By controlling the elongation at break within the above range, it is possible to obtain a film exhibiting excellent flatness and to improve dimensional stability.

Elongation at break is the ratio (in percent) of the magnitude of elongation prior to the break due to elongation. It is possible to determine elongation at break employing a tensile strength tester. A cut sample of a length of 15 cm and a width of 1 cm is prepared with respect to the direction to be determined. The sample which has been humidity-conditioned at 25° C. and 60 percent relative humidity for 24 hours is elongated at the same conditions and elongation at break is determined. In a tensile strength tester, the distance between the chucks is set at 10 cm while the pulling rate is set at 10 mm/minute. The ratio (expressed in percent) of the magnitude of elongation at break to the length of the sample prior to elongation is designated as elongation at break (percent).

### <Determination Method of Elastic Modulus, Elongation at Break, and Stress at Break of Film>

Determination was conducted at 23° C. and 55 percent relative humidity based on the method described in JIS K 7127. A sample was cut into pieces of a width of 10 mm and a length of 130 mm. Tests were performed in such a manner that at optional temperature, the distance between the chucks was set at 100 mm and the pulling rate was set at 100 mm/minute and above values were determined.

### (Center Line Mean Roughness (Ra))

High flatness is required for the polarizing plate protective film of the present invention. Its center line mean roughness (Ra) is preferably 0.0001 to 0.1 μm, is more preferably at most 0.01 μm, but is most preferably 0.001 μm or less. The center line mean roughness (Ra) is the numerical value specified by JIS B 0601 and is determined employing methods, such as a needle contacting method or an optical method.

Center line mean roughness (Ra) was determined employing a non-contact surface micro-shape measurement instrument WYKO NT-2000.

### (Thickness)

The thickness of the cellulose ester film of the present invention is commonly in the range of 5 to 500 μm. When employed as a polarizing plate protective film, in view of dimensional stability of polarizing plates and water barrier properties, the thickness is preferably 20 to 200 μm. Further, as a roll film, the distribution in the longitudinal direction and the width direction is preferably within ±3 percent, is more preferably within ±1 percent, but is most preferably within ±0.1 percent.

The average thickness of a film can be adjusted so as to become desired thickness by the controlling of an extrusion flow rate, the gap distance of a casting port of a die, the speed of a cooling roller.

### (Layer Thickness Distribution)

After humidity conditioning a sample film for 4 hours in the room conditioned at 23° C. and 55 percent relative humidity, the layer thickness was determined at 10 mm intervals in the width direction. Based on the resulting layer thickness distribution data, layer thickness distribution R (%) was calculated based on the formula below.

R(percent)={R(max)−R(min)}×100/R(ave)

wherein R(max) represents the maximum layer thickness, R(min) represents the minimum layer thickness, and R(ave) represents the average layer thickness.

### (Curling)

In the film of the present invention, eaves-shaped curl (curl in the width direction) is preferably at most 30 m⁻¹, is more preferably 25 m⁻¹, but is further more preferably 20 m⁻¹. The curl value, as described herein, is represented by a reciprocal of radius (determined utilizing m units) of curvature of curl, whereby as the value increases, curl is more pronounced. A curl determination method is described below. In the case of large curl, a polymer film is not subjected to an eaves shape but is subjected to a cylindrical shape. Even after the film is subjected to a heat treatment, it is preferable that the resulting curl is within the above range. It is possible to increase or decrease the eaves-shaped curl by providing coating layers. Alternatively, by coating solvents which swell or dissolve film, it is possible to result in curl on the interior side with respect to the coating side, whereby it is possible to control curl within the specified range via a counterbalancing curl.

### (Curl Determination Method)

After allowing the film sample of the present invention to stand at 25° C. and 55 percent relative humidity for three days, the resulting film sample was cut into a piece of 50 mm in the width direction and 2 mm in the longitudinal direction. After humidity conditioning the above film piece at an ambience of 23° C.±2° C. and 55 percent relative humidity for 24 hours, it is possible to determined the curl value of the above film employing a curvature scale. Degree of curl was determined based on A Method of JIS K 7619-1988.

Curl values are expressed by 1/R, wherein R is the radius of curvature, while using m units.

### (Luminescent Spots Due to Foreign Matter)

In the present invention, preferably employed are cellulose resins or melt compositions, which result in minimal luminescent spots due to foreign matter. Luminescent spots due to foreign matter, as described herein, refer to spots which are viewed as a lighting spot due to the light transmission of a light source when a cellulose resinous film sample is placed between cross-nicol arranged polarizing plates and while one side is exposed to light, the other side is viewed. Desired as a polarizing plate protective film for display devices is one which results in minimal luminescent spots due to foreign matter. The number of luminescent spots due to foreign matter at a size of at least 10 μm is preferably at most 100 spots/cm², and is most preferably zero, while the number of the spots at a size of 5 to 10 μm is preferably at most 200 spots/cm², is more preferably at most 50 spots/cm², but is most preferably zero. It is also preferable that luminescent spots due to foreign matter at a size of less than 5 μm are minimized. It is possible to decrease luminescent spots due to foreign matter of polarizing plate protective film by selecting cellulose resins as a raw material which incorporate minimal foreign matter or by filtering cellulose resin solutions or cellulose resinous melt compositions.

### <Determination Method of Luminescent Spots Due to Foreign Matter>

A film sheet was interposed by two polarizing plates in an orthogonal state (being a cross-nicol state), and light was exposed to the exterior side of one of the polarizing plates and the exterior side of the other plate was observed employing a microscope (at a magnification factor of 30). Subsequently, the number of lighting spots (luminescent spots due to foreign matter) per 25 mm² was determined. The resulting luminescent spots due to foreign matter are foreign substances, which are viewed as a lighting spot by being transmitted through spots in which foreign substances are present. Determination was conducted at 10 areas and the number of luminescent spots due to foreign matter per total 250 mm² was determined and the number/cm² was obtained and employed for evaluation.

### (Measurement of Free Volume Radius by Positron Annihilation Lifetime Spectroscopy)

A positron annihilation lifetime and relative intensity were measured under the following measurement condition.

### (Measurement Condition)

| | |
|---|---|
| Positron source: | 22NaCl (intensity: 1.85MBq) |
| Gamma-ray detector: | Plastic scintillator + |
| | Photomultiplier tube |
| Apparatus time resolution: | 290 ps |
| Measurement temperature: | 23° C. |
| Total number of counts: | 1 million counts |
| Specimen size: | 20 mm × 15 mm × 2 mm |

20 pieces of 20 mm × 15 mm sized films were piled to prepare an
about 2 mm thick sample. The sample was dried under vacuum 24 hours.

| | |
|---|---|
| Irradiation area: | A circle of about 10 mm in |
| | diameter |
| Time per channel: | 23.3 ps/ch |

According to the above measurement condition, positron annihilation lifetime spectroscopy was carried out. A three component analysis using a nonlinear least-square method was carried out for the obtained results. When the annihilation times were referred to as, in small order, τ1, τ2 and τ3 and the corresponding intensities were referred to as I1, I2 and I3 (I1+I2+I3=100%), respectively, using the largest annihilation time τ3, a free volume radius R3 (nm) was determined using the following formula. The larger the τ3 value is, the larger the estimated free volume is.

τ3=(½)[1−{R3/(R3+0.166)}+(½π)sin {2πR3/(R3+0.166)}]⁻¹

where, 0.166 (nm) represents the thickness of the electronic layer which is exuding from the wall of a hole.

The above measurements were repeated twice and the mean values were calculated for the determination.

Evaluation of a free volume in polymer by positron annihilation spectroscopy is explained in, for example, MATERIAL STAGE vol. 4, No. 5, 2004, pp. 21-25, The TRC News, No. 80 (July, 2002) PP. 20-22 (published by Toray Research Center), and “BUNSEKI (Analysis)”, 1988, pp. 11-20”.

### (Image Definition)

Image definition is defined in JIS K 7105. When determined employing a 1 mm slit, at least 90 percent is preferred, at least 95 percent is more preferred, but at least 99 percept is most preferred.

A functional layer which may be formed on the surface of the polarizing plate protective film of the present invention will now be described.

### (Formation of Functional Layers)

During production of the polarizing plate protective film of the present invention, prior to/after stretching, coated may be functional layers such as a transparent conductive layer, a hard coating layer, an antireflection layer, a lubricating layer, an adhesion aiding layer, a glare shielding layer, a barrier layer, or an optical compensating layer. Specifically, it is preferable to arrange at least one layer selected from the group consisting of a transparent conductive layer, an antireflection layer, an adhesion aiding layer, a glare shielding layer, and an optical compensating layer. In such a case, if desired, it is possible to conduct various surface treatments such as a corona discharge treatment, a plasma treatment, or a chemical treatment.

### <Transparent Conductive Layer>

In the film of the present invention, it is preferable to provide a transparent conductive layer, employing surface active agents or minute conductive particles. The film itself may be made to be conductive or a transparent conductive layer may be provided. In order to provide antistatic properties, it is preferable to provide a transparent conductive layer. It is possible to provide the transparent conductive layer employing methods such as a coating method, an atmospheric pressure plasma treatment, vacuum deposition, sputtering, or an ion plating method. Alternatively, by employing a co-extrusion method, a transparent conductive layer is prepared by incorporating minute conductive particles into the surface layer or only into the interior layer. The transparent conductive layer may be provided on one side of the film or on both sides. Minute conductive particles may be employed together with matting agents resulting in lubrication or may be employed as a matting agent.

Preferred as examples of metal oxides are ZnO, TiO₂, SnO₂, Al₂O₃, In₂O₃, SiO₂, MgO, BaO, MoO₂, and V₂O₅ or composite oxides thereof. Of these, Zn, TiO₂, and SnO₂ are particularly preferred. As an example of incorporating a different type of atom, it is effective that Al and In are added to ZnO, Nb and Ta are added to TiO₂, or Sb, Nb and halogen elements are added to SnO₂. The addition amount of these different types of atoms is preferably in the range of 0.01-25 mol percent, but is most preferably in the range of 0.1-15 mol percent.

In the present invention, the transparent conductive layer may be formed in such a manner that minute conductive particles are dispersed into binders and provided on a substrate, or a substrate is subjected to a subbing treatment onto which minute conductive particles are applied.

Further, it is possible to incorporate the ionen conductive polymers represented by Formulas (I)-(V), described in paragraph 0038-0055 of JP-A No. 9-203810, and quaternary ammonium cationic polymers represented by Formula (1) or (2), described in paragraphs 0056-0145 of the above patent.

Further, to result in a matted surface and to improve layer quality, heat resistant agents, weather resistant agents, inorganic particles, water-soluble resins, and emulsions may be incorporated into the transparent conducive layer composed of metal oxides within the amount range which does not adversely affect the effects of the present invention.

Binders employed in the transparent conductive layer are not particularly limited as long as they exhibit film forming capability. Listed as binders may, for example, be proteins such as gelatin or casein; cellulose compounds such as carboxymethyl cellulose, hydroxyethyl cellulose, acetyl cellulose, diacetyl cellulose, or triacetyl cellulose; saccharides such as dextran, agar, sodium alginates, or starch derivatives; and synthetic polymers such as polyvinyl alcohol, polyvinyl acetate, polyacrylates, polymethacrylates, polystyrene, polyacrylamides, poly-N-vinylpyrrolidone, polyester, polyvinyl chloride, or polyacrylic acid.

Particularly preferred are gelatin (such as alkali process gelatin, acid process gelatin, oxygen decomposition gelatin, phthalated gelatin, or acetylated gelatin), acetyl cellulose, diacetyl cellulose, triacetyl cellulose, polyvinyl acetate, polyvinyl alcohol, butyl polyacrylate, polyacrylamide, and dextran.

### <Antireflection Film>

It is preferable that a hard coating layer and an antireflection layer are provided on the surface of the optical film of the present invention to be an antireflection film.

Preferably employed as the hard coating layer is an actinic radiation curable resinous layer or heat curable resinous layer. The hard coating layer may be provided directly onto the support or on the other layer such as an antistatic layer or a subbing layer.

In cases in which an actinic radiation curable resinous layer is provided as a hard coating layer, it is preferable to incorporate actinic radiation curable resins which are subjected to curing by exposure to ultraviolet radiation.

In view of optical design, the refractive index of the hard coating layer is preferably in the range of 1.45 to 1.65. Further, in view of providing the antireflection film with sufficient durability, impact resistance, and appropriate flexibility, as well as economics during production, the thickness of the hard coating layer is preferably in the range of 1 to 20 μm, but is more preferably 1 to 10 μm.

The actinic radiation curable resinous layer, as described herein, refers to the layer incorporating, as a main component, resins which undergo crosslinking reaction via exposure to actinic radiation (“actinic radiation”, as described in the present invention, includes all electromagnetic waves such as electron beams, neutron beams, X-rays, alpha rays, ultraviolet rays, visible rays, or infrared rays) and are cured. Listed as actinic radiation curable resins are ultraviolet radiation curable resins and electron beam curable resins as representative ones. However, resins may be employed which are subjected to curing via exposure to radiation other than ultraviolet rays or electron beams. Listed as ultraviolet radiation curable resins may, for example, be ultraviolet radiation curable acryl urethane based resins, ultraviolet radiation curable polyester acrylate based resins, ultraviolet radiation curable epoxy acrylate based resins, ultraviolet curable polyol acrylate based resins, or ultraviolet radiation curable epoxy resins.

It is also possible to list ultraviolet radiation curable acryl urethane based resins, ultraviolet radiation curable polyester acrylate based resins, ultraviolet radiation curable epoxy acrylate resins, ultraviolet radiation curable polyol acrylate based resins, or ultraviolet radiation curable epoxy resins.

Further, it is possible to incorporate photoreaction initiators and photosensitizers. Specifically listed are acetophenone, benzophenone, hydroxybenzophenone, Michler's ketone, α-amiloxim ester, and thioxanthone, as well as derivatives thereof. Further, when photoreaction agents are employed in the synthesis of epoxy acrylate based resins, it is possible to employ sensitizers such as n-butylamine, triethylamine, and tri-n-butylphosphine. The content of photoreaction initiators or photosensitizers incorporated in an ultraviolet radiation curable resin composition, from which solvent components which volatilize after coating and drying are removed, is preferably 2.5 to 6 percent by weight with respect to the composition.

Resin monomers include, for example, as a monomer having one unsaturated double bond, common monomers such as methyl acrylate, ethyl acrylate, butyl acrylate, vinyl acetate, benzyl acrylate, cyclohexyl acrylate, or styrene. Further, listed as monomers having at least two unsaturated double bonds may be ethylene glycol diacrylate, propylene glycol diacrylate, divinylbenzene, 1,4-cyclohexane diacrylate, and 1,4-cyclohexyldimethyl acrylate, as well as trimethylolpropane triacrylate and pentaerythritolpropane acrylate, described above.

Further, UV absorbents may be incorporated in an ultraviolet radiation curable resin composition in the amount which does not hinder actinic radiation curing of the above ultraviolet radiation curable resin composition.

In order to enhance heat resistance of cured layers, antioxidants which do not retard actinic radiation curing reaction are selected and then employed. For example, listed may be hindered phenol derivatives, thiopropionic acid derivatives, and phosphite derivatives. Specific examples include 4,4′-thiobis(6-t-3-methylphenol), 4,4′-bytylidenebis(6-t-butyl-3-methylphenol), 1,3,5-tris(3,5-di-t-butyl-4-hydroxybenzyl)isocyanurate, 2,4,6-tris(3,5-di-t-butyl-4-hydroxybenzyl)mesitylene, and d-octadecyl-4-hydroxy-3,5-di-butylbenzyl phosphate.

Selected and employed as ultraviolet radiation curable resins may, for example, be ADEKA OPTOMER KR and BY Series such as KR-400, KR-410, KR-550, KR-566, KR-567, or BY-320B (all produced by Asahi Denka Kogyo Co., Ltd.); EIKOHARD such as A-101-KK, A-101-WS, C-302, C-4,0-N, C-501, M-101, M-102, T-102, D-102, NS-101, FT-102Q8, MAG-1-P20, AG-106, or M-101-C (all produced by Koei Chemical Industry Co., Ltd.); SEKABEAM such as PHC2210(S), PHCX-9 (K-3), PHC2213, DP-10, DP-20, DP-30, P1000, P1100, P1200, P1300, P1400, P1500, P1600, or SCR900 (all produced by Dainichi Seika Industry Co., Ltd.); KRM7033, KRM7039, KRM7130, KRM7131, UVECRYL29201, and UVECRYL29202 (all produced by Daicel UCB Co., Ltd.); RC-5015, RC-5016, RC-5020, RC-5031, RC-5100, RC-5102, RC-5120, RC-5122, RC-5152, RC-5171, RC-5180, and RC-5181 (all produced by Dainippon Ink & Chemicals Co., Ltd.); ORLEX No. 340 CLEAR (produced by Chugoku Paint Co., Ltd.); SUNRAD H-601 (produced by Sanyo Chemicla Industry Co., Ltd.); SP-1509 and SP-1507 (both produced by Showa Polymer Co., Ltd.); RCC-15C (produced by Grace Japan Co., Ltd.); ARONIX M-6100, M-8030, and M-8060 (all produced by To a Gosei Co., Ltd.), as well as any other commercially available products.

In the coating compositions of the actinic radiation curable resinous layer, the solid concentration is preferably 10 to 95 percent by weight, and suitable concentration is selected based on coating methods.

Employed as a radiation source to form a cured layer via the actinic radiation curing reaction of actinic radiation curable resins may be any of the radiation sources which generate ultraviolet radiation. Practically, it is possible to employ the radiation sources described in the above radiation item. Exposure conditions vary depending on each of the lamps. Exposure amount is preferably in the range of 20 mJ/cm² to 10,000 mJ/cm², but is more preferably in the range of 50 mJ/cm² to 2,000 mJ/cm². From the near infrared region to the visible region, it is possible to use sensitizers which exhibit the maximum absorption in the above range.

Solvents which are employed during coating of the actinic radiation curable resinous layer are suitably selected, for example, from hydrocarbons (toluene and xylene); alcohols (methanol, ethanol, isopropanol, butanol, and cyclohexanol); ketones (acetone, methyl ethyl ketone, and methyl isobutyl ketone); ketone alcohols (diacetone alcohol); esters (methyl acetate, ethyl acetate, and methyl lactate); glycol ethers, and other organic solvents, and then employed. It is possible to blend these and to use the resulting mixture. It is preferable to employ the above solvents which incorporate propylene glycol monoalkyl ether (the number of carbon atoms of the alkyl group being 1 to 4) or propylene glycol monoalkyl ether acetate (the number of carbon atoms of the alkyl group being 1 to 4) in an amount of preferably at least 5 percent by weight or more preferably 5 to 80 percent by weight.

Employed as a coating method of an actinic radiation curable resinous composition coating liquid are prior art methods employing coaters such as a gravure coater, a spinner coater, a wire bar coater, a roller coater, a reverse coater, an extrusion coater, or an air-doctor coater. The coated amount is suitably 0.1 to 30 μm in terms of wet layer thickness, but is preferably 0.5 to 15 μm. The coating rate is preferably in the range of 10 to 80 m/minute.

The actinic radiation curable resinous composition is coated and subsequently dried, and then is exposed to ultraviolet radiation. Exposure time is preferably 0.5 second to 5 minutes, but is more preferably 3 seconds to 2 minutes in view of the curing efficiency of ultraviolet radiation curable resins and operation efficiency.

Thus, it is possible to obtain a cured coating layer. In order to provide glare shielding properties with the panel surface of liquid crystal display devices, to minimize adhesion to other substances, and to enhance abrasion resistance, it is possible to incorporate minute inorganic or organic particles into the curable layer coating composition.

For example, listed as minute inorganic particles may be those composed of silicon oxide, zirconium oxide, titanium oxide, aluminum oxide, tin oxide, zinc oxide, calcium carbonate, barium sulfate, talc, kaolin, and calcium sulfate.

Further listed as minute organic particles may be polymethacrylic acid methyl acrylate resin powder, acryl styrene based resinous powder, polymethyl methacrylate resinous powder, silicone based resinous powder, polystyrene based resinous powder, polycarbonate resinous powder, benzoguanamine based resinous powder, melamine based resinous powder, polyolefin based resinous powder, polyester based resinous powder, polyamide based resinous powder, polyimide based resinous powder, or fluorinated ethylene based resinous powder. It is possible to incorporate these into ultraviolet radiation curable resinous compositions and then to employ them. The average particle diameter of these minute particle powders is commonly 0.01 to 10 μm. The used amount is preferably 0.1 to 20 parts by weight with respect to 100 parts by weight of the ultraviolet radiation curable resin composition. In order to provide glare shielding properties, it is preferable that minute practices of an average particle diameter of 0.1 to 1 μm are employed in an amount of 1 to 15 parts by weight with respect to 100 parts by weight of the ultraviolet radiation curable resin composition.

By incorporating such minute particles into ultraviolet radiation curable resins, it is possible to form a glare shielding layer exhibiting the preferred unevenness of center line mean surface roughness Ra of 0.05 to 0.5 μm. Further, when the above minute particles are not incorporated into ultraviolet radiation curable resin compositions, it is possible to form a hard cost layer exhibiting the desired smooth surface of a center line means roughness Ra of less than 0.05 μm, but preferably 0.002 to 0.04 μm.

Other than these, as a material to result in a blocking prevention function, it is possible to employ microscopic particles of a volume average particle diameter of 0.005 μm to 0.1 μm which are the same components as above in an amount of 0.1 to 5 parts by weight with respect to 100 parts by weight of the resin composition.

An antireflection layer is provided on the above hard coating layer. The providing methods are not particularly limited, and a common coating method, a sputtering method, a deposition method, CVD (chemical vapor deposition) method and an atmospheric pressure plasma method may be employed individually or in combination. In the present invention, it is particularly preferable to provide the antireflection layer employing a common coating method.

Listed as methods to form the antireflection layer via coating are a method in which metal oxide powder is dispersed into binder resins dissolved in solvents and the resulting dispersion is coated and subsequently dried, and a method in which ethylenic unsaturated monomers and photopolymerization initiators are incorporated and a layer is formed via exposure to actinic radiation.

In the present invention, it is possible to provide an antireflection layer on the cellulose ester film provided with an ultraviolet radiation curable resinous layer. In order to decrease reflectance, it is preferable to form a low refractive index layer on the uppermost layer of optical film and then to provide between them a metal oxide layer which is a high refractive index layer, and further to provide a medium refractive index layer (being a metal oxide layer of which refractive index has been controlled by varying the metal oxide content, the ratio to the resinous binders, or the kind of metal). The refractive index of the high refractive index layer is preferably 1.55 to 2.30, but is more preferably 1.57 to 2.20. The refractive index of the medium refractive index layer is controlled to the intermediate value between the refractive index (approximately 1.5) of cellulose ester film as a substrate and the refractive index of the high refractive index layer. The refractive index of the medium refractive index layer is preferably 1.55 to 1.80. The thickness of each layer is preferably 5 nm to 0.5 μm, is more preferably 10 nm to 0.3 μm, but is most preferably 30 nm to 0.2 μm. The haze of the metal oxide layer is preferably at most 5 percent, is more preferably at most 3 percent, but is most preferably at most 1 percent. The strength of the metal oxide layer is preferably at least 3H in terms of pencil strength of 1 kg load, but is most preferably at least 4H. In cases in which the metal oxide layer is formed employing a coating method, it is preferable that minute inorganic particles and binder polymers are incorporated.

It is preferable that the medium and high refractive index layers in the present invention are formed in such a manner that a liquid coating composition incorporating monomers or oligomers of organic titanium compounds represented by Formula (14) below, or hydrolyzed products thereof are coated and subsequently dried, and the resulting refractive index is 1.55 to 2.5.

Ti(OR¹)₄ Formula (14)

wherein R¹ is an aliphatic hydrocarbon group having 1 to 8 carbon atoms, but is preferably an aliphatic hydrocarbon group having 1 to 4 carbon atoms. Further, in monomers or oligomers of organic titanium compounds or hydrolyzed products thereof, the alkoxide group undergoes hydrolysis to form a crosslinking structure via reaction such as —Ti—O—Ti, whereby a cured layer is formed.

Listed as preferred examples of monomers and oligomers of organic titanium compounds employed in the present invention are dimers—decamers of Ti(OCH₃)₄, Ti(OC₂H₅)₄, Ti(O-n-C₃H₇)₄, Ti(O-i-C₃H₇)₄, Ti(O-n-C₄H₉)₄, and Ti(O-n-C₃H₇)₄, dimers—decamers of Ti(O-i-C₃H₇)₄ and dimers—decamers of Ti(O-n-C₄H₉)₄. These may be employed individually or in combinations of at least two types. Of these, particularly preferred are dimers—decamers of Ti(O-n-C₃H₇)₄, Ti(O-i-C₃H₇)₄, Ti(O-n-C₄H₉)₄, and Ti(O-n-C₃H₇)₄, dimers—decamers of Ti(O-n-C₄H₉)₄.

In the course of preparation of the medium and high refractive index layer liquid coating compositions in the present invention, it is preferable that the above organic titanium compounds are added to the solution into which water and organic solvents, described below, have been successively added. In cases in which water is added later, hydrolysis/polymerization is not uniformly performed, whereby cloudiness is generated or the layer strength is lowered. It is preferable that after adding water and organic solvents, the resulting mixture is vigorously stirred to enhance mixing and dissolution has been completed.

Further, an alternative method is employed. A preferred embodiment is that organic titanium compounds and organic solvents are blended, and the resulting mixed solution is added to the above solution which is prepared by stirring the mixture of water and organic solvents.

Further, the amount of water is preferably in the range of 0.25 to 3 mol per mol of the organic titanium compounds. When the amount of water is less than 0.25 mol, hydrolysis and polymerization are not sufficiently performed, whereby layer strength is lowered, while when it exceeds 3 mol, hydrolysis and polymerization are excessively performed, and coarse TiO₂ particles are formed to result in cloudiness. Accordingly, it is necessary to control the amount of water within the above range.

Further, the content of water is preferably less than 10 percent by weight with respect to the total liquid coating composition. When the content of water exceeds 10 percent by weight with respect to the total liquid coating composition, stability during standing of the liquid coating composition is degraded to result in cloudiness. Therefore, it is not preferable.

Organic solvents employed in the present invention are preferably water-compatible. Preferred as water-compatible solvents are, for example, alcohols (for example, methanol, ethanol, propanol, isopropanol, butanol, isobutanol, secondary butanol, tertiary butanol, pentanol, hexanol, cyclohexanol, and benzyl alcohol; polyhydric alcohols (for example, ethylene glycol, diethylene glycol, triethylene glycol, polyethylene glycol, propylene glycol, dipropylene glycol, polypropylene glycol, butylenes glycol, hexanediol, pentanediol, glycerin, hexanetriol, and thioglycol); polyhydric alcohol ethers (for example, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, and tetramethylpropylenediamine); amides (for example, formamide, N,N-dimethylfromamide, and N,N-dimethylacetamide); heterocycles (for example, 2-pyrrolidone, N-methyl-2-pyrrolidone, cyclohexylpyrrolidone, 2-oxazolidone, 1,3-dimethyl-2-imidazolidinone); and sulfoxides (for example, dimethylsulfoxide); sulfones (for example, sulfolane); as well as urea, acetonitrile, and acetone. Of these, particularly preferred are alcohols, polyhydric alcohols, and polyhydric alcohol ethers. As noted above, the used amount of these organic solvents may be controlled so that the content of water is less than 10 percent by weight with respect to the total liquid coating composition by controlling the total used amount of water and the organic solvents.

The content of monomers and oligomers of organic titanium compounds employed in the present invention, as well as hydrolyzed products thereof is preferably 50.0 to 98.0 percent by weight with respect to solids incorporated in the liquid coating composition. The solid ratio is more preferably 50 to 90 percent by weight, but is still more preferably 55 to 90 percent by weight. Other than these, it is preferable to incorporate polymers of organic titanium compounds (which are subjected to hydrolysis followed by crosslinking) in a liquid coating composition, or to incorporate minute titanium oxide particles.

The high refractive index and medium refractive index layers in the present invention may incorporate metal oxide particles as minute particles and further may incorporate binder polymers.

In the above method of preparing liquid coating compositions, when hydrolyzed/polymerized organic titanium compounds and metal oxide particles are combined, both strongly adhere to each other, whereby it is possible to obtain a strong coating layer provided with hardness and uniform layer flexibility.

The refractive index of metal oxide particles employed in the high and medium refractive index layers is preferably 1.80 to 2.80, but is more preferably 1.90 to 2.80. The weight average diameter of the primary particle of metal oxide particles is preferably 1 to 150 nm, is more preferably 1 to 100 nm, but is most preferably 1 to 80 nm. The weight average diameter of metal oxide particles in the layer is preferably 1 to 200 nm, is more preferably 5 to 150 nm, is still more preferably 10 to 100 nm, but is most preferably 10 to 80 nm. Metal oxide particles at an average particle diameter of at least 20 to 30 nm are determined employing a light scattering method, while the particles at a diameter of at most 20 to 30 nm are determined employing electron microscope images. The specific surface area of metal oxide particles is preferably 10 to 400 m²/g as a value determined employing the BET method, is more preferably 20 to 200 m²/g, but is most preferably 30 to 150 m²/g.

Examples of metal oxide particles are metal oxides incorporating at least one element selected from the group consisting of Ti, Zr, Sn, Sb, Cu, Fe, Mn, Pb, Cd, As, Cr, Hg, Zn, Al, Mg, Si, P, and S. Specifically listed are titanium dioxide, (for example, rutile, rutile/anatase mixed crystals, anatase, and amorphous structures), tin oxide, indium oxide, zinc oxide, and zirconium oxide. Of these, titanium oxide, tin oxide, and indium oxide are particularly preferred. Metal oxide particles are composed of these metals as a main component of oxides and are capable of incorporating other metals. Main component, as described herein, refers to the component of which content (in percent by weight) is the maximum in the particle composing components. Listed as examples of other elements are Ti, Zr, Sn, Sb, Cu, Fe, Mn, Pb, Cd, As, Cr, Hg, Zn, Al, Mg, Si, P and S.

It is preferable that metal oxide particles are subjected to a surface treatment. It is possible to perform the surface treatment employing inorganic or organic compounds. Listed as examples of inorganic compounds used for the surface treatment are alumina, silica, zirconium oxide, and iron oxide. Of these, alumina and silica are preferred. Listed as examples of organic compounds used for the surface treatment are polyol, alkanolamine, stearic acid, silane coupling agents, and titanate coupling agents. Of these, silane coupling agents are most preferred.

Specific examples of silane coupling agents include methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-glycidyloxypropyltrimethoxysilane, γ-glycidyloxypropyltriethoxysilane, γ-(β-glycidyloxyethoxy)propyltrimethoxysilane, β-(3,4-epoxycyclohexyl)ethyltrimethoxysilane, β-(3,4-epoxycyclohexyl)ethyltriethoxysilane, γ-acryloyloxypropyltrimethoxysilane, γ-methacryloyloxypropyltrimethoxysilane, γ-aminopropyltrimethoxysilane, γ-aminopropyltriethoxysilane, γ-mercaptopropyltriethoxysilane, N-β-(aminoethyl)-γ-aminopropyltrimethoxysilane, and β-cyanoethyltriethoxysilane.

Further, examples of silane coupling agents having an alkyl group of 2-substitution for silicon include dimethyldimethoxysilane, phenylmethyldimethoxysilane, dimethyldiethoxysilane, phenylmethyldiethoxysilane, γ-glycidyloxypropylmethyldiethoxysilane, γ-glycidyloxypropylmethyldimethoxysilane, γ-glycidyloxypropylphenyldiethoxysilane, γ-chloropropylmethyldiethoxysilane, dimethyldiacetoxysilane, γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethoxysilane, γ-mercaptopropylmethyldimethoxysilane, γ-mercaptopropylmethyldiethoxysilane, γ-aminopropylmethyldimethoxysilane, γ-aminopropyldiethoxysilane, methylvinyldimethoxysilane, and methylvinyldiethoxysilane.

Of these, preferred are vinyltrimethoxysilane, vinyltriethoxysilane, vinylacetoxysilane, vinyltrimethoxethoxyysilane, γ-acryloyloxypropylmethoxysilane, and γ-methacryloyloxypropylmethoxysilane which have a double bond in the molecule, as well as γ-acryloyloxypropylmethyldimethoxysilane, γ-acryloyloxypropyldiethoxysilane, Y-methacryloyloxypropylmethyldimethoxysilane, γ-methacryloyloxypropylmethyldiethoxysilane, methylvinyldimethoxysilane, and methylvinyldiethaoxysilane which have an alkyl group having 2-substitution to silicon. Of these, particularly preferred are γ-acryloyloxypropyltrimethoxysilane, γ-methacryloyloxypropyltrimethoxysilane, γ-acryloyloxypropylmethyldimethoxysilane, acryloyloxypropylmethyldiethoxysilane, γ-methacryloyloxypropylmethyldimethoxysilane, and γ-methacryloyloxypropylmethyldiethoxysilane.

At least two types of coupling agents may simultaneously be employed. In addition to the above silane coupling agents, other silane coupling agents may be employed. Listed as other silane coupling agents are alkyl esters of ortho-silicic acid (for example, methyl orthosilicate, ethyl orthosilicate, n-propyl orthosilicate, i-propyl orthosilicate, n-butyl orthosilicate, sec-butyl orthosilicate, and t-butyl orthosilicate) and hydrolyzed products thereof.

It is possible to practice a surface treatment employing coupling agents in such a manner that coupling agents are added to a minute particle dispersion and the resulting dispersion is allowed to stand at room temperature to 60° C. for several hours to 10 days. In order to promote the surface treatment reaction, added to the above dispersion may be inorganic acids (for example, sulfuric acid, hydrochloric acid, nitric acid, chromic acid, hypochlorous acid, boric acid, orthosilicic acid, phosphoric acid, and carbonic acid), and organic acids (for example, acetic acid, polyacrylic acid, benzenesulfonic acid, phenol, and polyglutamic acid), or salts thereof (for example, metal salts and ammonium salts).

It is preferable that these coupling agents have been hydrolyzed employing water in a necessary amount. When the silane coupling agent is hydrolyzed, the resulting coupling agent easily react with the above organic titanium compounds and the surface of metal oxide particles, whereby a stronger layer is formed. Further, it is preferable to previously incorporate hydrolyzed silane coupling agents into a liquid coating composition. It is possible to use the water employed for hydrolysis to perform hydrolysis/polymerization of organic titanium compounds.

In the present invention, a treatment may be performed by combining at least two types of surface treatments. It is preferable that the shape of metal oxide particles is rice grain-shaped, spherical, cubic, spindle-shaped, or irregular. At least two types of metal oxide particles may be employed in the high refractive index layer and the medium refractive index layer.

The content of metal oxide particles in the high refractive index and medium refractive index layers is preferably 5 to 90 percent by weight, is more preferably 10 to 85 percent by weight, but is still more preferably 20 to 80 percent by weight. In cases in which minute particles are incorporated, the ratio of monomers or oligomers of the above organic titanium compounds or hydrolyzed products thereof is commonly 1 to 50 percent by weight with solids incorporated in the liquid coating composition, is preferably 1 to 40 percent by weight, but is more preferably 1 to 30 percent by weight.

The above metal oxide particles are dispersed into a medium and fed to liquid coasting compositions to form a high refractive index layer and a medium refractive index layer. Preferably employed as dispersion medium of metal oxide particles is a liquid at a boiling point of 60 to 170° C. Specific examples of dispersion media include water, alcohols (for example, methanol, ethanol, isopropanol, butanol, and benzyl alcohol), ketones (for example, acetone, methyl ethyl ketone, methyl isobutyl ketone, and cyclohexanone), esters (for example, methyl acetate, ethyl acetate, propyl acetate, butyl acetate, methyl formate, ethyl formate, propyl formate and butyl formate), aliphatic hydrocarbons (for example, hexane and cyclohexanone), halogenated hydrocarbons (for example, methylene chloride, chloroform, and carbon tetrachloride), aromatic hydrocarbons (for example, benzene, toluene, and xylene), amides (for example, dimethylformamide, diethylacetamide, and n-methylpyrrolidone), ethers (for example, diethyl ether, dioxane, and tetrahydrofuran), and ether alcohols (for example, 1-methoxy-2-propanol). Of these, particularly preferred are toluene, xylene, methyl ethyl ketone, methyl isobutyl ketone, cyclohexane and butanol.

Further, it is possible to disperse metal oxide particles into a medium employing a homogenizer. Listed as examples of homogenizers are a sand grinder mill (for example, a bead mill with pins), a high speed impeller mill, a pebble mill, a roller mill, an attritor, and a colloid mill. Of these, particularly preferred are the sand grinder and the high speed impeller mill. Preliminary dispersion may be performed. Listed as examples which are used for the preliminary dispersion are a ball mill, a three-roller mill, a kneader, and an extruder.

It is preferable to employ polymers having a crosslinking structure (hereinafter referred to as a crosslinking polymer) as a binder polymer in the high refractive index and medium refractive index layers. Listed as examples of the crosslinking polymers are crosslinking products (hereinafter referred to as polyolefin) such as polymers having a saturated hydrocarbon chain such as polyolefin, polyether, polyurea, polyurethane, polyester, polyamine, polyamide, or melamine resins. Of these, crosslinking products of polyolefin, polyether, and polyurethane are preferred, crosslinking products of polyolefin and polyether are more preferred, and crosslinking products of polyolefin are most preferred. Further, it is more preferable that crosslinking polymers have an anionic group. The anionic group exhibits a function to maintain the dispersion state of minute inorganic particles and the crosslinking structure exhibits a function to strengthen layers by providing a polymer with layer forming capability. The above anionic group may directly bond to a polymer chain or may bond to a polymer chain via a linking group. However, it is preferable that the anionic group bonds to the main chain via a linking group as a side chain.

Listed as examples of the anionic group are a carboxylic acid group (carboxyl), a sulfonic acid group (sulfo), and phosphoric acid group (phosphono). Of these, preferred are the sulfonic acid group and the phosphoric acid group. Herein, the anionic group may be in the form of its salts. Cations which form salts with the anionic group are preferably alkali metal ions. Further, protons of the anionic group may be dissociated. The linking group which bond the anionic group with a polymer chain is preferably a bivalent group selected from the group consisting of —CO—, —O—, an alkylene group, and an arylene group, and combinations thereof. Crosslinking polymers which are binder polymers are preferably copolymers having repeating units having an anionic group and repeating units having a crosslinking structure. In this case, the ratio of the repeating units having an anionic group in copolymers is preferably 2 to 96 percent by weight, is more preferably 4 to 94 percent by weight, but is most preferably 6 to 92 percent by weight. The repeating unit may have at least two anionic groups.

In crosslinking polymers having an anionic group, other repeating units (an anionic group is also a repeating unit having no crosslinking structure) may be incorporated. Preferred as other repeating units are repeating units having an amino group or a quaternary ammonium group and repeating units having a benzene ring. The amino group or quaternary ammonium group exhibits a function to maintain a dispersion state of minute inorganic particles. The benzene ring exhibits a function to increase the refractive index of the high refractive index layer. Incidentally, even though the amino group, quaternary ammonium group and benzene ring are incorporated in the repeating units having an anionic group and the repeating units having a crosslinking structure, identical effects are achieved.

In crosslinking polymers incorporating as a constituting unit the above repeating units having an amino group or a quaternary ammonium group, the amino group or quaternary ammonium group may directly bond to a polymer chain or may bond to a polymer chain via a side chain. But the latter is preferred. The amino group or quaternary ammonium group is preferably a secondary amino group, a tertiary amino group or a quaternary ammonium group, but is more preferably a tertiary amino group or a quaternary ammonium group. A group bonded to the nitrogen atom of a secondary amino group, a tertiary amino group or a quaternary ammonium group is preferably an alkyl group, is more preferably an alkyl group having 1 to 12 carbon atoms, but is still more preferably an alkyl group having 1 to 6 carbon atoms. The counter ion of the quaternary ammonium group is preferably a halide ion. The linking group which links an amino group or a quaternary ammonium group with a polymer chain is preferably a bivalent group selected from the group consisting of —CO—, —NH—, —O—, an alkylene group and an arylene group, or combinations thereof. In cases in which the crosslinking polymers incorporate repeating units having an amino group or an quaternary ammonium group, the ratio is preferably 0.06 to 32 percent by weight, is more preferably 0.08 to 30 percent by weight, but is most preferably 0.1 to 28 percent t by weight.

It is preferable that high and medium refractive index layer liquid coating compositions composed of monomers to form crosslinking polymers are prepared and crosslinking polymers are formed via polymerization reaction during or after coating of the above liquid coating compositions. Each layer is formed along with the formation of crosslinking polymers. Monomers having an anionic group function as a dispersing agent of minute inorganic particles in the liquid coating compositions. The used amount of monomers having an anionic group is preferably 1 to 50 percent by weight with respect to the minute inorganic particles, is more preferably 5 to 40 percent by weight, but is still more preferably 10 to 30 percent by weight. Further, monomers having an amino group or a quaternary ammonium group function as a dispersing aid in the liquid coating compositions. The used amount of monomers having an amino group or a quaternary ammonium group is preferably 3 to 33 percent by weight with respect to the monomers having an anionic group. By employing a method in which crosslinking polymers are formed during or after coating of a liquid coating composition, it is possible to allow these monomers to effectively function prior to coating of the liquid coating compositions.

Most preferred as monomers employed in the present invention are those having at least two ethylenic unsaturated groups. Listed as those examples are esters of polyhydric alcohols and (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol-(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene, 4-vinyl-benzoic acid-2-acryloylethyl ester, and 1,4-divinylcyclohexane); vinylsulfones (for example, divinylsulfone); acrylamides (for example, methylenebisacrylamide); and methacrylamides. Commercially available monomers having an anionic group and monomers having an amino group or a quaternary ammonium group may be employed. Listed as commercially available monomers having an anionic group which are preferably employed are KAYAMAR PM-21 and PM-2 (both produced by Nihon Kayaku Co., Ltd.); ANTOX MS-60, MS-2N, and MS-NH4 (all produced by Nippon Nyukazai Co., Ltd.), ARONIX M-5000, M-6000, and M-8000 SERIES (all produced by Toagosei Chemical Industry Co., Ltd.); BISCOAT #2000 SERIES (produced by Osaka Organic Chemical Industry Ltd.); NEW FRONTIER GX-8289 (produced by Dai-ichi Kogyo Seiyaku Co., Ltd.); NK ESTER CB-1 and A-SA (produced by Shin-Nakamura Chemical Co., Ltd.); and AR-100, MR-100, and MR-200 (produced by Diahachi Chemical Industry Co., Ltd.). Listed as commercially available monomers having an amino group or a quaternary ammonium group which are preferably employed are DMAA (produced by Osaka Organic Chemical Industry Ltd.); DMAEA and DMAPAA (produced by Kojin Co., Ltd.); BLENMER QA (produced by NOF Corp.), and NEW FRONTIER C-1615 (produced by Dia-ichi Kogyo Seiyaku Co., Ltd.).

It is possible to perform polymer polymerization reaction employing a photopolymerization reaction or a thermal polymerization reaction. The photopolymerization reaction is particularly preferred. It is preferable to employ polymerization initiators to perform the polymerization reaction. For example, listed are thermal polymerization initiators and photopolymerization imitators described below which are employed to form binder polymers of the hard coating layer.

Employed as the polymerization initiators may be commercially available ones. In addition to the polymerization initiators, employed may be polymerization promoters. The added amount of polymerization initiators and polymerization promoters is preferably in the range of 0.2 to 10 percent by weight of the total monomers. Polymerization of monomers (or oligomers) may be promoted by heating a liquid coating composition (being an inorganic particle dispersion incorporating monomers). Further, after the photopolymerization reaction after coating, the resulting coating is heated whereby the formed polymer may undergo additional heat curing reaction.

It is preferable to use relatively high refractive index polymers in the medium and high refractive index layers. Listed as examples of polymers exhibiting a high refractive index are polystyrene, styrene copolymers, polycarbonates, melamine resins, phenol resins, epoxy resins, and urethanes which are obtained by allowing cyclic (alicyclic or aromatic) isocyanates to react with polyols. It is also possible to use polymers having another cyclic (aromatic, heterocyclic, and alicyclic) group and polymers having a halogen atom other than fluorine as a substituent due to their high refractive index.

Low refractive index layers usable in the present invention include a low refractive index layer which is formed by crosslinking of fluorine containing resins (hereinafter referred to as “fluorine containing resins prior to crosslinking) which undergo crosslinking by heat or ionizing radiation, a low refractive index layer prepared employing a sol-gel method, and a low refractive index layer composed of minute particles and binder polymers in which voids exist among minute particles or in the interior of the minute particle. In the present invention, preferred is the low refractive index layer mainly employing minute particles and binder polymers. The low refractive index layer having voids in the interior of the particle (also called the minute hollow particle) is preferred since it is possible to lower the refractive index. However, a decrease in the refractive index of the low refractive index layer is preferred due to an improvement of antireflection performance, while it becomes difficult to provide desired strength. In view of the above compatibility, the refractive index of the low refractive index layer is preferably at most 1.45, is more preferably 1.30 to 1.50, is still more preferably 1.35 to 1.49, but is most preferably 1.35 to 1.45.

Further, the above preparation methods of the low refractive index layer may be suitably combined.

Preferably listed as fluorine containing resins prior to coating are fluorine containing copolymers which are formed employing fluorine containing vinyl monomers and crosslinking group providing monomers. Listed as specific examples of the above fluorine containing vinyl monomer units are fluoroolefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (for example, BISCOAT 6FM (produced by Osaka Organic Chemical Industry Ltd.) and M-2020 (produced by Daikin Industries, Ltd.), and completely or partially fluorinated vinyl ethers. Listed as monomers to provide a crosslinking group are vinyl monomers previously having a crosslinking functional group in the molecule, such as glycidyl methacrylate, vinyltrimethoxysilane, γ-methacryloyloxypropyltrimethoxysilane, or vinyl glycidyl ether, as well as vinyl monomers having a carboxyl group, a hydroxyl group, an amino group, or a sulfone group (for example, (meth)acrylic acid, methylol (meth)acrylate, hydroxyalkyl (meth)acrylate, allyl acrylate, hydroxyalkyl vinyl ether, and hydroxyalkyl allyl ether). JP-A Nos. 10-25388 and 10-147739 describe that a crosslinking structure is introduced into the latter by adding compounds having a group which reacts with the functional group in the polymer and at least one reacting group. Listed as examples of the crosslinking group are a acryloyl, methacryloyl, isocyanate, epoxy, aziridine, oxazoline, aldehyde, carbonyl, hydrazine, carboxyl, methylol or active methylene group. When fluorine containing polymers undergo thermal crosslinking due to the presence of a thermally reacting crosslinking group or the combinations of an ethylenic unsaturated group with thermal radical generating agents or an epoxy group with a heat generating agent, the above polymers are of a heat curable type. On the other hand, in cases in which crosslinking undergoes by exposure to radiation (preferably ultraviolet radiation and electron beams) employing combinations of an ethylenic unsaturated group with photo-radical generating agents or an epoxy group with photolytically acid generating agents, the polymers are of an ionizing radiation curable type.

Further, employed as a fluorine containing resins prior to coating may be fluorine containing copolymers which are prepared by employing the above monomers with fluorine containing vinyl monomers, and monomers other than monomers to provide a crosslinking group in addition to the above monomers. Monomers capable being simultaneously employed are not particularly limited. Those examples include olefins (ethylene, propylene, isoprene, vinyl chloride, and vinylidene chloride); acrylates (methyl acrylate, ethyl acrylate, and 2-ethylhexyl acrylate); methacrylates (methyl methacrylate, ethyl methacrylate, butyl methacrylate, and ethylene glycol dimethacrylate); styrene derivatives (styrene, divinylbenzene, vinyltoluene, and α-methylstyrene); vinyl ethers (methyl vinyl ether); vinyl esters (vinyl acetate, vinyl propionate, and vinyl cinnamate); acrylamides (N-tert-butylacrylamide and N-cyclohexylacrylamide); methacrylamides; and acrylonitrile derivatives. Further, in order to provide desired lubricating properties and antistaining properties, it is also preferable to introduce a polyorganosiloxane skeleton or a perfluoropolyether skeleton into fluorine containing copolymers. The above introduction is performed, for example, by polymerization of the above monomers with polyorganosiloxane and perfluoroether having, at the end, an acryl group, a methacryl group, a vinyl ether group, or a styryl group and reaction of polyorganosiloxane and perfluoropolyether having a functional group.

The used ratio of each monomer to form the fluorine containing copolymers prior to coating is as follows. The ratio of fluorine containing vinyl monomers is preferably 20 to 70 mol percent, but is more preferably 40 to 70 mol percent; the ratio of monomers to provide a crosslinking group is preferably 1 to 20 mol percent, but is more preferably 5 to 20 mol percent, and the ratio of the other monomers simultaneously employed is preferably 10 to 70 mol percent, but is more preferably 10 to 50 mol percent.

It is possible to obtain the fluorine containing copolymers by polymerizing these monomers employing methods such as a solution polymerization method, a block polymerization method, an emulsion polymerization method or a suspension polymerization method.

The fluorine containing resins prior to coating are commercially available and it is possible to employ commercially available products. Listed as examples of the fluorine containing resins prior to coating are SAITOP (produced by Asahi Glass Co., Ltd.), TEFLON (a registered trade name) AD (produced by Du Pont), vinylidene polyfluoride, RUMIFRON (produced by Asahi Glass Co., Ltd.), and OPSTAR (produced by JSR).

The dynamic friction coefficient and contact angle to water of the low refractive index layer composed of crosslinked fluorine containing resins are in the range of 0.03 to 0.15 and in the range of 90 to 120 degrees, respectively.

In view of controlling the refractive index, it is preferable that the low refractive index layer composed of crosslinked fluorine containing resins incorporates minute inorganic particles described below. Further, it is preferable that minute inorganic particles are subjected to a surface treatment. Surface treatment methods include physical surface treatments such as a plasma discharge treatment and a corona discharge treatment, and a chemical surface treatment employing coupling agents. It is preferable to use the coupling agents. Preferably employed as coupling agents are organoalkoxy metal compounds (for example, a titanium coupling argent and a silane coupling agent). In cases in which minute inorganic particles are composed of silica, the treatment employing the silane coupling agent is particularly effective.

Further, preferably employed as components for the low refractive index layer may be various types of sol-gel components. Preferably employed as such sol-gel components may be metal alcolates (being alcolates of silane, titanium, aluminum, or zirconium, and organoalkoxy metal compounds and hydrolysis products thereof. Particularly preferred are alkoxysilane, and hydrolysis products thereof. It is also preferable to use tetraalkoxysilane (tetramethoxysilane and tetraethoxysilane), alkyltrialkoxysilane (methyltrimethoxysilane, and ethyltrimethoxysilane), aryltrialkoxysilane (phenyltrimethoxysilane, dialkyldialkoxysilane, diaryldialkoxysilane. Further, it is also preferable to use organoalkoxysilanes having various type of functional group (vinyltrialkoxysilane, methylvinyldialkoxysilane, γ-glycidyloxypropyltrialkoxysilane, γ-glycidyloxyoropylmethyldialkoxysilane, β-(3,4)epoxycyclohexyl)ethyltrialkoxysilane, γ-merthacryloyloxypropyltrialkoxysilane, γ-aminopropyltrialkoxysilane, γ-mercaptopropyltrialkoxysilane, and γ-chloropropyltrialkoxysilane), perfluoroalkyl group containing silane compounds (for example, (heptadecafluoro1,1,2,2-tetradecyl)triethoxysilane, 3,3,3-trifluoropropyltrimethoxy silane). In view of decreasing the refractive index of the layer and providing water repellency and oil repellency, it is preferable to particularly use fluorine containing silane compounds.

As a low refractive index layer, it is preferable to employ a layer which is prepared in such a manner that minute inorganic or organic particles are employed and micro-voids are formed among minute particles or in the minute particle. The average diameter of the minute particles is preferably 0.5 to 200 nm, is more preferably 1 to 100 nm, is still more preferably 3 to 70 nm, but is most preferably 5 to 40 nm. Further, it is preferable that the particle diameter is as uniform (monodispersion) as possible.

Minute inorganic particles are preferably non-crystalline. The minute inorganic particles are preferably composed of metal oxides, nitrides, sulfides or halides, are more preferably composed of metal oxides or metal halides, but are most preferably composed of metal oxides or metal fluorides. Preferred as metal atoms are Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Ob and Ni. Of these, more preferred are Mg, Ca, B and Si. Inorganic compounds incorporating two types of metal may be employed. Specific examples of preferred inorganic compounds include SuO₂ or MgF₂, and SiO₂ is particularly preferred.

It is possible to form particles having micro-voids in the interior of an inorganic particle, for example, by crosslinking silica molecules. When silica molecules undergo crosslinking, the resulting volume decreases whereby a particle becomes porous. It is possible to directly synthesize micro-void containing (porous) inorganic particles as a dispersion, employing the sol-gel method (described in JP-A Nos. 53-112732 and 57-9051) and the deposition method (described in Applied Optics, Volume 27, page 3356 (1988)). Alternatively, it is also possible to obtain a dispersion in such a manner that powder prepared by a drying and precipitation method is mechanically pulverized. Commercially available minute porous inorganic particles (for example, SiO₂ sol) may be employed.

In order to form a low refractive index layer, it is preferable that these minute inorganic particles are employed in the state dispersed in a suitable medium. Preferred as media are water, alcohol (for example, methanol, ethanol, and isopropyl alcohol), and ketone (for example, methyl ethyl ketone and methyl isobutyl ketone).

It is also preferable that minute organic particles are non-crystalline and are minute polymer particles which are synthesized by the polymerization reaction (for example, an emulsion polymerization method) of monomers. It is preferable that the polymers of minute organic particles incorporate fluorine atoms. The ratio of fluorine atoms in polymers is preferably 35 to 80 percent by weight, but is more preferably 45 to 75 percent by weight. Further, it is preferable that micro-voids are formed in the minute organic particle in such a manner that particle forming polymers undergo crosslinking so that a decrease in the volume forms micro-voids. In order that particle forming polymers undergo crosslinking, it is preferable that at least 20 mol percent of monomers to synthesize a polymer are multifunctional monomers. The ratio of the multifunctional monomers is more preferably 30 to 80 mol percent, but is most preferably 35 to 50 mol percent. Listed as examples of fluorine containing monomers employed to synthesize the above fluorine containing polymers are fluorolefins (for example, fluoroethylene, vinylidene fluoride, tetrafluoroethylene, hexafluoropropylene, and perfluoro-2,2-dimethyl-1,3-dioxol), as well as fluorinated alkyl esters of acrylic acid or methacrylic acid and fluorinated vinyl ethers. Copolymers of monomers with and without fluorine atoms may be employed. Listed as examples of monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, ethyl methacrylate and butyl methacrylate), styrenes (for example, styrene, vinyltoluene, and α-methylstyrene), vinyl ethers (for example, methyl vinyl ether), vinyl esters (for example, vinyl acetate and vinyl propionate), acrylamides (for example, N-tert-butylacrylamide and N-cyclohexylacrylamide), methacrylamides, and acrylonitriles. Listed as examples of multifunctional monomers are dienes (for example, butadiene and pentadiene), esters of polyhydric alcohol with acrylic acid (for example, ethylene glycol diacrylate, 1,4-cyclohexane diacrylate, and dipentaerythritol hexaacrylate), esters of polyhydric alcohol with methacrylic acid (for example, ethylene glycol dimethacrylate, 1,2,4-cyclohexane tetramethacrylate, and pentaerythritol tetramethacrylate), divinyl compounds (for example, divinylcyclohexane and 1,4-divinylbenzene), divinylsulfone, and bisacrylamides (for example, methylenebisacrylamide) and bismethacrylamides.

It is possible to form micro-voids among particles by piling at least two minute particles. Incidentally, when minute spherical particles (completely monodispersed) of an equal diameter are subjected to closest packing, micro-voids at a 26 percent void ratio by volume are formed among minute particles. When spherical particles of an equal diameter are subjected to simple cubic packing, micro-voids at 48 percent void ratio by volume are formed among minute particles. In a practical low refractive index layer, the void ratio significantly shifts from the theoretical value due to the distribution of diameter of the minute particles and the presence of voids in the particle. As the void ratio increases the refractive index of the low refractive index layer decreases. When micro-voids are formed by piling minute particles, it is possible to easily control the size of micro-voids among particles to an appropriate value (being a value minimizing scattering light and resulting in no problems of the strength of the low refractive index layer) by adjusting the diameter of minute particles. Further, by making the diameter of minute particles uniform, it is possible to obtain an optically uniform low refractive index layer of the uniform size of micro-voids among particles. By doing so, though the resulting low refractive index layer is microscopically a micro-void containing porous layer, optically or macroscopically, it is possible to make it a uniform layer. It is preferable that micro-voids among particles are confined in the low refractive index layer employing minute particles and polymers. Confined voids exhibits an advantage such that light scattering on the surface of a low refractive index layer is decreased compared to the voids which are not confined.

By forming micro-voids, the macroscopic refractive index of the low refractive index layer becomes lower than the total refractive index of the components constituting the low refractive index layer. The refractive index of a layer is the sum of the refractive indexes per volume of layer constituting components. The refractive index value of the constituting components such as minute particles or polymers of the low refractive index lay is larger than 1, while the refractive index of air is 1.00. Due to that, by forming micro-voids, it is possible to obtain a low refractive index layer exhibiting significantly lower refractive index.

Further, in the present invention, an embodiment is also preferred in which minute hollow SiO₂ particles are employed.

Minute hollow particles, as described in the present invention, refer to particles which have a particle wall, the interior of which is hollow. An example of such particles includes particles which are formed in such a manner that the above SiO₂ particles having voids in the interior of particles are further subjected to surface coating employing organic silicon compounds (being alkoxysilanes such as tetraethoxysilane) to close the pores. Alternatively, voids in the interior of the wall of the above particles may be filled with solvents or gases. For example, in the case of air, it is possible to significantly lower the refractive index (at 1.2 to 1.4) of minute hollow particles compared to common silica (at a refractive index of 1.46). By adding such minute hollow SiO₂ particles, it is possible to further lower the refractive index of the low refractive index layer.

Making particles having micro-voids in the above minute inorganic particle hollow may be achieved based on the methods described in JP-A Nos. 2001-167637 and 2001-233611. Further, it is possible to use commercially available minute hollow SiO₂ particles. Listed as a specific example of commercially available particles is P-4 produced by Shokubai Kasei Kogyo Co.

It is preferable that the low refractive index layer incorporates polymers in an amount of 5 to 50 percent by weight. The above polymers exhibit functions such that minute particles are subjected to adhesion and the structure of the above low refractive index layer is maintained. The used amount of the polymers is controlled so that without filing voids, it is possible to maintain the strength of the low refractive index layer. The amount of the polymers is preferably 10 to 30 percent by weight of the total weight of the low refractive index layer. In order to achieve adhesion of minute particles employing polymers, it is preferable that (1) polymers are combined with surface processing agents of minute particles, (2) a polymer shell is formed around a minute particle used as a core, or (3) polymers are employed as a binder among minute particles. The polymers which are combined with the surface processing agents in (1) are preferably the shell polymers of (2) or binder polymers of (3). It is preferable that the polymers of (2) are formed around the minute particles employing a polymerization reaction prior to preparation of the low refractive index layer liquid coating composition. It is preferable that the polymers of (3) are formed employing a polymerization reaction during or after coating of the low refractive index layer while adding their monomers to the above low refractive index layer coating composition. It is preferable that at least two of (1), (2), and (3) or all are combined and employed. Of these, it is particularly preferable to practice the combination of (1) and (3) or the combination of (1), (2), and (3). (1) surface treatment, (2) shell, and (3) binder will now successively be described in that order.

### (1) Surface Treatments

It is preferable that minute particles (especially, minute inorganic particles) are subjected to a surface treatment to improve affinity with polymers. These surface treatments are classified into a physical surface treatment such as a plasma discharge treatment or a corona discharge treatment and a chemical surface treatment employing coupling agents. It is preferable that the chemical surface treatment is only performed or the physical surface treatment and the chemical surface treatment are performed in combination. Preferably employed as coupling agents are organoalkoxymetal compounds (for example, titanium coupling agents and silane coupling agents). In cases in which minute particles are composed of SiO₂, it is possible to particularly effectively affect a surface treatment employing the silane coupling agents. As specific examples of the silane coupling agents, preferably employed are those listed above.

The surface treatment employing the coupling agents is achieved in such a manner that coupling agents are added to a minute particle dispersion and the resulting mixture is allowed to stand at room temperature to 60° C. for several hours to 10 days. In order to accelerate a surface treatment reaction, added to a dispersion may be inorganic acids (for example, sulfuric acid, hydrochloric acid, nitric acid, chromic acid, hypochloric acid, boric acid, orthosilicic acid, phosphoric acid, and carbonic acid), or salts thereof (for example, metal salts and ammonium salts).

### (2) Shell

Shell forming polymers are preferably polymers having a saturated hydrocarbon as a main chain. Polymers incorporating fluorine atoms in the main chain or the side chain are preferred, while polymers incorporating fluorine atoms in the side chain are more preferred. Acrylates or methacrylates are preferred and esters of fluorine-substituted alcohol with polyacrylic acid or methacrylic acid are most preferred. The refractive index of shell polymers decreases as the content of fluorine atoms in the polymer increases. In order to lower the refractive index of a low refractive index layer, the shell polymers incorporate fluorine atoms in an amount of preferably 35 to 80 percent by weight, but more preferably 45 to 75 percent by weight. It is preferable that fluorine containing polymers are synthesized via the polymerization reaction of fluorine atom containing ethylenic unsaturated monomers. Listed as examples of fluorine atom containing ethylenic unsaturated monomers are fluorolefins (for example, fluoroethylene, vinylidene fluoride, tetrafluoroethylene, hexafluoropropylene, perfluoro-2,-dimethyl-1,3-dixol), fluorinated vinyl ethers and esters of fluorine substituted alcohol with acrylic acid or methacrylic acid.

Polymers to form the shell may be copolymers having repeating units with and without fluorine atoms. It is preferable that the units without fluorine atoms are prepared employing the polymerization reaction of ethylenic unsaturated monomers without fluorine atoms. Listed as examples of ethylenic unsaturated monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, butyl methacrylate, and ethylene glycol dimethacrylate), styrenes and derivatives thereof (for example, styrene, divinylbenzene, vinyltoluene, and α-methylstyrene), vinyl ethers (for example, methyl vinyl ether), vinyl esters (for example, vinyl acetate, vinyl propionate, and vinyl cinnamate), acrylamides (for example, N-tetrabutylacrylamide and N-cyclohexylacrylamide), as well as methacrylamide and acrylonitrile.

In the case of (3) in which binder polymers described below are simultaneously used, a crosslinking functional group may be introduced into shell polymers and the shell polymers and binder polymers are chemically bonded via crosslinking. Shell polymers may be crystalline. When the glass transition temperature (Tg) of the shell polymer is higher than the temperate during the formation of a low refractive index layer, micro-voids in the low refractive index layer are easily maintained. However, when Tg is higher than the temperature during formation of the low refractive index layer, minute particles are not fused and occasionally, the resulting low refractive index layer is not formed as a continuous layer (resulting in a decrease in strength). In such a case, it is desirous that the low refractive index layer is formed as a continuous layer simultaneously employing the binder polymers of (3). A polymer shell is formed around the minute particle, whereby a minute core/shell particle is obtained. A core composed of a minute inorganic particle is incorporated preferably 5 to 90 percent by volume in the minute core/shell particle, but more preferably 15 to 80 percent by volume. At least two types of minute core/shell particle may be simultaneously employed. Further, inorganic particles without a shell and core/shell particles may be simultaneously employed.

### (3) Binders

Binder polymers are preferably polymers having saturated hydrocarbon or polyether as a main chain, but is more preferably polymers having saturated hydrocarbon as a main chain. The above binder polymers are subjected to crosslinking. It is preferable that the polymers having saturated hydrocarbon as a main chain is prepared employing a polymerization reaction of ethylenic unsaturated monomers. In order to prepare crosslinked binder polymers, it is preferable to employ monomers having at least two ethylenic unsaturated groups. Listed as examples of monomers having at least two ethylenic unsaturated groups are esters of polyhydric alcohol with (meth)acrylic acid (for example, ethylene glycol di(meth)acrylate, 1,4-dicyclohexane diacrylate, pentaerythritol-tetra(meth)acrylate, pentaerythritol (meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene and 4-vinylbenzoic acid-2-acryloylethyl ester, and 1,4-divinylcyclohexane); vinylsulfones (for example, divinylsulfone); acrylamides (for example, methylenebisacrylamide); and methacrylamides. It is preferable that polymers having polyether as a main chain are synthesized employing a ring opening polymerization reaction. A crosslinking structure may be introduced into binder polymers employing a reaction of crosslinking group instead of or in addition to monomers having at least two ethylenic unsaturated groups. Listed as examples of the crosslinking functional groups are an isocyanate group, an epoxy group, an aziridine group, an oxazoline group, an aldehyde group, a carbonyl group, a hydrazine group, a carboxyl group, a methylol group, and an active methylene group. It is possible to use, as a monomer to introduce a crosslinking structure, vinylsulfonic acid, acid anhydrides, cyanoacrylate derivatives, melamine, ether modified methylol, esters and urethane. Functional groups such as a block isocyanate group, which exhibit crosslinking properties as a result of the decomposition reaction, may be employed. The crosslinking groups are not limited to the above compounds and include those which become reactive as a result of decomposition of the above functional group. Employed as polymerization initiators used for the polymerization reaction and crosslinking reaction of binder polymers are heat polymerization initiators and photopolymerization initiators, but the photopolymerization initiators are more preferred. Examples of photopolymerization initiators include acetophenones, benzoins, benzophenones, phosphine oxides, ketals, antharaquinones, thioxanthones, azo compounds, peroxides, 2,3-dialkyldiones, disulfide compounds, fluoroamine compounds, and aromatic sulfoniums. Examples of acetophenones include 2,2-diethoxyacetophenone, p-dimethylacetophenone, 1-hydroxydimethyl phenyl ketone, 1-dihydroxycyclohexyl phenyl ketone, 2-methyl-4-methylthio-2-morpholinopropiophene, and 2-benzyl-2-dimethylamino-1-(4-morpholinophenyl)-butanone. Examples of benzoins include benzoin ethyl ether and benzoin isopropyl ether. Examples of benzophenones include benzophenone, 2,4-dichlorobenzophenone, 4,4-dichlorobenzophenone, and p-chlorobenzophenone. An example of phosphine oxides includes 2,4,6-trimethylbenzoyldiphenylphosphine oxide.

It is preferable that binder polymers are formed in such a manner that monomers are added to a low refractive index layer liquid coating composition and the binder polymers are formed during or after coating of the low refractive index layer utilizing a polymerization reaction (if desired, further crosslinking reaction). A small amount of polymers (for example, polyvinyl alcohol, polyoxyethylene, polymethyl methacrylate, polymethyl acrylate, diacetyl cellulose, triacetyl cellulose, nitrocellulose, polyester, and alkyd resins) may be added to the low refractive index layer liquid coating composition.

Further, it is preferable to add slipping agents to the low refractive index layer or other refractive index layers. By providing desired slipping properties, it is possible to improve abrasion resistance. Preferably employed as slipping agents are silicone oil and wax materials. For example, preferred are the compounds represented by the formula below.

R₁COR₂ Formula

In the above formula, R₁ represents a saturated or unsaturated aliphatic hydrocarbon group hang at least 12 carbon atoms, while R₁ is preferably an alkyl group or an alkenyl group but is more preferably an alkyl group or an alkenyl group having at least 16 carbon atoms. R₂ represents —OM₁ group (M₁ represents an alkaline metal such as Na or K), —OH group, —NH₂ group, or —OR₃ group (R₃ represents a saturated or unsaturated aliphatic hydrocarbon group having at least 12 carbon atoms and is preferably an alkyl group or an alkenyl group). R₂ is preferably —OH group, —NH₂ group or —OR₃ group. In practice, preferably employed may be higher fatty acids or derivatives thereof such as behenic acid, stearic acid amide, or pentacosanoic acid or derivatives thereof and natural products such as carnauba wax, beeswax, or montan wax, which incorporate a large amount of such components. Further listed may be polyorganosiloxane disclosed in Japanese Patent Publication No. 53-292, higher fatty acid amides discloses in U.S. Pat. No. 4,275,146, higher fatty acid esters (esters of a fatty acid having 10-24 carbon atoms and alcohol having 10 to 24 carbon atoms) disclosed in Japanese Patent Publication No. 58-33541, British Patent No. 927,446, or JP-A Nos. 55-126238 and 58-90633, higher fatty acid metal salts disclosed in U.S. Pat. No. 3,933,516, polyester compounds composed of dicarboxylic acid having at least 10 carbon atoms and aliphatic or alicyclic diol disclosed in JP-A No. 51-37217, and oligopolyesters composed of dicarboxylic acid and diol disclosed in JP-A No. 7-13292.

For example, the added amount of slipping agents employed in the low refractive index layer is preferably 0.01 to 10 mg/m².

Added to each of the antireflection layers or the liquid coating compositions thereof may be polymerization inhibitors, leveling agents, thickeners, anti-coloring agents, UV absorbents, silane coupling agents, antistatic agents, and adhesion providing agents, other than metal oxide particles, polymers, dispersion media, polymerization initiators, and polymerization accelerators.

It is possible to form each layer of the antireflection films employing coating methods such as a dip coating method, an air-knife coating method, a curtain coating method, a roller coating method, a wire bar coating method, a gravure coating method, or an extrusion coating method (U.S. Pat. No. 2,681,294). At least two layers may be simultaneously coated. Simultaneous coating methods are described in U.S. Pat. Nos. 2,761,791, 2,941,898, 3,508,947, and 3,526,528, as well as Yuji Harazaki, Coating Kogaku (Coating Engineering), page 253, Asakura Shoten (1973).

In the present invention, in the production of an antireflection film, after applying the above liquid coating composition onto a support, drying is performed preferably at 60° C. or higher, but more preferably at 80° C. or higher. Further, drying is performed preferably at a dew point of 20° C. or lower, but is more preferably at a dew point of 15° C. or lower. It is preferable that drying is initiated within 0.10 seconds after coating onto a support. Combining the above conditions results in the preferred production method to achieve the effects of the present invention.

As noted above, the optical film of the present invention is preferably employed as an antireflection film, a hard coating film, a glare shielding film, a phase different film, an antistatic film, and a luminance enhancing film.

### (Polarizing Plates)

The polarizing plates of the present invention will be described.

It is possible to prepare the polarizing plates employing common methods. It is preferable that the reverse side of the cellulose ester film of the present invention is subjected to an alkali saponification treatment and the resulting cellulose ester film is adhered, employing an aqueous completely-saponified polyvinyl alcohol solution, to at least one surface of a polarizing film which has been prepared by being immersed into an iodine solution and subsequently being stretched. The cellulose ester film of the present invention or another polarizing plate protective film may be employed on the other surface. Employed as a polarizing plate protective film employed on the other surface, instead of the cellulose ester film of the present invention, may be commercially available cellulose ester film. For example, preferably employed as commercially available cellulose ester films are KC8UX2M, KC4UX, KCSUX, KC4UY, KC5UY, KC8UY, KC12UR, KC8UCR-3, KC8UCR-4, KC4VEW, and KC4FR-1 (all produced by Konica Minolta Opt, Inc.). Alternatively, it is preferable to use a polarizing plate protective film, also functioning as an optical compensating film having an optical anisotropic layer, which is prepared by orienting liquid crystal compounds such as a discotic liquid crystal, a rod-shaped liquid crystal, or a cholesteric liquid crystal. It is possible to form the optical anisotropic layer employing the method described in JP-A No. 2003-98348. By employing the combination of the antireflection film of the present invention, it is possible to obtain polarizing plates which exhibit excellent flatness and viewing angle increasing effects.

The polarizing film which is a major constituting component of polarizing plates, as described herein, refers to the element which only transmits the light of a polarized wave in the definite direction. The representative polarizing film, which is presently known, is a polyvinyl alcohol based polarizing film which is classified to one prepared by dying polyvinyl alcohol based film with iodine and the other prepared by dying the same with dichroic dyes. The polarizing film is prepared in such a manner that an aqueous polyvinyl alcohol solution is cast and the resulting cast film is subjected to uniaxial orientation and dying, or is subjected to dying and uniaxial orientation and subsequently to a durability treatment employing preferably boron compounds. One side of the cellulose ester film of the present invention is adhered to the surface of the above polarizing film, whereby a polarizing plate is formed. Adhesion is performed employing preferably water based adhesives employing completely-saponified polyvinyl alcohol as a major component.

A polarizing film is subjected to uniaxial orientation (commonly in the longitudinal direction). When a polarizing plate is allowed to stand at high temperature and high humidity, the length in the orientation direction (commonly in the longitudinal direction) decreases, while the length in the perpendicular direction (commonly the width direction) increases. As the thickness of a polarizing plate protective film decreases, elongation and shrinkage ratio increases, while a degree of contraction in the orientation direction of the polarizing film particularly increases. Generally, adhesion of a polarizing film to a polarizing plate protective film so that the orientation direction of the polarizing film is at the fright angles to the casting direction (being the MD direction) of the polarizing plate protective layer. Consequently, it is critical that when the thickness of the polarizing plate protective film decreases, it is important that elongation and shrinkage ratio in the casting direction exhibit no significant change. The optical film of the present invention is suitably applied to such a polarizing plate protective film due to excellent dimensional stability.

Namely, in a durability test at 60° C. and 90% RH, wavy unevenness does not increase. After the durability test, the polarizing plate having an optical compensating film on the reverse side results in no variation of viewing angle characteristics whereby it is possible to provide excellent visibility.

It is possible to constitute a polarizing plate further by adhering a protect film onto one side of the polarizing plate and a separate film onto the opposite side. The protect film and separate film are employed to protect the polarizing plate at its shipping and product inspection. In this case, the protect film is adhered to protect the surface of the polarizing plate and is employed on the side opposite the side to adhere the polarizing plate to a liquid crystal plate. Further, the separate film is employed to cover the adhesion layer to adhere to the liquid crystal plate and is employed on the side to adhere the polarizing plate to a liquid cell.

### (Display Devices)

By incorporating the polarizing plate of the present invention into a display device, it is possible to prepare the various display devices of the present invention, which exhibit excellent visibility. The antireflection film of the present invention is preferably employed in a reflection type, transmission type, and a semi-transmission type LCD or LCD of various driving systems such as a TN type, a STN type, an OCB type a HAN type, a VA type (a PVA type and a MVA type), and an IPS type. Further, the cellulose ester film of the present invention exhibits excellent flatness and is employed to various display devices such as a plasma display, a field emission display, an organic EL display, an inorganic EL display, an electrons paper. Particularly, in a large image screen display device of 30 or more type, uneven color and wavy unevenness were minimized, resulting in effects of minimal eye fatigue even for viewing of an extended period.

### EXAMPLE

Hereafter, the present invention is concretely explained based on Examples, however, the present invention is not limited to these Examples.

### Example 1

### Synthesis Example of Polymer UV Agent P-1

Based on the method described below, was synthesized 2(2′-hydroxy-5′-t-butyl-phenyl)-5-carboxylic acid-(2-methacryloyloxy)ethylester-2H-benzotriazol (Exemplified Compound MUV-19).

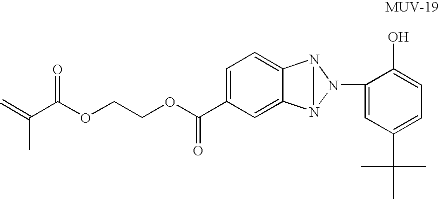

Dissolved in 160 ml of water was 20.0 g of 3-nitro-4-amino-benzoic acid followed by the addition of 43 ml of concentrated hydrochloric acid. After adding 8.0 g of sodium nitrite which was dissolved in 20 ml of water to the above solution at 20° C., the resulting mixture was stirred for two hours while maintained at 0° C. Into the resulting solution dripped was a solution prepared by dissolving 17.3 g of 4-t-butylphenol in 50 ml of water and 100 ml of methanol at 0° C. while maintained to be alkaline employing potassium carbonate. The resulting solution was stirred at 0° C. for one hour and stirred at room temperature for an additional one hour. The reaction liquid composition was acidified by the addition of hydrochloric acid. The formed precipitates were collected via filtration and were well washed with water.

The precipitates collected by filtration were dissolved in 500 ml of a 1 mol/L aqueous NaOH solution. After adding 35 g of zinc powder to the resulting solution, 110 g of a 40% aqueous NaOH solution was dripped. After dripping, stirring was performed for approximately two hours. The resulting mixture was filtered and washed with water. The resulting filtrate was neutralized by the addition of hydrochloric acid. Deposited precipitates were collected by filtration, washed with water and dried. Thereafter recrystallization was performed employing a mixed solvent of ethyl acetate and acetone, whereby 2(2′-hydroxy-5′-t-butyl-phenyl)-5-carboxylic acid-2H-benzotriazole was obtained.

Subsequently added to 100 ml of toluene were 10.0 g of 2(2′-hydroxy-5′-t-butyl-phenyl)-5-carboxylic acid-2H-benzotriazole, 0.1 g of hydroquinone, 4.6 g of 2-hydroxyethyl methacrylate, and 0.5 g of p-toluenesulfonic acid, the resulting mixture underwent thermal refluxing for 10 hours in a reaction vessel fitted with an ester tube. The reaction solution was poured to water, and deposited crystals were collected via filtration, washed with water, dried, and recrystallized employing ethyl acetate, whereby 2(2′-hydroxy-5′-t-butyl-phenyl)-5-carboxylic acid-(2-methacryloyloxy)ethylester-2H-benzotriazole which was Exemplified compound MUV-19 was obtained.

Subsequently, the copolymer (Polymer UV Agent P-1) of 2(2′-hydroxy-5′-t-butyl-phenyl)-carboxylic acid-(2-methacryloyloxy)ethylester-2H-benzotriazole with methyl methacrylate was synthesized employing the method described below.

Added to 250 ml of tetrahydrofuran were 4.0 g of 2(2′-hydroxy-5′-t-butyl-phenyl)-5-carboxylic acid-(2-methacryloyloxy)ethylester-2H-benzotriazole, which was synthesized in above method, and 5.0 g of methyl methacrylate and 1 g of hydroxyethyl methacrylate, and then 2 g of azoisobutyronitrile. The resulting mixture underwent thermal refluxing in an ambience of nitrogen for 8 hours. After distilling out tetrahydrofuran under vacuum, the resulting products were re-dissolved in 20 ml of tetrahydrofuran, and the resulting solution was dripped into an excessive amount of methanol. The deposited precipitates were collected via filtration and was dried under vacuum at 40° C., whereby Polymer UV Agent P-1 in the form of gray powders was obtained. It was confirmed that the weight average molecular weight of the resulting copolymer was 3,000, employing GPC analysis in which the standard polystyrene was used as a standard.

Based on NMR spectra and UV spectra, the above copolymer was identified to have almost the following composition; 2(2′-hydroxy-5′-t-butyl-phenyl)-5-carbocylic acid-(2-methacryloyloxy)ethylester-2H-benzotriazol:methyl methacrylate:hydroxyethyl methacrylate was 40:50:10.

### (Production of Polarizing Plate Protective Film)

With a vacuum-Nautar mixer, 100 parts by weight of cellulose acetate propionate already dried at 80° C. for 6 hours (moisture content: 200 ppm) and having an acetyl group substitution degree of 1.95, a propionyl group substitution degree of 0.7 and a number average molecular weight of 60000, parts by weight of trimethylolpropane tribenzoate, 1.0 parts by weight of polymer UV agent P-1, 0.1 parts by weight of 2,6-di-t-butyl-p-cresol 0.1 parts by weight of pentaerisritil tetrakis[3-(3,5-di-t-butyl-4-hydroxyphenyl) propionate], 0.1 parts by weight of triisodecyl phosphate and 0.1 parts by weight of SeahostarKEP-10 (produced by NIPPON SHOKUBAI) were further dried at 80° C. under 1 Torr for 3 hours while being mixed. The obtained mixture was melted and mixed at 235° C. by a bi-axial type extruder and was pelletized. At this time, in order to reduce heat generation due to shearing at the time of kneading, an all-screw type screw was used in place of a kneading disk. Further, vacuum was produced through a vent hole, and the volatile components generated during kneading were removed by vacuum suction. To avoid moisture absorption into the resin, a dry nitrogen atmosphere was used in the space between the feed and hopper for supply to the extruder, and the cooling tank from the extrusion dies.

The film was formed using the film manufacturing apparatus of FIG. 1.

The first cooling roll and second cooling roll were made of stainless steel having a diameter of 40 cm, and the surface was provided with hard chromium plating. A temperature adjusting oil (coolant fluid) was circulated inside to control the roll surface temperature. The elastic touch roll had a diameter of 20 cm and the inner sleeve and outer sleeve were made of stainless steel. The surface of the outer sleeve was provided with hard chromium plating. The outer sleeve had a wall thickness of 2 mm, and a temperature adjusting oil (coolant fluid) was circulated in the space between the inner sleeve and outer sleeve, whereby the surface temperature of the elastic touch roll was controlled.

Using a single screw extruder, the pellets having been obtained (moisture regain: 50 ppm) was melt-extruded in the form of a film at a melting temperature of 250° C. through the T-die onto the first cooling roll having a surface temperature of 100° C. This was drawn at a draw ratio of 20, whereby a cast film having a thickness of 80 μm was produced. In this case, the T-die used had a lip clearance of 1.5 mm and a lip section average surface roughness of Ra 0.01 μm. Further, on the first cooling roll, an elastic touch roll having a 2 mm-thick metal surface was pressed against the film at a linear pressure of 10 kg/cm. The film temperature on the side of the touch roll at the time of pressing was 180° C.±1° C. (The film temperature on the touch roll side at the time of pressing in the sense in which it is used here refers to the average value of the film surface temperatures of the film at the position in contact with the touch roll on the first roll (cooling roll), wherein these temperatures were measured at 50 points by a non-contact thermometer across the width at a position 50 cm away by retracting the touch roll so that there was no touch roll. The glass transition temperature Tg of this film was 136° C. (The glass transition temperature of the film extruded by the die was measured according to the DSC method (temperature rise at 10° C. per minute in nitrogen) using the DSC6200 of Seiko Co., Ltd.

The surface temperature of the elastic touch roll was 100° C., and the surface temperature of the second cooling roll was 30° C. The surface temperatures of the elastic touch roll, the first cooling roll and second cooling roll were obtained as follows: The temperatures of the roll surface 90° before in the direction of rotation from the position wherein the film contacts the roll for the first time were measured across the width at ten points using a non-contact thermometer. The average of these measurements was used as the surface temperature of each roll.

The film having been obtained was introduced into a tenter having a preheating zone, drawing zone, retaining zone, and cooling zone (as well as the neutral zones to ensure heat insulation between zones). It was drawn to 1.3 times across the width at 160° C. After that, the film was loosened 2% across the width and temperature was reduced to 30° C. Then the film was released from the clip and the clip holding section was trimmed off, whereby a polarizing plate protective film 1 having a thickness of 60 μm was obtained. In this case, the preheating temperature and retaining temperature were adjusted to avoid bowing resulting from the process of drawing. No residual solvent was detected from the polarizing plate protective film 1 having been produced.

Inventive polarizing plate protective films 2 to 8 according to the present invention and comparative polarizing plate protective films 1 to 4 with respective thickness of 60 μm were obtained with the same ways as that of the polarizing plate protective film 1 except that the lip clearance, the touch roll line pressure, and the film temperature at the time of pressing were changed as shown in Table 1.

The obtained polarizing plate protective films were subjected to Ro and Rt measurement and polarizing plates were produced based on these polarizing plate protective films. When a liquid crystal display device was observed, light and dark streaks and spot-like unevenness were evaluated. The results are indicated in Table 0.1.

### (Production of a Polarizing Plate)

Polyvinyl alcohol film with a thickness of 120 μm was immersed in 100 parts by weight of aqueous solution containing 1 parts by weight of iodine and 4 parts by weight of boric acid and was stretched vertically to 6 times at 50° C., whereby a polarizing film was made.

Subsequently, two sheets of each of the polarizing plate protective films of the present invention were immersed into a sodium hydroxide aqueous solution with a concentration 2 mol/l for 2 minutes at 60° C., then were washed with water and dried at 100° C. for 10 minutes thereafter, the resultant polarizing plate protective films of the present invention were pasted on both sides of the polarizing film with adhesive composed of 5% complete saponification type polyvinyl alcohol aqueous solution, whereby polarizing plates were produced. With the same manner, another polarizing plates were produced based on the comparative polarizing plate protective films.

Corona treatment was performed for the one side surface of the obtained polarizing plates with a processing rate of 50 dyn/cm, and then an adhesive layer was laminated, and aging processing was conducted for one week at normal temperature. The adhesive layer was prepared in such a way that a solution in which 0.1 parts by weight of trimethylolpropane tolylene diisocyanate as a cross linking agent was mixed in 99.9 parts by weight of acrylic ester system binder (mass ratio of butyl acrylate to acrylic acid was 95:5) was coated on a releasing type film (38 μm thickness polyethylene terephthalate film one side of which was subjected to a silicone treatment) and dried.

After the polarizing plate beforehand pasted on a commercial liquid crystal display was removed carefully, the obtained polarizing plate was pasted so as to conform with the transmission axis of the polarizing plate pasted originally, whereby the liquid crystal display was prepared.

### (Ro, Rt)

With Respect to the Obtained Films, Ro and Rt were measured at 10 points along the width direction in the following manner and were represented by the average values, respectively.

Three dimensional refractive index measurement was performed at a wavelength of 590 nm under an atmosphere of 23° C., 55% RH by use of an automatic double refractometer KOBRA-21ADH (produced by Oji Scientific Instruments) so as to obtain refractive index Nx in the slow axis direction, refractive index Ny in the fast axis direction and refractive index Nz in the thickness direction. Retardation in the thickness direction (Rt) and retardation in the in-plane direction (Ro) were calculated according to the following equation.

Ro=(Nx−Ny)×d

Rt={(Nx+Ny)/2−Nz},

(Here, a refractive index in the slow axis direction is Nx, a refractive index in the fast axis direction is Ny, a refractive index in the thickness direction is Nz and a layer thickness of film is d (nm).

### (Light and Dark Streak)

The films were pasted on respective polarizing plate, and these polarizing plates were assembled into a liquid crystal display and an image was displayed. The light and dark streaks due to streaks were visually observed and ranked based on the following criteria.

Rank Criteria

AA: No streaks are observed.

A: No streaks are observed.

B: Slight streaks are partly observed on the screen.

C: Slight streaks are observed all over the screen.

D: Distinct steaks are partly observed on the screen.

E: Distinct streaks are observed all over on the screen.

### (Spot-Like Unevenness)

The films were pasted on respective polarizing plate, and these polarizing plates were assembled into a liquid crystal display. When a black indication was displayed, light and dark appearing in a spot-like or a plane-like were visually observed and ranked based on the following criteria.

Rank Criteria

AA: No pass-through of light and uniform-dark visual field all over the screen.

A: No pass-through of light and uniform dark visual field all over on the screen.

B: Light and dark was slightly partly observed on the screen.

C: Light and dark was slightly observed all over on the screen.

D: Light and dark was partly observed on the screen.

E: Light and dark was observed all over on the screen.

Here, Rank AA shows a more preferable result than Rank A.

TABLE 1

| | | | Film | | | | |
|---|---|---|---|---|---|---|---|
| | | Touch | temperature | | | Light and | |
| | Draw | roll line | at the time | | | dark | Spot-like |
| | ratio | pressure | of pressing | R0 | Rt | streaks | unevenness |
| | — | Kg/cm | ° C. | nm | nm | Rank | Rank |
| Inventive polarizing plate | 18.8 | 10 | 180 ± 1 | 10 | 130 | A | A |
| protective film 1 | | | | | | | |
| Inventive polarizing plate | 18.8 | 1 | 180 ± 1 | 15 | 100 | B | A |
| protective film 2 | | | | | | | |
| Inventive polarizing plate | 18.8 | 15 | 180 ± 1 | 5 | 120 | A | A |
| protective film 3 | | | | | | | |
| Comparative polarizing plate | 18.8 | Non-use | (180 ± 1) | 20 | 140 | E | D |
| protective film 1 | | | | | | | |
| Inventive polarizing plate | 10 | 10 | 180 ± 1 | 45 | 125 | A | A |
| protective film 4 | | | | | | | |
| Inventive polarizing plate | 30 | 10 | 180 ± 1 | 1 | 130 | A | B |
| protective film 5 | | | | | | | |
| Comparative polarizing plate | 18.8 | 20 | 180 ± 1 | 5 | 130 | D | E |
| protective film 2 | | | | | | | |
| Comparative polarizing plate | 5 | 10 | 180 ± 1 | 50 | 110 | D | D |
| protective film 3 | | | | | | | |
| Comparative polarizing plate | 35 | 10 | 180 ± 1 | 3 | 150 | D | E |
| protective film 4 | | | | | | | |
| Inventive polarizing plate | 18.8 | 10 | 140 ± 1 | 8 | 125 | B | B |
| protective film 6 | | | | | | | |
| Inventive polarizing plate | 18.8 | 10 | 245 ± 1 | 50 | 120 | A | A |
| protective film 7 | | | | | | | |
| Inventive polarizing plate | 18.8 | 7 | 180 ± 1 | 10 | 130 | AA | AA |
| protective film 8 | | | | | | | |

In the polarizing plate protective films 1-8 of the present invention in comparison with comparative examples, it is more distinct from the above Table that light and dark streaks and spot-like unevenness are improved.

### Example 2

With a vacuum-Nautar mixer, 100 parts by weight of cellulose acetate propionate already dried at 80° C. for 6 hours (moisture content: 150 ppm) and having an acetyl group substitution degree of 1.6, a propionyl group substitution degree of 1.2 and a number average molecular weight of 75000, 11 parts by weight of trimethylolpropane tribenzoate, 1.0 parts by weight of polymer UV agent P-1, 0.2 parts by weight of IRGANOX1010 (produced by in Chiba Specialty Chemicals), and 0.1 parts by weight of triisodecyl phosphate were further dried at 80° C. under 1 Torr for 3 hours while being mixed. Under dry nitrogen atmosphere, the obtained mixture was melted and mixed at 235° C. by a bi-axial type extruder and was pelletized. At this time, in order to reduce heat generation due to shearing at the time of kneading, an all-screw type screw was used in place of a kneading disk. Further, vacuum was produced through a vent hole, and the volatile components generated during kneading were removed by vacuum suction. To avoid moisture absorption into the resin, a dry nitrogen atmosphere was used in the space between the feed and hopper for supply to the extruder, and the cooling tank from the extrusion dies.

Polarizing plate protective films 2-1 to 2-22 of the present invention and the polarizing plate protective film 3-1 to 3-11 of the comparative example were produced as shown in Table 2 with the same manner as that of Example 1 except that the pellets produced by the above-mentioned method were used. The glass transition temperature of the film was 132° C.

With the same manner as that of Example 1, polarizing plates were produced based on the obtained polarizing plate protective films and were assembled in a liquid crystal display device. When the liquid crystal display device was observed, light and dark streaks and spot-like unevenness were evaluated. The results are indicated in Table 2.

TABLE 2

| | | | Film | | |
|---|---|---|---|---|---|
| | | Touch | temperature | Light and | |
| | Draw | roll line | at the time | dark | Spot-like |
| | ratio | pressure | of pressing | streaks | unevenness |
| | — | Kg/cm | ° C. | Rank | Rank |
| * 2-1 | 18.8 | 10 | 175 | A | A |
| * 2-2 | 18.8 | 1 | 175 | B | A |
| * 2-3 | 18.8 | 15 | 180 | A | A |
| * 2-4 | 18.8 | 10 | 140 | B | B |
| * 2-5 | 18.8 | 15 | 133 | B | B |
| * 2-6 | 18.8 | 15 | 160 | A | A |
| * 2-7 | 18.8 | 5 | 220 | AA | AA |
| * 2-8 | 18.8 | 8 | 200 | AA | AA |
| * 2-9 | 18.8 | 10 | 220 | A | A |
| * 2-10 | 10 | 5 | 200 | AA | AA |
| * 2-11 | 10 | 1 | 240 | A | A |
| * 2-12 | 10 | 10 | 150 | B | B |
| * 2-13 | 10 | 15 | 140 | B | B |
| * 2-14 | 10 | 1 | 175 | B | A |
| * 2-15 | 10 | 5 | 175 | AA | AA |
| * 2-16 | 10 | 10 | 175 | A | A |
| * 2-17 | 10 | 15 | 175 | A | A |
| * 2-18 | 30 | 1 | 175 | B | B |
| * 2-19 | 30 | 5 | 175 | AA | AA |
| * 2-20 | 30 | 5 | 190 | AA | AA |
| * 2-21 | 30 | 10 | 180 | A | B |
| * 2-22 | 30 | 15 | 180 | A | B |
| ** 3-1 | 18.8 | 20 | 175 | D | E |
| ** 3-2 | 10 | 20 | 175 | D | E |
| ** 3-3 | 30 | 20 | 175 | D | E |
| ** 3-4 | 30 | 20 | 125 | E | E |
| ** 3-5 | 5 | 10 | 175 | D | D |
| ** 3-6 | 5 | 20 | 175 | D | D |
| ** 3-7 | 35 | 10 | 175 | D | E |
| ** 3-8 | 18.8 | (Non-use) | 175 | E | D |
| ** 3-9 | 10 | (Non-use) | 175 | E | D |
| ** 3-10 | 10 | (Non-use) | 245 | E | E |
| ** 3-11 | 30 | (Non-use) | 175 | E | D |

* Inventive polarizing plate protective film
** Comparative polarizing plate protective film

In the polarizing plate protective films 2-1 to 2-12 of the present invention in comparison with comparative examples, it is more distinct from the above Table that light and dark streaks and spot-like unevenness are improved, reproducing the results of Example 1.

1-9. (canceled)

10. A film producing method, comprising the steps of:
extruding a melt containing cellulose resin from a slit of a die onto a cooling roller so as to form a melted film such that a below-defined draw ratio becomes 10 to 30;
pressing the melted film onto the cooling roller with a touch roll; and
conveying the melted film while solidifying the melted film on the cooling roller;
wherein the touch roller comprises a metallic outer cylinder, an inner cylinder and a space to accommodate a coolant between the metallic outer cylinder and the inner cylinder and presses the melted film onto the cooling roller with a line pressure of 1 kg/cm to 15 kg/cm, and
wherein the draw ratio is a value obtained by a calculation to divide a slit gap size B of the die by an average thickness A of the film solidified on the cooling roller.

11. The film producing method described in claim 10, wherein when the average thickness of the film solidified on the cooling roller is 70 μm or more and 100 μm or less, the draw ratio is 10 or more and less than 20.

12. The film producing method described in claim 10, wherein when the average thickness of the film solidified on the cooling roller is 50 μm or more and less than 70 μm, the draw ratio is 20 or more and less than 25.

13. The film producing method described in claim 10, wherein when the average thickness of the film solidified on the cooling roller is less than 50 μm, the draw ratio is 25 or more and less than 30.

14. The film producing method described in claim 10, wherein the line pressure is 2 kg/cm² or more and less than 10 kg/cm².

15. The film producing method described in claims 10, wherein a touch roller side film surface temperature T (° C.) of the melted film is within a range of Tg<T<(Tg+110), here, Tg is a glass transition temperature of the film and is obtained by DSC measurement.

16. A polarizing plate protective film produced by the film producing method described in claim 10.

17. A polarizing plate, comprising:
a polarizer; and
the polarizing plate protective film described in claim 16 and pasted on at least one surface of the polarizer.

18. A liquid crystal display apparatus, comprising:
a liquid crystal cell, and
the polarizing plate described in claim 17 and pasted on at least one surface of the liquid crystal cell.
